(19) United States
(12) Patent Application Publication
(10) Pub. No.: US 2015/0090922 A1
(43) Pub. Date: Apr. 2, 2015

(54) THERMALLY CONDUCTIVE SHEET

(71) Applicant: NITTO DENKO CORPORATION, Ibaraki-shi, Osaka (JP)

(72) Inventors: Yoshiharu Hatakeyama, Osaka (JP); Kenichi Fujikawa, Osaka (JP); Miho Yamaguchi, Osaka (JP); Saori Yamamoto, Osaka (JP); Seiji Izutani, Osaka (JP)

(73) Assignee: NITTO DENKO CORPORATION, Ibaraki-shi, Osaka (JP)

(21) Appl. No.: 14/373,564

(22) PCT Filed: Feb. 7, 2013
(86) PCT No.: PCT/JP2013/052954

§ 371 Date: Jul. 21, 2014

(30) Foreign Application Priority Data
Feb. 8, 2012 (JP) 2012-025344
Jan. 25, 2013 (JP) 2013-012648
Jan. 25, 2013 (JP) 2013-012649
Jan. 25, 2013 (JP) 2013-012650
Jan. 25, 2013 (JP) 2013-012651
Jan. 25, 2013 (JP) 2013-012652
Jan. 25, 2013 (JP) 2013-012653

(51) Int. Cl. C09K 5/14

(52) U.S. Cl. CPC C09K 5/14
USPC 252/74

(57) ABSTRACT

A thermally conductive sheet is a thermally conductive sheet 1 formed from a thermally conductive composition containing boron nitride particles 2 in a plate shape and a rubber component. The content ratio of the boron nitride particles 2 is 35 vol % or more and the thermal conductivity in a direction perpendicular to a plane direction PD of the thermally conductive sheet 1 is 4 W/m·K or more.

### TECHNICAL FIELD

The present invention relates to a thermally conductive sheet, to be specific, to a thermally conductive sheet preferably used for power electronics technology.

### BACKGROUND ART

In recent years, power electronics technology that uses a semiconductor element to convert and control electric power is applied in a high-brightness LED device, an electromagnetic induction heating device, and the like. In the power electronics technology, a high current is converted to heat or the like and thus, a material that is disposed at the semiconductor element is required to have excellent heat dissipating properties (excellent thermally conductive properties).

For example, a thermally conductive sheet containing a boron nitride filler and an epoxy resin has been proposed (ref: for example, Patent Document 1).

### PRIOR ART DOCUMENT

### Patent Document

Patent Document 1: Japanese Unexamined Patent Publication No. 2008-189818

### SUMMARY OF THE INVENTION

### Problems to be Solved by the Invention

The thermally conductive sheet may be required to have high thermally conductive properties in a direction (a plane direction) perpendicular to a thickness direction depending on its use and purpose.

There is also a disadvantage that when the thermally conductive sheet in Patent Document 1 is disposed so as to cover an electronic component such as a semiconductor element, the flexibility of the sheet is low in the thermally conductive sheet, so that damage such as cracking (a crack) easily occurs in a portion that corresponds to a corner portion of the semiconductor element.

It is an object of the present invention to provide a thermally conductive sheet having excellent thermally conductive properties in the plane direction and excellent flexibility.

### Solution to the Problems

In order to achieve the above-described object, the present invention includes the following first to sixth invention groups.

(First Invention Group)

A thermally conductive sheet of the present invention is formed from a thermally conductive composition containing boron nitride particles in a plate shape and a rubber component, wherein the content ratio of the boron nitride particles in the thermally conductive sheet is 35 vol % or more and the thermal conductivity in a direction perpendicular to a thickness direction of the thermally conductive sheet is 4 W/m·K or more.

In the thermally conductive sheet of the present invention, it is preferable that the thermally conductive sheet has the maximum elongation in the direction perpendicular to the thickness direction in a tensile test of 101.7% or more.

In the thermally conductive sheet of the present invention, it is preferable that a rubber-containing sheet has a shear storage elastic modulus of 5.6×10³ to 2×10⁵ Pa at least any temperature in a temperature range of 20 to 150° C. when the temperature of the rubber-containing sheet is increased under the following conditions:

a temperature rising rate of 2° C./min, and

a frequency of 1 Hz,

the rubber-containing sheet being formed from a rubber-containing composition obtained by excluding the boron nitride particles from the thermally conductive composition.

In the thermally conductive sheet of the present invention, it is preferable that the thermally conductive sheet has a 90 degree peel adhesive force of 2 N/10 mm or more when the thermally conductive sheet is peeled at 90 degrees and a rate of 10 mm/min from a copper foil after bonding the thermally conductive sheet to the copper foil.

In the thermally conductive sheet of the present invention, it is preferable that the thermally conductive composition further contains an epoxy resin composition.

(Second Invention Group)

A thermally conductive sheet of the present invention is formed from a thermally conductive composition containing boron nitride particles in a plate shape, an epoxy resin, at least one of a curing agent and a curing accelerator, and a rubber component, wherein the content ratio of the boron nitride particles in the thermally conductive sheet is 35 vol % or more; the thermal conductivity in a direction perpendicular to a thickness direction of the thermally conductive sheet is 4 W/m·K or more; and a rubber-containing sheet has a shear storage elastic modulus of 5.5×10³ to 7.0×10⁴ Pa at least any temperature in a temperature range of 50 to 80° C. when the temperature of the rubber-containing sheet is increased under the following conditions:

a temperature rising rate of 2° C./min, and

a frequency of 1 Hz,

the rubber-containing sheet being formed from a rubber-containing composition obtained by excluding the boron nitride particles from the thermally conductive composition.

In the thermally conductive sheet of the present invention, it is preferable that the epoxy resin contains a liquid epoxy resin at a normal temperature and a solid epoxy resin at a normal temperature.

In the thermally conductive sheet of the present invention, it is preferable that the curing agent is a phenol resin.

In the thermally conductive sheet of the present invention, it is preferable that the curing accelerator is an imidazole compound.

In the thermally conductive sheet of the present invention, it is preferable that the thermally conductive sheet has an epoxy reaction rate after being stored at a room temperature for 30 days of less than 40%.

In the thermally conductive sheet of the present invention, it is preferable that the thermally conductive sheet has an epoxy reaction rate after being stored in a temperature range of 40 to 100° C. for one day of 40% or more.

(Third Invention Group)

A thermally conductive sheet of the present invention contains boron nitride particles in a plate shape and a resin component, wherein the content ratio of the boron nitride particles is 60 mass % or more, the thermal conductivity in a plane direction is 4 W/m·K or more, and the thermally conductive sheet has a tack force of 350 g/diameter of 2 cm or more in a temperature range of 40° C. or more.

In the thermally conductive sheet of the present invention, it is preferable that the thermally conductive sheet has a tack force of 1200 g/diameter of 2 cm or more in a temperature range of 90° C. or less.

In the thermally conductive sheet of the present invention, it is preferable that the thermally conductive sheet has a tack force of 50 g/diameter of 2 cm or more in a temperature range of 60° C. or less.

In the thermally conductive sheet of the present invention, it is preferable that the thermally conductive sheet has a tack force of 50 g/diameter of 2 cm or less in a temperature range of 25° C. or less.

In the thermally conductive sheet of the present invention, it is preferable that the resin component contains an epoxy resin.

In the thermally conductive sheet of the present invention, it is preferable that the resin component contains a rubber.

A thermally conductive sheet-forming particle aggregate powder of the present invention contains resin-covered boron nitride particles containing boron nitride particles and a resin component covering the surfaces of the boron nitride particles, wherein the ratio of resin contributing ion/boron nitride contributing ion based on a TOF-SIMS analysis is 0.4 or more.

A method for producing a thermally conductive sheet-forming particle aggregate powder of the present invention includes a covering step of obtaining a particle aggregate powder containing resin-covered boron nitride particles containing boron nitride particles and a resin component covering the surfaces of the boron nitride particles by spraying the resin component to the boron nitride particles, while the boron nitride particles in a plate shape are floated in the air.

A method for producing a thermally conductive sheet of the present invention includes a covering step of obtaining a particle aggregate powder containing resin-covered boron nitride particles containing boron nitride particles and a resin component covering the surfaces of the boron nitride particles by spraying the resin component to the boron nitride particles, while the boron nitride particles in a plate shape are floated in the air and a forming step of forming a thermally conductive sheet by heating and pressing the particle aggregate powder.

(Fourth Invention Group)

A thermally conductive sheet of the present invention has thermal conductivity in a plane direction of 4 W/m·K or more and has a breaking strain in the plane direction of 125% or more in a temperature range of 40° C. or more.

In the thermally conductive sheet of the present invention, it is preferable that the thermally conductive sheet has a breaking strain of less than 125% in a temperature range of less than 40° C.

In the thermally conductive sheet of the present invention, it is preferable that the thermally conductive sheet has a breaking strain in the plane direction of less than 125% in a temperature range of 25° C. or less and has a breaking strain in the plane direction of 125% or more in a temperature range of 40° C. or more and less than 100° C.

In the thermally conductive sheet of the present invention, it is preferable that the thermally conductive sheet has a breaking strain in the plane direction of 125% or more in a temperature range of 60° C. or more and less than 70° C.

In the thermally conductive sheet of the present invention, it is preferable that the thermally conductive sheet contains boron nitride particles in a plate shape.

In the thermally conductive sheet of the present invention, it is preferable that the thermally conductive sheet contains a rubber.

In the thermally conductive sheet of the present invention, it is preferable that the thermally conductive sheet contains an epoxy resin and a phenol resin.

In the thermally conductive sheet of the present invention, it is preferable that the thermally conductive sheet contains a liquid epoxy resin at a normal temperature, a solid epoxy resin at a normal temperature, and a phenol resin.

In the thermally conductive sheet of the present invention, it is preferable that the thermally conductive sheet further contains a curing accelerator.

In the thermally conductive sheet of the present invention, it is preferable that the thermally conductive sheet is curable at 100° C. or less.

In the thermally conductive sheet of the present invention, it is preferable that the thermally conductive sheet has a dielectric breakdown voltage of 10 kV/mm or more.

(Fifth Invention Group)

A thermally conductive sheet of the present invention includes a thermally conductive layer containing boron nitride particles in a plate shape and a rubber component and having thermal conductivity in a direction perpendicular to a thickness direction of 4 W/m·K or more and an adhesive layer laminated on at least one surface of the thermally conductive layer.

In the thermally conductive sheet of the present invention, it is preferable that the adhesive layer has a tack force of 650 g/(diameter of 1 cm) or more in a temperature range of 0° C. or more and is a pressure-sensitive adhesive layer capable of pressure-sensitive adhesion.

In the thermally conductive sheet of the present invention, it is preferable that the adhesive layer contains a rubber component.

In the thermally conductive sheet of the present invention, it is preferable that the rubber component contained in the thermally conductive layer and the adhesive layer contains an acrylic rubber.

In the thermally conductive sheet of the present invention, it is preferable that the adhesive layer further contains an epoxy resin, a curing agent, and a curing accelerator.

In the thermally conductive sheet of the present invention, it is preferable that the thermally conductive layer further contains an epoxy resin, a curing agent, and a curing accelerator.

In the thermally conductive sheet of the present invention, it is preferable that the adhesive layer has a thickness of 50 μm or less.

(Sixth Invention Group)

A thermally conductive sheet of the present invention includes a thermally conductive layer containing boron nitride particles in a plate shape and a rubber component and having thermal conductivity in a direction perpendicular to a thickness direction of 4 W/m·K or more and a pressure-sensitive adhesive layer laminated on at least one surface of the thermally conductive layer.

In the thermally conductive sheet of the present invention, it is preferable that the pressure-sensitive adhesive layer contains an acrylic pressure-sensitive adhesive.

In the thermally conductive sheet of the present invention, it is preferable that the acrylic pressure-sensitive adhesive is prepared from an acrylic polymer obtained by polymerization of a monomer material containing an alkyl(meth)acrylate.

In the thermally conductive sheet of the present invention, it is preferable that the pressure-sensitive adhesive layer includes a substrate film, and a first pressure-sensitive adhesive layer and a second pressure-sensitive adhesive layer laminated on one surface and the other surface in the thickness direction of the substrate film.

In the thermally conductive sheet of the present invention, it is preferable that the pressure-sensitive adhesive layer has a thickness of 100 μm or less.

In the thermally conductive sheet of the present invention, it is preferable that the thermally conductive layer further contains an epoxy resin, a curing agent, and a curing accelerator.

### Effect of the Invention

The thermally conductive sheet of the present invention has the thermal conductivity in the direction perpendicular to the thickness direction of 4 W/m·K or more and thus, has excellent thermally conductive properties in the direction perpendicular to the thickness direction. Thus, the thermally conductive sheet of the present invention is capable of being used for various heat dissipation applications as a thermally conductive sheet that has excellent thermally conductive properties in the direction perpendicular.

The thermally conductive sheet of the present invention contains the rubber component. Thus, the thermally conductive sheet has excellent flexibility, so that when the thermally conductive sheet is disposed so as to cover an electronic component such as a semiconductor element, damage such as a crack is capable of being suppressed. As a result, the thermally conductive sheet is capable of surely covering a heat dissipation object and thus, heat generated from the heat dissipation object is capable of being further surely conducted by the boron nitride particles.

### BRIEF DESCRIPTION OF THE DRAWINGS

FIG. 1 shows a perspective view of a first embodiment of a thermally conductive sheet of the present invention.

FIG. 2 shows a process drawing for illustrating a method for producing the thermally conductive sheet shown in FIG. 1.

FIG. 3 shows process drawings for illustrating a method for producing another embodiment of a thermally conductive sheet of the present invention:

FIG. 3A illustrating a step of dividing a pressed sheet into a plurality of pieces and

FIG. 3B illustrating a step of laminating divided sheets.

FIG. 4 shows a perspective view of a Type I test device of a bend test (before the bend test).

FIG. 5 shows a perspective view of a Type I test device of a bend test (during the bend test).

FIG. 6 shows a straight line and an inclination thereof calculated by a least squares method from plotted points obtained by plotting the maximum elongation A (%) in a plane direction of a thermally conductive sheet obtained by a tensile test with respect to the volume ratio X (%) of boron nitride particles in each of the thermally conductive sheets in Examples 42 to 44 and Comparative Example 6.

FIG. 7 shows a schematic view of a mounted substrate on which an electronic component is mounted used in a conformability to unevenness test.

FIG. 8 shows a sectional view for illustrating a test method in a conformability to unevenness test.

FIG. 9 shows a schematic view for illustrating a covering step in a method for producing a third embodiment of a thermally conductive sheet of the present invention.

FIG. 10 shows a perspective view of a fifth embodiment of a thermally conductive sheet of the present invention.

FIG. 11 shows sectional views for illustrating another embodiment of a thermally conductive sheet of the present invention:

FIG. 11A illustrating an embodiment in which adhesive layers are laminated on one surface and the other surface in a thickness direction of a thermally conductive layer and

FIG. 11B illustrating an embodiment in which an adhesive layer is a substrate-including adhesive layer obtained by laminating the adhesive layers on one surface and the other surface in the thickness direction of a base substrate.

FIG. 12 shows a perspective view of a sixth embodiment of a thermally conductive sheet of the present invention.

FIG. 13 shows sectional views for illustrating another embodiment of a thermally conductive sheet of the present invention:

FIG. 13A illustrating an embodiment in which pressure-sensitive adhesive layers are laminated on one surface and the other surface in a thickness direction of a thermally conductive layer and

FIG. 13B illustrating an embodiment in which the pressure-sensitive adhesive layer includes a substrate film, and a first pressure-sensitive adhesive layer and a second pressure-sensitive adhesive layer laminated on one surface and the other surface in the thickness direction of the substrate film.

### EMBODIMENT OF THE INVENTION

In the following, the present invention is described in detail in first to sixth embodiments.

### First Embodiment

A thermally conductive sheet in the first embodiment contains boron nitride particles and a rubber component.

To be specific, the thermally conductive sheet is formed from a thermally conductive composition that contains the boron nitride (BN) particles and the rubber component as a polymer matrix.

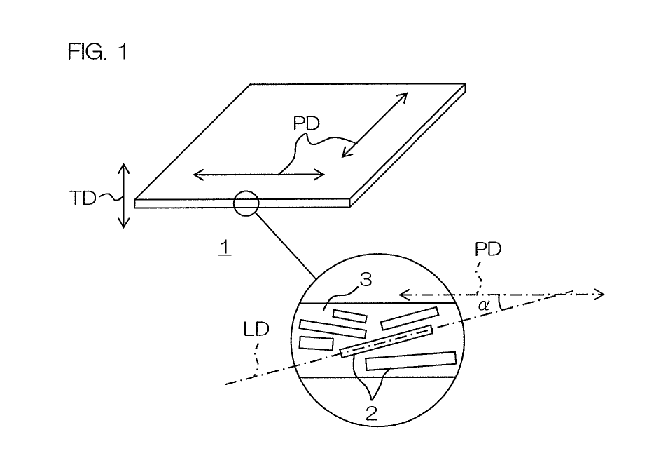

The boron nitride particles are formed into a plate shape (or a flake shape). The plate shape is required to include at least a flat plate shape having an aspect ratio and includes a circular plate shape and a hexagonal flat plate shape in a thickness direction of the plate. The plate shape may be a laminate in a plurality of layers. When the plate shape is a laminate, a shape obtained by laminating plate shapes each having a different size in step shapes and a shape having an end surface cleaved are included. The plate shape includes a linear shape (ref: FIG. 1) in a direction perpendicular to the thickness direction of the plate (a plane direction) and furthermore, a shape in which a linear shape thereof is slightly bent at a midway position. The boron nitride particles (ref: a numeral 2 in FIG. 1) are dispersed in a polymer matrix (ref: a numeral 3 in FIG. 1) so as to be oriented in the plane direction (described later) in the thermally conductive sheet.

The boron nitride particles have an average length in a longitudinal direction (the maximum length in the direction perpendicular to the thickness direction of the plate) of particles that account for 60% or more by volume ratio of, for example, 1 μm or more, preferably 5 μm or more, more preferably 10 μm or more, further more preferably 20 μm or more, particularly preferably 30 μm or more, or most preferably 40 μm or more, and of, for example, usually 800 μm or less.

The boron nitride particles have an average thickness (the length in the thickness direction of the plate, that is, the length in a short-side direction of the particles) of particles that account for 60% or more by volume ratio of, for example, 0.01 μm or more, or preferably 0.1 μm or more, and of, for example, 20 μm or less, or preferably 15 μm or less.

The boron nitride particles have an aspect ratio (the length in the longitudinal direction/the thickness) of particles that account for 60% or more by volume ratio of, for example, 2 or more, preferably 3 or more, or more preferably 4 or more, and of, for example, 10,000 or less, preferably 5,000 or less, or more preferably 2,000 or less.

The form, thickness, length in the longitudinal direction, and aspect ratio of the boron nitride particles are measured and calculated by an image analysis method. The form, thickness, length in the longitudinal direction, and aspect ratio of the boron nitride particles are capable of being obtained by, for example, SEM, X-ray CT, or a particle size distribution image analysis method.

The boron nitride particles have a volume average particle size measured by a laser diffraction and scattering method (a laser diffraction particle size analyzer (SALD-2100, manufactured by Shimadzu Corporation) of, for example, 1 μm or more, preferably 5 μm or more, more preferably 10 μm or more, further more preferably 20 μm or more, particularly preferably 30 μm or more, or most preferably 40 μm or more, and of, for example, 1000 μm or less, preferably 500 μm or less, or further more preferably 100 μm or less.

When the volume average particle size of the boron nitride particles satisfies the above-described range, the thermal conductivity is further excellent, compared to the case where the boron nitride particles having a volume average particle size out of the above-described range are mixed at the same vol %.

The boron nitride particles have a bulk density (JIS K 5101, an apparent density) of, for example, 0.1 g/cm³ or more, preferably 0.15 g/cm³ or more, or more preferably 0.2 g/cm³ or more, and of, for example, 2.3 g/cm³ or less, preferably 2.0 g/cm³ or less, further more preferably 1.8 g/cm³ or less, or particularly preferably 1.5 g/cm³ or less.

As the boron nitride particles, a commercially available product or processed goods thereof can be used. Examples of the commercially available product of the boron nitride particles include the “PT” series (for example, “PT-110” and “PT-120”) manufactured by Momentive Performance Materials Inc.; BN (for example, “SPG”) manufactured by DENKI KAGAKU KOGYO KABUSHIKI KAISHA; the “SHOBN™ UHP” series (for example, “SHOBN™ UHP-1”) manufactured by Showa Denko K.K.; and “HP-40” manufactured by MIZUSHIMA FERROALLOY CO., LTD.

The thermally conductive sheet (that is, the thermally conductive composition) may contain other inorganic microparticles in addition to the above-described boron nitride particles. Examples of the other inorganic microparticles include, as inorganic materials, carbide, a nitride (excluding boron nitride), an oxide, a hydroxide, a metal, and a carbon-based material.

Examples of the carbide include silicon carbide, boron carbide, aluminum carbide, titanium carbide, and tungsten carbide.

Examples of the nitride (excluding boron nitride) include a silicon nitride, an aluminum nitride, a gallium nitride, a chromium nitride, a tungsten nitride, a magnesium nitride, a molybdenum nitride, and a lithium nitride.

Examples of the oxide include a silicon oxide (silica), an aluminum oxide (alumina), a magnesium oxide (magnesia), a zinc oxide, a titanium oxide, and a cerium oxide. Furthermore, examples of the oxide also include an indium tin oxide and an atimony tin oxide obtained by doping a metal ion thereto.

Examples of the hydroxide include an aluminum hydroxide, a magnesium hydroxide, and a zinc hydroxide.

Examples of the metal include copper, silver, gold, nickel, tin, and iron or an alloy thereof. Furthermore, examples of the metal also include carbide, a nitride, and an oxide of the above-described metal.

Examples of the carbon-based material include carbon black, graphite, diamond, a fullerene, a carbon nanotube, a carbon nanofiber, nanohorn, a carbon microcoil, and a nanocoil.

The other inorganic microparticles may be functional particles having, for example, flame retardancy, cold storage performance, antistatic performance, magnetic properties, reflective index adjusting properties, or dielectric constant adjusting properties.

These other inorganic microparticles can be used alone or in combination of two or more at an appropriate proportion.

The thermally conductive sheet may contain minute boron nitride or boron nitride particles in a deformed shape that fail to be included in the above-described boron nitride particles.

The polymer matrix is a component that is capable of dispersing the boron nitride particles, that is, a dispersion medium in which the boron nitride particles are dispersed and contains a rubber component.

The rubber component is a polymer that develops rubber elasticity and contains, for example, an elastomer. To be specific, examples thereof include a urethane rubber, an acrylic rubber, a silicone rubber, a vinyl alkyl ether rubber, a polyvinyl alcohol rubber, a polyvinyl pyrrolidone rubber, a polyacrylamide rubber, a cellulose rubber, a natural rubber, a butadiene rubber, a chloroprene rubber, a styrene-butadiene rubber (SBR), an acrylonitrile-butadiene rubber (NBR), a styrene-ethylene-butadiene-styrene rubber, a styrene-isoprene-styrene rubber, a styrene-isobutylene rubber, an isoprene rubber, a polyisobutylene rubber, and a butyl rubber. The rubber component contains a prepolymer that develops rubber elasticity depending on a subsequent reaction.

As the rubber component, preferably, a urethane rubber, a butadiene rubber, SBR, NBR, a styrene-isobutylene rubber, and an acrylic rubber are used.

The urethane rubber is a urethane oligomer that contains the main chain bonded by a urethane bond. The urethane rubber contains a reactive urethane polymer containing a reactive group that is bonded to an end or a middle of the main chain.

Examples of the reactive group include a vinyl group-containing group that contains a vinyl group (a polymerizable group) such as an acryloyl group and a methacryloyl group, an epoxy group (a glycidyl group), a carboxyl group, an amino group, and a hydroxyl group. As the reactive group contained in the urethane rubber, preferably, a vinyl group-containing group is used, or more preferably, an acryloyl group is used.

The urethane rubber may contain one or two or more reactive group(s).

When the urethane rubber contains the two reactive groups, as a first reactive group, for example, an acryloyl group is used and as a second reactive group, for example, a carboxyl group is used.

To be specific, examples of the urethane rubber include an acrylate-modified urethane rubber, a methacrylate-modified urethane rubber, and an epoxy-modified urethane rubber. Preferably, an acrylate-modified urethane rubber is used.

The average number of reactive group, to be specific, the average number of vinyl group in the reactive urethane polymer is, for example, 1 to 10.

The reactive urethane polymer has a reactive group equivalent, to be specific, a vinyl group equivalent of, for example, 100 g/eq. or more, preferably 200 g/eq. or more, or more preferably 500 g/eq. or more, and of, for example, 50,000 g/eq. or less, preferably 20,000 g/eq. or less, or more preferably 10,000 g/eq. or less.

The urethane rubber has a weight average molecular weight of, for example, 1,000 or more, preferably 2,000 or more, more preferably 2,000 or more, or further more preferably 2,500 or more, and of, for example, 2,000,000 or less, preferably 1,000,000 or less, more preferably 500,000 or less, further more preferably 50,000 or less, or particularly preferably 10,000 or less. The weight average molecular weight (calibrated with standard polystyrene) of the urethane rubber is calculated with GPC.

The butadiene rubber contains the main chain prepared from a polybutadiene. The butadiene rubber contains a reactive polybutadiene containing the above-described reactive group that is bonded to an end or a middle of the main chain.

As the reactive group contained in the reactive polybutadiene, preferably, an epoxy group is used.

To be specific, examples of the reactive butadiene include an acrylate-modified polybutadiene, a methacrylate-modified polybutadiene, and an epoxy-modified polybutadiene. Preferably, an epoxy-modified polybutadiene is used.

The epoxy-modified polybutadiene has an epoxy equivalent of, for example, 100 g/eq. or more, preferably 130 g/eq. or more, or more preferably 150 g/eq. or more, and is, for example, 30,000 g/eq. or less, preferably 20,000 g/eq. or less, or more preferably 10,000 g/eq. or less.

The butadiene rubber has a number average molecular weight of, for example, 500 g/eq. or more, preferably 1,000 g/eq. or more, or more preferably 2,000 or more, and of, for example, 3,000,000 or less, preferably 2,000,000 g/eq. or less, or more preferably 1,000,000 or less. The number average molecular weight (calibrated with standard polystyrene) of the butadiene rubber is calculated with GPC.

The SBR is a synthetic rubber obtained by copolymerization of styrene with butadiene. Examples thereof include a styrene-butadiene random copolymer and a styrene-butadiene block copolymer. Examples of the SBR include a modified SBR containing the above-described reactive group and a cross-linked SBR in which a part thereof is cross-linked with sulfur, a metal oxide, or the like.

As the SBR, preferably, a modified SBR is used, or, to be specific, an epoxy-modified SBR is used.

The epoxy-modified SBR has an epoxy equivalent of, for example, 100 g/eq. or more, preferably 200 g/eq. or more, or more preferably 250 g/eq. or more, and of, for example, 30,000 g/eq. or less, preferably 20,000 g/eq. or less, or more preferably 10,000 g/eq. or less.

The SBR has a styrene content of, for example, 10 mass % or more, preferably 15 mass % or more, or more preferably 20 mass % or more, and of, for example, 60 mass % or less, preferably 55 mass % or less, or more preferably 50 mass % or less.

The NBR is a synthetic rubber obtained by copolymerization of acrylonitrile with butadiene. Examples thereof include an acrylonitrile-butadiene random copolymer and an acrylonitrile-butadiene block copolymer.

Examples of the NBR include a modified NBR containing the above-described reactive group and a cross-linked NBR in which a part thereof is cross-linked with sulfur, a metal oxide, or the like.

As the NBR, preferably, a carboxy-modified NBR is used.

The styrene-isobutylene rubber is a synthetic rubber obtained by copolymerization of styrene with isobutylene. Examples thereof include a styrene-isobutylene random copolymer and a styrene-isobutylene block copolymer. Preferably, a styrene-isobutylene block copolymer is used.

To be specific, an example of the styrene-isobutylene block copolymer includes a styrene-isobutylene-styrene block copolymer (SIBS).

The styrene-isobutylene rubber has a styrene content of, for example, 5 mass % or more, preferably 10 mass % or more, or more preferably 15 mass % or more, and of, for example, 50 mass % or less, preferably 45 mass % or less, or more preferably 40 mass % or less.

The styrene-isobutylene rubber has a weight average molecular weight of, for example, 1,000 or more, preferably 5,000 or more, or more preferably 10,000 or more, and of, for example, 2,000,000 or less, preferably 1,000,000 or less, or more preferably 500,000 or less. The weight average molecular weight (calibrated with standard polystyrene) of the styrene-isobutylene rubber is calculated with GPC.

The acrylic rubber is a synthetic rubber obtained by polymerization of a monomer that contains an alkyl(meth)acrylate.

The alkyl(meth)acrylate is an alkyl methacrylate and/or an alkyl acrylate. An example thereof includes a straight chain or branched chain alkyl(meth)acrylate containing an alkyl portion having 1 to 10 carbon atoms such as a methyl(meth)acrylate, an ethyl(meth)acrylate, a butyl(meth)acrylate, a hexyl(meth)acrylate, a 2-ethyl hexyl(meth)acrylate, and a nonyl(meth)acrylate. Preferably, a straight chain alkyl(meth)acrylate containing an alkyl portion having 2 to 8 carbon atoms is used.

The mixing ratio of the alkyl(meth)acrylate with respect to the monomer is, for example, 50 mass % or more, or preferably 75 mass % or more, and is, for example, 99 mass % or less.

The monomer can contain a copolymerizable monomer that is capable of polymerizing with an alkyl(meth)acrylate.

The copolymerizable monomer contains a vinyl group. Examples thereof include a cyano group-containing vinyl monomer such as (meth)acrylonitrile and an aromatic vinyl monomer such as styrene.

The mixing ratio of the copolymerizable monomer with respect to the monomer is, for example, 50 mass % or less, or preferably 25 mass % or less, and is, for example, 1 mass % or more.

These copolymerizable monomers can be used alone or in combination of two or more.

In order to increase the bonding force, the acrylic rubber may contain a functional group that is bonded to an end or a middle of the main chain. Examples of the functional group include a carboxyl group, a hydroxyl group, an epoxy group, and an amide group. Preferably, a carboxyl group and an epoxy group are used.

When the functional group is a carboxyl group, the acrylic rubber is a carboxy-modified acrylic rubber in which a part of an alkyl portion of the alkyl(meth)acrylate is replaced with a carboxyl group. The carboxy-modified acrylic rubber has an acid value of, for example, 5 mgKOH/g or more, or preferably 10 mgKOH/g or more, and of, for example, 100 mgKOH/g or less, or preferably 50 mgKOH/g or less.

When the functional group is an epoxy group, the acrylic rubber is an epoxy-modified acrylic rubber in which an epoxy group is introduced to a side chain thereof. The epoxy-modified acrylic rubber has an epoxy equivalent of, for example, 50 eq./g or more, or preferably 100 eq./g or more, and of, for example, 1,000 eq./g or less, or preferably 500 eq./g or less.

The acrylic rubber has a weight average molecular weight of, for example, 10,000 or more, preferably 50,000 or more, or more preferably 100,000 or more, and of, for example, 10,000,000 or less, preferably 5,000,000 or less, more preferably 3,000,000 or less, or further more preferably 1,000,000 or less. The weight average molecular weight (calibrated with standard polystyrene) of the acrylic rubber is calculated with GPC.

The acrylic rubber has a glass transition temperature of, for example, −100° C. or more, preferably −80° C. or more, more preferably −50° C. or more, or further more preferably −40° C. or more, and of, for example, 200° C. or less, preferably 100° C. or less, more preferably 50° C. or less, or further more preferably 40° C. or less. The glass transition temperature of the acrylic rubber is calculated by, for example, a midpoint glass transition temperature or a theoretical calculated value after heat treatment measured based on JIS K 7121-1987. When the glass transition temperature of the acrylic rubber is measured based on JIS K7121-1987, to be specific, the glass transition temperature is calculated at a temperature rising rate of 10° C./min in a differential scanning calorimetry (heat flux DSC).

The acrylic rubber has a decomposition temperature of, for example, 200° C. or more, or preferably 250° C. or more, and of, for example, 500° C. or less, or preferably 450° C. or less.

The acrylic rubber has a specific gravity of, for example, 0.5 or more, or preferably 0.8 or more, and, of, for example, 1.5 or less, or preferably 1.4 or less.

These rubber components can be used alone or in combination of two or more.

The rubber component can be used as a rubber component solution prepared by being dissolved with a solvent as required.

An example of the solvent includes an organic solvent such as ketone including acetone and methyl ethyl ketone (MEK); an aromatic hydrocarbon including toluene, xylene, and ethyl benzene; ester including ethyl acetate; and amide including N,N-dimethylformamide.

These solvents can be used alone or in combination of two or more.

When the rubber component is prepared as a rubber component solution, the content ratio of the rubber component with respect to the rubber component solution is, for example, 1 mass % or more, preferably 2 mass % or more, or more preferably 5 mass % or more, and is, for example, 99 mass % or less, preferably 90 mass % or less, or more preferably 80 mass % or less.

The rubber component is also capable of being prepared as a rubber composition containing a rubber component and a polymerization initiator by being used in combination with the polymerization initiator.

Preferably, when the rubber component contains a polymerizable group, the polymerization initiator is blended into the rubber component.

In this way, a polymerization reaction by the polymerizable groups with themselves in the rubber component is progressed, so that the rubber component is capable of surely developing rubber elasticity.

An example of the polymerization initiator includes a radical polymerization initiator such as a photopolymerization initiator and a thermal polymerization initiator.

Examples of the photopolymerization initiator include a benzoin ether compound, an acetophenone compound, an α-ketol compound, an aromatic sulfonyl chloride compound, a photo active oxime compound, a benzoin compound, a benzyl compound, a benzophenone compound, a thioxanthone compound, and an α-aminoketone compound.

To be specific, examples of the benzoin ether compound include benzoin methyl ether, benzoin ethyl ether, benzoin propyl ether, benzoin isopropyl ether, benzoin isobutyl ether, 2,2-dimethoxy-1,2-diphenylethane-1-one, and anisole methyl ether.

Examples of the acetophenone compound include 2,2-diethoxyacetophenone, 2,2-dimethoxy-2-phenylacetophenone, 1-hydroxycyclohexyl phenyl ketone, 4-phenoxydichloroacetophenone, and 4-(t-butyl)dichloroacetophenone.

Examples of the α-ketol compound include 2-methyl-2-hydroxypropiophenone and 1-[4-(2-hydroxyethyl)phenyl]-2-methylpropane-1-one. An example of the aromatic sulfonyl chloride compound includes 2-naphthalenesulfonylchloride. An example of the photo active oxime compound includes 1-phenyl-1,1-propanedione-2-(o-ethoxycarbonyl)-oxime.

An example of the benzoin compound includes benzoin. An example of the benzyl compound includes benzyl. Examples of the benzophenone compound include benzophenone, benzoylbenzoic acid, 3,3′-dimethyl-4-methoxybenzophenone, polyvinylbenzophenone, and α-hydroxycyclohexyl phenyl ketone.

Examples of the thioxanthone compound include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

Examples of the α-aminoketone compound include 2-methyl-1-phenyl-2-morpholinopropane-1-one, 2-methyl-1-[4-(hexyl)phenyl]-2-morpholinopropane-1-one, 2-ethyl-2-dimethylamino-1-(4-morpholinophenyl)-butanone-1, and 2-methyl-1-[4-(methylthio)phenyl]-2-morpholinopropane-1-one.

As the photopolymerization initiator, preferably, a thioxanthone compound and an α-aminoketone compound are used.

Examples of the thermal polymerization initiator include an organic peroxide such as a dibenzoyl peroxide, a di-tert-butyl peroxide, a cumene hydroperoxide, and a lauroyl peroxide and an azo compound such as 2,2′-azobisisobutyronitrile (AIBN) and azobisisovaleronitrile.

As the thermal polymerization initiator, preferably, an azo compound is used.

These polymerization initiators can be used alone or in combination of two or more.

The mixing ratio of the polymerization initiator with respect to 100 parts by mass of the rubber component is, for example, 0.01 parts by mass or more, or preferably 0.1 parts by mass or more, and is, for example, 20 parts by mass or less, or preferably 10 parts by mass or less.

The mixing ratio of the rubber component with respect to the polymer matrix is, for example, 0.1 mass % or more, preferably 1 mass % or more, or more preferably 5 mass % or more, and is, for example, 100 mass % or less, preferably 99.9 mass % or less, or more preferably 99 mass % or less.

The mixing ratio of the rubber composition with respect to the polymer matrix is, for example, 0.1 mass % or more, preferably 1 mass % or more, or more preferably 5 mass % or more, and is, for example, 100 mass % or less, preferably 99 mass % or less, or more preferably 95 mass % or less.

The polymer matrix is also capable of containing an epoxy resin composition in addition to the rubber component.

The epoxy resin composition is a thermosetting resin composition. The epoxy resin composition preferably contains an epoxy resin and furthermore, if necessary, contains a curing agent and/or a curing accelerator.

The epoxy resin is in a state of liquid, semi-solid, or solid at a normal temperature.

To be specific, examples of the epoxy resin include an aromatic epoxy resin such as a bisphenol epoxy resin (for example, a bisphenol A epoxy resin, a bisphenol F epoxy resin, a bisphenol S epoxy resin, a hydrogenated bisphenol A epoxy resin, and a dimer acid-modified bisphenol epoxy resin), a novolak epoxy resin (for example, a phenol novolak epoxy resin, a cresol novolak epoxy resin, and a biphenyl epoxy resin), a naphthalene epoxy resin, a fluorene epoxy resin (for example, a bisaryl fluorene epoxy resin), and a triphenylmethane epoxy resin (for example, a trishydroxyphenylmethane epoxy resin); a nitrogen-containing-cyclic epoxy resin such as a triepoxypropyl isocyanurate (a triglycidyl isocyanurate) and a hydantoin epoxy resin; an aliphatic epoxy resin; an alicyclic epoxy resin (for example, a dicyclo ring-type epoxy resin such as a dicyclopentadiene epoxy resin); a glycidylether epoxy resin; and a glycidylamine epoxy resin.

Preferably, an aromatic epoxy resin is used, or more preferably, a bisphenol epoxy resin, a fluorene epoxy resin, and a triphenylmethane epoxy resin are used. Also, preferably, an alicyclic epoxy resin is used, or more preferably, a dicyclo ring-type epoxy resin is used.

The epoxy resin may contain a molecular structure that forms a liquid crystal structure, a crystalline structure, or the like in its molecular structure. To be specific, an example of the molecular structure includes a mesogen group.

These epoxy resins can be used alone or in combination of two or more.

The epoxy resin has an epoxy equivalent of, for example, 100 g/eq. or more, preferably 130 g/eq. or more, or more preferably 150 g/eq. or more, and of, for example, 10,000 g/eq. or less, preferably 9,000 g/eq. or less, more preferably 8,000 g/eq. or less, further more preferably 5,000 g/eq. or less, particularly preferably 1,000 g/eq. or less, or most preferably 500 g/eq. or less.

When the epoxy resin is in a solid state at a normal temperature, the softening point thereof is, for example, 20° C. or more, or preferably 40° C. or more, and is, for example, 130° C. or less, or preferably 90° C. or less and the melting point thereof is, for example, 20° C. or more, or preferably 40° C. or more, and is, for example, 130° C. or less, or preferably 90° C. or less.

When the epoxy resin is in a liquid state at a normal temperature, the viscosity (at 25° C.) thereof is, for example, 100 mPa·s or more, preferably 200 mPa·s or more, or more preferably 500 mPa·s or more, and is, for example, 1,000,000 mPa·s or less, preferably 800,000 mPa·s or less, or more preferably 500,000 mPa·s or less.

When the epoxy resin is in a semi-solid state, the viscosity thereof at 150° C. is, for example, 1 mPa·s or more, preferably 5 mPa·s or more, or more preferably 10 mPa·s or more, and is, for example, 10,000 mPa·s or less, preferably 5,000 mPa·s or less, or more preferably 1,000 mPa·s or less.

The mixing ratio of the epoxy resin with respect to the epoxy resin composition is, for example, 100 mass % or less, preferably 99 mass % or less, or more preferably 95 mass % or less, and is, for example, 10 mass % or more.

The volume blending ratio (the number of parts by volume of epoxy resin/the number of parts by volume of rubber component) of the epoxy resin to the rubber component is, for example, 0 or more, preferably 0.01 or more, more preferably 0.1 or more, or particularly preferably 0.2 or more, and is, for example, 99 or less, preferably 90 or less, more preferably 19 or less, or particularly preferably 8.5 or less.

The curing agent is, for example, a curing agent (an epoxy resin curing agent) that is capable of curing the epoxy resin by heating. Examples thereof include a phenol resin, an amine compound, an acid anhydride compound, an amide compound, and a hydrazide compound.

Examples of the phenol resin include a novolak phenol resin obtained by condensing or co-condensing a phenol compound such as phenol, cresol, resorcin, catechol, bisphenol A, bisphenol F, phenylphenol, and aminophenol and/or a naphthol compound such as α-naphthol, β-naphthol, and dihydroxynaphthalene with an aldehyde group-containing compound such as formaldehyde, benzaldehyde, and salicylaldehyde under an acid catalyst; a phenol-aralkyl resin synthesized from a phenol compound and/or a naphthol compound and dimethoxyparaxylene or bis(methoxymethyl)biphenyl; an aralkyl phenol resin such as a biphenylene phenol-aralkyl resin, and a naphthol-aralkyl resin; a dicyclopentadiene phenol novolak resin synthesized by copolymerization of a phenol compound and/or a naphthol compound and dicyclopentadiene; a dicyclopentadiene phenol resin such as a dicyclopentadiene naphthol novolak resin; a triphenylmethane phenol resin; a terpene-modified phenol resin, a paraxylylene and/or methaxylylene-modified phenol resin; and a melamine-modified phenol resin. Preferably, a phenol-aralkyl resin is used.

The phenol resin has a hydroxyl group equivalent of, for example, 80 g/eq. or more, preferably 90 g/eq. or more, or more preferably 100 g/eq. or more, and of, for example, 2,000 g/eq. or less, preferably 1,000 g/eq. or less, or more preferably 500 g/eq. or less.

Examples of the amine compound include a polyamine such as an ethylene diamine, a propylene diamine, a diethylene triamine, and a triethylene tetramine and amine adducts thereof; a metha phenylenediamine; a diaminodiphenyl methane; and a diaminodiphenyl sulfone.

Examples of the acid anhydride compound include a phthalic anhydride, a maleic anhydride, a tetrahydrophthalic anhydride, a hexahydrophthalic anhydride, a 4-methyl-hexahydrophthalic anhydride, a methyl nadic anhydride, a pyromellitic anhydride, a dodecenylsuccinic anhydride, a dichloro succinic anhydride, a benzophenone tetracarboxylic anhydride, and a chlorendic anhydride.

Examples of the amide compound include a dicyandiamide and a polyamide.

An example of the hydrazide compound includes an adipic acid dihydrazide.

These curing agents can be used alone or in combination of two or more.

As the curing agent, preferably, a phenol resin is used.

The curing accelerator is, for example, a curing accelerator (an epoxy resin curing accelerator) that is capable of accelerating curing of an epoxy resin by heating and serves as, for example, a catalyst. To be specific, examples thereof include an imidazole compound, an imidazoline compound, an organic phosphine compound, and a urea compound. Preferably, an imidazole compound and an imidazoline compound are used, or more preferably, an imidazole compound is used.

Examples of the imidazole compound include an imidazole such as a 2-phenyl imidazole, a 2-methyl imidazole, a 2-ethyl-4-methyl imidazole, a 2-phenyl-4-methyl imidazole, and a 2-phenyl-4-methyl-5-hydroxymethyl imidazole and an isocyanuric acid adduct such as a 2,4-diamino-6-[2′-methylimidazolyl-(1′)]-ethyl-s-triazine isocyanuric acid adduct, a 2,4-diamino-6-[2′-methylimidazolyl-(1′)]-ethyl-s-triazine isocyanuric acid adduct, and a 2-phenyl imidazole isocyanuric acid adduct.

Examples of the imidazoline compound include a methyl imidazoline, a 2-ethyl-4-methyl imidazoline, an ethyl imidazoline, an isopropyl imidazoline, a 2,4-dimethyl imidazoline, a phenyl imidazoline, an undecyl imidazoline, a heptadecyl imidazoline, and a 2-phenyl-4-methyl imidazoline.

The mixing ratio of the curing agent and/or the curing accelerator with respect to 100 parts by mass of the epoxy resin is, for example, 0.1 parts by mass or more, preferably 0.2 parts by mass or more, further more preferably 0.5 parts by mass or more, or particularly preferably 1 part by mass or more, and is, for example, 500 parts by mass or less, preferably 400 parts by mass or less, further more preferably 300 parts by mass or less, or particularly preferably 200 parts by mass or less.

The curing agent and/or the curing accelerator can be used by being prepared as a solvent solution and/or a solvent dispersion liquid obtained by being dissolved and/or dispersed with a solvent as required.

An example of the solvent includes an organic solvent such as ketone including acetone and methyl ethyl ketone, ester including ethyl acetate, and amide including N,N-dimethylformamide. An example of the solvent also includes an aqueous solvent such as water and an alcohol including methanol, ethanol, propanol, and isopropanol. As the solvent, preferably, an organic solvent is used, or more preferably, ketone is used.

The mixing ratio of the polymer matrix with respect to 100 parts by mass of the boron nitride particles is, for example, 2 parts by mass or more, preferably 5 parts by mass or more, or more preferably 10 parts by mass or more, and is, for example, 200 parts by mass or less, or preferably 100 parts by mass or less.

The mixing ratio of the polymer matrix with respect to the total amount of the boron nitride particles and the polymer matrix (that is, the thermally conductive composition) is, for example, 3 mass % or more, preferably 5 mass % or more, or more preferably 10 mass % or more, and is, for example, 60 mass % or less, preferably 40 mass % or less, or more preferably 35 mass % or less.

The content ratio of the boron nitride particles, based on mass, is, for example, 40 mass % or more, preferably 50 mass % or more, more preferably 60 mass % or more, or further more preferably 65 mass % or more, and is, for example, 98 mass % or less, preferably 96 mass % or less, more preferably 94 mass % or less, or further more preferably 93 mass % or less.

An additive such as a dispersant can be also contained in the polymer matrix.

The dispersant is blended into the polymer matrix so as to prevent aggregation or precipitation of the boron nitride particles and to improve the dispersibility as required.

Examples of the dispersant include a polyaminoamide salt and polyester.

These dispersants can be used alone or in combination. The mixing ratio of the dispersant with respect to 100 parts by mass of the boron nitride particles is, for example, 0.01 parts by mass or more, or preferably 0.1 parts by mass or more, and is, for example, 20 parts by mass or less, or preferably 10 parts by mass or less.

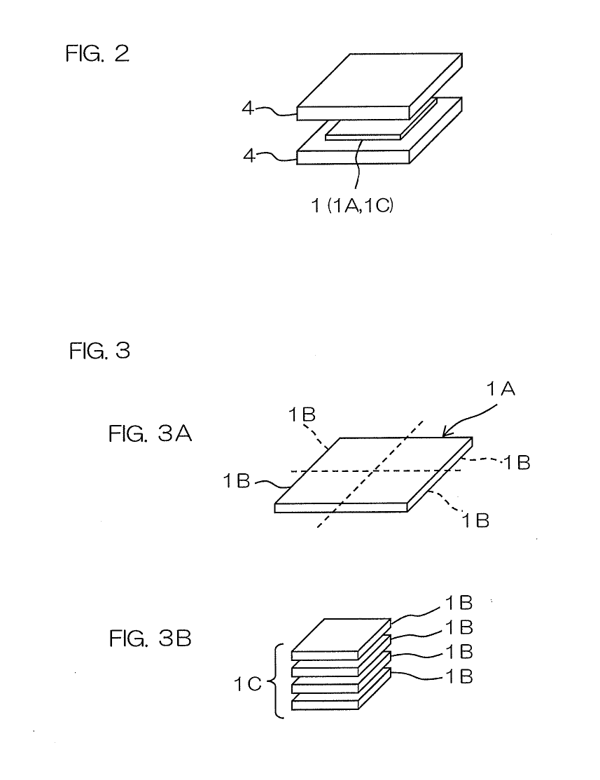

Next, a method for producing one embodiment of a thermally conductive sheet in the first embodiment is described with reference to FIGS. 1 and 2.

In this method, first, the above-described components are blended at the above-described mixing proportion to be stirred and mixed, so that a thermally conductive composition is prepared.

In the stirring and mixing, for example, a solvent is blended with the above-described components in order to efficiently mix the components.

An example of the solvent includes the same organic solvent as that described above. When the above-described thermally conductive composition is prepared as a solvent solution and/or a solvent dispersion liquid, the solvent in the solvent solution and/or the solvent dispersion liquid is capable of being subjected as a mixed solvent for the stirring and mixing without adding a solvent in the stirring and mixing. Or, a solvent is also capable of being further added as a mixed solvent in the stirring and mixing.

In the stirring and mixing, a stirring device such as a hybrid mixer and a three-one motor is also capable of being used as required.

When the stirring and mixing is performed using a solvent, for example, the components are allowed to stand at a room temperature for one to 48 hours after the stirring and mixing and in this way, the solvent is removed. At this time, if necessary, the components can be also dried, for example, by an air blast or the like. Or, the solvent can be also removed by vacuum drying, for example, under the conditions of a room temperature and five minutes to 48 hours. Or, a varnish containing a thermally conductive composition and a solvent is applied onto a separator with a coating device and the varnish can be dried at the inside of a drying oven.

Thereafter, the thermally conductive composition is fractured so as to be formed into a sheet shape as required, so that a powder (a thermally conductive composition powder) is obtained.

Next, in this method, the obtained thermally conductive composition (including the thermally conductive composition powder and sheet, hereinafter the same) is hot pressed.

To be specific, as shown in FIG. 2, the thermally conductive composition is hot pressed, for example, between two pieces of release films 4 as required.

The conditions for the hot pressing are as follows: a temperature of, for example, 30° C. or more, or preferably 40° C. or more, and of, for example, 170° C. or less, or preferably 150° C. or less; a pressure of, for example, 0.5 MPa or more, or preferably 1 MPa or more, and of, for example, 100 MPa or less, or preferably 75 MPa or less; and a duration of, for example, 0.1 minutes or more, or preferably 1 minute or more, and of, for example, 100 minutes or less, or preferably 30 minutes or less.

More preferably, the thermally conductive composition is hot pressed under vacuum. The degree of vacuum in the vacuum hot pressing is, for example, 100 Pa or less, or preferably 50 Pa or less, and is, for example, 1 Pa or more, or preferably 5 Pa or more. The temperature, pressure, and duration are the same as those in the above-described hot pressing.

In the hot pressing, after the thermally conductive composition is placed on the release film 4, if necessary, a spacer (not shown in FIG. 2) having a desired thickness is disposed on the periphery of the thermally conductive composition in a frame shape, so that a thermally conductive sheet 1 having substantially the same thickness as that of the spacer is capable of being obtained.

Also, before the hot pressing, the thermally conductive composition is capable of being extended by applying pressure into a sheet shape (a pre-sheet) with a twin roll or the like. In this case, the rolling conditions are as follows: a pressure of, for example, 0.1 to 8 MPa; a temperature of roll of, for example, 60 to 150° C.; and a revolving rate of roll of, for example, 0.5 to 10 rpm or 0.1 to 50 m/min. The roll is also capable of having a plurality of steps.

In this way, the thermally conductive sheet 1 is capable of being obtained.

When a polymer matrix 3 contains an epoxy resin composition or a rubber component containing an epoxy group, the thermally conductive sheet 1 is obtained as a sheet in a semi-cured state (in a B-stage state) by the above-described hot pressing.

Furthermore, when the rubber composition contains a thermal polymerization initiator and when the rubber component contains a polymerizable group, the polymerizable group in the rubber component reacts by the thermally polymerization initiator and in this way, a cross-linking reaction of the rubber component is progressed.

When the rubber component contains a carboxy-modified NBR, a cross-linking reaction is progressed by a dehydration reaction of carboxyl groups with themselves by heating.

Furthermore, when the rubber component contains an epoxy-modified polybutadiene rubber and/or an epoxy-modified SBR and furthermore, when the polymer matrix contains an epoxy resin composition, an epoxy group in the epoxy-modified polybutadiene rubber and/or the epoxy-modified SBR, along with an epoxy group in an epoxy resin, is subjected to a cross-linking reaction by heating by a curing agent.

On the other hand, when the rubber composition contains a photopolymerization initiator and when the rubber component contains a polymerizable group, for example, an energy ray such as an ultraviolet ray is applied to the thermally conductive sheet 1. The dose of the energy ray is, for example, 100 J/m² or more, preferably 200 J/m² or more, or more preferably 500 J/m² or more, and is, for example, 10,000 J/m² or less, preferably 8,000 J/m² or less, or more preferably 5,000 J/m² or less. The polymerizable group in the rubber component reacts by the photopolymerization initiator based on the application of the energy ray and in this way, a cross-linking reaction of the rubber component is progressed.

Next, the reaction is also capable of being accelerated by heating. The components are put into a drying oven at, for example, 50 to 70° C. (to be specific, 60° C.) to be processed for, for example, 0.5 to two hours (to be specific, one hour) and in this way, the reaction is also capable of being accelerated.

A shear storage elastic modulus G′ at the time of increasing the temperature of a rubber-containing sheet formed from a rubber-containing composition (that is, a polymer matrix) obtained by excluding the boron nitride particles from the thermally conductive composition under the conditions of a frequency of 1 Hz and a temperature rising rate of 2° C./min is, for example, 5.6×10³ Pa or more, preferably 1×10⁴ Pa or more, or more preferably 3×10⁴ Pa or more, and is, for example, 2×10⁵ Pa or less, preferably 1×10⁵ Pa or less, or more preferably 5×10⁴ Pa or less at least at any temperature (particularly preferably, at 80° C.) in a temperature range of 20 to 150° C.

By setting the shear storage elastic modulus to be 5.6×10³ Pa or more, when the thermally conductive sheet formed from the thermally conductive composition obtained by adding the boron nitride particles into the rubber containing-composition is bonded to a mounted substrate by heating, the conformability to unevenness with respect to the mounted substrate is improved and cracking generated in the thermally conductive sheet is capable of being reduced. On the other hand, when the shear storage elastic modulus is set to be 2×10⁵ Pa or less, the bonding properties with respect to the mounted substrate becomes further more excellent.

A shear loss elastic modulus G″ (the measurement conditions are the same as those of the shear storage elastic modulus) of the rubber-containing sheet is, for example, 1×10³ Pa or more, preferably 5×10³ Pa or more, or more preferably 1×10⁴ Pa or more, and is, for example, 1×10⁶ Pa or less, preferably 1×10⁵ Pa or less, or more preferably 5×10⁴ Pa or less at least at any temperature (particularly preferably, at 80° C.) in a temperature range of 20 to 150° C.

A complex shear viscosity η* (the measurement conditions are the same as those of the shear storage elastic modulus) of the rubber-containing sheet is, for example, 9×10⁵ mPa·s or more, preferably 1×10⁶ mPa·s or more, or more preferably 5×10⁶ mPa·s or more, and is, for example, 1×10⁸ mPa·s or less, preferably 1×10⁷ mPa·s or less, or more preferably 7×10⁶ mPa·s or less at least at any temperature (particularly preferably, at 80° C.) in a temperature range of 20 to 150° C.

The shear storage elastic modulus, the shear loss elastic modulus, and the complex shear viscosity are measured in conformity with JIS K 7244-10 “Plastics-Determination of dynamic mechanical properties-Part 10: Complex shear viscosity using a parallel plate oscillatory rheometer” using a viscosity and viscoelasticity measurement device (trade name: HAAKE RheoStress 600, manufactured by EKO Instruments).

The thermally conductive sheet in the first embodiment is also capable of being formed as follows: the above-described polymer matrix and, if necessary, a solvent are blended to prepare a rubber-containing composition having an elastic modulus within the above-described range; next, boron nitride particles are further blended into the obtained rubber-containing composition to prepare a thermally conductive composition; and the thermally conductive sheet is formed from the obtained thermally conductive composition.

The thermally conductive sheet obtained in this way has a thickness of, for example, 2000 μm or less, preferably 1000 μm or less, or more preferably 800 μm or less, and of usually, for example, 50 μm or more, preferably 100 μm or more, more preferably 150 μm or more, or particularly preferably 200 μm or more.

The content ratio (the solid content, that is, the volume percentage of the boron nitride particles with respect to the total volume of the polymer matrix and the boron nitride particles) of the boron nitride particles in the thermally conductive sheet, based on volume, is, as described above, for example, 35 vol % or more (preferably 50 vol % or more, more preferably 60 vol % or more, further more preferably 65 vol % or more, particularly preferably 68 vol % or more, or most preferably 75 vol % or more), and is usually 95 vol % or less (preferably 90 vol % or less, more preferably 85 vol % or less, or further more preferably 80 vol % or less). The mixing ratio of the boron nitride particles in the thermally conductive sheet, based on mass, is, for example, 40 mass % or more, preferably 50 mass % or more, more preferably 60 mass % or more, further more preferably 65 mass % or more, or particularly preferably 75 mass % or more, and is, for example, 98 mass % or less, preferably 96 mass % or less, more preferably 94 mass % or less, or further more preferably 93 mass % or less.

When the content proportion of the boron nitride particles is below the above-described range, there may be a case where a thermally conductive path of the boron nitride particles with themselves is not formed, so that the thermally conductive properties in a plane direction PD are reduced in the thermally conductive sheet. When the content proportion of the boron nitride particles is above the above-described range, there may be a case where the thermally conductive sheet is fragile, so that the handling ability, the conformability to irregularities, and the like are reduced.

In the thermally conductive sheet 1 obtained in this way, as shown in FIG. 1 and its partially enlarged schematic view, a longitudinal direction LD of boron nitride particles 2 is oriented along the plane direction PD that crosses (is perpendicular to) a thickness direction TD of the thermally conductive sheet 1.

The calculated average absolute value of the angle between the longitudinal direction LD of the boron nitride particles 2 and the plane direction PD of the thermally conductive sheet 1 (an orientation angle α of the boron nitride particles 2 with respect to the thermally conductive sheet 1) is, for example, 30 degrees or less, preferably 25 degrees or less, or more preferably 20 degrees or less, and is usually 0 degree or more.

The orientation angle α of the boron nitride particles 2 with respect to the thermally conductive sheet 1 is obtained as follows: the thermally conductive sheet 1 is cut along the thickness direction with a cross section polisher (CP); the cross section thus appeared is photographed with a scanning electron microscope (SEM) at a magnification that enables observation of 200 or more boron nitride particles 2 in the field of view; a tilt angle α between the longitudinal direction LD of the boron nitride particles 2 and the plane direction PD (the direction perpendicular to the thickness direction TD) of the thermally conductive sheet 1 is obtained from the obtained SEM photograph; and the average value of the tilt angle α is calculated.

In this way, the thermal conductivity in the plane direction PD of the thermally conductive sheet is, for example, 4 W/m·K or more, preferably 5 W/m·K or more, more preferably 10 W/m·K or more, further more preferably 15 W/m·K or more, particularly preferably 20 W/m·K or more, or most preferably 25 W/m·K or more, and is usually 200 W/m·K or less.

When the polymer matrix contains an epoxy resin, the thermal conductivity in the plane direction PD of the thermally conductive sheet is substantially the same before and after thermal curing (complete curing) to be described later.

When the thermal conductivity in the plane direction PD of the thermally conductive sheet is below the above-described range, the thermally conductive properties in the plane direction PD are not sufficient, so that the thermally conductive sheet may not be capable of being used for heat dissipation application that requires the thermally conductive properties in the plane direction PD.

The thermal conductivity in the plane direction PD of the thermally conductive sheet is measured by a pulse heating method. In the pulse heating method, a xenonflash analyzer “LFA-447” (manufactured by Erich NETZSCH GmbH & Co. Holding KG) is used.

The thermal conductivity in the thickness direction TD of the thermally conductive sheet is, for example, 0.3 W/m·K or more, preferably 0.5 W/m·K or more, more preferably 0.8 W/m·K or more, further more preferably 1 W/m·K or more, or particularly preferably 1.2 W/m·K or more, and is, for example, 20 W/m·K or less, preferably 15 W/m·K or less, more preferably 12 W/m·K or less, or further more preferably 10 W/m·K or less.

The thermal conductivity in the thickness direction TD of the thermally conductive sheet is measured by a pulse heating method, a laser flash method, or a TWA method. In the pulse heating method, the above-described device is used, in the laser flash method, “TC-9000” (manufactured by Ulvac, Inc.) is used, and in the TWA method, “ai-Phase mobile” (manufactured by ai-Phase Co., Ltd) is used.

In this way, the ratio (the thermal conductivity in the plane direction PD/the thermal conductivity in the thickness direction TD) of the thermal conductivity in the plane direction PD of the thermally conductive sheet 1 to that in the thickness direction TD of the thermally conductive sheet 1 is, for example, 1.5 or more, preferably 1.8 or more, more preferably 2 or more, or particularly preferably 3 or more, and is usually 100 or less, or preferably 50 or less.

The thermally conductive sheet 1 has the maximum elongation in the plane direction PD of, preferably 101.7% or more, more preferably 101.9% or more, further more preferably 102.0% or more, or particularly preferably 102.2% or more, and of, for example, 1000% or less.

When the maximum elongation in the plane direction PD of the thermally conductive sheet 1 is within the above-described range, damage is capable of being effectively prevented at the time of placement thereof with respect to a semiconductor element.

The maximum elongation (a measured value measured by the following method) in the plane direction PD of the thermally conductive sheet 1 is measured as follows.

That is, the thermally conductive sheet 1 in a B-stage state is cut into a strip and the obtained strip is set in a tensile testing device to measure the maximum elongation (%) at the time of pulling the strip in the longitudinal direction at a rate of 5 mm/min as a measured value (a tensile test).

Also, the maximum elongation Z % of the polymer matrix 3 in the thermally conductive sheet 1 in a volume ratio X % of the arbitrary boron nitride particles 2 is easily speculated as an estimate from the following formulas (1) and (2). The maximum elongation Z % speculated from the formulas (1) and (2) is, for example, 100.1% or more, preferably 100.5% or more, more preferably 100.8% or more, or further more preferably 101% or more, and is, for example, 2000% or less.

Y (%)=M (%)×e^{X×k} (1)

Z (%)=Y (%)+100(%) (2)

k: constant

M: the proportion of the maximum elongation in the plane direction PD of the thermally conductive sheet 1 with respect to 100 of the length in the plane direction PD of the thermally conductive sheet 1 before the tensile test at the time when the volume ratio of the boron nitride particles 2 in the thermally conductive sheet 1 is 0% (hereinafter, defined as the proportion of the maximum elongation). That is, the maximum elongation A (%) at the time when the volume ratio of the polymer matrix 3 in the thermally conductive sheet 1 is 100%, −100

A: the maximum elongation (a measured value) (%) in the plane direction PD of the thermally conductive sheet 1

X: the volume ratio (%) of the boron nitride particles 2 in the thermally conductive sheet 1

Y: the amount of the maximum elongation (%) in the plane direction PD of the thermally conductive sheet 1, that is, a percentage of the amount of the maximum elongation with respect to the thermally conductive sheet 1 before the tensile test

Z: the maximum elongation (an estimate) (%) in the plane direction PD of the thermally conductive sheet 1 obtained from the calculation

When the maximum elongation (an estimate) Z % is within the above-described range, damage is capable of being effectively prevented at the time of placement with respect to a semiconductor element.

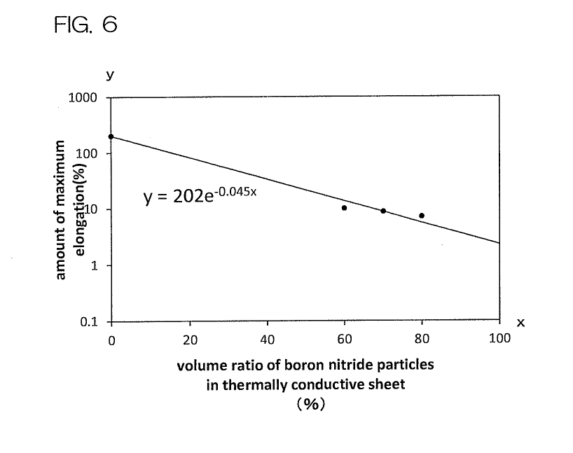

As referred in FIG. 6, the constant “k” is obtained as an inclination of a straight line calculated by a least squares method from plotted points obtained by plotting the proportion of the maximum elongation (the measured value) in the plane direction PD of the thermally conductive sheet 1 obtained by the above-described tensile test, that is, the maximum elongation A (%)−100, with respect to the volume proportion X (%) of the boron nitride particles 2 in the thermally conductive sheet 1.

The constant “k” is, for example, −0.1 or more, preferably −0.09 or more, more preferably −0.08 or more, or particularly preferably −0.07 or more, and is, for example, −0.001 or less, preferably −0.005 or less, more preferably −0.008 or less, or particularly preferably −0.01 or less.

When the constant “k” is within the above-described range, damage is capable of being effectively prevented at the time of placement with respect to a semiconductor element.

An elongation C (%) at the time of fracture of the thermally conductive sheet 1 is measured as a measured value in the above-described tensile test. To be specific, the elongation C (%) at the time of fracture thereof is, for example, 101.9% or more, preferably 102.0% or more, or more preferably 103.0% or more, and is, for example, 1000% or less.

Also, an elongation W % at the time of fracture of the polymer matrix 3 in the thermally conductive sheet 1 in a volume ratio X % of the arbitrary boron nitride particles 2 is easily speculated as an estimate from the following formulas (3) and (4). The elongation W % at the time of fracture speculated from the formulas (3) and (4) is, for example, 101% or more, preferably 101.3% or more, or more preferably 101.7% or more, and is, for example, 3000% or less.

V (%)=N (%)×e^{X×L} (3)

W (%)=V (%)+100(%) (4)

L: constant

N: the proportion of the elongation at the time of fracture in the plane direction PD of the thermally conductive sheet 1 with respect to 100 of the length in the plane direction PD of the thermally conductive sheet 1 before the tensile test at the time when the volume ratio of the boron nitride particles 2 in the thermally conductive sheet 1 is 0% (hereinafter, defined as the proportion of the elongation at the time of fracture). That is, an elongation C (%) at the time of fracture at the time when the volume ratio of the polymer matrix 3 in the thermally conductive sheet 1 is 100%, −100

C: the elongation at the time of fracture (a measured value) (%) in the plane direction PD of the thermally conductive sheet 1

X: the volume ratio (%) of the boron nitride particles 2 in the thermally conductive sheet 1

V: the amount of the elongation at the time of fracture (%) in the plane direction PD of the thermally conductive sheet 1, that is, a percentage of the amount of the elongation at the time of fracture with respect to the thermally conductive sheet 1 before the tensile test

W: the elongation at the time of fracture (an estimate) (%) in the plane direction PD of the thermally conductive sheet 1 obtained from the calculation

When the elongation (an estimate) W % at the time of fracture is within the above-described range, damage is capable of being effectively prevented at the time of placement with respect to a semiconductor element.

The constant L is obtained as an inclination of a straight line calculated by a least squares method from plotted points obtained by plotting the proportion of the elongation at the time of fracture (the measured value) in the plane direction PD of the thermally conductive sheet 1 obtained by the above-described tensile test, that is, the elongation C (%) at the time of fracture −100, with respect to the volume proportion X (%) of the boron nitride particles 2 in the thermally conductive sheet 1.

The constant L is, for example, −0.1 or more, preferably −0.09 or more, more preferably −0.08 or more, or particularly preferably −0.07 or more, and is, for example, −0.001 or less, preferably −0.005 or less, more preferably −0.01 or less, or particularly preferably −0.03 or less.

When the constant L is within the above-described range, damage is capable of being effectively prevented at the time of placement with respect to a semiconductor element.

The thermally conductive sheet 1 has a tensile elastic modulus of, for example, 5 N/mm² or more, preferably 10 N/mm² or more, more preferably 15 N/mm² or more, or further more preferably 30 N/mm² or more, and of, for example, 3000 N/mm² or less.

When the tensile elastic modulus of the thermally conductive sheet 1 is within the above-described range, damage is capable of being effectively prevented at the time of placement with respect to a semiconductor element.

The tensile elastic modulus of the thermally conductive sheet 1 is measured by the above-described tensile test.

When the thermally conductive sheet 1 is evaluated in a bend test in conformity with a cylindrical mandrel method of JIS K 5600-5-1 under the following test conditions, for example, fracture is not observed.

Test Conditions

Test device: Type I

Mandrel: diameter of 10 mm or diameter of 5 mm

Bending angle: 90 degrees or more

Thickness of thermally conductive sheet 1: 0.3 mm

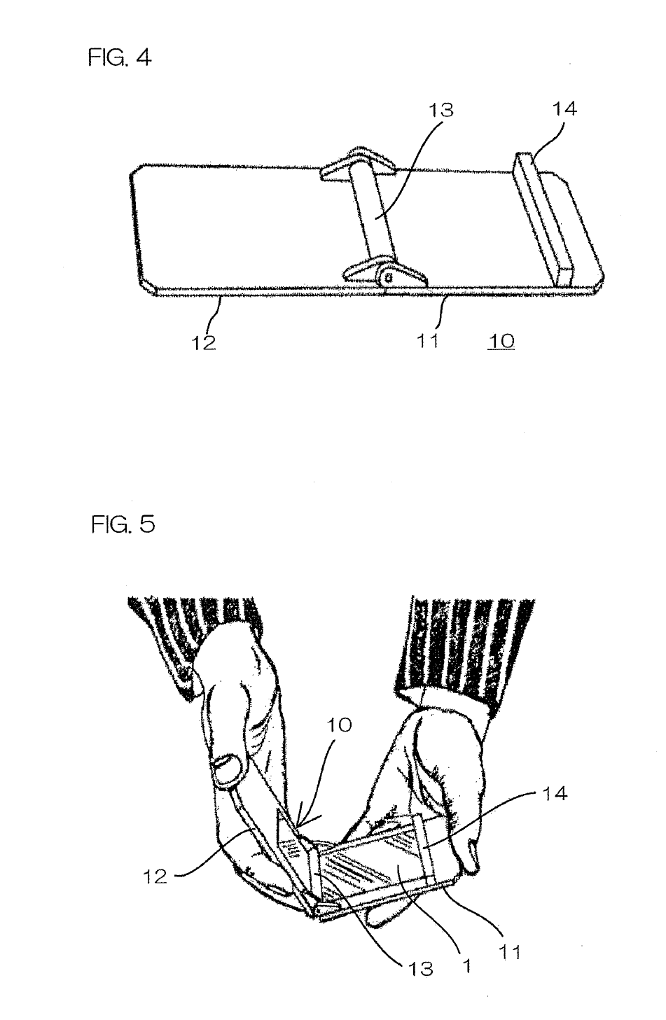

FIG. 4 shows a perspective view of a Type I test device of a bend test (before the bend test). FIG. 5 shows a perspective view of a Type I test device of a bend test (during the bend test).

The perspective views of the Type I test device are shown in FIGS. 4 and 5. In the following, the Type I test device is described.

In FIGS. 4 and 5, a Type I test device 10 includes a first flat plate 11, a second flat plate 12 that is disposed in parallel with the first flat plate 11, and a mandrel (a revolving axis) 13 that is provided for allowing the first flat plate 11 and the second flat plate 12 to revolve relatively.

The first flat plate 11 is formed into a generally rectangular flat plate shape. A stopper 14 is provided at one end portion (a free end portion) of the first flat plate 11. The stopper 14 is formed on the surface of the first flat plate 11 so as to extend along the one end portion of the first flat plate 11.

The second flat plate 12 is formed into a generally rectangular flat plate shape and one side thereof is disposed so as to be adjacent to one side (one side of the other end portion (the proximal end portion) that is the opposite side to the one end portion in which the stopper 14 is provided) of the first flat plate 11.

The mandrel 13 is formed so as to extend along one side of the first flat plate 11 and the second flat plate 12 that are adjacent to each other.

As shown in FIG. 4, in the type I test device 10, the surface of the first flat plate 11 is flush with the surface of the second flat plate 12 before the start of the bend test.

In order to perform the bend test, the thermally conductive sheet 1 is placed on the surface of the first flat plate 11 and the surface of the second flat plate 12. The thermally conductive sheet 1 is placed so that one side thereof is in contact with the stopper 14.

Next, as shown in FIG. 5, the first flat plate 11 and the second flat plate 12 are revolved relatively. To be specific, the free end portion of the first flat plate 11 and the free end portion of the second flat plate 12 are revolved to a predetermined angle with the mandrel 13 as the center. To be more specific, the first flat plate 11 and the second flat plate 12 are revolved so as to bring the surfaces of the free end portions thereof closer (opposed to each other).

In this way, the thermally conductive sheet 1 is bent with the mandrel 13 as the center, while conforming to the revolving of the first flat plate 11 and the second flat plate 12.

Preferably, fracture is not observed in the thermally conductive sheet 1, even when the mandrel 13 having a diameter of 5 mm is used under the above-described test conditions.

When fracture is observed in the thermally conductive sheet 1 in the bend test using the above-described mandrel 13 having a diameter of 5 mm, excellent flexibility may not be capable of being imparted to the thermally conductive sheet 1.

The thermally conductive sheet 1 in a B-stage state is used in the bend test.

When the thermally conductive sheet 1 is evaluated in a 3-point bending test in conformity with JIS K 7171 (in 2008) under the following test conditions, for example, fracture is not observed.

Test Conditions

Test piece: a size of 20 mm×15 mm

Distance between supporting points: 5 mm

Test rate: 20 mm/min (pressing rate of indenter)

Bending angle: 120 degrees

Evaluation method: a presence or absence of fracture such as a crack at the central portion of the test piece is visually observed when the test is performed under the above-described test conditions.

In the 3-point bending test, the thermally conductive sheet 1 in a semi-cured state is used.

Accordingly, fracture is not observed in the above-described 3-point bending test, so that the thermally conductive sheet 1 has excellent conformability to irregularities. The conformability to irregularities is, when the thermally conductive sheet 1 is provided at an object with irregularities to be installed, properties of the thermally conductive sheet 1 that conforms to be in tight contact with the irregularities.

When the polymer matrix contains an epoxy resin composition, the thermally conductive sheet 1 is bonded to a semiconductor element that is a heat dissipation object by being thermally cured by heating (being brought into a C-stage state) after the attachment.

In order to thermally cure the thermally conductive sheet 1, the thermally conductive sheet 1 is heated at, for example, 40° C. or more, preferably 60° C. or more, more preferably 90° C. or more, or further more preferably 150° C. or more, and at, for example, 250° C. or less, or preferably 200° C. or less for, for example, 10 seconds or more, preferably one minute or more, more preferably five minutes or more, or further more preferably 10 minutes or more, and for, for example, 10 days or less, preferably seven days or less, more preferably three days or less, further more preferably two days or less, or particularly preferably 10 hours or less.

The thermally conductive sheet 1 has a 90 degree peel adhesive force with respect to a copper foil of, for example, 2 N/10 mm or more, preferably 2.2 N/10 mm or more, more preferably 2.4 N/10 mm or more, or particularly preferably 2.6 N/10 mm or more, and of usually 30 N/10 mm or less.

When the 90 degree peel adhesive force of the thermally conductive sheet 1 with respect to a copper foil is below the above-described range, the bonding force with respect to an adherend may be reduced.

The 90 degree peel adhesive force of the thermally conductive sheet 1 with respect to a copper foil is measured as follows.

That is, first, the thermally conductive sheet 1 in a B-stage state is cut into a piece having an appropriate size. The obtained piece is overlapped with a rough surface of the copper foil to be in contact therewith, so that a copper foil laminated sheet is fabricated.

The copper foil has a rough surface at one side in the thickness direction and has a flat surface at the other side in the thickness direction. Surface roughness Rz (ten point average roughness in conformity with JIS B0601-1994) of the rough surface is 5 to 20 μm. The copper foil has a thickness of, for example, 10 to 200 μm, or, to be specific, 70 μm.

Next, the fabricated copper foil laminated sheet is disposed in a vacuum hot pressing device to be hot pressed at a pressure of, for example, 20 to 60 MPa for one to 10 minutes. Subsequently, in a state of retaining the pressure, the temperature thereof is increased to, for example, 80 to 180° C. to be retained for one to 60 minutes. In this way, the reaction is accelerated, so that the thermally conductive sheet 1 is brought from a B-stage state into a C-stage state.

Thereafter, the copper foil laminated sheet is put into a drying oven at, for example, 80 to 180° C. to be allowed to stand still for 0.5 to 24 hours and in this way, the thermally conductive sheet is bonded to the copper foil.

Next, the copper foil laminated sheet is cut into a strip and the obtained strip is set in a tensile testing device. Subsequently, the 90 degree peel adhesive force at the time when the thermally conductive sheet is peeled at an angle of 90 degrees with respect to the copper foil at a rate of 10 mm/min in the longitudinal direction of the strip is measured.

The thermally conductive sheet 1 has the thermal conductivity in the plane direction PD of 4 W/m·K or more and thus, has excellent thermally conductive properties in the plane direction PD. Thus, the thermally conductive sheet 1 is capable of being used for various heat dissipation applications as a thermally conductive sheet that has excellent thermally conductive properties in the plane direction PD.

The thermally conductive sheet 1 contains the rubber component and thus, has excellent flexibility. Thus, when the thermally conductive sheet 1 is disposed so as to cover a semiconductor element, damage such as cracking is capable of being prevented.

The thermally conductive sheet 1 has the maximum elongation in the plane direction PD in a tensile test of 101.7% or more and thus, has further excellent flexibility. Thus, when the thermally conductive sheet 1 is disposed so as to cover the semiconductor element, damage such as cracking is capable of being prevented. As a result, the thermally conductive sheet 1 is capable of surely covering a heat dissipation object and thus, heat generated from the heat dissipation object is capable of being surely conducted by the boron nitride particles 2.

The thermally conductive sheet 1 is formed from the thermally conductive composition obtained by adding the boron nitride particles to the rubber-containing composition that forms the rubber-containing sheet having a shear storage elastic modulus of 5.6×10³ to 2×10⁵ Pa at least at any temperature (particularly preferably, at 80° C.) in a temperature range of 20 to 150° C. Thus, when the thermally conductive sheet 1 is bonded to a mounted substrate on which an electronic component is mounted and having unevenness on the surface thereof by heating, the thermally conductive sheet 1 is capable of expanding with appropriate flexibility. As a result, the occurrence of cracking in the thermally conductive sheet 1 is reduced, and the thermally conductive sheet 1 is capable of covering the mounted substrate, while conforming to the surface with unevenness thereof. Accordingly, the contact area of the mounted substrate and the thermally conductive sheet 1 is capable of being increased and thus, heat generated from the mounted substrate is capable of being further efficiently conducted by the boron nitride particles.

Examples of the heat dissipation object to or with which the thermally conductive sheet is attached or covered include an electronic component and a mounted substrate on which the electronic component is mounted.

An example of the electronic component includes an electronic element such as a semiconductor element (an IC (integrated circuit) chip or the like), a condenser, a coil, a resistor, and a light emitting diode. Furthermore, an example thereof also includes an electronic component used for power electronics such as a thyristor (a rectifier), a motor component, an inverter, and a power transmission component. Examples of the substrate include a glass epoxy substrate, a glass substrate, a PET substrate, a Teflon substrate, a ceramic substrate, and a polyimide substrate.

Examples of the heat dissipation object can also include an LED heat dissipation substrate and a heat dissipation material for a battery.

The thermally conductive sheet 1 can be, for example, also used as a substrate on which an electronic component is mounted.

On one surface or both surfaces in the thickness direction of the thermally conductive sheet 1, a pressure-sensitive adhesive layer, an adhesive layer, a release film, or the like can be also laminated.

A difference in level of the unevenness on the surface of the heat dissipation object (for example, a height of the electronic component) is, for example, 10 μm or more, preferably 50 μm or more, more preferably 100 μm or more, or further more preferably 200 μm or more, and is, for example, 10 mm or less, preferably 5 mm or less, more preferably 2 mm or less, or further more preferably 1 mm or less.

When the mounted substrate on which the electronic component having a height of, for example, 200 to 900 μm is mounted is covered, a thermally conductive sheet having a thickness of, for example, 100 μm or more (preferably 150 μm or more, or more preferably 200 μm or more, and of, for example, 1000 μm or less) is preferably used. By setting the thickness of the thermally conductive sheet within this range, the occurrence of cracking in the thermally conductive sheet is capable of being reduced, when the mounted substrate is covered with the thermally conductive sheet.

In the above-described first embodiment, the application of the energy ray is performed after the hot pressing as required. However, the timing thereof is not particularly limited and the application of the energy ray can be also performed, for example, before the hot pressing.

FIG. 3 shows process drawings for illustrating a method for producing another embodiment of a thermally conductive sheet of the present invention: FIG. 3A illustrating a step of dividing a pressed sheet into a plurality of pieces and FIG. 3B illustrating a step of laminating divided sheets.

In the above-described embodiment in FIG. 2, the thermally conductive composition is hot pressed once and the thermally conductive sheet 1 is obtained. Alternatively, for example, as shown in FIGS. 2, 3A, and 3B, the hot pressing can be also performed by a plurality of times.

To be specific, as shown in FIG. 2, first, the thermally conducive sheet 1 obtained by hot pressing the thermally conductive composition once is defined as a pressed sheet 1A. Subsequently, as shown in FIG. 3A, the pressed sheet 1A is divided into a plurality of pieces (for example, four pieces) and divided sheets 1B are obtained (a dividing step). In the division of the pressed sheet 1A, the pressed sheet 1A is cut along the thickness direction so that the pressed sheet 1A is divided into a plurality of pieces, when projected in the thickness direction.

Next, as shown in FIG. 3B, each of the divided sheets 1B is laminated in the thickness direction, so that a laminated sheet 1C is obtained (a laminating step).

Thereafter, as shown in FIG. 2, the laminated sheet 1C is hot pressed (preferably, hot pressed under vacuum) (a hot pressing step). The conditions for the hot pressing are the same as those for the hot pressing of the thermally conductive composition described above.

Thereafter, the series of the steps of the above-described dividing step (FIG. 3A), laminating step (FIG. 3B), and hot pressing step (FIG. 2) are repeatedly performed. The number of the repetition is not particularly limited and can be appropriately set in accordance with a dispersed state of the boron nitride particles. The number of repetition is, for example, once or more, preferably twice or more, and is, for example, 10 times or less, or preferably seven times or less.

According to this method, in the thermally conductive sheet 1, the boron nitride particles 2 can be efficiently oriented in the plane direction PD in the polymer matrix 3.

### Second Embodiment

A thermally conductive sheet in the second embodiment is an embodiment included in the thermally conductive sheet in the first embodiment. The thermally conductive sheet in the second embodiment is formed from a thermally conductive composition containing boron nitride particles in a plate shape, a rubber component, an epoxy resin, and at least one of a curing agent and a curing accelerator. That is, the thermally conductive composition that forms the thermally conductive sheet in the second embodiment contains the boron nitride particles and a polymer matrix, and the polymer matrix contains the rubber component, the epoxy resin, and at least one of the curing agent and the curing accelerator.

Examples of the boron nitride particles include the same as those described above in the first embodiment. The mixing proportion of the boron nitride particles is the same as that in the first embodiment.

An example of the rubber component includes the same as that described above in the first embodiment. Preferably, an acrylic rubber, a urethane rubber, a butadiene rubber, SBR, NBR, and a styrene-isobutylene rubber are used, or more preferably, an acrylic rubber is used.

The mixing ratio of the rubber component with respect to 100 parts by mass of the boron nitride particles is, for example, 0.1 parts by mass or more, preferably 1 part by mass or more, more preferably 3 parts by mass or more, or particularly preferably 5 parts by mass or more, and is, for example, 100 parts by mass or less, preferably 80 parts by mass or less, more preferably 50 parts by mass or less, or particularly preferably 30 parts by mass or less.

An example of the epoxy resin includes the same as that described above in the first embodiment.

The mixing ratio of the epoxy resin with respect to 100 parts by mass of the boron nitride particles is, for example, 0.1 parts by mass or more, preferably 1 part by mass or more, or more preferably 3 parts by mass or more, and is, for example, 150 parts by mass or less, preferably 80 parts by mass or less, more preferably 50 parts by mass or less, further more preferably 30 parts by mass or less, or particularly preferably 12 parts by mass or less.

The volume blending ratio (the number of parts by volume of epoxy resin/the number of parts by volume of rubber component) of the epoxy resin to the rubber component is, for example, 0.01 or more, preferably 0.1 or more, or more preferably 0.2 or more, and is, for example, 99 or less, preferably 90 or less, or more preferably 20 or less.

The epoxy resin preferably contains a liquid epoxy resin at a normal temperature and a solid epoxy resin at a normal temperature.

When the liquid epoxy resin at a normal temperature and the solid epoxy resin at a normal temperature are contained, the mixing ratio of the liquid epoxy resin at a normal temperature with respect to 100 parts by mass of the solid epoxy resin at a normal temperature is, for example, 10 parts by mass or more, preferably 20 parts by mass or more, or more preferably 40 parts by mass or more, and is, for example, 500 parts by mass or less, preferably 300 parts by mass or less, or more preferably 200 parts by mass or less. By setting the mixing ratio thereof to be 10 parts by mass or more, temporary bonding properties are excellent. On the other hand, by setting the mixing ratio thereof to be 500 parts by mass or less, crack resistance is excellent.

When the thermally conductive composition contains a liquid epoxy resin at a normal temperature and a solid epoxy resin at a normal temperature, the liquid epoxy resin at a normal temperature is preferably an aromatic epoxy resin (more preferably, a bisphenol epoxy resin) and the solid epoxy resin at a normal temperature is preferably an alicyclic epoxy resin (more preferably, a dicyclo ring-type epoxy resin).

An example of the curing agent includes the same as that described above in the first embodiment. When the thermally conductive composition contains a curing agent, the mixing ratio of the curing agent with respect to 100 parts by mass of the epoxy resin is, for example, 0.1 parts by mass or more, preferably 1 part by mass or more, more preferably 10 parts by mass or more, further more preferably 30 parts by mass or more, or particularly preferably 100 parts by mass or more, and is, for example, 1000 parts by mass or less, preferably 500 parts by mass or less, more preferably 300 parts by mass or less, or further more preferably 200 parts by mass or less. When the thermally conductive sheet is stored at a low temperature heating (for example, 40 to 100° C.) for one day, the reaction rate of the epoxy group can be set to be 40% or more by blending of the curing agent.

The curing agent equivalent with respect to the epoxy group in the epoxy resin is, for example, 0.5 or more, preferably 1.3 or more, more preferably 1.5 or more, or further more preferably 2 or more, and is, for example, 10 or less. By setting the curing agent equivalent to be 0.5 or more, the curing rate is excellent. On the other hand, by setting the curing agent equivalent to be 10 or less, the storage stability is excellent.

An example of the curing accelerator includes the same as that described above in the first embodiment. Preferably, an imidazole compound is used, or more preferably, an isocyanuric acid adduct is used.

When the thermally conductive composition contains a curing accelerator, the mixing ratio of the curing accelerator with respect to 100 parts by mass of the epoxy resin is, for example, 0.1 parts by mass or more, preferably 0.5 parts by mass or more, or more preferably 1 part by mass or more, and is, for example, 100 parts by mass or less, preferably 50 parts by mass or less, or more preferably 30 parts by mass or less.

The thermally conductive composition in the second embodiment preferably contains both of the curing agent and the curing accelerator.

The mixing proportion of the materials other than the mixing proportion described above is the same as that of the materials in the first embodiment.

The method for producing a thermally conductive sheet in the second embodiment is, in the above-described material and mixing proportion, performed in the same manner as that described above in the first embodiment.

In the thermally conductive sheet in the second embodiment, in particular, preferably, of the above-described components, the components other than the boron nitride particles (that is, the polymer matrix, to be specific, the epoxy resin, the curing agent, the curing accelerator, the rubber component, and the like) are first blended and furthermore, a solvent is added to the obtained mixture, so that a rubber-containing composition is formed. At this time, the solid content of the rubber-containing composition is, for example, 5 mass % or more, or preferably 10 mass % or more, and is, for example, 90 mass % or less, or preferably 80 mass % or less.

In the rubber-containing composition, a shear storage elastic modulus G′ at the time of increasing the temperature of a rubber-containing sheet formed by volatilizing a solvent contained in the rubber-containing composition under the conditions of a frequency of 1 Hz and a temperature rising rate of 2° C./min is, for example, 5.5×10³ Pa or more, preferably 1×10⁴ Pa or more, more preferably 2×10⁴ Pa or more, or further more preferably 3×10⁴ Pa or more, and is, for example, 7.0×10⁴ Pa or less, preferably 6×10⁴ Pa or less, more preferably 5×10⁴ Pa or less, or further more preferably 4×10⁴ Pa or less at least at any temperature in a temperature range of the attaching temperature (for example, 50 to 80° C., preferably 60 to 80° C., more preferably 70 to 80° C., or particularly preferably 80° C.).

When the shear storage elastic modulus at the attaching temperature is less than 5.5×10³ Pa, there may be a case where, when the thermally conductive sheet formed from the thermally conductive composition obtained by adding the boron nitride particles to the rubber-containing composition is bonded to a mounted substrate by heating, the thermally conductive sheet is excessively soft, so that a crack is generated in the thermally conductive sheet. On the other hand, when the shear storage elastic modulus at the attaching temperature is above 7.0×10⁴ Pa, there may be a case where the thermally conductive sheet is fragile, so that a crack is generated.

The attaching pressure is, for example, 0.05 kN or more, or preferably 0.1 kN or more, and is, for example, 5 kN or less, or preferably 1 kN or less.

Next, the boron nitride particles are blended into the rubber-containing composition so as to have the above-described mixing proportion, so that a thermally conductive composition is obtained. Then, the thermally conductive sheet in the second embodiment is produced using the obtained thermally conductive composition in the same manner as that described above.

The content ratio (the solid content, that is, the content ratio of the boron nitride particles in a component in which the solvent is removed from the thermally conductive composition) of the boron nitride particles in the thermally conductive sheet in the second embodiment, based on volume, is, for example, 35 vol % or more, preferably 50 vol % or more, more preferably 60 vol % or more, or further more preferably 65 vol % or more, and is, for example, 95 vol % or less, or preferably 90 vol % or less and is also, for example, 40 mass % or more (preferably, 50 mass % or more, or more preferably 65 mass % or more), and is, for example, 98 mass % or less (preferably 96 mass % or less, or more preferably 93 mass % or less).

The thermally conductive sheet in the second embodiment contains an epoxy resin, so that the thermally conductive sheet is obtained as a sheet in a semi-cured state (in a B-stage state) by the above-described hot pressing.

In the thermally conductive sheet 1 obtained in this way, as shown in FIG. 1 and its partially enlarged schematic view, the longitudinal direction LD of the boron nitride particles 2 is oriented along the plane direction PD that crosses (is perpendicular to) the thickness direction TD of the thermally conductive sheet 1. The orientation angle α is the same as that in the thermally conductive sheet in the first embodiment.

In this way, the thermal conductivity in the plane direction PD of the thermally conductive sheet 1 is, for example, 4 W/m·K or more, preferably 5 W/m·K or more, more preferably 10 W/m·K or more, particularly preferably 15 W/m·K or more, or most preferably 20 W/m·K or more, and is usually 200 W/m·K or less. When the thermal conductivity in the plane direction PD of the thermally conductive sheet 1 is below the above-described range, the thermally conductive properties in the plane direction PD are not sufficient, so that the thermally conductive sheet 1 may not be capable of being used for heat dissipation application that requires the thermally conductive properties in the plane direction PD.

The thermal conductivity in the thickness direction TD of the thermally conductive sheet 1 is, for example, 0.3 W/m·K or more, preferably 0.5 W/m·K or more, more preferably 0.8 W/m·K or more, further more preferably 1 W/m·K or more, or particularly preferably 1.2 W/m·K or more, and is, for example, 20 W/m·K or less.

The thermally conductive sheet 1 has an epoxy reaction rate after being stored at a room temperature (for example, 30° C.) for 30 days of, for example, less than 40%, preferably less than 30%, or more preferably less than 25%, and of, for example, 0.1% or more.

The thermally conductive sheet 1 has an epoxy reaction rate after being stored at 40 to 100° C. (to be more specific, 90° C.) for one day of, for example, 40% or more, preferably 60% or more, more preferably 80% or more, or particularly preferably 90% or more, and of, for example, 100% or less.

The thermally conductive sheet 1 has an epoxy reaction rate after being stored at 40 to 100° C. (to be more specific, 90° C.) for one hour of, for example, 5% or more, preferably 10% or more, or more preferably 20% or more, and of, for example, 60% or less.

The epoxy reaction rate of the thermally conductive sheet 1 can be obtained as follows: a DSC curve is obtained by increasing the temperature of the thermally conductive sheet from 0 to 250° C. at a rate of 10° C./min under a nitrogen gas atmosphere and the reaction rate is obtained from a heating value that is calculated from the obtained DSC curve. The details are described in Examples.

The obtained thermally conductive sheet 1 has a dielectric breakdown voltage (a measurement method is described later) of, for example, 10 kV/mm or more, preferably 20 kV/mm or more, more preferably 30 kV/mm or more, or further more preferably 40 kV/mm or more, and of, for example, 100 kV/mm or less.

The thermally conductive sheet 1 is bonded to an object to be covered (for example, though described later, an electronic component, a mounted substrate on which the electronic component is mounted, or the like) by heating. An example of the object to be covered includes the same object to be covered (heat dissipation object) as that in the first embodiment.

The heating temperature is, for example, 70° C. or more, or preferably 90° C. or more, and is, for example, 250° C. or less, preferably 200° C. or less, or more preferably 150° C. or less. In this way, the epoxy resin and the like at the inside of the thermally conductive sheet 1 react and the thermally conductive sheet 1 is capable of being strongly in tight contact with the object to be covered. At this time, the thermally conductive sheet 1 is brought into a sheet in a cured state (in a C-stage state).

The bonding is capable of being performed, while the thermally conductive sheet 1 and/or the object to be covered are/is heated and pressed as required.

The heating temperature is, for example, 50° C. or more, or preferably 60° C. or more, and is, for example, 150° C. or less, or preferably 120° C. or less.

The pressure is, for example, 0.01 MPa or more, or preferably 0.02 MPa or more, and is, for example, 50 MPa or less, or preferably 10 MPa or less.

When a difference in level such as unevenness is confirmed on the surface of the object to be covered, the height of the difference in level of the object to be covered is, for example, 10 μm or more, preferably 50 μm or more, more preferably 100 μm or more, or further more preferably 200 μm or more, and is, for example, 1 cm or less, preferably 5 mm or less, more preferably 2 mm or less, or particularly preferably 1 mm or less.

When the thickness of the thermally conductive sheet 1 is defined as A and the height of the difference in level of the object to be covered is defined as B, the ratio (B/A) of B to A is, for example, 50 or less, preferably 25 or less, or more preferably 10 or less, and is, for example, 0.005 or more. By setting the ratio to be 50 or less, the occurrence of a crack is capable of being suppressed when the thermally conductive sheet 1 is brought into tight contact with the object to be covered.

The thermally conductive sheet 1 has the thermal conductivity in the plane direction PD of the thermally conductive sheet 1 of 4 W/m·K or more and thus, has excellent thermally conductive properties in the plane direction PD. Thus, the thermally conductive sheet 1 is capable of being used for various heat dissipation applications as a thermally conductive sheet that has excellent thermally conductive properties in the plane direction PD.

The thermally conductive sheet 1 is formed from the thermally conductive composition containing the boron nitride particles, the epoxy resin, the curing agent, the curing accelerator, and the rubber component. Thus, the thermally conductive sheet 1 is capable of being bonded to a mounted substrate at a lower temperature, for example, at 100° C. or less. As a result, a thermal load to the mounted substrate is capable of being reduced.

The thermally conductive sheet 1 is formed from the thermally conductive composition obtained by adding the boron nitride particles to the rubber-containing composition that forms the rubber-containing sheet having a shear storage elastic modulus of 5.5×10³ to 7.0×10⁴ Pa at the attaching temperature. Thus, when an object to be covered having unevenness on the surface thereof is covered with the thermally conductive sheet 1, the thermally conductive sheet 1 is capable of expanding with appropriate flexibility. As a result, the occurrence of a crack in the thermally conductive sheet 1 is reduced, and the thermally conductive sheet 1 is capable of covering the object to be covered, while conforming to the surface with unevenness thereof. Accordingly, the contact area of the object to be covered and the thermally conductive sheet 1 is capable of being increased and thus, heat generated from the object to be covered is capable of being further efficiently conducted by the boron nitride particles.

The thermally conductive sheet 1 is formed from the thermally conducive composition containing the liquid epoxy resin at a normal temperature and the solid epoxy resin at a normal temperature, so that the thermally conductive sheet 1 has excellent flexibleness.

The thermally conductive sheet 1 is formed from the thermally conductive composition containing a phenol resin as a curing agent, so that the thermally conductive sheet 1 has excellent low temperature bonding properties.

The thermally conductive sheet 1 is formed from the thermally conductive composition containing an imidazole compound as a curing accelerator, so that the thermally conductive sheet 1 has excellent low temperature bonding properties and excellent storage stability.

The thermally conductive sheet 1 is formed from the thermally conductive composition in which the boron nitride particles are blended into the rubber-containing composition that forms the rubber-containing sheet having an epoxy reaction rate of less than 30% after being stored at a room temperature for 30 days, so that the thermally conductive sheet 1 has excellent storage stability.

As a conventional problem, the thermally conductive sheet may require to have high thermally conductive properties in the direction (the plane direction) perpendicular to the thickness direction depending on its use and purpose. In the case where a mounted substrate on which an electronic component having a different height of unevenness and a shape (for example, an electronic element such as an IC chip, a condenser, a coil, and a resistor) is mounted is covered with the thermally conductive sheet, when the contact area of the thermally conductive sheet, and the electronic component and the substrate is increased, since the thermally conductive sheet is brought into tight contact with the electronic component and the substrate along the upper surface and a side surface of the electronic component and the shape of the surface of the substrate without the occurrence of a crack (cracking) in the sheet, heat generated from the electronic component and the substrate is capable of being more efficiently dissipated. Accordingly, the thermally conductive sheet is required to have properties (conformability to unevenness) of conforming to the surface or the side surface with unevenness of the mounted substrate (the electronic component and the like) without the occurrence of a crack. Also, after the mounted substrate is brought into tight contact with the thermally conductive sheet, the mounted substrate can be bonded thereto by heating. However, the electronic component is vulnerable to heat, so that the thermally conducive sheet is required to have low temperature bonding properties that is capable of being bonded at a lower temperature (for example, 100° C. or less).

As described above, the thermally conductive sheet in the second embodiment is capable of solving this problem. That is, the thermally conductive sheet in the second embodiment suppresses a crack and has excellent conformability to unevenness and excellent low temperature bonding properties with respect to the mounted substrate, while having excellent thermally conductive properties.

### Third Embodiment

A thermally conductive sheet in the third embodiment includes a part of the thermally conductive sheet in the first embodiment. The thermally conductive sheet in the third embodiment contains boron nitride particles and a resin component as a polymer matrix.

Examples of the boron nitride particles include the same as those described above in the first embodiment. The mixing proportion of the boron nitride particles is the same as that in the first embodiment.

The resin component can contain, for example, any one of a thermosetting resin and a thermoplastic resin. Preferably, the resin component contains a thermosetting resin.

Examples of the thermosetting resin include an epoxy resin, a thermosetting polyimide, a urea resin, a melamine resin, an unsaturated polyester resin, a diallyl phthalate resin, a silicone resin, and a thermosetting urethane resin. Preferably, an epoxy resin is used. The resin component contains an epoxy resin, so that initial adhesiveness is excellent.

These thermosetting resins can be used alone or in combination of two or more.

An example of the epoxy resin includes the same as that described above in the first embodiment. Preferably, an aromatic epoxy resin is used, or more preferably, a bisphenol epoxy resin is used. Also, preferably, an alicyclic epoxy resin is used, or more preferably, a dicyclo ring-type epoxy resin is used.

These epoxy resins can be used alone or in combination of two or more. Preferably, a liquid epoxy resin at a normal temperature and a solid epoxy resin at a normal temperature are used in combination.

When the liquid epoxy resin at a normal temperature and the solid epoxy resin at a normal temperature are used in combination, the mixing ratio of the solid epoxy resin at a normal temperature to 100 parts by mass of the liquid epoxy resin at a normal temperature is, for example, 10 parts by mass or more, preferably 30 parts by mass or more, or more preferably 50 parts by mass or more, and is, for example, 1000 parts by mass or less, preferably 500 parts by mass or less, more preferably 300 parts by mass or less, or further more preferably 200 parts by mass or less.

When the liquid epoxy resin at a normal temperature and the solid epoxy resin at a normal temperature are used in combination, the liquid epoxy resin at a normal temperature is preferably an aromatic epoxy resin (more preferably, a bisphenol epoxy resin) and the solid epoxy resin at a normal temperature is preferably an alicyclic epoxy resin (more preferably, a dicyclo ring-type epoxy resin).

Preferably, a curing agent, along with the epoxy resin, is contained in the resin component.

An example of the curing agent includes the same as that described above.

The mixing ratio of the curing agent with respect to 100 parts by mass of the epoxy resin is, for example, 0.1 parts by mass or more, preferably 1 part by mass or more, more preferably 10 parts by mass or more, or further more preferably 30 parts by mass or more, and is, for example, 1000 parts by mass or less, preferably 500 parts by mass or less, more preferably 300 parts by mass or less, or further more preferably 200 parts by mass or less.

A curing accelerator, along with the curing agent, can be also contained in the resin component.

An example of the curing accelerator includes the same as that described above.

The mixing ratio of the curing accelerator with respect to 100 parts by mass of the epoxy resin is, for example, 0.1 parts by mass or more, preferably 0.5 parts by mass or more, or more preferably 1 part by mass or more, and is, for example, 100 parts by mass or less, preferably 50 parts by mass or less, or more preferably 30 parts by mass or less.

The resin component preferably contains a rubber.

An example of the rubber includes the same as that described above. Preferably, an acrylic rubber, a urethane rubber, a butadiene rubber, SBR, NBR, and a styrene-isobutylene rubber are used, or more preferably, an acrylic rubber is used. The resin component contains the above-described rubber, so that the conformability to unevenness is excellent.

When the rubber is prepared as a rubber solution, the content ratio (the solid content ratio) of the rubber with respect to the rubber solution is, for example, 1 mass % or more, preferably 5 mass % or more, or more preferably 10 mass % or more, and is, for example, 90 mass % or less, preferably 50 mass % or less, or more preferably 30 mass % or less.

The mixing ratio of the rubber with respect to 100 parts by mass of the epoxy resin is, for example, 10 parts by mass or more, preferably 25 parts by mass or more, more preferably 50 parts by mass or more, or further more preferably 100 parts by mass or more, and is, for example, 1000 parts by mass or less, preferably 500 parts by mass or less, or more preferably 300 parts by mass or less.

The mixing proportion of the materials other than the mixing proportion described above is the same as that of the materials in the first embodiment.

Next, one embodiment of a method for producing a thermally conductive sheet in the third embodiment is described.

The thermally conductive sheet in the third embodiment is obtained by the same method for producing a thermally conductive sheet as that in the first embodiment. Preferably, the method for producing a thermally conductive sheet in the third embodiment includes a covering step of producing a particle aggregate powder containing resin-covered boron nitride particles including boron nitride particles and a resin component covering the surfaces of the boron nitride particles and a forming step of forming the produced particle aggregate powder into a sheet shape.

Examples of the method for producing the particle aggregate powder include a vacuum drying method, a vacuum stirring and drying method, and a spray drying method. An example of the vacuum stirring and drying method includes a method using a Nauta Mixer (manufactured by Hosokawa Micron Group). An example of the spray drying method includes a method using Spray Dryer (manufactured by Nihon BUCHI K.K.), Agromaster (manufactured by Hosokawa Micron Group), and a tumbling fluidized coating device (manufactured by Powrex Corp.). In the third embodiment, preferably, a spray drying method is used, or more preferably, a method using a tumbling fluidized coating device (a tumbling fluidized bed granulation method) is used. By producing the particle aggregate powder using the tumbling fluidized bed granulation method, the particle aggregate powder in which the resin component uniformly covers the boron nitride particles is capable of being obtained. Also, the particle aggregate powder capable of producing the thermally conductive sheet having a desired tack force is capable of being surely obtained.

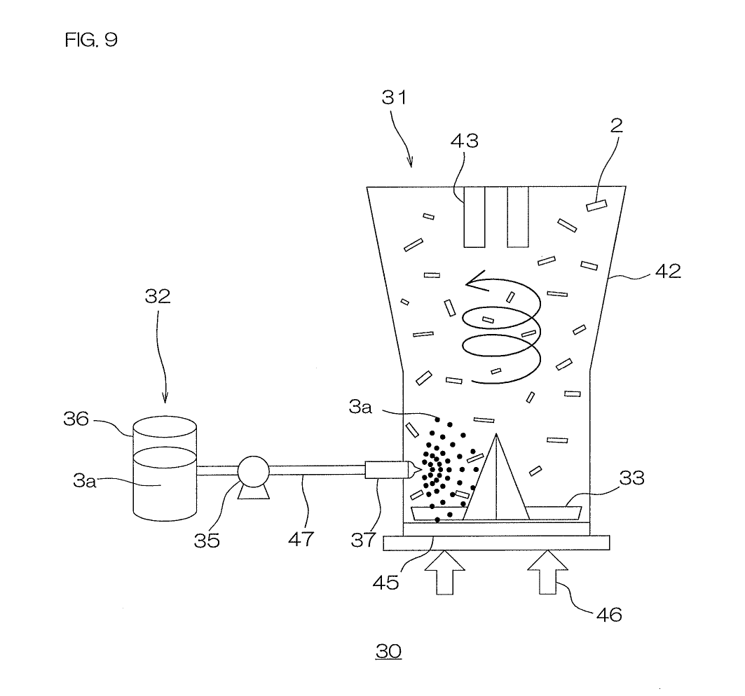

Hereinafter, a method for producing the particle aggregate powder in the third embodiment is described using the tumbling fluidized bed granulation method with reference to FIG. 9.

In the tumbling fluidized bed granulation method, the particle aggregate powder containing the resin-covered boron nitride particles in which the resin component covers the surfaces of the boron nitride particles 2 is obtained by spraying the resin component to the boron nitride particles 2, while the boron nitride particles 2 in a plate shape are floated in the air.

The resin component (the polymer matrix 3) is preferably used as a liquid composition 3a (a varnish) obtained by being dispersed or dissolved in a solvent. That is, preferably, the liquid composition 3a is sprayed to the boron nitride particles 2, while the boron nitride particles 2 are floated in the air.

An example of the solvent includes the same organic solvent as that described above. Preferably, an organic hydrocarbon is used, or more preferably, ketone is used. These solvents can be used alone or in combination of two or more.

The solid content (the solid content concentration) of the liquid composition 3a is, for example, 1 mass % or more, preferably 5 mass % or more, more preferably 8 mass % or more, further more preferably 10 mass % or more, or particularly preferably 12 mass % or more, and is, for example, 90 mass % or less, preferably 70 mass % or less, more preferably 50 mass % or less, further more preferably 30 mass % or less, or particularly preferably 20 mass % or less.

In this step, for example, a tumbling fluidized coating device shown in FIG. 9 is used.

A tumbling fluidized coating device 30 is provided with a retention portion 31 and a supply portion 32.

The retention portion 31 includes a chamber 42 and a stirring blade 33 that is housed in the chamber 42.

The chamber 42 extends in the up-down direction and is formed into a generally cylindrical shape with the upper end and the lower end closed.

At the upper end of the chamber 42, fabric filters 43 are provided so as to retain the boron nitride particles 2 in the chamber 42. At the lower end of the chamber 42, a mesh 45 is mounted so as to allow a gas 46 sent from below of the chamber 42 to pass therethrough without allowing the boron nitride particles 2 in the chamber 42 to pass therethrough. The boron nitride particles 2 are made so as to be floated (tumbled and fluidized) in the air by the gas 46 by sending the gas 46 from below upwardly to pass through the mesh 45 to the inside of chamber 42. The tumbling fluidized coating device 30 is a batch type and the input of the boron nitride particles 2 is performed with the chamber 42 open.

An outlet portion (not shown) is provided in the chamber 42 so as to take out the particle aggregate powder from the chamber 42.

The stirring blade 33 is provided at the lower portion of the chamber 42 and its revolving axis is provided capable of revolving so as to be in common with the axis of the chamber 42.

The supply portion 32 stores the liquid composition 3a and is provided with a material tank 36 that is disposed at the outside of the chamber 42, a spray port 37, and a pump 35 that is provided at the midpoint between the material tank 36 and the spray port 37.

The spray port 37 is provided at the lower portion of the chamber 42. A compressed air blower (not shown) is connected to the spray port 37. The spray port 37 is made so as to be capable of spraying the liquid composition 3a to the inside of the chamber 42 by a compressed air. The spray port 37 is connected to the material tank 36 via a connecting pipe 47.

The pump 35 is provided at the midpoint of the connecting pipe 47. The pump 35 is driven so as to supply the liquid composition 3a in the material tank 36 to the spray port 37.

Then, the covering step is performed using the tumbling fluidized coating device 30. In order to perform the covering step, first, the boron nitride particles 2 in a plate shape are put into the inside of the chamber 42.

Next, the gas 46 that is heated or cooled to a desired temperature is sent from below to pass through the mesh 45 to the inside of the chamber 42. In this way, the boron nitride particles 2 are floated in the air.

The temperature (the charge air temperature) of the gas 46 is, for example, 0° C. or more, preferably 5° C. or more, more preferably 10° C. or more, or further more preferably 20° C. or more and is, for example, 150° C. or less, preferably 100° C. or less, more preferably 60° C. or less, or further more preferably 40° C. or less.

Next, the liquid composition 3a is, by driving of the pump 35, supplied from the material tank 36 to the spray port 37 via the connecting pipe 47 and the liquid composition 3a is sprayed from the spray port 37 to the inside of the chamber 42. The amount of spray of the liquid composition 3a with respect to 100 parts by mass of the boron nitride particles 2 is, for example, 10 parts by mass or more, preferably 30 parts by mass or more, or more preferably 50 parts by mass or more, and is, for example, 500 parts by mass or less, preferably 300 parts by mass or less, or more preferably 200 parts by mass or less.

In this way, the liquid composition 3a is attached to the boron nitride particles 2 to be dried. Then, the particle aggregate powder made of the resin-covered boron nitride particles in which the surfaces of the boron nitride particles 2 are covered with the resin component is obtained. That is, the resin-covered boron nitride particles include the boron nitride particles 2 in a plate shape and the resin component covering the surfaces of the boron nitride particles 2.

In the particle aggregate powder obtained in this way, the ratio (C₇H₇⁺/B⁺) of a resin contributing ion (C₇H₇⁺) to a boron nitride contributing ion (B⁺) based on a TOF-SIMS analysis is, for example, 0.4 or more, preferably 1.0 or more, or more preferably 2.0 or more, and is, for example, 10 or less. By setting the ratio within this range, the thermally conductive sheet having an excellent tack force is capable of being produced.

In the analysis based on the TOF-SIMS, the measurement is performed under the conditions of primary ion: Bi₃²⁺, pressurized voltage: 25 kV, and measurement area: 200 μm square using TOF-SIMS (manufactured by ION-TOF GmbH) as a device.

In the covering amount (the mass ratio) of the resin component with respect to the boron nitride particles 2 in the particle aggregate powder, for example, the covering amount of the resin component with respect to 100 parts by mass of the boron nitride particles is, for example, 1 part by mass or more, preferably 5 parts by mass or more, more preferably 7 parts by mass or more, or further more preferably 10 parts by mass or more, and is, for example, 100 parts by mass or less, preferably 50 parts by mass or less, more preferably 30 parts by mass or less, or further more preferably 25 parts by mass or less.

The particle aggregate powder produced by this producing method may contain completely covered-boron nitride particles in which the entire surfaces of the boron nitride particles 2 are covered with the resin component. Or, the particle aggregate powder produced by this producing method may also contain partially covered-boron nitride particles in which a part of the surfaces of the boron nitride particles 2 is covered with the resin component and the remaining part thereof is exposed from the resin component.

In this producing method, at the time of the treatment, a known additive may be blended into the inside of the chamber 42 at an appropriate proportion. Or, a known additive may be also blended into the liquid composition 3a at an appropriate proportion.

By blending a known additive into the obtained particle aggregate powder at an appropriate proportion, a particle composition containing the particle aggregate powder is also capable of being obtained. The content ratio of the particle aggregate powder in the particle composition is, for example, 80 mass % or more, preferably 85 mass % or more, or more preferably 90 mass % or more, and is, for example, below 100 mass %.

Examples of the known additive include a flame retardant, a dispersant, a tackifier, a silane coupling agent, a fluorine-based surfactant, an oxidation inhibitor, a colorant, a lubricant, a catalyst, and inorganic particles other than the boron nitride particles.

The particle aggregate powder and the particle composition can be used for various applications, for example, for a sheet forming application. More preferably, the particle aggregate powder and the particle composition can be used for forming a thermally conductive sheet, that is, used as a thermally conductive sheet-forming particle aggregate powder and a thermally conductive sheet-forming composition.

Next, in this method, the obtained particle aggregate powder is hot pressed.

To be specific, the particle aggregate powder (a pre-sheet in the case of allowing the particle aggregate powder to be subjected to a rolling pressure treatment) is hot pressed with a pressing device. The hot pressing device is provided with a heatable and movable pedestal and a top plate that is disposed above the pedestal in opposed relation at spaced intervals thereto. The hot pressing device is made so that the pedestal is capable of moving to the top plate at the time of pressing.

The particle aggregate powder is sandwiched between two pieces of release films as required. The obtained particle aggregate powder is placed on the heated pedestal and next, the pedestal is moved upwardly, so that the particle aggregate powder is compressed between the pedestal and the top plate.

The conditions for the hot pressing are as follows: a heating temperature of, for example, 30° C. or more, or preferably 40° C. or more, and of, for example, 170° C. or less, or preferably 150° C. or less; a pressure of, for example, 0.5 MPa or more, preferably 1 MPa or more, or more preferably 5 MPa or more, and of, for example, 100 MPa or less, preferably 75 MPa or less, or more preferably 50 MPa or less; and a pressing duration of, for example, 0.1 minutes or more, or preferably 1 minute or more, and of, for example, 200 minutes or less, preferably 100 minutes or less, more preferably 30 minutes or less, or further more preferably 15 minutes or less.

More preferably, the particle aggregate powder is hot pressed under vacuum. The degree of vacuum in the vacuum hot pressing is, for example, 1 Pa or more, or preferably 5 Pa or more, and is, for example, 100 Pa or less, or preferably 50 Pa or less. The temperature, pressure, and duration are the same as those in the above-described hot pressing.

Examples of a material that forms the release film include a polyester film (a polyethylene terephthalate film and the like); a fluorine-based film prepared from a fluorine-based polymer (for example, a polytetrafluoroethylene, a polychlorotrifluoroethylene, polyvinyl fluoride, polyvinylidene fluoride, a tetrafluoroethylene-hexafluoropropylene copolymer, a chlorofluoroethylene-vinylidene fluoride copolymer); an olefin-based resin film prepared from an olefin-based resin (polyethylene, polypropylene, and the like); a plastic-based substrate film (a synthetic resin film) such as a polyvinyl chloride film, a polyimide film, a polyamide film (a nylon film), and a rayon film; papers such as a wood free paper, a Japanese paper, a kraft paper, a glassine paper, a synthetic paper, and a top-coated paper; and a complex of the above-described components by lamination.

The release film has a thickness of, for example, 1 μm or more, or preferably 10 μm or more, and of, for example, 300 μm or less, or preferably 500 μm or less.

In the hot pressing, if necessary, a spacer having a desired thickness is disposed on the periphery of the particle aggregate powder in a frame shape, so that a thermally conductive sheet having substantially the same thickness as that of the spacer is capable of being obtained.

In the producing method in the third embodiment, preferably, before the hot pressing, the particle aggregate powder is extended by applying pressure into a sheet shape (a pre-sheet) with a twin roll or the like (a rolling pressure step).

The rolling conditions in the rolling pressure step are as follows: a heating temperature of roll of, for example, 40° C. or more, or preferably 50° C. or more, and of, for example, 150° C. or less, preferably 100° C. or less, or more preferably 80° C. or less and a revolving rate of roll of, for example, 0.1 rpm or more, or preferably 0.5 rpm or more, and of, for example, 10 rpm or less, or preferably 5 rpm or less.

The rolling pressure steps may be repeatedly performed. That is, the particle aggregate powder is formed into a pre-sheet in the rolling pressure step (the first time) and furthermore, the pre-sheet may be subjected to the rolling pressure step after the second time. The number of the repetition of the rolling pressure step is, for example, once or more, or preferably twice or more, and is, for example, 10 times or less, or preferably five times or less. By adjusting the number of repetition of the rolling pressure step, the tack force and the thermal conductivity of the thermally conductive sheet can be adjusted.

In the twin roll, two pieces of rolls are disposed at spaced intervals (for example, 10 to 1000 μm) so that the axes of the rolls are in parallel. At the upstream side of each of the rolls, a guide in a plate shape is provided so as to guide the particle aggregate powder to the above-described gap. The guides are disposed at spaced intervals (for example, 1 to 50 cm) to each other.

Two pieces of release films can be also provided so as to sandwich the particle aggregate powder therebetween in the above-described gap between the rolls.

In this way, the thermally conductive sheet 1 is capable of being obtained. In the third embodiment, the thermally conductive sheet is produced using the particle aggregate powder. When the particle composition is used, the thermally conductive sheet is also capable of being produced under the same conditions.

When the resin component contains an epoxy resin or a rubber containing an epoxy group, the thermally conductive sheet 1 is obtained as a sheet in a semi-cured state (in a B-stage state) by the above-described hot pressing.

In the thermally conductive sheet 1 obtained in this way, the longitudinal direction LD of the boron nitride particles 2 is oriented along the plane direction PD that crosses (is perpendicular to) the thickness direction TD of the thermally conductive sheet 1. The orientation angle α of the boron nitride particles 2 is the same as that in the thermally conductive sheet in the first embodiment.

The calculated average absolute value (with respect to the thermally conductive sheet 1) of the angle between the longitudinal direction LD of the boron nitride particles 2 and the plane direction PD of the thermally conductive sheet 1 is, for example, 30 degrees or less, preferably 25 degrees or less, or more preferably 20 degrees or less, and is usually 0 degree or more.

In this way, the thermal conductivity in the plane direction PD of the thermally conductive sheet 1 is, for example, 4 W/m·K or more, preferably 5 W/m·K or more, more preferably 10 W/m·K or more, further more preferably 15 W/m·K or more, particularly preferably 20 W/m·K or more, or most preferably 25 W/m·K or more, and is usually 200 W/m·K or less.

When the thermal conductivity in the plane direction PD of the thermally conductive sheet 1 is below the above-described range, the thermally conductive properties in the plane direction PD are not sufficient, so that the thermally conductive sheet 1 may not be capable of being used for heat dissipation application that requires the thermally conductive properties in the plane direction PD.

The thermal conductivity in the thickness direction TD of the thermally conductive sheet 1 is, for example, 0.3 W/m·K, preferably 0.5 W/m·K, more preferably 0.8 W/m·K or more, further more preferably 1 W/m·K or more, or particularly preferably 1.2 W/m·K or more, and is, for example, 20 W/m·K or less.

The thermally conductive sheet 1 has a tack force with respect to a glass epoxy substrate of, for example, 350 g/(diameter of 2 cm) or more, preferably 650 g/(diameter of 2 cm) or more, more preferably 1000 g/(diameter of 2 cm) or more, further more preferably 1300 g/(diameter of 2 cm) or more, particularly preferably 1500 g/(diameter of 2 cm) or more, or most preferably 2000 g/(diameter of 2 cm) or more, and of, for example, 50000 g/(diameter of 2 cm) or less in a temperature range of, for example, 40° C. or more (preferably 60° C. or more, more preferably 70° C. or more, or further more preferably 80° C. or more). By setting the tack force at 40° C. or more within the above-described range, the thermally conductive sheet 1 has excellent initial adhesiveness.

The thermally conductive sheet 1 has a tack force of, for example, 500 g/(diameter of 2 cm) or more, preferably 1200 g/(diameter of 2 cm) or more, more preferably 1300 g/(diameter of 2 cm) or more, further more preferably 1500 g/(diameter of 2 cm) or more, or particularly preferably 2000 g/(diameter of 2 cm) or more, and of, for example, 50000 g/(diameter of 2 cm) or less in a temperature range of, for example, 90° C. Furthermore, the thermally conductive sheet 1 has a tack force of, for example, 50 g/(diameter of 2 cm) or more, preferably 60 g/(diameter of 2 cm) or more, more preferably 100 g/(diameter of 2 cm) or more, further more preferably 200 g/(diameter of 2 cm) or more, or particularly preferably 650 g/(diameter of 2 cm) or more in a temperature range of, for example, 60° C. or less. Furthermore, the thermally conductive sheet 1 has a tack force of, for example, 50 g/(diameter of 2 cm) or less, preferably 30 g/(diameter of 2 cm) or less, more preferably 20 g/(diameter of 2 cm) or less, or further more preferably 10 g/(diameter of 2 cm) or less in a temperature range of, for example, 25° C. or less. By having a tack force within the above-described range, the thermally conductive sheet 1 has excellent handling ability at a normal temperature and the initial adhesion is possible by heating or pressurization, so that the bonding properties thereof at the subsequent curing treatment is further more excellent.

The tack force is obtained as follows: using a texture analyzer (a compression-tensile test, trade name: Texture Analyzer (TA. XTPL/5), manufactured by EKO Instruments), one surface of the thermally conductive sheet is bonded to the tip (a diameter of 20 mm) of a short needle of the texture analyzer and the other surface thereof is bonded to a glass epoxy substrate, and next, the maximum load at the time of peeling the thermally conductive sheet from the glass epoxy substrate is measured. The details are described later in Examples.

The thermally conductive sheet 1 has a thickness of, for example, 1000 μm or less, preferably 800 μm or less, or more preferably 500 μm or less, and of, for example, 10 μm or more, preferably 50 μm or more, or more preferably 100 μm or more.

The mixing ratio of the boron nitride particles 2 in the thermally conductive sheet 1 with respect to the thermally conductive sheet, based on mass, is, for example, 60 mass % or more, preferably 70 mass % or more, more preferably 75 mass % or more, or further more preferably 80 mass % or more, and is, for example, 95 mass % or less, preferably 93 mass % or less, or more preferably 90 mass % or less.

When the content proportion of the boron nitride particles 2 is below the above-described range, there may be a case where a thermally conductive path of the boron nitride particles with themselves is not formed, so that the thermally conductive properties in the plane direction PD are reduced in the thermally conductive sheet 1. When the content proportion of the boron nitride particles 2 is above the above-described range, the formability of the thermally conductive sheet 1 may be reduced.

The thermally conductive sheet 1 contains the boron nitride particles in a plate shape, has the content ratio of the boron nitride particles glass of 60 mass % or more, and has the thermal conductivity in the plane direction of 4 W/m·K or more. Thus, the thermally conductive sheet 1 has excellent thermally conductive properties in the plane direction. Thus, the thermally conductive sheet 1 is capable of being used for various heat dissipation applications as a thermally conductive sheet that has excellent thermally conductive properties in the plane direction. An example of the object to be covered includes the same object to be covered (heat dissipation object) as that in the first embodiment.

The thermally conductive sheet 1 has a tack force of 350 g/diameter of 2 cm or more in a temperature range of 40° C. or more, so that the initial bonding properties are excellent.

The thermally conductive sheet contains an epoxy resin, so that the initial bonding properties thereof with respect to an adherend are further more excellent.

The thermally conductive sheet contains a rubber, so that the conformability to unevenness is excellent.

The particle aggregate powder for forming the thermally conductive sheet contains the resin-covered boron nitride particles including the boron nitride particles and the resin component covering the surfaces of the boron nitride particles, and the ratio of the resin contributing ion to the boron nitride contributing ion based on a TOF-SIMS analysis is 0.4 or more. Thus, the thermally conductive sheet having an excellent initial bonding force is capable of being further surely produced.

The particle aggregate powder is produced by spraying the resin component to the boron nitride particles, while the boron nitride particles in a plate shape are floated in the air. Thus, the particle aggregate powder that is capable of forming the thermally conductive sheet having an excellent initial bonding force is capable of being surely produced.

The thermally conducive sheet is produced by obtaining the particle aggregate powder by spraying the resin component to the boron nitride particles, while the boron nitride particles in a plate shape are floated in the air and next, by heating and pressing the obtained particle aggregate powder. Thus, the thermally conductive sheet having an excellent initial bonding force is capable of being obtained.

As a conventional problem, in order to further improve the thermally conductive properties of the thermally conductive sheet, a method of increasing the content proportion of the boron nitride particles is effective. However, in the thermally conductive sheet obtained by the conventional producing method, when the content proportion of the boron nitride particles is increased, the proportion of a resin (for example, an epoxy resin) at the surface of the thermally conductive sheet is reduced. Thus, there is a disadvantage that the thermally conductive sheet is not easily bonded to an adherend at the initial stage of attaching the thermally conductive sheet to the adherend such as an electronic component.

As described above, the thermally conductive sheet in the third embodiment is capable of solving this problem. That is, the thermally conductive sheet in the third embodiment has excellent initial bonding properties.

### Fourth Embodiment

A thermally conductive sheet in the third embodiment includes a part of the thermally conductive sheet in the first embodiment. The thermally conductive sheet in the fourth embodiment contains, for example, thermally conducive particles and a resin component as a polymer matrix.

The thermally conductive particles are formed from a thermally conductive material into a particle shape. An example of the thermally conductive material includes an inorganic material.

Examples of the inorganic material include carbide, a nitride, an oxide, a hydroxide, a metal, and a carbon-based material. Examples of the inorganic material include the same other inorganic particles (however, including the boron nitride particles) as those described above in the first embodiment.

Of the inorganic materials, in view of thermally conductive properties, preferably, a nitride including boron nitride is used, or more preferably, boron nitride is used.

The shape of the thermally conductive particles is not particularly limited as long as the shape thereof is in a particle shape (in a powder shape). Examples of the shape thereof may include a bulk shape, a needle shape, or a plate shape (or a flake shape). Preferably, a plate shape is used.

An example of the boron nitride in a plate shape includes the same as that in the first embodiment.

The resin component can contain, for example, any one of a thermosetting resin and a thermoplastic resin. Preferably, the resin component contains a thermosetting resin. An example of the thermosetting resin includes the same as that described above in the third embodiment.

Preferably, a curing agent, along with the epoxy resin, is contained in the resin component.

An example of the curing agent includes the same as that in the first embodiment.

The mixing ratio of the curing agent with respect to 100 parts by mass of the epoxy resin is, for example, 0.1 parts by mass or more, preferably 1 part by mass or more, more preferably 10 parts by mass or more, or further more preferably 30 parts by mass or more, and is, for example, 1000 parts by mass or less, preferably 500 parts by mass or less, more preferably 300 parts by mass or less, or further more preferably 200 parts by mass or less.

As combination of the epoxy resin and the curing agent, preferably, combination of an epoxy resin and a phenol resin is used; more preferably, combination of a liquid epoxy resin at a normal temperature, a solid resin at a normal temperature, and a phenol resin is used; further more preferably, combination of an aromatic epoxy resin, an alicyclic epoxy resin, and a phenol resin is used; or particularly preferably, combination of a bisphenol epoxy resin, a dicyclo ring-type epoxy resin, and a phenol-aralkyl resin is used. In this way, the thermally conductive sheet further surely has a breaking strain of 125% or more in a temperature range of 40° C. or more, so that a crack is more preferably suppressed and the conformability to unevenness is excellent.

A curing accelerator, along with the curing agent, can be also contained in the resin component. When the resin component contains the curing accelerator (preferably, an imidazole compound), low temperature curing is further surely possible.

An example of the curing accelerator includes the same as that described above in the first embodiment.

The mixing ratio of the curing accelerator with respect to 100 parts by mass of the epoxy resin is, for example, 0.1 parts by mass or more, preferably 0.5 parts by mass or more, or more preferably 1 part by mass or more, and is, for example, 100 parts by mass or less, preferably 50 parts by mass or less, or more preferably 30 parts by mass or less.

The resin component, in view of conformability to unevenness of the thermally conductive sheet, preferably contains a rubber, in addition to the thermosetting resin and the thermoplastic resin.

An example of the rubber includes the same as that described above in the first embodiment. Preferably, an acrylic rubber, a urethane rubber, a butadiene rubber, SBR, NBR, and a styrene-isobutylene rubber are used, or more preferably, an acrylic rubber is used.

When the rubber is prepared as a rubber solution, the mixing ratio (the solid content ratio) of the rubber with respect to the rubber solution is, for example, 1 mass % or more, preferably 5 mass % or more, or more preferably 10 mass % or more, and is, for example, 90 mass % or less, preferably 50 mass % or less, or more preferably 30 mass % or less.

The mixing ratio of the rubber with respect to 100 parts by mass or the epoxy resin is, for example, 10 parts by mass or more, preferably 25 parts by mass or more, more preferably 50 parts by mass or more, or further more preferably 100 parts by mass or more, and is, for example, 1000 parts by mass or less, preferably 500 parts by mass or less, or more preferably 300 parts by mass or less.

The resin component can contain a known additive at an appropriate proportion. Examples of the known additive include a flame retardant, a dispersant, a tackifier, a silane coupling agent, a fluorine-based surfactant, a plasticizer, an oxidation inhibitor, and a colorant.

The mixing ratio of the resin component with respect to 100 parts by mass of the thermally conductive particles is, for example, 1 part by mass or more, preferably 5 parts by mass or more, more preferably 7 parts by mass or more, or further more preferably 10 parts by mass or more, and is, for example, 100 parts by mass or less, preferably 50 parts by mass or less, more preferably 30 parts by mass or less, or further more preferably 25 parts by mass or less.

The mixing proportion of the materials other than the mixing proportion described above is the same as that of the materials in the first embodiment.

Next, a method for producing one embodiment of a thermally conductive sheet in the fourth embodiment is described.

The method for producing a thermally conductive sheet in the fourth embodiment is the same as that described above in the first embodiment.

In the fourth embodiment, a thermally conductive composition is also capable of being prepared by a tumbling fluidized bed granulation method.

To be specific, a thermally conductive composition containing resin-covered thermally conductive particles in which a resin component covers the surfaces of thermally conductive particles is obtained by spraying the resin component to the thermally conductive particles, while the thermally conductive particles (preferably, the boron nitride particles in a plate shape) are floated in the air. The thermally conductive composition is prepared by the tumbling fluidized bed granulation method, so that the surface of the powder is covered with the resin component and thus, the properties of the resin are easily developed. To be specific, the elongation of the thermally conductive sheet at the time of heating is excellent, so that the conformability to unevenness is excellent.

The resin component is preferably used as a liquid composition (a varnish) obtained by being dispersed or dissolved in a solvent. That is, preferably, the liquid composition is sprayed onto the thermally conductive particles, while the thermally conductive particles are floated in the air.

Examples of the solvent and the liquid composition include the same as those described above in the third embodiment.

Examples of the device (the tumbling fluidized coating device shown in FIG. 9), the conditions, and the like in the tumbling fluidized bed granulation method include the same as those in the third embodiment.

Next, in this method, the obtained thermally conductive composition is hot pressed by the tumbling fluidized bed granulation method. Examples of the device, the conditions, and the like in the hot pressing include the same as those in the third embodiment.

Preferably, before the hot pressing, the thermally conductive composition is extended by applying pressure into a sheet shape (a pre-sheet) with a twin roll or the like (a rolling pressure step).

An example of the rolling pressure step includes the same as that described above in the third embodiment. By adjusting the number of repetition of the rolling pressure step, the breaking strain and the thermal conductivity of the thermally conductive sheet can be adjusted.

In this way, as shown in FIG. 1, the thermally conductive sheet 1 is capable of being obtained.

When the resin component contains an epoxy resin or a rubber containing an epoxy group, the thermally conductive sheet 1 is obtained as a sheet in a semi-cured state (in a B-stage state) by the above-described hot pressing.

In the thermally conductive sheet 1 obtained in this way, preferably, the longitudinal direction LD of the thermally conductive particles (preferably, the boron nitride particles 2 in a plate shape) is oriented along the plane direction PD that crosses (is perpendicular to) the thickness direction TD of the thermally conductive sheet 1. The orientation angle α of the thermally conductive particles is the same as that of the boron nitride particles 2 in the first embodiment.

The thermal conductivity in the plane direction PD of the thermally conductive sheet 1 is, for example, 4 W/m·K or more, preferably 5 W/m·K or more, more preferably 10 W/m·K or more, further more preferably 15 W/m·K or more, particularly preferably 20 W/m·K or more, or most preferably 25 W/m·K or more, and is usually 200 W/m·K or less.

When the thermal conductivity in the plane direction PD of the thermally conductive sheet 1 is below the above-described range, the thermally conductive properties in the plane direction PD are not sufficient, so that the thermally conductive sheet 1 may not be capable of being used for heat dissipation application that requires the thermally conductive properties in the plane direction PD.

The thermal conductivity in the thickness direction TD of the thermally conductive sheet 1 is, for example, 0.3 W/m·K or more, preferably 0.5 W/m·K or more, more preferably 0.8 W/m·K or more, further more preferably 1 W/m·K or more, or particularly preferably 1.2 W/m·K or more, and is usually 20 W/m·K or less.

The thermally conductive sheet 1 obtained in this way has a breaking strain in the plane direction PD (the direction perpendicular to the thickness direction) of the thermally conductive sheet 1 of 125% or more in a temperature range of 40° C. or more (preferably, 40° C. or more and less than 100° C., more preferably 50° C. or more and less than 80° C., or particularly preferably 60° C. or more and less than 70° C.). The thermally conductive sheet 1 has a breaking strain in the plane direction PD of preferably 140% or more, more preferably 150% or more, further more preferably 160% or more, particularly preferably 170° C. or more, or most preferably 180% or more, and of, for example, 1000% or less. When the breaking strain in the plane direction PD satisfies the above-described range at least at any temperature in a temperature range of 40° C. or more, the thermally conductive sheet 1 is capable of sufficiently expanding, so that the conformability to unevenness is excellent.

Preferably, the breaking strain in the plane direction PD is 125% or more over the above-described entire temperature range. That is, the breaking strain in the plane direction PD is preferably 125% or more, more preferably 140% or more, further more preferably 150% or more, particularly preferably 160% or more, particularly preferably 170% or more, or most preferably 180% or more, and is, for example, 1000% or less in a temperature range of 40° C. or more (preferably, 40° C. or more and less than 100° C., more preferably 50° C. or more and less than 80° C., or particularly preferably 60° C. or more and less than 70° C.). By setting the breaking strain within this range, the conformability to unevenness is capable of being surely improved.

The thermally conductive sheet 1 has a breaking strain in the plane direction PD of preferably less than 125% in a temperature range of less than 40° C. (preferably, 0° C. or more and less than 40° C., more preferably 0° C. or more and 25° C. or less). The thermally conductive sheet 1 has a breaking strain in the plane direction PD of preferably less than 120%, more preferably less than 110%, or further more preferably less than 115%, and of, for example, 100% or more. When the breaking strain in the plane direction PD satisfies the above-described range at least at any temperature in a temperature range of less than 40° C., the thickness of the thermally conductive sheet at a normal temperature is capable of being surely retained, so that the handling ability of the thermally conductive sheet 1 at a normal temperature is excellent.

Furthermore, the breaking strain in the plane direction PD is preferably less than 125%, more preferably less than 120%, further more preferably less than 110%, or particularly preferably less than 115%, and is, for example, 100% or more in a temperature range of 25° C. or less (preferably, 0° C. or more and 25° C. or less). When the breaking strain in the plane direction PD satisfies the above-described range, that is, when the thermally conductive sheet 1 fails to have a breaking strain in the plane direction PD of 125% or more in the above-described entire temperature range, the handling ability of the thermally conductive sheet 1 is further improved.

The breaking strain in the plane direction PD of the thermally conductive sheet 1 is capable of being measured with a universal tensile and compression testing machine (TG-10 kN, manufactured by Minebea Co., Ltd., Load Cell TT3D-1 kN) attached with a thermostatic chamber. The details are described later in Examples.

The thermally conductive sheet 1 has an elastic modulus in the plane direction PD of preferably 400 N/mm² or less in a temperature range of 40° C. or more (preferably, 40° C. or more and less than 100° C., more preferably 50° C. or more and less than 80° C., or further more preferably 60° C. or more and less than 70° C.). The thermally conductive sheet 1 has an elastic modulus in the plane direction PD of preferably 300 N/mm² or less, more preferably 200 N/mm² or less, further more preferably 180 N/mm² or less, particularly preferably 120 N/mm² or less, or most preferably 70 N/mm² or less, and of, for example, 1 N/mm² or more. When the elastic modulus in the plane direction PD satisfies the above-described range at least at any temperature in a temperature range of 40° C. or more, the sheet has appropriate toughness of sufficiently expanding, so that the conformability to unevenness is excellent.

The elastic modulus in the plane direction PD at the time of pulling the thermally conductive sheet 1 in the plane direction is particularly preferably 400 N/mm² or less over the above-described entire temperature range. That is, the elastic modulus in the plane direction PD is preferably 300 N/mm² or less, more preferably 200 N/mm² or less, further more preferably 180 N/mm² or less, particularly preferably 120 N/mm² or less, or most preferably 70 N/mm² or less, and is, for example, 1 N/mm² or more in the entire temperature range of 40° C. or more (preferably, 40° C. or more and less than 100° C., more preferably 50° C. or more and less than 80° C., or further more preferably 60° C. or more and less than 70° C.). By setting the elastic modulus within this range, the conformability to unevenness is capable of being surely improved.

The thermally conductive sheet 1 has an elastic modulus in the plane direction PD of preferably 500 N/mm² or more, more preferably 700 N/mm² or more, further more preferably 800 N/mm² or more, or particularly preferably 1000 N/mm² or more, and of, for example, 100000 N/mm² or less in a temperature range of 25° C. or less (preferably, 0° C. or more and 25° C. or less). When the elastic modulus in the plane direction PD satisfies the above-described range, the thickness of the thermally conductive sheet at a normal temperature (for example, 25° C.) is capable of being surely retained, so that the handling ability of the thermally conductive sheet 1 at a normal temperature is excellent.

The elastic modulus in the plane direction PD of the thermally conductive sheet 1 is capable of being measured with a universal tensile and compression testing machine (TG-10 kN, manufactured by Minebea Co., Ltd., Load Cell TT3D-1 kN) attached with a thermostatic chamber.

The thermally conductive sheet 1 has an elongation in the thickness direction TD of the thermally conductive sheet 1 of 1.5 mm/(200 μm) or more in a temperature range of 40° C. or more (preferably, 40° C. or more and less than 100° C., more preferably 50° C. or more and less than 80° C., or particularly preferably 60° C. or more and less than 70° C.). The thermally conductive sheet 1 has an elongation in the thickness direction TD of preferably 1.6 mm/(200 μm) or more, more preferably 1.7 mm/(200 μm) or more, further more preferably 1.8 mm/(200 μm) or more, particularly preferably 1.9 mm/(200 μm) or more, or most preferably 2.0 mm/(200 μm) or more, and of, for example, 5.0 mm/(200 μm) or less. When the elongation in the thickness direction TD satisfies the above-described range at least at any temperature in a temperature range of 40° C. or more, the thermally conductive sheet 1 is capable of sufficiently expanding, so that the conformability to unevenness is excellent.

Preferably, the elongation in the thickness direction TD is 1.0 mm/(200 μm) or more over the above-described entire temperature range. That is, the elongation in the thickness direction TD is preferably 1.0 mm/(200 μm) or more, more preferably 1.4 mm/(200 μm) or more, further more preferably 1.5 mm/(200 μm) or more, particularly preferably 1.6 mm/(200 μm) or more, particularly preferably 1.7 mm/(200 μm) or more, or most preferably 2.0 mm/(200 μm) or more, and is, for example, 5.0 mm/(200 μm) or less in a temperature range of 40° C. or more (preferably, 40° C. or more and less than 100° C., more preferably 50° C. or more and less than 100° C., further more preferably 60° C. or more and less than 90° C., or particularly preferably 70° C. or more and less than 90° C.). By setting the elongation within this range, the conformability to unevenness is capable of being surely improved.

The thermally conductive sheet 1 has an elongation in the thickness direction TD of preferably less than 1.6 mm/(200 μm) in a temperature range of less than 40° C. (preferably, 0° C. or more and less than 40° C., more preferably 0° C. or more and 25° C. or less). The thermally conductive sheet 1 has an elongation in the thickness direction TD of preferably less than 1.3 mm/(200 μm), more preferably less than 1.1 mm/(200 μm), or further more preferably less than 1.01 mm/(200 μm), and of, for example, 0.01 mm/(200 μm) or more. When the elongation in the thickness direction TD satisfies the above-described range at least at any temperature in a temperature range of less than 40° C., the thickness of the thermally conductive sheet at a normal temperature is capable of being surely retained, so that the handling ability of the thermally conductive sheet 1 at a normal temperature is excellent.

Furthermore, the elongation in the thickness direction TD is preferably less than 1.5 mm/(200 μm), more preferably less than 1.3 mm/(200 μm), further more preferably less than 1.1 mm/(200 μm), or particularly preferably less than 1.01 mm/(200 μm), and is, for example, 0.01 mm/(200 μm) or more in a temperature range of 25° C. or less (preferably, 0° C. or more and 25° C. or less). When the elongation in the thickness direction TD satisfies the above-described range, that is, when the thermally conductive sheet 1 fails to have an elongation in the thickness direction TD of 1.5 mm/(200 μm) or more in the above-described entire temperature range, the handling ability of the thermally conductive sheet 1 is further improved.

The elongation in the thickness direction TD of the thermally conductive sheet 1 is capable of being measured with a texture analyzer (a compression-tensile test, trade name: Texture Analyzer (TA. XTPL/5), manufactured by EKO Instruments). The details are described later in Examples.

The thermally conductive sheet 1 has an elastic modulus in the thickness direction TD of preferably 11 MPa or less in a temperature range of 40° C. or more (preferably, 40° C. or more and less than 100° C., more preferably 50° C. or more and less than 100° C., further more preferably 60° C. or more and less than 100° C., or particularly preferably 70° C. or more and less than 90° C.). The thermally conductive sheet 1 has an elastic modulus in the thickness direction TD of preferably 5 MPa or less, more preferably 2 MPa or less, further more preferably, 1.5 MPa or less, or particularly preferably 1.0 MPa or less, and of, for example, 0.3 MPa or more. When the elastic modulus in the thickness direction TD satisfies the above-described range at least at any temperature in a temperature range of 40° C. or more, the sheet has appropriate toughness of sufficiently expanding, so that the conformability to unevenness is excellent.

The elastic modulus in the thickness direction TD at the time of sticking a short needle in the thickness direction of the thermally conductive sheet 1 is particularly preferably 11 MPa or less over the above-described entire temperature range. That is, the elastic modulus in the thickness direction TD is preferably 9 MPa or less, more preferably 7 MPa or less, further more preferably 3 MPa or less, particularly preferably 2 MPa or less, or most preferably 1.1 MPa or less, and is, for example, 0.3 MPa or more in the entire temperature range of 40° C. or more (preferably, 40° C. or more and less than 100° C., more preferably 50° C. or more and less than 100° C., further more preferably 60° C. or more and less than 100° C., or particularly preferably 70° C. or more and less than 90° C.). By setting the elastic modulus within this range, the conformability to unevenness is capable of being surely improved.

The thermally conductive sheet 1 has an elastic modulus in the thickness direction TD of preferably 4 MPa or more, more preferably 7 MPa or more, further more preferably 8 MPa or more, or particularly preferably 10 MPa or more, and of, for example, 100 MPa or less in a temperature range of 25° C. or less (preferably, 0° C. or more and 25° C. or less). When the elastic modulus in the thickness direction TD satisfies the above-described range, the thickness of the thermally conductive sheet at a normal temperature (for example, 25° C.) is capable of being surely retained, so that the handling ability of the thermally conductive sheet 1 at a normal temperature is excellent.

The elastic modulus in the thickness direction TD at the time of sticking the short needle in the thickness direction of the thermally conductive sheet 1 is capable of being measured with a texture analyzer (a compression-tensile test, trade name: Texture Analyzer (TA. XTPL/5), manufactured by EKO Instruments).

The thermally conductive sheet 1 is preferably curable at a low temperature. That is, the thermally conductive sheet 1 is brought into a completely cured state (a C-stage state) by being heated at a low temperature. The conditions for the curing are as follows: a curable temperature of, for example, 120° C. or less, preferably 100° C. or less, or more preferably 90° C. or less, and of, for example, 50° C. or more, preferably 70° C. or more, or more preferably 80° C. or more and a heating duration of, for example, three minutes or more, or preferably five minutes or more, and of, for example, 100 hours or less, preferably 80 hours or less, more preferably 50 hours or less, or further more preferably 25 hours or less. By allowing the thermally conductive sheet to be curable at a low temperature, when an object to be covered is covered with the thermally conductive sheet 1 and the thermally conductive sheet 1 is thermally cured, a thermal load to the object to be covered is suppressed.

The thermally conductive sheet 1 has a thickness of, for example, 1000 μm or less, preferably 800 μm or less, or more preferably 500 μm or less, and of usually, for example, 50 μm or more, or preferably 100 μm or more.

The mixing ratio of the thermally conductive particles in the thermally conductive sheet 1 with respect to the thermally conductive sheet 1, based on mass, is, for example, 60 mass % or more, preferably 70 mass % or more, more preferably 75 mass % or more, or further more preferably 80 mass % or more, and is, for example, 98 mass % or less, preferably 95 mass % or less, or more preferably 90 mass % or less.

When the mixing proportion of the thermally conductive particles satisfies the above-described range, a thermally conductive path of the thermally conductive particles with themselves is easily formed, so that the thermally conductive properties in the plane direction PD are excellent in the thermally conductive sheet 1. Also, the formability of the thermally conductive sheet 1 is excellent.

The thermally conductive sheet 1 has a dielectric breakdown voltage (a measurement method is described later) of, for example, 10 kV/mm or more, preferably 20 kV/mm or more, more preferably 30 kV/mm or more, or further more preferably 40 kV/mm or more, and of, for example, 200 kV/mm or less.

The thermally conductive sheet 1 has the thermal conductivity in the plane direction of 4 W/m·K or more and thus, has excellent thermally conductive properties in the plane direction. Thus, the thermally conductive sheet 1 is capable of being used for various heat dissipation applications as a thermally conductive sheet that has excellent thermally conductive properties in the plane direction.

The thermally conductive sheet 1 has a breaking strain of 125% or more in a temperature range of 40° C. or more, so that the conformability to unevenness is excellent.

An example of the object to be attached to or to be covered with the thermally conductive sheet 1 includes the same object to be covered (heat dissipation object) as that in the first embodiment.

As a conventional problem, the thermally conductive sheet may require to have high thermally conductive properties in the plane direction depending on its use and purpose. The thermally conductive sheet is used for a mounted substrate having unevenness on the surface thereof (an electronic component) and in such a case, the thermally conductive sheet is required to have properties (conformability to unevenness) of conforming to the surface or the side surface with unevenness without the occurrence of a crack (cracking) in the surface of the thermally conductive sheet.

As described above, the thermally conductive sheet in the fourth embodiment is capable of solving this problem. That is, the thermally conductive sheet in the fourth embodiment has excellent thermally conductive properties in the plane direction and has excellent conformability to unevenness.

### Fifth Embodiment

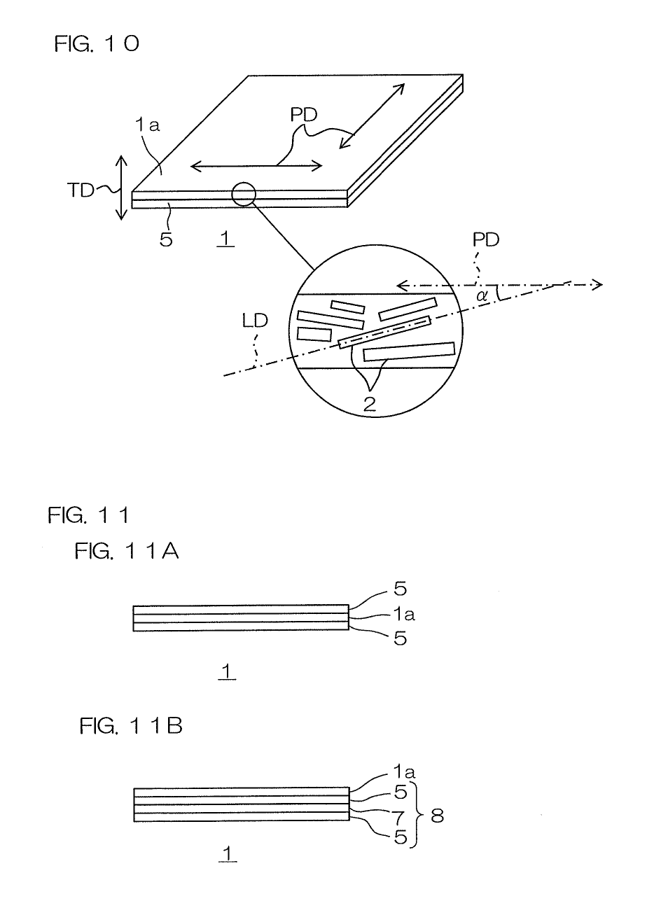

A thermally conductive sheet in the fifth embodiment includes a part of the thermally conductive sheet in the first embodiment. The thermally conductive sheet in the fifth embodiment includes a thermally conductive layer (ref: a numeral 1a in FIG. 10) and an adhesive layer laminated on at least one surface of the thermally conductive layer (ref: a numeral 5 in FIG. 10).

The thermally conductive layer is formed into a sheet shape and contains boron nitride particles and a rubber component. An example of the thermally conductive layer includes the same as that described above in the first embodiment.

Examples of the boron nitride particles include the same as those described above in the first embodiment.

An example of the rubber component includes the same as that described above in the first embodiment. Preferably, an acrylic rubber, a urethane rubber, a butadiene rubber, SBR, NBR, and a styrene-isobutylene rubber are used, or more preferably, an acrylic rubber is used.

The mixing ratio of the rubber component with respect to 100 parts by mass of the boron nitride particles is, for example, 0.1 parts by mass or more, preferably 1 part by mass or more, or more preferably 2 parts by mass or more, and is, for example, 50 parts by mass or less, preferably 20 parts by mass or less, or more preferably 15 parts by mass or less.

A resin, or preferably, an epoxy resin can be contained in the thermally conductive layer.

An example of the epoxy resin includes the same as that described above in the first embodiment. Preferably, an aromatic epoxy resin is used, more preferably, a bisphenol epoxy resin, a fluorene epoxy resin, and a triphenylmethane epoxy resin are used, or particularly preferably, a bisphenol epoxy resin is used. Also, preferably, an alicyclic epoxy resin is used, or more preferably, a dicyclo ring-type epoxy resin is used.

The mixing ratio of the epoxy resin with respect to 100 parts by mass of the boron nitride particles is, for example, 0.1 parts by mass or more, preferably 1 part by mass or more, or more preferably 2 parts by mass or more, and is, for example, 50 parts by mass or less, preferably 20 parts by mass or less, or more preferably 10 parts by mass or less.

The volume blending ratio (the number of parts by volume of epoxy resin/the number of parts by volume of rubber component) of the epoxy resin to the rubber component is, for example, 0.01 or more, preferably 0.1 or more, or more preferably 0.2 or more, and is, for example, 99 or less, preferably 90 or less, or more preferably 19 or less.

A curing agent, along with the epoxy resin, can be also contained in the thermally conductive layer.

An example of the curing agent includes the same as that described above in the first embodiment. Preferably, an imidazole compound is used, or more preferably, an isocyanuric acid adduct is used.

The mixing ratio of the curing accelerator with respect to 100 parts by mass of the epoxy resin is, for example, 0.1 parts by mass or more, preferably 0.5 parts by mass or more, or more preferably 1 part by mass or more, and is, for example, 100 parts by mass or less, preferably 50 parts by mass or less, or more preferably 20 parts by mass or less.

The mixing proportion of the materials other than the mixing proportion described above is the same as that of the materials in the first embodiment.

The method for producing a thermally conductive layer is the same as that described above in the first embodiment.

In a thermally conductive layer 1a obtained in this way, as shown in FIG. 10 and its partially enlarged schematic view, the longitudinal direction LD of the boron nitride particles 2 is oriented along the plane direction PD that crosses (is perpendicular to) the thickness direction TD of the thermally conductive layer 1a (that is, the thermally conductive sheet 1). The orientation angle α of the boron nitride particles is the same as that in the first embodiment.

In this way, the thermal conductivity in the plane direction PD of the thermally conductive layer 1a is, for example, 4 W/m·K or more, preferably 5 W/m·K or more, more preferably 10 W/m·K or more, particularly preferably 15 W/m·K or more, or most preferably 20 W/m·K or more, and is usually 200 W/m·K or less. When the thermal conductivity in the plane direction PD of the thermally conductive layer 1a is below the above-described range, the thermally conductive properties in the plane direction PD are not sufficient, so that the thermally conductive layer 1a may not be capable of being used for heat dissipation application that requires the thermally conductive properties in the plane direction PD.

The thermal conductivity in the thickness direction TD of the thermally conductive layer 1a is, for example, 0.5 W/m·K or more, preferably 0.8 W/m·K or more, or more preferably 1 W/m·K or more, and is, for example, 15 W/m·K or less, preferably 12 W/m·K or less, or more preferably 10 W/m·K or less.

The obtained thermally conductive layer 1a has a thickness of, for example, 2000 μm or less, preferably 800 μm or less, more preferably 600 μm or less, or particularly preferably 400 μm or less, and of, for example, 50 μm or more, or preferably 100 μm or more.

As shown in FIG. 1, an adhesive layer 5 is formed on the entire lower surface of the thermally conductive layer 1a.

The adhesive layer 5 is a layer so as to increase a bonding force of the adhesive layer with an object to be covered that is in contact therewith by curing a component in the adhesive layer by heating. The above-described adhesive layer has, for example, an adhesion force at a normal temperature and may be capable of being temporarily fixed. Or, even when the adhesive layer fails to have an adhesion force at a normal temperature, the adhesive layer is once melted by heating and then, may develop the adhesion force.

The adhesive layer 5 contains, for example, a rubber component. By containing the rubber component, the conformability to unevenness to the object to be covered in the adhesive layer 5 is capable of being improved.

An example of the rubber component includes the same as that in the thermally conductive layer 1a. Preferably, an acrylic rubber, a urethane rubber, a butadiene rubber, SBR, NBR, and a styrene-isobutylene rubber are used, or more preferably, an acrylic rubber and NBR are used.

The rubber component, in particular, may contain a functional group in the same manner as that in the rubber component in the thermally conductive layer 1a. Examples of the functional group include a carboxyl group, a hydroxyl group, an epoxy group, and an amide group. Preferably, a carboxyl group and an epoxy group are used, or more preferably, a carboxyl group is used. A pressure-sensitive adhesive layer 6 contains the rubber component, so that the temporary fixing properties at a normal temperature (at 25° C.) are excellent.

The mixing ratio of the rubber component in the adhesive layer 5 is, for example, 10 mass % or more, preferably 20 mass % or more, more preferably 30 mass % or more, or further more preferably 40 mass % or more, and is, for example, 80 mass % or less, preferably 70 mass % or less, or more preferably 60 mass % or less.

A resin component (preferably, an epoxy resin) can be contained in the adhesive layer 5 as required. Furthermore, a curing agent and/or a curing accelerator can be also contained in the adhesive layer 5. Preferably, the adhesive layer 5 contains an epoxy resin, a curing agent, and a curing accelerator. By containing these components, for example, the adhesive layer 5 is capable of being temporarily fixed to an object to be covered at a normal temperature and being bonded to the object to be covered at a low temperature (for example, heating at 100° C. or less).

An example of the epoxy resin includes the same as that in the thermally conducive layer 1a. Preferably, an aromatic epoxy resin and an alicyclic epoxy resin are used, or more preferably, a bisphenol epoxy resin and a dicyclo ring-type epoxy resin are used.

The mixing ratio of the epoxy resin in the adhesive layer 5 is, for example, 10 mass % or more, preferably 15 mass % or more, or more preferably 20 mass % or more, and is, for example, 98 mass % or less, preferably 50 mass % or less, more preferably 40 mass % or less, or further more preferably 30 mass % or less.

An example of the curing agent includes the same as that in the thermally conductive layer 1a. Preferably, a phenol-aralkyl resin is used.

The mixing ratio of the curing agent in the adhesive layer 5 with respect to 100 parts by mass of the epoxy resin is, for example, 1 part by mass or more, preferably 10 parts by mass or more, or more preferably 20 parts by mass or more, and is, for example, 300 parts by mass or less, preferably 200 parts by mass or less, or more preferably 100 parts by mass or less.

An example of the curing accelerator includes the same as that in the thermally conductive layer 1a. Preferably, an imidazole compound is used, or more preferably, an isocyanuric acid adduct is used.

The mixing ratio of the curing accelerator in the adhesive layer 5 with respect to 100 parts by mass of the epoxy resin is, for example, 0.1 parts by mass or more, or preferably 1 part by mass or more, and is, for example, 20 parts by mass or less, or preferably 10 parts by mass or less.

The adhesive layer 5 can contain an additive that is added in the thermally conductive layer 1a as required. Examples of the additive include a polymerization initiator, a dispersant, a flame retardant, a leveling agent, a tackifier, and inorganic particles.

Next, a method for forming the adhesive layer 5 is described.

In this method, first, the above-described components are blended at the above-described mixing proportion to be stirred and mixed, so that an adhesive composition is prepared.

In the stirring and mixing, for example, a solvent is blended with the above-described components in order to efficiently mix the components.

An example of the solvent includes the same organic solvent as that described above. When the above-described curing agent is prepared as a solvent solution and/or a solvent dispersion liquid, the solvent in the solvent solution and/or the solvent dispersion liquid is capable of being subjected as a mixed solvent for the stirring and mixing without adding a solvent in the stirring and mixing. Or, a solvent is also capable of being further added as a mixed solvent in the stirring and mixing.

The solid content of the adhesive composition is, for example, 1 mass % or more, preferably 5 mass % or more, or more preferably 10 mass % or more, and is, for example, 80 mass % or less, preferably 60 mass % or less, or more preferably 40 mass % or less.

Next, the adhesive composition is applied to a release film with an applicator or the like.

The adhesive layer has a thickness (before drying) at the time of application of, for example, 1 μm or more, preferably 5 μm or more, or more preferably 10 μm or more, and of, for example, 1000 μm or less, or preferably 500 μm or less.

Next, the solvent is removed with a drying oven, so that the adhesive layer laminated on the release film is capable of being obtained.

The drying temperature is, for example, a normal temperature or more, or preferably 40° C. or more, and is, for example, 150° C. or less, or preferably 100° C. or less.

The drying duration is, for example, one minute or more, or preferably two minutes or more, and is, for example, five hours or less, or preferably two hours or less.

In this way, the adhesive layer 5 formed on the release film is capable of being obtained.

The adhesive layer 5 obtained in this way has a thickness of, for example, 500 μm or less, preferably 100 μm or less, more preferably 50 μm or less, or further more preferably 30 μm or less, and of, for example, 100 nm or more, or preferably 1 μm or more.

The adhesive layer 5 is preferably an adhesive layer (a pressure-sensitive adhesive layer) having pressure-sensitive adhesive properties that is capable of pressure-sensitive adhesion at the initial stage of being brought into contact with an object to be covered.

In order to obtain the thermally conductive sheet 1, the thermally conductive layer 1a and the adhesive layer 5 are prepared and the adhesive layer 5 is laminated on the surface of the thermally conductive layer 1a.

To be more specific, for example, the adhesive layer 5 and the thermally conductive layer 1a are overlapped so as to be the same in plane view and a pressure is uniformly applied to the obtained laminate inwardly in the thickness direction with a hand roller or the like.

At this time, preferably the adhesive layer 5 and the thermally conductive layer 1a are laminated, while being heated. The heating temperature is, for example, 40° C. or more, or preferably 60° C. or more, and is, for example, 150° C. or less, or preferably 120° C. or less.

In this way, the thermally conductive sheet 1 is capable of being obtained.

The thermally conductive sheet 1 has the adhesive layer 5 laminated on the surface thereof and preferably has pressure-sensitive adhesive properties that is capable of pressure-sensitive adhesion at the initial stage of being brought into contact with an object to be covered.

To be specific, in the peel adhesive force at the temporary fixing of the adhesive layer 5 of the thermally conductive sheet 1, the thermally conductive sheet 1 has a tack force with respect to a glass epoxy substrate of, for example, 100 g/(diameter of 1 cm) or more, preferably 300 g/(diameter of 1 cm) or more, more preferably 500 g/(diameter of 1 cm) or more, or further more preferably 650 g/(diameter of 1 cm) or more, and of, for example, 20000 g/(diameter of 1 cm) or less, or preferably 10000 g/(diameter of 1 cm) or less in a temperature range of, for example, 0° C. or more, preferably 0 to 50° C., more preferably 10 to 40° C., further more preferably 20 to 30° C., or particularly preferably 25° C. By having the tack force of 100 g/(diameter of 1 cm) or more in a temperature range of 0 to 50° C., the adhesive layer 5 of the thermally conductive sheet 1 is appropriately hard to slip with respect to the object to be covered, so that the temporary fixing becomes easy. On the other hand, by setting the tack force to be 20000 g/(diameter of 1 cm) or less, the adhesive layer 5 is capable of being easily peeled from the object to be covered.

Furthermore, the thermally conductive sheet 1 has a tack force with respect to a glass epoxy substrate of, for example, 650 g/(diameter of 1 cm) or more, preferably 900 g/(diameter of 1 cm) or more, more preferably 1000 g/(diameter of 1 cm) or more, further more preferably 1200 g/(diameter of 1 cm) or more, or particularly preferably 1500 g/(diameter of 1 cm) or more, and of, for example, 20000 g/(diameter of 1 cm) or less, or preferably 10000 g/(diameter of 1 cm) or less in a temperature range of, for example, 0° C. or more (preferably 20° C. or more, more preferably 40° C. or more, or further more preferably 60° C. or more). By having the tack force within the above-described range at 0° C. or more, the thermally conductive sheet 1 has excellent temporary bonding properties.

The thermally conductive sheet 1 has a tack force with respect to a glass epoxy substrate of, for example, 650 g/(diameter of 1 cm) or more, preferably 1000 g/(diameter of 1 cm) or more, or more preferably 1500 g/(diameter of 1 cm) or more, and of, for example, 20000 g/(diameter of 1 cm) or less, or preferably 10000 g/(diameter of 1 cm) or less in a temperature range of 70° C. By having the tack force within the above-described range at 70° C., the thermally conductive sheet 1 has excellent temporary bonding properties.

The thermally conductive sheet 1 has excellent temporary bonding properties, so that the thermally conductive sheet 1 is capable of being temporarily bonded to the object to be covered without being peeled, even in the case of the vibration or the contact with another component at the time of transportation of a component to another place after the temporary bonding.

The tack force is obtained as follows: using a texture analyzer (a compression-tensile test, trade name: Texture Analyzer (TA. XTPL/5), manufactured by EKO Instruments), the side of the thermally conductive layer 1a of the thermally conductive sheet 1 is fixed to the tip (a diameter of 10 mm) of a short needle thereof; the adhesive layer 5 is pressed and brought into contact with a glass epoxy substrate; and next, the maximum load at the time of peeling the adhesive layer 5 of the thermally conductive sheet 1 from the glass epoxy substrate is measured. The details are described later in Examples.

The thermally conductive sheet 1 has a dielectric breakdown voltage (a measurement method is described later) of, for example, 10 kV/mm or more, preferably 30 kV/mm or more, more preferably 50 kV/mm or more, or further more preferably 60 kV/mm or more, and of, for example, 200 kV/mm or less. When the thermally conductive sheet 1 having the dielectric breakdown voltage within this range is used, the thermally conductive sheet 1 is capable of being used by crossing wiring of an electronic component.

The thermally conductive sheet 1 is brought into contact with the object to be covered so that the adhesive layer 5 is in contact with the surface of the object to be covered and the adhesive layer 5 is thermally cured by heating (is brought into a C-stage state), so that the thermally conductive sheet 1 is capable of being bonded to the object to be covered.

In order to thermally cure the adhesive layer 5, the thermally conductive sheet is heated at a temperature of, for example, 40° C. or more, preferably 60° C. or more, more preferably 60° C. or more, or further more preferably 80° C. or more, and of, for example, 250° C. or less, preferably 200° C. or less, more preferably 150° C. or less, or further more preferably 120° C. or less for, for example, 10 seconds or more, preferably one minute or more, or more preferably five minutes or more, and for, for example, 10 days or less, preferably seven days or less, or more preferably three days or less.

The thermally conductive sheet 1 has the thermal conductivity in the plane direction PD of the thermally conductive layer 1a of 4 W/m·K or more and thus, has excellent thermally conductive properties in the plane direction PD. Thus, the thermally conductive sheet 1 is capable of being used for various heat dissipation applications as a thermally conductive sheet that has excellent thermally conductive properties in the plane direction PD.

The thermally conductive sheet 1 contains the boron nitride particles and the rubber component. Thus, when an object to be covered having unevenness on the surface thereof is covered with the thermally conductive sheet 1, both of the thermally conductive sheet 1 and the adhesive layer 5 conform to the surface with unevenness and expand, so that a gap that is not covered with the thermally conductive sheet 1 is capable of being embedded by the adhesive layer 5. In this way, a heat dissipation object as the object to be covered is capable of being surely covered and heat generated from the heat dissipation object is capable of being further surely conducted by the boron nitride particles.

The thermally conductive sheet 1 includes the adhesive layer 5, so that after the heat dissipation object having different height of unevenness on the surface is covered with the thermally conductive sheet 1, the heat dissipation object is not easily peeled from the thermally conductive sheet 1. As a result, deterioration of the thermally conductive properties of heat caused by peeling is capable of being suppressed.

Also, the adhesive layer 5 is a pressure-sensitive adhesive layer, so that the adhesive layer 5 is capable of being temporarily fixed to the object to be covered. Thus, the thermally conductive sheet 1 and the object to be covered are positioned and after the temporary fixing, the thermally conductive sheet 1 and the object to be covered can be again peeled to be positioned. As a result, the reworkability is excellent.

The adhesive layer 5 contains the rubber component, so that the thermally conductive sheet 1 is capable of further surely covering the object to be covered by conforming to the unevenness of the object to be covered.

The adhesive layer 5 contains the epoxy resin, the curing agent, and the curing accelerator, so that when the thermally conductive sheet 1 is bonded to the object to be covered by heating, the bonding is capable of being performed at a lower temperature. Thus, damage to the object to be covered by heating is capable of being reduced.

An example of the object to be attached to or to be covered with the thermally conductive sheet 1 includes the same object to be covered (heat dissipation object) as that in the first embodiment.

In the fifth embodiment, the adhesive layer 5 is laminated on one surface in the thickness direction of the thermally conductive layer 1a. Alternatively, as referred in FIG. 11A, the adhesive layers 5 can be also laminated on one surface and the other surface in the thickness direction of the thermally conductive layer 1a.

Also, as referred in FIG. 11B, the adhesive layer 5 can be changed to a substrate-including adhesive layer 8 in which the adhesive layers 5 are laminated on one surface and the other surface in the thickness direction of a base substrate 7. In this way, the strength of the thermally conductive sheet is capable of being improved.

The base substrate 7 is, for example, a sheet in a flat plate shape in which the surface thereof is not subjected to a release treatment.

An example of a material of the base substrate 7 includes the same material of the substrate of the release film such as PET.

The base substrate 7 has a film thickness of, for example, 1 μm or more, preferably 2 μm or more, or more preferably 5 μm or more, and of, for example, 20 μm or less, or preferably 15 μm or less.

Although not shown in FIGS. 1, 3A, and 3B, a release film may be laminated on at least one surface of the topmost surface of the thermally conductive sheet.

As a conventional problem, the thermally conductive sheet may require to have high thermally conductive properties in the direction (the plane direction) perpendicular to the thickness direction depending on its use and purpose. In the case where a mounted substrate on which an electronic component having a different height of unevenness and a shape (for example, an electronic element such as an IC chip, a condenser, a coil, and a resistor) is mounted is covered with the thermally conductive sheet, when the contact area of the thermally conductive sheet, and the electronic component and the substrate is increased, since the thermally conductive sheet is brought into tight contact with the electronic component and the substrate along the upper surface and the side surface of the electronic component and the shape of the surface of the substrate without a gap, heat generated from the electronic component and the substrate is capable of being more efficiently dissipated. Accordingly, the thermally conductive sheet is required to have properties (conformability to unevenness) of conforming to the surface or the side surface with unevenness of the mounted substrate (the electronic component and the like). Furthermore, there is a disadvantage that in the mounted substrate having unevenness on the surface thereof, when the thermally conductive sheet is brought into tight contact with the mounted substrate, peeling easily occurs.

As described above, the thermally conductive sheet in the fifth embodiment is capable of solving this problem. That is, the thermally conductive sheet in the fifth embodiment has excellent conformability to unevenness with respect to the mounted substrate and is not easily peeled, while having excellent thermally conductive properties.

### Sixth Embodiment

A thermally conductive sheet in the sixth embodiment includes a part of the thermally conductive sheet in the first embodiment. The thermally conductive sheet in the sixth embodiment includes a thermally conductive layer (ref: the numeral 1a in FIG. 12) and a pressure-sensitive adhesive layer laminated on at least one surface of the thermally conductive layer (ref: a numeral 6 in FIG. 12).

The thermally conductive layer is formed into a sheet shape and contains boron nitride particles and a rubber component. An example of the thermally conductive layer includes the same as that described above in the first embodiment. More preferably, an example of the thermally conducive layer includes the same as that described above in the fifth embodiment.

The method for producing a thermally conductive layer is the same as that described above in the first embodiment.

As shown in FIG. 12, a pressure-sensitive adhesive layer 6 is formed on the entire lower surface of the thermally conductive layer 1a.

The pressure-sensitive adhesive layer 6 is a pressure-sensitive adhesive layer that is capable of pressure-sensitive adhesion at the initial stage of being brought into contact with an object to be covered and has tackiness (pressure-sensitive adhesive properties).

The pressure-sensitive adhesive layer 6 preferably contains an acrylic pressure-sensitive adhesive. The acrylic pressure-sensitive adhesive is, for example, prepared from an acrylic polymer obtained by polymerization of a monomer material containing an alkyl(meth)acrylate.

To be more specific, an example of the alkyl(meth)acrylate includes a straight chain or branched chain alkyl(meth)acrylate containing an alkyl portion having 1 to 20 carbon atoms such as a methyl(meth)acrylate, an ethyl(meth)acrylate, a propyl(meth)acrylate, an isopropyl(meth)acrylate, a butyl(meth)acrylate, an isobutyl(meth)acrylate, an sec-butyl(meth)acrylate, a t-butyl(meth)acrylate, a pentyl(meth)acrylate, a neopentyl(meth)acrylate, a hexyl(meth)acrylate, a heptyl(meth)acrylate, an octyl(meth)acrylate, an isooctyl(meth)acrylate, a 2-ethyl hexyl(meth)acrylate, a nonyl(meth)acrylate, an isononyl(meth)acrylate, a decyl(meth)acrylate, an isodecyl(meth)acrylate, a lauryl(meth)acrylate, a bornyl(meth)acrylate, an isobornyl(meth)acrylate, a myristyl(meth)acrylate, a pentadecyl(meth)acrylate, and a stearyl(meth)acrylate. Preferably, a straight chain or branched chain alkyl(meth)acrylate containing an alkyl portion having 2 to 10 carbon atoms is used.

These alkyl(meth)acrylates are appropriately used alone or in combination.

When the alkyl(meth)acrylates are used in combination, for example, combination of an alkyl acrylate containing an alkyl portion having 2 to 5 carbon atoms and an alkyl acrylate containing an alkyl portion having 6 to 10 carbon atoms is used.

The alkyl(meth)acrylate with respect to the monomer material is contained at a content ratio of, for example, 80 mass % or more, or preferably 85 mass % or more, and of, for example, 100 mass % or less, or preferably 99.5 mass % or less.

In addition to the alkyl(meth)acrylate, a monomer that is copolymerizable with the alkyl(meth)acrylate can be also contained in the monomer material.

An example of the copolymerizable monomer includes a functional group-containing monomer that contains a functional group.

Examples of the functional group-containing monomer include a carboxyl group-containing monomer or an anhydride thereof such as acrylic acid, methacrylic acid, itaconic acid, maleic acid, crotonic acid, and maleic anhydride; a hydroxyl group-containing monomer such as 2-hydroxyethyl(meth)acrylate, 2-hydroxypropyl(meth)acrylate, and 2-hydroxybutyl(meth)acrylate; an amide group-containing monomer such as (meth)acrylamide, N,N-dimethyl(meth)acrylamide, N-methylol(meth)acrylamide, N-methoxymethyl(meth)acrylamide, and N-butoxymethyl(meth)acrylamide; an amino group-containing monomer such as dimethylaminoethyl(meth)acrylate and t-butylaminoethyl(meth)acrylate; a glycidyl group-containing monomer such as glycidyl(meth)acrylate; (meth)acrylonitrile; N-(meth)acryloylmorpholine; and N-vinyl-2-pyrrolidone.

These functional group-containing monomers are appropriately used alone or in combination. The content ratio of the functional group-containing monomer with respect to the monomer material is, for example, 20 mass % or less, or preferably 15 mass % or less.

The acrylic polymer has a weight average molecular weight of, for example, 50,000 or more, or preferably 100,000 or more, and of, for example, 5,000,000 or less, or preferably 3,000,000 or less. The weight average molecular weight is calculated with GPC (calibrated with standard polystyrene).

The acrylic polymer is, for example, polymerized with a known radical polymerization.

Examples of a polymerization initiator used in the radial polymerization include an azo-based initiator such as 2,2′-azobisisobutyronitrile, 2,2′-azobis(2-methylpropioneamidine)disulfate, 2,2′-azobis(2-amidinopropane)dihydrochloride, 2,2′-azobis[2-(5-methyl-2-imidazoline-2-yl)propane]dihydrochloride, 2,2′-azobis(N,N′-dimethyleneisobutylamidine), and 2,2′-azobis[N-2(carboxyethyl)-2-methylpropioneamidine]hydrate; a persulfate-based initiator such as potassium persulfate and ammonium persulfate; a peroxide-based initiator such as benzoyl peroxide, t-butyl hydroperoxide, and hydrogen peroxide; a substituted ethane-based initiator such as phenyl-substituted ethane; a carbonyl-based initiator such as an aromatic carbonyl compound; and a redox-based initiator such as combination of persulfate and sodium hydrogen sulfite and combination of peroxide and sodium ascorbate.

These polymerization initiators are appropriately used alone or in combination. The mixing ratio of the polymerization initiator with respect to 100 parts by mass of the monomer material is, for example, 0.005 to 1 parts by mass.

An additive such as a chain transfer agent and a cross-linking agent can be appropriately blended in the polymerization of the acrylic polymer as required.

The content ratio of the acrylic pressure-sensitive adhesive in the pressure-sensitive adhesive layer 6 is, for example, 30 mass % or more, preferably 50 mass % or more, more preferably 70 mass % or more, further more preferably 80 mass % or more, or particularly preferably 95 mass % or more, and is usually, for example, 100 mass % or less.

A filler can be also contained in the pressure-sensitive adhesive layer.

Examples of the filler include inorganic particles in a sphere shape, a plate shape, a flake shape, or a needle shape.

Examples of the inorganic particles include carbide such as silicon carbide; a nitride (excluding boron nitride) such as silicon nitride; an oxide such as silicon oxide (silica) and aluminum oxide (alumina); a metal such as copper and silver; and carbon-based particles such as carbon black. Preferably, silica is used.

These inorganic particles can be used alone or in combination of two or more.

The content ratio of the filler in the pressure-sensitive adhesive layer 6 is, for example, 99 mass % or less, or preferably 90 mass % or less, and is, for example, 0 mass % or more, or preferably 10 mass % or more.

The pressure-sensitive adhesive layer 6 can also contain a known additive in addition to the above-described components. Examples of the known additive include a dispersant, a tackifier, a silane coupling agent, a fluorine-based surfactant, a plasticizer, a filler, an oxidation inhibitor, and a colorant.

A method for producing the pressure-sensitive adhesive layer 6 is described.

First, an acrylic pressure-sensitive adhesive is blended into an organic solvent to be dissolved, so that a pressure-sensitive adhesive composition (a varnish) is prepared and, if necessary, a filler, an additive, and the like are further added thereto. The obtained pressure-sensitive adhesive composition is applied to the surface of a release film with an applicator or the like and thereafter, the solvent is distilled off by normal pressure drying or vacuum (reduced pressure) drying, so that the pressure-sensitive adhesive layer is obtained.

An example of the organic solvent includes the same as that in the method for producing the thermally conductive layer 1a.

The solid content of the pressure-sensitive adhesive composition is, for example, 10 mass % or more, or preferably 20 mass % or more, and is, for example, 90 mass % or less, or preferably 80 mass % or less.

The drying temperature is, for example, a normal temperature or more, or preferably 40° C. or more, and is, for example, 150° C. or less, or preferably 100° C. or less.

The drying duration is, for example, one minute or more, or preferably five minutes or more, and is, for example, five hours or less, or preferably two hours or less.

In this way, the pressure-sensitive adhesive layer 6 formed on the release film is capable of being obtained.

The pressure-sensitive adhesive layer 6 obtained in this way has a thickness of, for example, 500 μm or less, preferably 100 μm or less, or more preferably 10 μm or less, and of, for example, 1 μm or more.

The pressure-sensitive adhesive layer 6 and the thermally conductive layer 1a are overlapped so as to be the same in plane view and a pressure is uniformly applied to the obtained laminate inwardly in the thickness direction with a hand roller or the like.

In this way, the thermally conductive sheet 1 is capable of being obtained.

The thermally conductive sheet 1 has a dielectric breakdown voltage (a measurement method is described later) of, for example, 10 kV/mm or more, preferably 20 kV/mm or more, more preferably 30 kV/mm or more, further more preferably 40 kV/mm or more, or particularly preferably 50 kV/mm or more, and of, for example, 100 kV/mm or less.

The ratio of the thickness of the thermally conductive layer 1a to that of the pressure-sensitive adhesive layer 6 is, for example, in the thermally conductive layer/the pressure-sensitive adhesive layer, 2/1 to 500/1 (preferably, 5/1 to 50/1).

The thermally conductive sheet 1 has the thermal conductivity in the plane direction PD of the thermally conductive layer 1a of 4 W/m·K or more and thus, has excellent thermally conductive properties in the plane direction PD. Thus, the thermally conductive sheet 1 is capable of being used for various heat dissipation applications as a thermally conductive sheet that has excellent thermally conductive properties in the plane direction PD.

The thermally conductive sheet 1 contains the boron nitride particles and the rubber component. Thus, when an object to be covered having unevenness on the surface thereof is covered with the thermally conductive sheet 1, the thermally conductive sheet 1 conforms to the surface with unevenness and expands, so that the occurrence of cracking (a crack) in the thermally conductive sheet 1 is capable of being reduced. As a result, a heat dissipation object as the object to be covered is capable of being surely covered and heat generated from the heat dissipation object is capable of being further surely conducted by the boron nitride particles.

The thermally conductive sheet 1 includes the pressure-sensitive adhesive layer 6, so that the bonding properties with respect to a mounted substrate are excellent. Thus, the thermally conductive sheet is not easily peeled from the mounted substrate and the reworkability thereof is excellent.

Also, the pressure-sensitive adhesive layer 6 is an acrylic pressure-sensitive adhesive layer and is, in particular, prepared from an acrylic polymer obtained by polymerization of a monomer material containing an alkyl(meth)acrylate, so that the thermally conductive sheet 1 has excellent bonding properties.

The thermally conductive sheet 1, in particular, contains the rubber component and includes the pressure-sensitive adhesive layer 6, so that when a heat dissipation object having unevenness on the surface thereof is covered with the thermally conductive sheet 1, the conformability to unevenness is surely improved in a temperature range of, for example, 60 to 100° C.; simultaneously, furthermore, the adhesiveness is improved; and the thermally conductive sheet is strongly bonded to the heat dissipation object. An example of the object to be attached to or to be covered with the thermally conductive sheet 1 includes the same object to be covered (heat dissipation object) as that in the first embodiment.

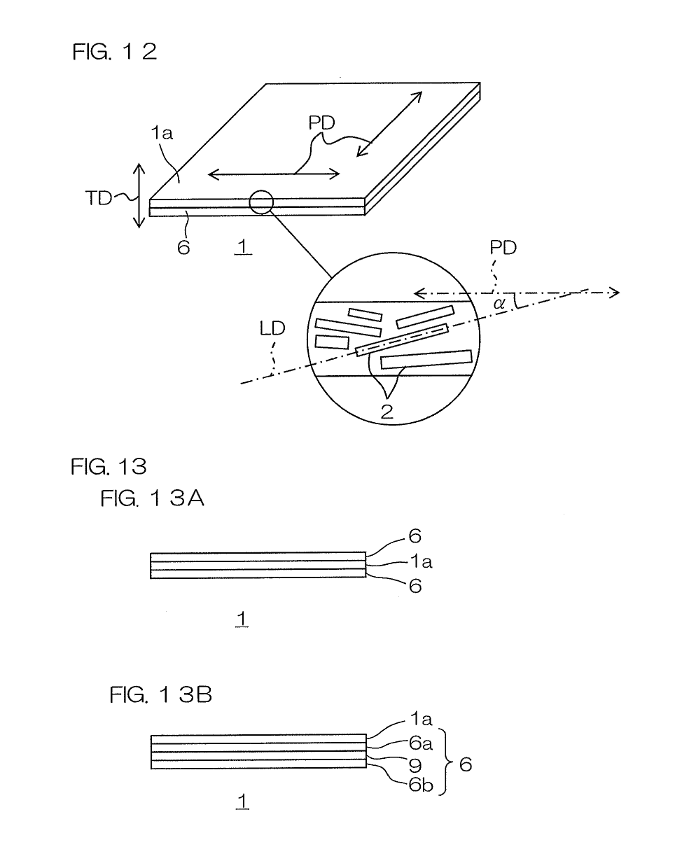

In the above-described embodiment, the pressure-sensitive adhesive layer 6 is laminated on one surface in the thickness direction of the thermally conductive layer 1a. Alternatively, as referred in FIG. 13A, the pressure-sensitive adhesive layers 6 can be also laminated on one surface and the other surface in the thickness direction of the thermally conductive layer 1a.

Also, as referred in FIG. 13B, the pressure-sensitive adhesive layer 6 can also include a substrate film 9, and a first pressure-sensitive adhesive layer 6a and a second pressure-sensitive adhesive layer 6b that are laminated on one surface and the other surface (the both surfaces) in the thickness direction of the substrate film 9. In this way, the strength of the thermally conductive sheet 1 is capable of being improved.

An example of a component of the first pressure-sensitive adhesive layer 6a and the second pressure-sensitive adhesive layer 6b includes the same as that described above in the pressure-sensitive adhesive layer 6. Preferably, an acrylic pressure-sensitive adhesive is contained. The acrylic pressure-sensitive adhesive is preferably prepared from an acrylic polymer obtained by polymerization of a monomer material containing an alkyl(meth)acrylate.

The substrate film 9 is, for example, a sheet in a flat plate shape in which the surface thereof is not subjected to a release treatment.

An example of a material of the substrate film 9 includes the same as that of the release film.

The substrate film 9 has a film thickness of, for example, 10 μm or less, or preferably 1 μm or less, and of, for example, 0.01 μm or more, or preferably 0.1 μm or more.

Each of the first pressure-sensitive adhesive layer 6a and the second pressure-sensitive adhesive layer 6b has a film thickness of, for example, 100 μm or less, or preferably 10 μm or less, and of, for example, 0.01 μm or more, or preferably 0.1 μm or more.

In the case where the first pressure-sensitive adhesive layer 6a and the second pressure-sensitive adhesive layer 6b are laminated on the both surfaces of the substrate film 9, the total of the film thickness is, for example, 0.1 μm or more, or preferably 1 μm or more, and is, for example, 100 μm or less, or preferably 20 μm or less.

Although not shown in FIGS. 1, 3A, and 3B, a release film may be laminated on at least one surface of the topmost surface of the thermally conductive sheet.

As a conventional problem, the thermally conductive sheet may require to have high thermally conductive properties in the direction (the plane direction) perpendicular to the thickness direction depending on its use and purpose. In the case where a mounted substrate on which an electronic component having a different height of unevenness and a shape (for example, an electronic element such as an IC chip, a condenser, a coil, and a resistor) is mounted is covered with the thermally conductive sheet, when the contact area of the thermally conductive sheet, and the electronic component and the substrate is increased, since the thermally conductive sheet is brought into tight contact with the electronic component and the substrate along the upper surface and the side surface of the electronic component and the shape of the surface of the substrate without the occurrence of a crack (cracking) in the surface of the sheet, heat generated from the electronic component and the substrate is capable of being more efficiently dissipated. Accordingly, the thermally conductive sheet is required to have properties (conformability to unevenness) of conforming to the surface or the side surface with unevenness of the mounted substrate (the electronic component and the like). Furthermore, there is a disadvantage that in the mounted substrate having unevenness on the surface thereof, when the thermally conductive sheet is brought into tight contact with the mounted substrate, peeling easily occurs.

As described above, the thermally conductive sheet in the sixth embodiment is capable of solving this problem. That is, the thermally conductive sheet in the sixth embodiment suppresses a crack, has excellent conformability to unevenness with respect to the mounted substrate, and is not easily peeled, while having excellent thermally conductive properties.

### EXAMPLES

The present invention will now be described in more detail by way of Examples, Reference Examples, and Comparative Examples. However, the present invention is not limited to the following Examples, Reference Examples, and Comparative Examples.

Values in Examples shown in the following can be replaced with the values (that is, the upper limit value or the lower limit value) described in the above-described embodiment.

Next, Examples 1 to 65 and Comparative Examples 1 to 10 are described as Examples and Comparative Examples corresponding to the first embodiment.

### Examples 1 and 2

Boron nitride particles and a polymer matrix were blended and stirred in conformity with the mixing formulation in Table 1, so that a mixture of a solid content (a thermally conductive composition) was prepared.

Next, the obtained mixture was fractured for 10 seconds with a pulverizer, so that a fined mixture powder (a thermally conductive composition powder) was obtained.

Next, the obtained mixture powder was set in a vacuum heating and pressing device.

To be specific, first, a release film having the surface subjected to a silicone treatment was disposed on a hot plate of the vacuum heating and pressing device and then, 1 g of the mixture powder was put on the release film. Next, a spacer made of brass and having a thickness of 200 μm was disposed on the release film in a frame shape so as to surround the mixture powder. Next, a release film having the surface subjected to the silicone treatment was disposed on the spacer and the mixture powder. In this way, the mixture powder was sandwiched between two pieces of the release films in the thickness direction to be set in the vacuum heating and pressing device.

Next, hot pressing was performed under a vacuum atmosphere of 10 Pa at 60 MPa at 80° C. for 15 minutes, so that a thermally conductive sheet having a thickness of 200 μm was obtained. (ref: FIG. 2).

Next, an ultraviolet ray was applied to the hot-pressed thermally conductive sheet at a dose of 3,000 mJ/cm².

In this way, a thermally conductive sheet in a B-stage state was obtained. The obtained thermally conductive sheet had rubber elasticity.

Next, the thermally conductive sheet in a B-stage state was put in a drying oven at 150° C. to be heated for 60 minutes, so that the thermally conductive sheet was thermally cured. In this way, a thermally conductive sheet in a C-stage state was obtained.

### Examples 3 to 10, 14 to 21, 24 to 26, 29 to 32, and 37 to 57 and Comparative Examples 1 to 9

A thermally conductive sheet in a B-stage state was obtained in the same manner as that in Examples 1 and 2, except that the mixing amount of the boron nitride particles and the polymer matrix was changed in conformity with the mixing formulation in Tables 1 to 10 and an ultraviolet ray was not applied to the hot-pressed thermally conductive sheet.

Next, the thermally conductive sheet in a B-stage state was put in a drying oven at 150° C. to be heated for 60 minutes, so that the thermally conductive sheet was thermally cured. In this way, a thermally conductive sheet in a C-stage state was obtained.

### Examples 11 to 13, 22, 23, 27, 28, and 33 to 36

A thermally conductive sheet was obtained in the same manner as that in Examples 1 and 2, except that the mixing amount of the boron nitride particles and the polymer matrix was changed in conformity with the mixing formulation in Tables 2, 4, 5, and 6 and an ultraviolet ray was not applied to the hot-pressed thermally conductive sheet. The obtained thermally conductive sheet had rubber elasticity.

Next, the thermally conductive sheet was put in a drying oven at 150° C. to be heated for 60 minutes.

### Examples 58 to 61

Components were mixed and stirred in conformity with the mixing formulation in Table 11 and subsequently, were subjected to vacuum drying, so that a mixture was obtained.

Two pieces of rolls were prepared. A separator having one surface subjected to treatment was set between the rolls. The revolving rate of roll was adjusted to be 1.0 rpm and the mixture obtained in the description above was extended by applying pressure with the two pieces of the rolls, so that a pre-sheet was obtained.

Next, the obtained pre-sheet was hot pressed under a vacuum atmosphere of 10 Pa at 60 MPa at 70° C. for 10 minutes with a heating and pressing device, so that each of the thermally conductive sheets in Examples 58 to 61 was obtained. The obtained thermally conductive sheet was in a B-stage state and had rubber elasticity. The thickness of each of the thermally conductive sheets was as follows: 266 μm in Example 58, 269 μm in Example 59, 273 μm in Example 60, and 309 μm in Example 61.

### Examples 62 and 63

Components were mixed and stirred in conformity with the mixing formulation in Table 11 and subsequently, were subjected to vacuum drying, so that a mixture was obtained.

Next, the obtained mixture was hot pressed under a vacuum atmosphere of 10 Pa at 60 MPa at 70° C. for 15 minutes with a heating and pressing device, so that each of the thermally conductive sheets in Examples 62 and 63 was obtained. The obtained thermally conductive sheet was in a B-stage state and had rubber elasticity. The thickness of each of the thermally conductive sheets was as follows: 289 μm in Example 62 and 355 μm in Example 63.

### Example 64

First, an epoxy resin and a rubber component were blended in conformity with the mixing formulation in Table 12. MEK was added to the obtained mixture and was dissolved with an ultrasonic cleaning device. Next, a curing agent and boron nitride particles were further added thereto in conformity with the mixing formulation in Table 12, so that a mixture (a thermally conductive composition) having a solid content of 70 mass % was obtained.

Next, a release film was disposed on a coating stand and spacers each having a thickness of 800 μm were disposed on both edges of a release film at predetermined intervals to each other and a masking tape was attached onto the upper surfaces of the spacers, so that the spacers and the coating stand were fixed. Next, the MEK was added to the mixture and the viscosity of the mixture was adjusted. The mixture in which the viscosity was adjusted was applied onto the release film with an applicator. After the application, the applied mixture was put in a drying oven and was heated at 70° C. for 10 minutes. Thereafter, the mixture was again put in the drying oven and was heated at 80° C. for 10 minutes, so that a thermally conductive sheet having a thickness of 480 μm was obtained.

Next, the obtained thermally conductive sheet was cut into a piece having a size of 10 cm×10 cm. Spacers each having a thickness of 200 μm were disposed on the release film disposed on an SUS plate at predetermined intervals to each other. The cut thermally conductive sheet was disposed on the release film and next, another release film and another SUS plate were further disposed subsequently on the thermally conductive sheet. In this way, the thermally conductive sheet was sandwiched between one pair of the release films and one pair of the SUS plates.

Thereafter, the thermally conductive sheet was put into a vacuum pressing device set at 80° C. and a vacuum was produced for five minutes to be then pressed at 60 MPa for 10 minutes and thereafter, the resulting thermally conductive sheet was allowed to stand till the temperature was brought into a room temperature.

In this way, a thermally conductive sheet having a thickness of 220 μm was obtained. The obtained thermally conductive sheet was in a B-stage state and had rubber elasticity.

### Example 65

A thermally conductive sheet having a thickness of 210 μm was obtained in the same manner as that in Example 64, except that the mixing amount of the boron nitride particles and the polymer matrix was changed in conformity with the mixing formulation in Table 12. The obtained thermally conductive sheet was in a B-stage state and had rubber elasticity.

### Comparative Example 10

A thermally conductive sheet having a thickness of 230 μm was obtained in the same manner as that in Example 64, except that the mixing amount of the boron nitride particles and the polymer matrix was changed in conformity with the mixing formulation in Table 12.

(Evaluation)

(1) Thermal Conductivity Measurement

The thermal conductivity of each of the fabricated thermally conductive sheets (in the case of the mixture containing an epoxy group (and Example 23), in a B-stage state) (in the case of Examples 11 to 13, 22, 27, 28, and 33 to 36, after heating at 80° C.) was measured.

That is, the thermal conductivity in the thickness direction (TD) and the thermal conductivity in the plane direction (PD) were measured by a pulse heating method using a xenonflash analyzer “LFA-447” (manufactured by Erich NETZSCH GmbH & Co. Holding KG).

A. Thermal Conductivity in Thickness Direction (TC1)

Each of the thermally conductive sheets obtained in Examples and Comparative Examples was cut into a square having a size of 1 cm×1 cm to obtain a cut piece. A carbon spray (an alcohol dispersion solution of carbon) was applied onto the top surface (one surface in the thickness direction) of the cut piece to be dried. The applied portion was defined as a light receiving portion. Then, the carbon spray was applied onto the back surface (the other surface in the thickness direction) of the cut piece and the applied portion was defined as a detecting portion.

Next, an energy ray was applied to the light receiving portion with a xenonflash analyzer to detect the temperature of the detecting portion, so that the heat diffusivity (D1) in the thickness direction was measured. The thermal conductivity (TC1) in the thickness direction of the thermally conductive sheet was obtained from the obtained heat diffusivity (D1) by the following formula.

TC1=D1×ρ×Cp

ρ: density of thermally conductive sheet at 25° C.

Cp: specific heat of thermally conductive sheet (substantially 0.9)

B. Thermal Conductivity in Plane Direction (TC2)

Each of the thermally conductive sheets obtained in Examples and Comparative Examples was cut into a circular shape having a diameter of 2.5 cm. After masking the obtained cut piece, a carbon spray was applied thereto to be dried. The applied portion was defined as a light receiving portion. After masking the back surface of the cut piece in the same manner as that described above, the carbon spray was applied onto the back surface (the other surface in the thickness direction) to be dried. The applied portion was defined as a detecting portion.

Next, an energy ray was applied to the light receiving portion with a xenonflash analyzer to detect the temperature of the detecting portion, so that the heat diffusivity (D2) in the plane direction was measured. The thermal conductivity (TC2) in the plane direction of the thermally conductive sheet was obtained from the obtained heat diffusivity (D2) by the following formula.

TC2=D2×ρ×Cp

ρ: density of thermally conductive sheet at 25° C.

Cp: specific heat of thermally conductive sheet (substantially 0.9)

The results are shown in Tables 1 to 12.

(2) Tensile Test

Each of the fabricated thermally conductive sheets (in the case of the mixture containing an epoxy group (and Example 23), in a B-stage state) (in the case of Examples 11 to 13, 22, 27, 28, and 33 to 36, after heating at 80° C.) was cut into a strip having a size of 1×4 cm and the obtained strip was set in a tensile testing device. Subsequently, a tensile elastic modulus N/mm², the maximum elongation A %, and an elongation C % at the time of fracture at the time of pulling the strip in the longitudinal direction at a rate of 5 mm/min were measured and obtained as measured values.

The results are shown in Tables 1 to 12.

Also, the maximum elongation Z % of the polymer matrix in the thermally conductive sheet in a volume ratio X % of the arbitrary boron nitride particles 2 was easily speculated as an estimate from the following formulas (1) and (2).

Y (%)=M (%)×e^{X×k} (1)

Z (%)=Y (%)+100(%) (2)

k: constant

M: the amount of the maximum elongation (%) in the plane direction of the thermally conductive sheet when the volume ratio of the boron nitride particles in the thermally conductive sheet is 0%

X: the volume ratio (%) of the boron nitride particles in the thermally conductive sheet

Y: the amount of the maximum elongation (%) in the plane direction of the thermally conductive sheet

Z: the maximum elongation (an estimate) (%) in the plane direction of the thermally conductive sheet obtained from the calculation

The constant “k” was obtained as an inclination of a straight line calculated by a least squares method from plotted points obtained by plotting the maximum elongation A (%) in the plane direction of the thermally conductive sheet obtained by the above-described tensile test with respect to the volume ratio X (%) of the boron nitride particles in the thermally conductive sheet.

The results are shown in Tables 8 to 10.

In Examples 42 to 44 and Comparative Example 6, the above-described plotting is performed and the straight line and the inclination thereof calculated by the least squares method from the plotted points are shown in FIG. 6.

Also, an elongation W % at the time of fracture of the polymer matrix in the thermally conductive sheet in a volume ratio X % of the arbitrary boron nitride particles 2 was easily speculated as an estimate from the following formulas (3) and (4).

V (%)=N (%)×e^{X×L} (3)

W (%)=V (%)+100(%) (4)

L: constant

N: the amount of the elongation (%) at the time of fracture in the plane direction of the thermally conductive sheet when the volume ratio of the boron nitride particles in the thermally conductive sheet 1 is 0%

X: the volume ratio (%) of the boron nitride particles in the thermally conductive sheet

V: the amount of the elongation (%) at the time of fracture in the plane direction of the thermally conductive sheet

W: the elongation (an estimate) (%) at the time of fracture in the plane direction of the thermally conductive sheet obtained from the calculation

The constant L was obtained as an inclination of a straight line calculated by a least squares method from plotted points obtained by plotting the elongation C (%) at the time of fracture in the plane direction of the thermally conductive sheet obtained by the above-described tensile test with respect to the volume ratio X (%) of the boron nitride particles in the thermally conductive sheet.

The results are shown in Tables 8 to 10.

(3) Bend Resistance (Flexibility) Test

A bend test in conformity with JIS K 5600-5-1 bend resistance (a cylindrical mandrel method) was performed for each of the fabricated thermally conductive sheets (in the case of the mixture containing an epoxy resin, the thermally conductive sheet in a B-stage state).

To be specific, bend resistance (flexibility) of each of the thermally conductive sheets was evaluated under the following test conditions.

Test Conditions

Test Device: Type I

Mandrel: a diameter of 10 mm or a diameter of 5 mm

The thermally conductive sheet in a B-stage state was bent to a bending angle of above 0 degree and 180 degrees or less and was evaluated as follows based on the diameter of a mandrel of a test device in which fracture (damage) was generated in the thermally conductive sheet.

The results are shown in Tables 1 to 12.

Excellent: fracture was not generated even when the thermally conductive sheet was bent with a mandrel having a diameter of 5 mm.

Good: fracture was not generated when the thermally conductive sheet was bent with a mandrel having a diameter of 10 mm, but fracture was generated when bent with a mandrel having a diameter of 5 mm.

Bad: fracture was generated when the thermally conductive sheet was bent with a mandrel having a diameter of 10 mm.

(4) Conformability to Irregularities (3-Point Bending) Test

The 3-point bending test in conformity with JIS K 7171 (in 2008) was performed for each of the fabricated thermally conductive sheets (in the case of the mixture containing an epoxy resin, the thermally conductive sheet in a B-stage state) under the following test conditions, so that the conformability to irregularities was evaluated according to the following evaluation criteria.

The results are shown in Tables 1 to 12.

Test Conditions

Test piece: a size of 20 mm×15 mm

Distance between supporting points: 5 mm

Test rate: 20 mm/min (pressing rate of indenter)

Bending angle: 120 degrees

(Evaluation Criteria)

Excellent: fracture was not observed.

Bad: fracture was observed.

(5) 90 Degree Peel Adhesive Force Test

1 g of each of the mixture powders in Examples and Comparative Examples was sandwiched between two pieces of release films to be set in a vacuum heating and pressing device. One surface of each of the release films was subjected to a silicone treatment and the mixture powder was sandwiched between the silicone-treated surfaces thereof to be set.

Next, hot pressing was performed under a vacuum atmosphere of 10 Pa at 60 MPa at 80° C. for 10 minutes, so that the mixture powder was extended by applying pressure.

Next, the release films on both surfaces of the thermally conductive sheet were peeled from the surfaces of the thermally conductive sheet. The surface of the thermally conductive sheet was overlapped with a rough surface (in conformity with JIS B0601 (in 1994)) of a copper foil (GTS-MP, manufactured by FURUKAWA ELECTRIC CO., LTD.) having a surface roughness Rz of 12 μm and a thickness of 70 μm so as to be in contact therewith, so that a copper foil laminated sheet sandwiched by the copper foil was fabricated. The fabricated copper foil laminated sheet was set in the vacuum heating and pressing device.

Next, the resulting copper foil laminated sheet was pressed at 30 MPa for 9 minutes, while the temperature was increased to be 150° C., and the thermally conductive sheet was extended by applying pressure and brought into tight contact with the copper foil to be furthermore, retained at 30 MPa for 10 minutes. In this way, the reaction was accelerated, so that the thermally conductive sheet was brought from a B-stage state into a C-stage state (in the case of Examples 11 to 13, 22, 27, 28, and 33 to 36, an epoxy group was not contained and a reaction derived from the epoxy group failed to occur and in the case of Example 23, stayed in a B-stage state). Thereafter, the thermally conductive sheet was taken out from the vacuum heating and pressing device and was put into a drying oven at 150° C. to be allowed to stand still for one hour. In this way, the thermally conductive sheet was bonded to the copper foil.

Next, the obtained thermally conductive sheet was cut into a strip having a size of 1×4 cm and the obtained strip was set in a tensile testing device. Subsequently, the 90 degree peel adhesive force at the time when the strip was peeled at an angle of 90 degrees with respect to the copper foil at a rate of 10 mm/min in the longitudinal direction of the strip was measured.

The results are shown in Tables 1 to 12.

(6) Conformability to Unevenness Test (Mounted Substrate)

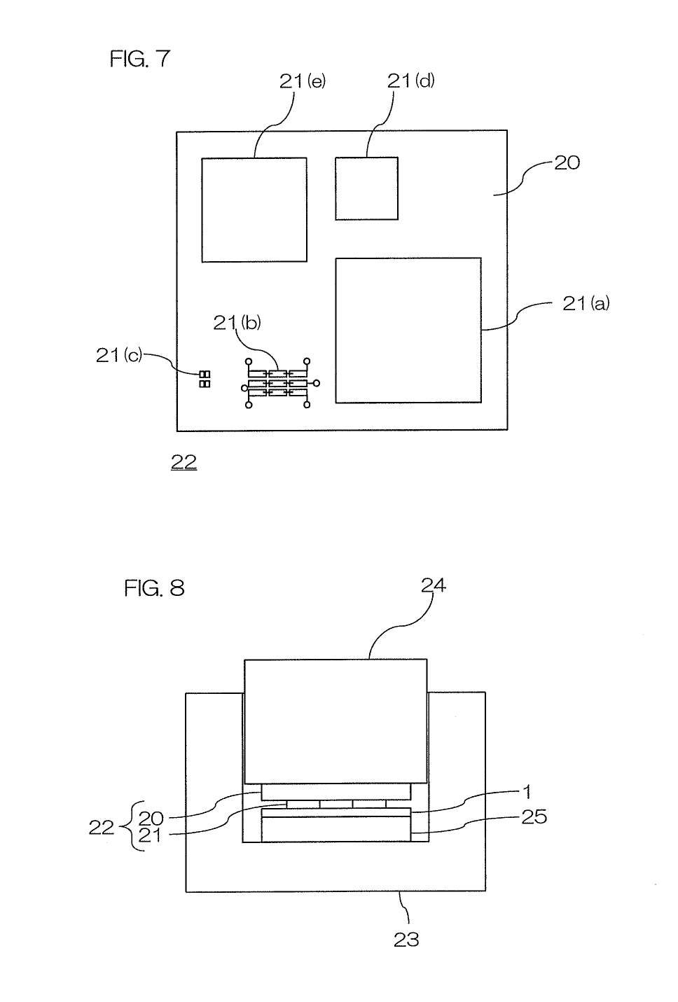

As referred in FIG. 7, a dummy mounted substrate 22 in which the following electronic components 21 (electronic components “a” to “e”) were mounted on a substrate 20 (a glass epoxy substrate, manufactured by TopLine) was prepared.

Electronic component “a”: a length of 7 mm, a width of 7 mm, and a height of 900 μm

Electronic component “b”: a length of 1.8 mm, a width of 3.3 mm, and a height of 300 μm

Electronic component “c”: a length of 0.15 mm, a width of 0.15 mm, and a height of 200 μm

Electronic component “d”: a length of 3 mm, a width of 3 mm, and a height of 700 μm

Electronic component “e”: a length of 5 mm, a width of 5 mm, and a height of 800 μm

The electronic component “b” is a chain circuit (total of nine pieces of resistors, a gap between each resistors of 0.15 mm) in which three rows of series circuits each having three pieces of the resistors (a length of 0.5 mm and a width of 1.0 mm) disposed in series are disposed in parallel. The electronic component “d” is a component in which four pieces of small electronic components are disposed at spaced intervals to each other.

As referred in FIG. 8, a lower metal mold 23 in a bottomed cylindrical shape and an upper metal mold 24 (an area of the bottom surface of 12.56 cm²) in a bottomed cylindrical shape were put into a drying oven in which the temperature of the inside thereof was 70° C. to be allowed to stand for a while. Thereafter, a sponge 25 (a silicone rubber sponge sheet, manufactured by OHYO) having a thickness of 5 mm was set on the inner bottom surface of the lower metal mold 23 to be allowed to stand for a while and then, the lower metal mold 23, the upper metal mold 24, and the sponge 25 were heated at 70° C. Furthermore, a release paper was disposed on the bottom surface of a hot plate or a thermostatic chamber at 70° C. and each of the thermally conductive sheets 1 in Examples and Comparative Examples was disposed thereon to be in contact with each other for 30 seconds, so that the thermally conductive sheet 1 was heated at 70° C. Next, each of the thermally conducive sheets 1 (cut into a size of 2 cm×2 cm) in Examples and Comparative Examples was set on the sponge 25 and the mounted substrate 22 was set on the thermally conductive sheet 1 so that the electronic components 21 served as the lower surface (that is, so that the electronic components 21 were in contact with the thermally conductive sheet 1). Thereafter, the heated upper metal mold 24 and a weight of 2 to 4 kg placed on the upper metal mold 24 were placed still on the mounted substrate 22. After one to five minutes, these were taken out from the drying oven; the weight and the upper metal mold 24 were removed; and the mounted substrate 22 in which the thermally conductive sheet 1 conformed to the unevenness of the electronic components 21 was taken out from the lower metal mold 23.

In the mounted substrate 22, a case where the thermally conductive sheet 1 was in contact with the surface of the substrate between the component “a” and the component “b” (a distance of 1.75 mm) in the mounted substrate 22 and where the occurrence of a crack was not confirmed in the thermally conductive sheet 1 was evaluated as “Good”. A case where the thermally conductive sheet 1 was not in contact with the surface of the substrate between the component “a” and the component “b” in the mounted substrate 22 or where the thermally conductive sheet 1 was in contact with the surface of the substrate between the component “a” and the component “b” in the mounted substrate 22 and the occurrence of a crack was capable of being confirmed in the thermally conductive sheet 1 was evaluated as “Bad”. The number of crack generated in the thermally conductive sheet 1 was measured. The number of crack in the thermally conductive sheet 1 was counted by one line (a crack) and when a vertical line and a lateral line thereof were continuous, each line was independently counted. That is, a crack in an “L” shape was counted as two and a crack in a “U” shape was counted as three.

The results are shown in Table 12.

(7) Elastic Modulus Test

After the components other than the boron nitride particles (that is, the epoxy resin, the rubber component, and the curing agent) were blended in conformity with the mixing formulation in Table 12 to prepare a rubber-containing composition, MEK was further added to the rubber-containing composition and a composition for elastic modulus measurement (a solid content of 30 mass %) in Example 64 was prepared.

A composition for elastic modulus measurement (a solid content of 30 mass %) in Example 65 was prepared in the same manner as that described above.

A composition for elastic modulus measurement (a solid content of 30 mass %) in Comparative Example 10 was prepared in the same manner as that described above (except that the rubber component was not contained).

The composition for elastic modulus measurement (a varnish) was added dropwise onto a release film A to be applied thereto using an applicator. Next, the release film A applied with the composition was put into the inside of the drying oven to be then dried at 80° C. for 10 minutes, so that a sheet in which a dried film having the surface dried was formed was obtained. Furthermore, a release film B was laminated on the dried film to be pressed with a roller, so that the release film B was attached to the dried film. Next, the release film A was peeled from the dried film and again, the dried film was put into the inside of the drying oven to be dried at 80° C. for 10 minutes, so that a dried film sheet was obtained.

The obtained dried film sheet was cut into a plurality of pieces. The dried films of the cut sheets were overlapped with each other to be next, extended by applying pressure with a vacuum pressing device and using a spacer having a thickness of 250 μm, so that a rubber-containing sheet (a sheet for elastic modulus measurement) in which the dried films were laminated and having a thickness of 250 μm was obtained.

Each of the sheets for elastic modulus measurement in Examples and Comparative Examples was set at the inside of a viscosity and elastic modulus measurement device (a rheometer, trade name: HAAKE RheoStress 600, manufactured by EKO Instruments) and measured under the conditions of a measurement range of 20 to 150° C., a temperature rising rate of 2.0° C./min, and a frequency of 1 Hz in conformity with a test method of JIS K 7244 “Plastics-Determination of dynamic mechanical properties”.

The results of the shear storage elastic modulus G′, the shear loss elastic modulus G″, and the complex shear viscosity η* at 80° C. at this time are shown in Table 12.

[Table 1]

TABLE 1

| Examples | | | Ex. 1 | Ex. 2 | Ex. 3 | Ex. 4 | Ex. 5 | Ex. 6 |
|---|---|---|---|---|---|---|---|---|
| Mixing | Boron Nitride Particles (g) (Percentage | PT-110 | 8.94 (69) | 8.94 (69) | 8.94 (69) | 8.94 (69) | 8.94 (69) | 8.94 (69) |
| Formula- | (vol %) to Total Amount of Boron Nitride | | | | | | | |
| tion of | Particles and Polymer Matrix) | | | | | | | |

| | | | | | | | | |
|---|---|---|---|---|---|---|---|---|
| Compo- | Polymer | Content Ratio (vol %) of Polymer Matrix in | 31 | 31 | 31 | 31 | 31 | 31 |
| nents | Matrix | Thermally Conductive Sheet | | | | | | |

| Epoxy | Epoxy | Liquid | EXA-4850-1000 | — | — | — | — | — | 1.01 |
|---|---|---|---|---|---|---|---|---|---|
| Resin | Resin | | EXA-4850-150 | 1.01 | 0.80 | — | — | 0.80 | — |
| Composi- | | Semi-Solid | EG-200 | — | — | — | — | — | — |
| tion | | Solid | YSLV-80XY | — | — | — | — | — | — |
| | | | EPPN | — | — | — | 1.01 | — | — |
| | | | HP-7200 | — | — | 1.01 | — | — | — |
| | | | 1002 | — | — | — | — | — | — |
| | | | 1256 | — | — | — | — | — | — |
| | Volume Blending Ratio of Epoxy | | | 1.00 | 0.67 | 1.00 | 1.00 | 0.67 | 1.00 |
| | Resin to Rubber Component *1 | | | | | | | | |
| | Curing Agent • | | MEHC-7800S | — | — | — | — | — | — |
| | Curing Accelerator | | MEHC-7800SS | — | — | — | — | — | — |
| | | | 2P4MHZ-PW | 0.010 | 0.008 | 0.010 | 0.010 | 0.008 | 0.010 |
| | Percentage (wt %) of Curing Agent • | | | 1.0 | 1.0 | 1.0 | 1.0 | 1.0 | 1.0 |
| | Curing Accelerator to Epoxy Resin | | | | | | | | |
| Rubber | Rubber | Acrylate- | Art-333 | — | 0.54 | 1.34 | 1.34 | 0.54 | — |
| Composi- | Compo- | Modified | MEK 75% | | | | | | |
| tion | nent | Urethane | Solution | | | | | | |
| | | Rubber | Art-5507 | 1.42 | 1.14 | — | — | 1.14 | 1.42 |
| | | | MEK 70.6% | | | | | | |
| | | | Solution | | | | | | |
| | | Carboxy- | XER-32C (NBR) | — | — | — | — | — | — |
| | | Modified | 1072J | — | — | — | — | — | — |
| | | NBR | DN631 | — | — | — | — | — | — |
| | | Styrene- | SIBSTAR | — | — | — | — | — | — |
| | | Isobutylene | | | | | | | |
| | | Rubber | | | | | | | |
| | | Modified | BR1220 | — | — | — | — | — | — |
| | | Poly- | PB3600 | — | — | — | — | — | — |
| | | butadiene | | | | | | | |
| | | Rubber | | | | | | | |
| | | Epoxy- | AT501 | — | — | — | — | — | — |
| | | Modified | | | | | | | |
| | | SBR | | | | | | | |
| | | Acrylic | SG-P3 MEK 15% | — | — | — | — | — | — |
| | | Rubber | Solution | | | | | | |
| | | | SG-280 TEA | — | — | — | — | — | — |
| | | | Toluene/ | | | | | | |
| | | | Ethyl | | | | | | |
| | | | Acetate 15% | | | | | | |
| | | | Solution | | | | | | |
| | | | LA2140e | — | — | — | — | — | — |
| | | | LA2250 | — | — | — | — | — | — |
| | | | AR31 | — | — | — | — | — | — |
| | Polymer- | Photopoly- | IRGACURE 907 | 0.036 | 0.041 | — | — | — | — |
| | ization | merization | DETX-S | 0.018 | 0.021 | — | — | — | — |
| | Initiator | Initiator | | | | | | | |
| | | Thermal | AIBN | — | — | 0.112 | 0.112 | 0.112 | 0.112 |
| | | Polymer- | | | | | | | |
| | | ization | | | | | | | |
| | | Initiator | | | | | | | |

| | | | | | | |
|---|---|---|---|---|---|---|
| Percentage (wt %) of | 5.4 | 5.1 | 11.1 | 11.1 | 9.3 | 11.1 |
| Polymerization Initiator | | | | | | |
| to Rubber Component | | | | | | |

| | | | | | | | |
|---|---|---|---|---|---|---|---|
| Dispersant (wt %) (Percentage to | BYK-2095 | — | — | — | — | — | — |
| Boron Nitride Particles) | | | | | | | |

| | | | | | | | | |
|---|---|---|---|---|---|---|---|---|
| Evalua- | Thermal Conductivity (W/m · K) | Density | 1.83 | 1.81 | 1.83 | 1.74 | 1.74 | 1.77 |
| tion | | Thickness | 2.83 | 1.92 | 1.77 | 1.22 | 1.65 | 1.55 |
| | | Direction (TD) | | | | | | |
| | | Plane | 22.03 | 24.59 | 19.88 | 15.94 | 12.51 | 17.12 |
| | | Direction (PD) | | | | | | |
| | Tensile Test | Tensile Elastic | 426.92 | 625.23 | 422.55 | 123.5 | 179.31 | 152.97 |
| | | Modulus (N/m²) | | | | | | |

| | | | | | | | |
|---|---|---|---|---|---|---|---|
| Maximum | A*2 | 103.38 | 102.28 | 105.33 | 104.69 | 104.34 | 102.47 |
| Elongation | | | | | | | |
| (%) | | | | | | | |
| Elongation | C*3 | 105.10 | 103.90 | 106.54 | 107.04 | 105.74 | 103.82 |
| at Time of | | | | | | | |
| Fracture | | | | | | | |
| (%) | | | | | | | |

| | | | | | | | |
|---|---|---|---|---|---|---|---|
| Flexibility/Bend Test | JIS K5600-5-1 | Good | Good | Excel- | Excel- | Good | Good |
| | | | | lent | lent | | |
| Conformability to Irregularities/ | JIS K7171 | Excel- | Excel- | Excel- | Excel- | Excel- | Excel- |
| 3-Point Bending Test | (in 2008) | lent | lent | lent | lent | lent | lent |

| | | | | | | |
|---|---|---|---|---|---|---|
| 90 Degree Peel Adhesive Force (vs Copper Foil) (N/10 mm) | — | — | — | — | — | — |

*1: Number of parts by volume of epoxy resin/number of parts by volume of rubber component
*2Maximum elongation of thermally conductive sheet (measured value)
*3Elongation at the time of fracture of thermally conductive sheet (measured value)

TABLE 2

| Examples | | | Ex. 7 | Ex. 8 | Ex. 9 | Ex. 10 |
|---|---|---|---|---|---|---|
| Mixing | Boron Nitride Particles (g) (Percentage | PT-110 | 8.94 (69) | 67.08 (69) | 67.08 (69) | 67.08 (69) |
| Formula- | (vol %) to Total Amount of Boron Nitride | | | | | |
| tion of | Particles and Polymer Matrix) | | | | | |

| | | | | | | |
|---|---|---|---|---|---|---|
| Compo- | Polymer | Content Ratio (vol %) of Polymer Matrix in | 31 | 31 | 31 | 31 |
| nents | Matrix | Thermally Conductive Sheet | | | | |

| Epoxy | Epoxy | Liquid | EXA-4850-1000 | 1.01 | — | — | — |
|---|---|---|---|---|---|---|---|
| Resin | Resin | | EXA-4850-150 | — | 7.50 | — | 6.00 |
| Composi- | | Semi-Solid | EG-200 | — | — | 7.50 | — |
| tion | | Solid | YSLV-80XY | — | — | — | — |
| | | | EPPN | — | — | — | — |
| | | | HP-7200 | — | — | — | — |
| | | | 1002 | — | — | — | — |
| | | | 1256 | — | — | — | — |
| | Volume Blending Ratio of Epoxy | | | 1.00 | 1.00 | 1.00 | 0.67 |
| | Resin to Rubber Component *1 | | | | | | |
| | Curing Agent • | | MEHC-7800S | — | — | — | — |
| | Curing Accelerator | | MEHC-7800SS | — | — | — | — |
| | | | 2P4MHZ-PW | 0.010 | 0.075 | 0.075 | 0.060 |
| | Percentage (wt %) of Curing Agent • | | | 1.0 | 1.0 | 1.0 | 1.0 |
| | Curing Accelerator to Epoxy Resin | | | | | | |
| Rubber | Rubber | Acrylate- | Art-333 | 1.34 | — | 10.00 | 4.00 |
| Composi- | Compo- | Modified | MEK 75% | | | | |
| tion | nent | Urethane | Solution | | | | |
| | | Rubber | Art-5507 | — | 10.62 | — | 8.50 |
| | | | MEK 70.6% | | | | |
| | | | Solution | | | | |
| | | Carboxy- | XER-32C (NBR) | — | — | — | — |
| | | Modified | 1072J | — | — | — | — |
| | | NBR | DN631 | — | — | — | — |
| | | Styrene- | SIBSTAR | — | — | — | — |
| | | Isobutylene | | | | | |
| | | Rubber | | | | | |
| | | Modified | BR1220 | — | — | — | — |
| | | Poly- | PB3600 | — | — | — | — |
| | | butadiene | | | | | |
| | | Rubber | | | | | |
| | | Epoxy- | AT501 | — | — | — | — |
| | | Modified | | | | | |
| | | SBR | | | | | |
| | | Acrylic | SG-P3 MEK 15% | — | — | — | — |
| | | Rubber | Solution | | | | |
| | | | SG-280 TEA | — | — | — | — |
| | | | Toluene/ | | | | |
| | | | Ethyl | | | | |
| | | | Acetate 15% | | | | |
| | | | Solution | | | | |
| | | | LA2140e | — | — | — | — |
| | | | LA2250 | — | — | — | — |
| | | | AR31 | — | — | — | — |
| | Polymer- | Photopoly- | IRGACURE 907 | — | — | — | — |
| | ization | merization | DETX-S | — | — | — | — |
| | Initiator | Initiator | | | | | |
| | | Thermal | AIBN | 0.112 | 0.840 | 0.840 | 1.008 |
| | | Polymer- | | | | | |
| | | ization | | | | | |
| | | Initiator | | | | | |

| | | | | |
|---|---|---|---|---|
| Percentage (wt %) of | 11.1 | 11.2 | 11.2 | 11.2 |
| Polymerization Initiator | | | | |
| to Rubber Component | | | | |

| | | | | | |
|---|---|---|---|---|---|
| Dispersant (wt %) (Percentage to | BYK-2095 | — | — | — | — |
| Boron Nitride Particles) | | | | | |

| | | | | | | |
|---|---|---|---|---|---|---|
| Evalua- | Thermal Conductivity (W/m · K) | Density | 1.76 | 1.79 | 1.84 | 1.86 |
| tion | | Thickness | 1.30 | 2.60 | 3.41 | 2.49 |
| | | Direction (TD) | | | | |
| | | Plane | 15.15 | 16.26 | 21.17 | 19.98 |
| | | Direction (PD) | | | | |
| | Tensile Test | Tensile Elastic | 67.21 | 197.12 | 422.0 | 421.97 |
| | | Modulus (N/m²) | | | | |

| | | | | | |
|---|---|---|---|---|---|
| Maximum | A*2 | 104.40 | 102.23 | 102.84 | 102.49 |
| Elongation | | | | | |
| (%) | | | | | |
| Elongation | C*3 | 105.95 | 103.02 | 103.95 | 103.63 |
| at Time of | | | | | |
| Fracture | | | | | |
| (%) | | | | | |

| | | | | | |
|---|---|---|---|---|---|
| Flexibility/Bend Test | JIS K5600-5-1 | Excel- | Good | Excel- | Good |
| | | lent | | lent | |
| Conformability to Irregularities/ | JIS K7171 | Excel- | Excel- | Excel- | Excel- |
| 3-Point Bending Test | (in 2008) | lent | lent | lent | lent |

| | | | | |
|---|---|---|---|---|
| 90 Degree Peel Adhesive Force (vs Copper Foil) (N/10 mm) | — | — | — | — |

| Examples | | | Ex. 11 | Ex. 12 | Ex. 13 |
|---|---|---|---|---|---|
| Mixing | Boron Nitride Particles (g) (Percentage | PT-110 | 8.94 (65) | 8.94 (66) | 8.94 (65) |
| Formula- | (vol %) to Total Amount of Boron Nitride | | | | |
| tion of | Particles and Polymer Matrix) | | | | |

| | | | | | |
|---|---|---|---|---|---|
| Compo- | Polymer | Content Ratio (vol %) of Polymer Matrix in | 35 | 34 | 35 |
| nents | Matrix | Thermally Conductive Sheet | | | |

| Epoxy | Epoxy | Liquid | EXA-4850-1000 | — | — | — |
|---|---|---|---|---|---|---|
| Resin | Resin | | EXA-4850-150 | — | — | — |
| Composi- | | Semi-Solid | EG-200 | — | — | — |
| tion | | Solid | YSLV-80XY | — | — | — |
| | | | EPPN | — | — | — |
| | | | HP-7200 | — | — | — |
| | | | 1002 | — | — | — |
| | | | 1256 | — | — | — |
| | Volume Blending Ratio of Epoxy | | | — | — | — |
| | Resin to Rubber Component *1 | | | | | |
| | Curing Agent • | | MEHC-7800S | — | — | — |
| | Curing Accelerator | | MEHC-7800SS | — | — | — |
| | | | 2P4MHZ-PW | — | — | — |
| | Percentage (wt %) of Curing Agent • | | | — | — | — |
| | Curing Accelerator to Epoxy Resin | | | | | |
| Rubber | Rubber | Acrylate- | Art-333 | — | — | — |
| Composi- | Compo- | Modified | MEK 75% | | | |
| tion | nent | Urethane | Solution | | | |
| | | Rubber | Art-5507 | — | — | — |
| | | | MEK 70.6% | | | |
| | | | Solution | | | |
| | | Carboxy- | XER-32C (NBR) | — | 2.00 | 1.00 |
| | | Modified | 1072J | — | — | — |
| | | NBR | DN631 | — | — | — |
| | | Styrene- | SIBSTAR | 2.00 | — | 1.00 |
| | | Isobutylene | | | | |
| | | Rubber | | | | |
| | | Modified | BR1220 | — | — | — |
| | | Poly- | PB3600 | — | — | — |
| | | butadiene | | | | |
| | | Rubber | | | | |
| | | Epoxy- | AT501 | — | — | — |
| | | Modified | | | | |
| | | SBR | | | | |
| | | Acrylic | SG-P3 MEK 15% | — | — | — |
| | | Rubber | Solution | | | |
| | | | SG-280 TEA | — | — | — |
| | | | Toluene/ | | | |
| | | | Ethyl | | | |
| | | | Acetate 15% | | | |
| | | | Solution | | | |
| | | | LA2140e | — | — | — |
| | | | LA2250 | — | — | — |
| | | | AR31 | — | — | — |
| | Polymer- | Photopoly- | IRGACURE 907 | — | — | — |
| | ization | merization | DETX-S | — | — | — |
| | Initiator | Initiator | | | | |
| | | Thermal | AIBN | — | — | — |
| | | Polymer- | | | | |
| | | ization | | | | |
| | | Initiator | | | | |

| | | | |
|---|---|---|---|
| Percentage (wt %) of | — | — | — |
| Polymerization Initiator | | | |
| to Rubber Component | | | |

| | | | | |
|---|---|---|---|---|
| Dispersant (wt %) (Percentage to | BYK-2095 | — | — | — |
| Boron Nitride Particles) | | | | |

| | | | | | |
|---|---|---|---|---|---|
| Evalua- | Thermal Conductivity (W/m · K) | Density | 1.75 | 1.83 | 1.78 |
| tion | | Thickness | 1.50 | 2.08 | 2.10 |
| | | Direction (TD) | | | |
| | | Plane | 17.69 | 20.22 | 20.25 |
| | | Direction (PD) | | | |
| | Tensile Test | Tensile Elastic | 53.23 | 49.54 | 43.96 |
| | | Modulus (N/m²) | | | |

| | | | | |
|---|---|---|---|---|
| Maximum | A*2 | 105.31 | 107.56 | 108.75 |
| Elongation | | | | |
| (%) | | | | |
| Elongation | C*3 | 115.92 | 132.23 | 122.05 |
| at Time of | | | | |
| Fracture | | | | |
| (%) | | | | |

| | | | | |
|---|---|---|---|---|
| Flexibility/Bend Test | JIS K5600-5-1 | Excel- | Excel- | Excel- |
| | | lent | lent | lent |
| Conformability to Irregularities/ | JIS K7171 | Excel- | Excel- | Excel- |
| 3-Point Bending Test | (in 2008) | lent | lent | lent |

| | | | |
|---|---|---|---|
| 90 Degree Peel Adhesive Force (vs Copper Foil) (N/10 mm) | 1.98 | 4.73 | 4.25 |

*1: Number of parts by volume of epoxy resin/number of parts by volume of rubber component
*2Maximum elongation of thermally conductive sheet (measured value)
*3Elongation at the time of fracture of thermally conductive sheet (measured value)

TABLE 3

| Examples | | | Ex. 14 | Ex. 15 | Ex. 16 | Ex. 17 |
|---|---|---|---|---|---|---|
| Mixing | Boron Nitride Particles (g) (Percentage | PT-110 | 8.94 (67) | 8.94 (68) | 8.94 (68) | 8.94 (70) |
| Formula- | (vol %) to Total Amount of Boron Nitride | | | | | |
| tion of | Particles and Polymer Matrix) | | | | | |

| | | | | | | |
|---|---|---|---|---|---|---|
| Compo- | Polymer | Content Ratio (vol %) of Polymer Matrix in | 33 | 32 | 32 | 30 |
| nents | Matrix | Thermally Conductive Sheet | | | | |

| Epoxy | Epoxy | Liquid | EXA-4850-1000 | — | 1.00 | — | — |
|---|---|---|---|---|---|---|---|
| Resin | Resin | | EXA-4850-150 | — | — | — | — |
| Composi- | | Semi-Solid | EG-200 | — | — | 1.00 | — |
| tion | | Solid | YSLV-80XY | — | — | — | — |
| | | | EPPN | — | — | — | — |
| | | | HP-7200 | 1.00 | — | — | 1.00 |
| | | | 1002 | — | — | — | — |
| | | | 1256 | — | — | — | — |
| | Volume Blending Ratio of Epoxy | | | 0.79 | 0.83 | 0.83 | 1.00 |
| | Resin to Rubber Component *1 | | | | | | |
| | Curing Agent • | | MEHC-7800S | — | — | — | — |
| | Curing Accelerator | | MEHC-7800SS | — | — | — | — |
| | | | 2P4MHZ-PW | 0.010 | 0.010 | 0.010 | 0.010 |
| | Percentage (wt %) of Curing Agent • | | | 1.0 | 1.0 | 1.0 | 1.0 |
| | Curing Accelerator to Epoxy Resin | | | | | | |
| Rubber | Rubber | Acrylate- | Art-333 | — | — | — | — |
| Composi- | Compo- | Modified | MEK 75% | | | | |
| tion | nent | Urethane | Solution | | | | |
| | | Rubber | Art-5507 | — | — | — | — |
| | | | MEK 70.6% | | | | |
| | | | Solution | | | | |
| | | Carboxy- | XER-32C (NBR) | — | 1.00 | 1.00 | — |
| | | Modified | 1072J | — | — | — | — |
| | | NBR | DN631 | — | — | — | — |
| | | Styrene- | SIBSTAR | 1.00 | — | — | — |
| | | Isobutylene | | | | | |
| | | Rubber | | | | | |
| | | Modified | BR1220 | — | — | — | — |
| | | Poly- | PB3600 | — | — | — | — |
| | | butadiene | | | | | |
| | | Rubber | | | | | |
| | | Epoxy- | AT501 | — | — | — | 0.82 |
| | | Modified | | | | | |
| | | SBR | | | | | |
| | | Acrylic | SG-P3 MEK 15% | — | — | — | — |
| | | Rubber | Solution | | | | |
| | | | SG-280 TEA | — | — | — | — |
| | | | Toluene/ | | | | |
| | | | Ethyl | | | | |
| | | | Acetate 15% | | | | |
| | | | Solution | | | | |
| | | | LA2140e | — | — | — | — |
| | | | LA2250 | — | — | — | — |
| | | | AR31 | — | — | — | — |
| | Polymer- | Photopoly- | IRGACURE 907 | — | — | — | — |
| | ization | merization | DETX-S | — | — | — | — |
| | Initiator | Initiator | | | | | |
| | | Thermal | AIBN | — | — | — | — |
| | | Polymer- | | | | | |
| | | ization | | | | | |
| | | Initiator | | | | | |

| | | | | |
|---|---|---|---|---|
| Percentage (wt %) of | — | — | — | — |
| Polymerization Initiator | | | | |
| to Rubber Component | | | | |

| | | | | | |
|---|---|---|---|---|---|
| Dispersant (wt %) (Percentage to | BYK-2095 | — | — | — | — |
| Boron Nitride Particles) | | | | | |

| | | | | | | |
|---|---|---|---|---|---|---|
| Evalua- | Thermal Conductivity (W/m · K) | Density | 1.83 | 1.83 | 1.84 | 1.83 |
| tion | | Thickness | 1.71 | 1.49 | 1.84 | 2.06 |
| | | Direction (TD) | | | | |
| | | Plane | 22.72 | 21.64 | 20.79 | 22.40 |
| | | Direction (PD) | | | | |
| | Tensile Test | Tensile Elastic | 1064.6 | 16.46 | 35.07 | 1017.87 |
| | | Modulus (N/m²) | | | | |

| | | | | | |
|---|---|---|---|---|---|
| Maximum | A*2 | 102.07 | 108.02 | 108.61 | 102.90 |
| Elongation | | | | | |
| (%) | | | | | |
| Elongation | C*3 | 103.23 | 123.00 | 158.52 | 106.81 |
| at Time of | | | | | |
| Fracture | | | | | |
| (%) | | | | | |

| | | | | | |
|---|---|---|---|---|---|
| Flexibility/Bend Test | JIS K5600-5-1 | Excel- | Excel- | Excel- | Excel- |
| | | lent | lent | lent | lent |
| Conformability to Irregularities/ | JIS K7171 | Excel- | Excel- | Excel- | Excel- |
| 3-Point Bending Test | (in 2008) | lent | lent | lent | lent |

| | | | | |
|---|---|---|---|---|
| 90 Degree Peel Adhesive Force (vs Copper Foil) (N/10 mm) | 3.02 | 2.49 | 4.23 | 4.07 |

| Examples | | | Ex. 18 | Ex. 19 | Ex. 20 |
|---|---|---|---|---|---|
| Mixing | Boron Nitride Particles (g) (Percentage | PT-110 | 8.94 (70) | 8.94 (70) | 8.94 (70) |
| Formula- | (vol %) to Total Amount of Boron Nitride | | | | |
| tion of | Particles and Polymer Matrix) | | | | |

| | | | | | |
|---|---|---|---|---|---|
| Compo- | Polymer | Content Ratio (vol %) of Polymer Matrix in | 30 | 30 | 30 |
| nents | Matrix | Thermally Conductive Sheet | | | |

| Epoxy | Epoxy | Liquid | EXA-4850-1000 | — | — | — |
|---|---|---|---|---|---|---|
| Resin | Resin | | EXA-4850-150 | — | — | — |
| Composi- | | Semi-Solid | EG-200 | 1.00 | — | — |
| tion | | Solid | YSLV-80XY | — | — | — |
| | | | EPPN | — | — | — |
| | | | HP-7200 | — | — | — |
| | | | 1002 | — | — | 1.00 |
| | | | 1256 | — | — | — |
| | Volume Blending Ratio of Epoxy | | | 1.00 | — | 1.00 |
| | Resin to Rubber Component *1 | | | | | |
| | Curing Agent • | | MEHC-7800S | — | — | — |
| | Curing Accelerator | | MEHC-7800SS | — | — | — |
| | | | 2P4MHZ-PW | 0.010 | — | 0.010 |
| | Percentage (wt %) of Curing Agent • | | | 1.0 | — | 1.0 |
| | Curing Accelerator to Epoxy Resin | | | | | |
| Rubber | Rubber | Acrylate- | Art-333 | — | — | — |
| Composi- | Compo- | Modified | MEK 75% | | | |
| tion | nent | Urethane | Solution | | | |
| | | Rubber | Art-5507 | — | — | — |
| | | | MEK 70.6% | | | |
| | | | Solution | | | |
| | | Carboxy- | XER-32C (NBR) | — | — | — |
| | | Modified | 1072J | — | — | — |
| | | NBR | DN631 | — | — | — |
| | | Styrene- | SIBSTAR | — | — | — |
| | | Isobutylene | | | | |
| | | Rubber | | | | |
| | | Modified | BR1220 | — | — | — |
| | | Poly- | PB3600 | — | — | 0.83 |
| | | butadiene | | | | |
| | | Rubber | | | | |
| | | Epoxy- | AT501 | 0.82 | 1.63 | — |
| | | Modified | | | | |
| | | SBR | | | | |
| | | Acrylic | SG-P3 MEK 15% | — | — | — |
| | | Rubber | Solution | | | |
| | | | SG-280 TEA | — | — | — |
| | | | Toluene/ | | | |
| | | | Ethyl | | | |
| | | | Acetate 15% | | | |
| | | | Solution | | | |
| | | | LA2140e | — | — | — |
| | | | LA2250 | — | — | — |
| | | | AR31 | — | — | — |
| | Polymer- | Photopoly- | IRGACURE 907 | — | — | — |
| | ization | merization | DETX-S | — | — | — |
| | Initiator | Initiator | | | | |
| | | Thermal | AIBN | — | — | — |
| | | Polymer- | | | | |
| | | ization | | | | |
| | | Initiator | | | | |

| | | | |
|---|---|---|---|
| Percentage (wt %) of | — | — | — |
| Polymerization Initiator | | | |
| to Rubber Component | | | |

| | | | | |
|---|---|---|---|---|
| Dispersant (wt %) (Percentage to | BYK-2095 | — | — | — |
| Boron Nitride Particles) | | | | |

| | | | | | |
|---|---|---|---|---|---|
| Evalua- | Thermal Conductivity (W/m · K) | Density | 1.84 | 1.82 | 1.78 |
| tion | | Thickness | 2.07 | 3.30 | 1.80 |
| | | Direction (TD) | | | |
| | | Plane | 22.19 | 22.89 | 18.03 |
| | | Direction (PD) | | | |
| | Tensile Test | Tensile Elastic | 160.11 | 300.64 | 11.66 |
| | | Modulus (N/m²) | | | |

| | | | | |
|---|---|---|---|---|
| Maximum | A*2 | 105.45 | 101.95 | 103.51 |
| Elongation | | | | |
| (%) | | | | |
| Elongation | C*3 | 113.14 | 103.94 | 108.05 |
| at Time of | | | | |
| Fracture | | | | |
| (%) | | | | |

| | | | | |
|---|---|---|---|---|
| Flexibility/Bend Test | JIS K5600-5-1 | Excel- | Excel- | Excel- |
| | | lent | lent | lent |
| Conformability to Irregularities/ | JIS K7171 | Excel- | Excel- | Excel- |
| 3-Point Bending Test | (in 2008) | lent | lent | lent |

| | | | |
|---|---|---|---|
| 90 Degree Peel Adhesive Force (vs Copper Foil) (N/10 mm) | 2.37 | 2.31 | 0.95 |

*1: Number of parts by volume of epoxy resin/number of parts by volume of rubber component
*2Maximum elongation of thermally conductive sheet (measured value)
*3Elongation at the time of fracture of thermally conductive sheet (measured value)

TABLE 4

| Examples | | | Ex. 21 | Ex. 22 | Ex. 23 | Ex. 24 |
|---|---|---|---|---|---|---|
| Mixing | Boron Nitride Particles (g) (Percentage | PT-110 | 8.94 (70) | 8.94 (70) | 8.94 (70) | 8.94 (70) |
| Formula- | (vol %) to Total Amount of Boron Nitride | | | | | |
| tion of | Particles and Polymer Matrix) | | | | | |

| | | | | | | |
|---|---|---|---|---|---|---|
| Compo- | Polymer | Content Ratio (vol %) of Polymer Matrix in | 30 | 30 | 30 | 30 |
| nents | Matrix | Thermally Conductive Sheet | | | | |

| Epoxy | Epoxy | Liquid | EXA-4850-1000 | — | — | — | — |
|---|---|---|---|---|---|---|---|
| Resin | Resin | | EXA-4850-150 | — | — | — | — |
| Composi- | | Semi-Solid | EG-200 | — | — | — | — |
| tion | | Solid | YSLV-80XY | — | — | — | — |
| | | | EPPN | — | — | — | — |
| | | | HP-7200 | — | — | — | — |
| | | | 1002 | 0.80 | — | — | 1.00 |
| | | | 1256 | — | — | — | — |
| | Volume Blending Ratio of Epoxy | | | 1.00 | — | — | 1.00 |
| | Resin to Rubber Component *1 | | | | | | |
| | Curing Agent • | | MEHC-7800S | 0.22 | — | — | — |
| | Curing Accelerator | | MEHC-7800SS | 0.18 | — | — | — |
| | | | 2P4MHZ-PW | 0.008 | — | — | 0.010 |
| | Percentage (wt %) of Curing Agent • | | | 51.0 | — | — | 1.0 |
| | Curing Accelerator to Epoxy Resin | | | | | | |
| Rubber | Rubber | Acrylate- | Art-333 | — | — | — | — |
| Composi- | Compo- | Modified | MEK 75% | | | | |
| tion | nent | Urethane | Solution | | | | |
| | | Rubber | Art-5507 | — | — | — | — |
| | | | MEK 70.6% | | | | |
| | | | Solution | | | | |
| | | Carboxy- | XER-32C (NBR) | 0.67 | — | — | — |
| | | Modified | 1072J | — | — | — | — |
| | | NBR | DN631 | — | — | — | — |
| | | Styrene- | SIBSTAR | — | — | — | — |
| | | Isobutylene | | | | | |
| | | Rubber | | | | | |
| | | Modified | BR1220 | — | — | — | — |
| | | Poly- | PB3600 | — | — | — | — |
| | | butadiene | | | | | |
| | | Rubber | | | | | |
| | | Epoxy- | AT501 | — | — | — | — |
| | | Modified | | | | | |
| | | SBR | | | | | |
| | | Acrylic | SG-P3 MEK 15% | — | — | 11.11 | — |
| | | Rubber | Solution | | | | |
| | | | SG-280 TEA | — | 11.11 | — | 5.56 |
| | | | Toluene/ | | | | |
| | | | Ethyl | | | | |
| | | | Acetate 15% | | | | |
| | | | Solution | | | | |
| | | | LA2140e | — | — | — | — |
| | | | LA2250 | — | — | — | — |
| | | | AR31 | — | — | — | — |
| | Polymer- | Photopoly- | IRGACURE 907 | — | — | — | — |
| | ization | merization | DETX-S | — | — | — | — |
| | Initiator | Initiator | | | | | |
| | | Thermal | AIBN | — | — | — | — |
| | | Polymer- | | | | | |
| | | ization | | | | | |
| | | Initiator | | | | | |

| | | | | |
|---|---|---|---|---|
| Percentage (wt %) of | — | — | — | — |
| Polymerization Initiator | | | | |
| to Rubber Component | | | | |

| | | | | | |
|---|---|---|---|---|---|
| Dispersant (wt %) (Percentage to | BYK-2095 | — | — | — | — |
| Boron Nitride Particles) | | | | | |

| | | | | | | |
|---|---|---|---|---|---|---|
| Evalua- | Thermal Conductivity (W/m · K) | Density | 1.86 | 1.87 | 1.88 | 1.85 |
| tion | | Thickness | 2.85 | 1.93 | 2.75 | 2.97 |
| | | Direction (TD) | | | | |
| | | Plane | 25.11 | 21.1 | 24.7 | 23.1 |
| | | Direction (PD) | | | | |
| | Tensile Test | Tensile Elastic | 719.76 | 22.70 | 674.0 | 360.0 |
| | | Modulus (N/m²) | | | | |

| | | | | | |
|---|---|---|---|---|---|
| Maximum | A*2 | 103.97 | 109.63 | 103.82 | 102.52 |
| Elongation | | | | | |
| (%) | | | | | |
| Elongation | C*3 | 107.63 | 116.23 | 105.61 | 105.25 |
| at Time of | | | | | |
| Fracture | | | | | |
| (%) | | | | | |

| | | | | | |
|---|---|---|---|---|---|
| Flexibility/Bend Test | JIS K5600-5-1 | Excel- | Excel- | Excel- | Good |
| | | lent | lent | lent | |
| Conformability to Irregularities/ | JIS K7171 | Excel- | Excel- | Excel- | Excel- |
| 3-Point Bending Test | (in 2008) | lent | lent | lent | lent |

| | | | | |
|---|---|---|---|---|
| 90 Degree Peel Adhesive Force (vs Copper Foil) (N/10 mm) | 3.81 | 1.36 | 4.82 | 3.00 |

| Examples | | | Ex. 25 | Ex. 26 | Ex. 27 |
|---|---|---|---|---|---|
| Mixing | Boron Nitride Particles (g) (Percentage | PT-110 | 8.94 (70) | 8.94 (70) | 8.94 (70) |
| Formula- | (vol %) to Total Amount of Boron Nitride | | | | |
| tion of | Particles and Polymer Matrix) | | | | |

| | | | | | |
|---|---|---|---|---|---|
| Compo- | Polymer | Content Ratio (vol %) of Polymer Matrix in | 30 | 30 | 30 |
| nents | Matrix | Thermally Conductive Sheet | | | |

| Epoxy | Epoxy | Liquid | EXA-4850-1000 | — | — | — |
|---|---|---|---|---|---|---|
| Resin | Resin | | EXA-4850-150 | — | — | — |
| Composi- | | Semi-Solid | EG-200 | — | 1.00 | — |
| tion | | Solid | YSLV-80XY | — | — | — |
| | | | EPPN | — | — | — |
| | | | HP-7200 | 1.00 | — | — |
| | | | 1002 | — | — | — |
| | | | 1256 | — | — | — |
| | Volume Blending Ratio of Epoxy | | | 1.00 | 1.00 | — |
| | Resin to Rubber Component *1 | | | | | |
| | Curing Agent • | | MEHC-7800S | — | — | — |
| | Curing Accelerator | | MEHC-7800SS | — | — | — |
| | | | 2P4MHZ-PW | 0.010 | 0.010 | — |
| | Percentage (wt %) of Curing Agent • | | | 1.0 | 1.0 | — |
| | Curing Accelerator to Epoxy Resin | | | | | |
| Rubber | Rubber | Acrylate- | Art-333 | — | — | — |
| Composi- | Compo- | Modified | MEK 75% | | | |
| tion | nent | Urethane | Solution | | | |
| | | Rubber | Art-5507 | — | — | — |
| | | | MEK 70.6% | | | |
| | | | Solution | | | |
| | | Carboxy- | XER-32C (NBR) | — | — | — |
| | | Modified | 1072J | — | — | — |
| | | NBR | DN631 | — | — | — |
| | | Styrene- | SIBSTAR | — | — | — |
| | | Isobutylene | | | | |
| | | Rubber | | | | |
| | | Modified | BR1220 | — | — | — |
| | | Poly- | PB3600 | — | — | — |
| | | butadiene | | | | |
| | | Rubber | | | | |
| | | Epoxy- | AT501 | — | — | — |
| | | Modified | | | | |
| | | SBR | | | | |
| | | Acrylic | SG-P3 MEK 15% | — | — | — |
| | | Rubber | Solution | | | |
| | | | SG-280 TEA | 5.56 | 5.56 | — |
| | | | Toluene/ | | | |
| | | | Ethyl | | | |
| | | | Acetate 15% | | | |
| | | | Solution | | | |
| | | | LA2140e | — | — | — |
| | | | LA2250 | — | — | 1.83 |
| | | | AR31 | — | — | — |
| | Polymer- | Photopoly- | IRGACURE 907 | — | — | — |
| | ization | merization | DETX-S | — | — | — |
| | Initiator | Initiator | | | | |
| | | Thermal | AIBN | — | — | — |
| | | Polymer- | | | | |
| | | ization | | | | |
| | | Initiator | | | | |

| | | | |
|---|---|---|---|
| Percentage (wt %) of | — | — | — |
| Polymerization Initiator | | | |
| to Rubber Component | | | |

| | | | | |
|---|---|---|---|---|
| Dispersant (wt %) (Percentage to | BYK-2095 | — | — | — |
| Boron Nitride Particles) | | | | |

| | | | | | |
|---|---|---|---|---|---|
| Evalua- | Thermal Conductivity (W/m · K) | Density | 1.83 | 1.84 | 1.83 |
| tion | | Thickness | 1.88 | 1.89 | 2.55 |
| | | Direction (TD) | | | |
| | | Plane | 21.5 | 19.2 | 21.7 |
| | | Direction (PD) | | | |
| | Tensile Test | Tensile Elastic | 33.9 | 28.1 | 182.0 |
| | | Modulus (N/m²) | | | |

| | | | | |
|---|---|---|---|---|
| Maximum | A*2 | 118.02 | 108.92 | 103.88 |
| Elongation | | | | |
| (%) | | | | |
| Elongation | C*3 | 210.50 | 146.71 | 106.32 |
| at Time of | | | | |
| Fracture | | | | |
| (%) | | | | |

| | | | | |
|---|---|---|---|---|
| Flexibility/Bend Test | JIS K5600-5-1 | Excel- | Excel- | Excel- |
| | | lent | lent | lent |
| Conformability to Irregularities/ | JIS K7171 | Excel- | Excel- | Excel- |
| 3-Point Bending Test | (in 2008) | lent | lent | lent |

| | | | |
|---|---|---|---|
| 90 Degree Peel Adhesive Force (vs Copper Foil) (N/10 mm) | 1.99 | 1.91 | 1.91 |

*1: Number of parts by volume of epoxy resin/number of parts by volume of rubber component
*2Maximum elongation of thermally conductive sheet (measured value)
*3Elongation at the time of fracture of thermally conductive sheet (measured value)

TABLE 5

| Examples | | | Ex. 28 | Ex. 29 | Ex. 30 | Ex. 31 |
|---|---|---|---|---|---|---|
| Mixing | Boron Nitride Particles (g) (Percentage | PT-110 | 8.94 (70) | 8.94 (70) | 8.94 (70) | 8.94 (70) |
| Formula- | (vol %) to Total Amount of Boron Nitride | | | | | |
| tion of | Particles and Polymer Matrix) | | | | | |

| | | | | | | |
|---|---|---|---|---|---|---|
| Compo- | Polymer | Content Ratio (vol %) of Polymer Matrix in | 30 | 30 | 30 | 30 |
| nents | Matrix | Thermally Conductive Sheet | | | | |

| Epoxy | Epoxy | Liquid | EXA-4850-1000 | — | — | — | — |
|---|---|---|---|---|---|---|---|
| Resin | Resin | | EXA-4850-150 | — | — | — | — |
| Composi- | | Semi-Solid | EG-200 | — | — | 1.00 | — |
| tion | | Solid | YSLV-80XY | — | — | — | — |
| | | | EPPN | — | — | — | — |
| | | | HP-7200 | — | 1.00 | — | 1.00 |
| | | | 1002 | — | — | — | — |
| | | | 1256 | — | — | — | — |
| | Volume Blending Ratio of Epoxy | | | — | 1.00 | 1.00 | 1.00 |
| | Resin to Rubber Component *1 | | | | | | |
| | Curing Agent • | | MEHC-7800S | — | — | — | — |
| | Curing Accelerator | | MEHC-7800SS | — | — | — | — |
| | | | 2P4MHZ-PW | — | 0.010 | 0.010 | 0.010 |
| | Percentage (wt %) of Curing Agent • | | | — | 1.0 | 1.0 | 1.0 |
| | Curing Accelerator to Epoxy Resin | | | | | | |
| Rubber | Rubber | Acrylate- | Art-333 | — | — | — | — |
| Composi- | Compo- | Modified | MEK 75% | | | | |
| tion | nent | Urethane | Solution | | | | |
| | | Rubber | Art-5507 | — | — | — | — |
| | | | MEK 70.6% | | | | |
| | | | Solution | | | | |
| | | Carboxy- | XER-32C (NBR) | — | — | — | — |
| | | Modified | 1072J | — | — | — | — |
| | | NBR | DN631 | — | — | — | — |
| | | Styrene- | SIBSTAR | — | — | — | — |
| | | Isobutylene | | | | | |
| | | Rubber | | | | | |
| | | Modified | BR1220 | — | — | — | — |
| | | Poly- | PB3600 | — | — | — | — |
| | | butadiene | | | | | |
| | | Rubber | | | | | |
| | | Epoxy- | AT501 | — | — | — | — |
| | | Modified | | | | | |
| | | SBR | | | | | |
| | | Acrylic | SG-P3 MEK 15% | — | — | — | — |
| | | Rubber | Solution | | | | |
| | | | SG-280 TEA | — | — | — | — |
| | | | Toluene/ | | | | |
| | | | Ethyl | | | | |
| | | | Acetate 15% | | | | |
| | | | Solution | | | | |
| | | | LA2140e | 1.83 | — | — | 0.92 |
| | | | LA2250 | — | 0.92 | 0.92 | — |
| | | | AR31 | — | — | — | — |
| | Polymer- | Photopoly- | IRGACURE 907 | — | — | — | — |
| | ization | merization | DETX-S | — | — | — | — |
| | Initiator | Initiator | | | | | |
| | | Thermal | AIBN | — | — | — | — |
| | | Polymer- | | | | | |
| | | ization | | | | | |
| | | Initiator | | | | | |

| | | | | |
|---|---|---|---|---|
| Percentage (wt %) of | — | — | — | — |
| Polymerization Initiator | | | | |
| to Rubber Component | | | | |

| | | | | | |
|---|---|---|---|---|---|
| Dispersant (wt %) (Percentage to | BYK-2095 | — | — | — | — |
| Boron Nitride Particles) | | | | | |

| | | | | | | |
|---|---|---|---|---|---|---|
| Evalua- | Thermal Conductivity (W/m · K) | Density | 1.83 | 1.8 | 1.8 | 1.77 |
| tion | | Thickness | 2.04 | 1.77 | 1.64 | 1.87 |
| | | Direction (TD) | | | | |
| | | Plane | 21.6 | 19.8 | 20.0 | 20.0 |
| | | Direction (PD) | | | | |
| | Tensile Test | Tensile Elastic | 48.6 | 140.0 | 279.0 | 77.0 |
| | | Modulus (N/m²) | | | | |

| | | | | | |
|---|---|---|---|---|---|
| Maximum | A*2 | 106.63 | 113.70 | 104.49 | 114.10 |
| Elongation | | | | | |
| (%) | | | | | |
| Elongation | C*3 | 109.66 | 116.41 | 117.93 | 128.73 |
| at Time of | | | | | |
| Fracture | | | | | |
| (%) | | | | | |

| | | | | | |
|---|---|---|---|---|---|
| Flexibility/Bend Test | JIS K5600-5-1 | Excel- | Excel- | Excel- | Excel- |
| | | lent | lent | lent | lent |
| Conformability to Irregularities/ | JIS K7171 | Excel- | Excel- | Excel- | Excel- |
| 3-Point Bending Test | (in 2008) | lent | lent | lent | lent |

| | | | | |
|---|---|---|---|---|
| 90 Degree Peel Adhesive Force (vs Copper Foil) (N/10 mm) | 1.51 | 2.05 | — | 1.68 |

| Examples | | | Ex. 32 | Ex. 33 | Ex. 34 |
|---|---|---|---|---|---|
| Mixing | Boron Nitride Particles (g) (Percentage | PT-110 | 8.94 (70) | 8.95 (70) | 8.95 (70) |
| Formula- | (vol %) to Total Amount of Boron Nitride | | | | |
| tion of | Particles and Polymer Matrix) | | | | |

| | | | | | |
|---|---|---|---|---|---|
| Compo- | Polymer | Content Ratio (vol %) of Polymer Matrix in | 30 | 30 | 30 |
| nents | Matrix | Thermally Conductive Sheet | | | |

| Epoxy | Epoxy | Liquid | EXA-4850-1000 | — | — | — |
|---|---|---|---|---|---|---|
| Resin | Resin | | EXA-4850-150 | — | — | — |
| Composi- | | Semi-Solid | EG-200 | 1.00 | — | — |
| tion | | Solid | YSLV-80XY | — | — | — |
| | | | EPPN | — | — | — |
| | | | HP-7200 | — | — | — |
| | | | 1002 | — | — | — |
| | | | 1256 | — | — | — |
| | Volume Blending Ratio of Epoxy | | | 1.00 | — | — |
| | Resin to Rubber Component *1 | | | | | |
| | Curing Agent • | | MEHC-7800S | — | — | — |
| | Curing Accelerator | | MEHC-7800SS | — | — | — |
| | | | 2P4MHZ-PW | 0.010 | — | — |
| | Percentage (wt %) of Curing Agent • | | | 1.0 | — | — |
| | Curing Accelerator to Epoxy Resin | | | | | |
| Rubber | Rubber | Acrylate- | Art-333 | — | — | — |
| Composi- | Compo- | Modified | MEK 75% | | | |
| tion | nent | Urethane | Solution | | | |
| | | Rubber | Art-5507 | — | — | — |
| | | | MEK 70.6% | | | |
| | | | Solution | | | |
| | | Carboxy- | XER-32C (NBR) | — | — | — |
| | | Modified | 1072J | — | — | — |
| | | NBR | DN631 | — | — | — |
| | | Styrene- | SIBSTAR | — | — | — |
| | | Isobutylene | | | | |
| | | Rubber | | | | |
| | | Modified | BR1220 | — | 1.5 | — |
| | | Poly- | PB3600 | — | — | — |
| | | butadiene | | | | |
| | | Rubber | | | | |
| | | Epoxy- | AT501 | — | — | — |
| | | Modified | | | | |
| | | SBR | | | | |
| | | Acrylic | SG-P3 MEK 15% | — | — | — |
| | | Rubber | Solution | | | |
| | | | SG-280 TEA | — | — | — |
| | | | Toluene/ | | | |
| | | | Ethyl | | | |
| | | | Acetate 15% | | | |
| | | | Solution | | | |
| | | | LA2140e | 0.92 | — | — |
| | | | LA2250 | — | — | — |
| | | | AR31 | — | — | 1.833 |
| | Polymer- | Photopoly- | IRGACURE 907 | — | — | — |
| | ization | merization | DETX-S | — | — | — |
| | Initiator | Initiator | | | | |
| | | Thermal | AIBN | — | — | — |
| | | Polymer- | | | | |
| | | ization | | | | |
| | | Initiator | | | | |

| | | | |
|---|---|---|---|
| Percentage (wt %) of | — | — | — |
| Polymerization Initiator | | | |
| to Rubber Component | | | |

| | | | | |
|---|---|---|---|---|
| Dispersant (wt %) (Percentage to | BYK-2095 | — | — | — |
| Boron Nitride Particles) | | | | |

| | | | | | |
|---|---|---|---|---|---|
| Evalua- | Thermal Conductivity (W/m · K) | Density | 1.81 | 1.84 | 1.88 |
| tion | | Thickness | 1.77 | 1.59 | 1.85 |
| | | Direction (TD) | | | |
| | | Plane | 21.0 | 22.46 | 23.96 |
| | | Direction (PD) | | | |
| | Tensile Test | Tensile Elastic | 155.0 | 18.23 | 37.67 |
| | | Modulus (N/m²) | | | |

| | | | | |
|---|---|---|---|---|
| Maximum | A*2 | 103.97 | 110.03 | 106.47 |
| Elongation | | | | |
| (%) | | | | |
| Elongation | C*3 | 118.21 | 105.03 | 116.32 |
| at Time of | | | | |
| Fracture | | | | |
| (%) | | | | |

| | | | | |
|---|---|---|---|---|
| Flexibility/Bend Test | JIS K5600-5-1 | Excel- | Excel- | Excel- |
| | | lent | lent | lent |
| Conformability to Irregularities/ | JIS K7171 | Excel- | Excel- | Excel- |
| 3-Point Bending Test | (in 2008) | lent | lent | lent |

| | | | |
|---|---|---|---|
| 90 Degree Peel Adhesive Force (vs Copper Foil) (N/10 mm) | — | — | 3.31 |

*1: Number of parts by volume of epoxy resin/number of parts by volume of rubber component
*2Maximum elongation of thermally conductive sheet (measured value)
*3Elongation at the time of fracture of thermally conductive sheet (measured value)

TABLE 6

| Examples | | | Ex. 35 | Ex. 36 | Ex. 37 | Ex. 38 |
|---|---|---|---|---|---|---|
| Mixing | Boron Nitride Particles (g) (Percentage | PT-110 | 8.95 (70) | 8.95 (70) | 8.95 (70) | 8.95 (70) |
| Formula- | (vol %) to Total Amount of Boron Nitride | | | | | |
| tion of | Particles and Polymer Matrix) | | | | | |

| | | | | | | |
|---|---|---|---|---|---|---|
| Compo- | Polymer | Content Ratio (vol %) of Polymer Matrix in | 30 | 30 | 30 | 30 |
| nents | Matrix | Thermally Conductive Sheet | | | | |

| Epoxy | Epoxy | Liquid | EXA-4850-1000 | — | — | — | — |
|---|---|---|---|---|---|---|---|
| Resin | Resin | | EXA-4850-150 | — | — | — | — |
| Composi- | | Semi-Solid | EG-200 | — | — | — | — |
| tion | | Solid | YSLV-80XY | — | — | — | — |
| | | | EPPN | — | — | — | — |
| | | | HP-7200 | — | — | 1.00 | 1.00 |
| | | | 1002 | — | — | — | — |
| | | | 1256 | — | — | — | — |
| | Volume Blending Ratio of Epoxy | | | — | — | 1.00 | 1.00 |
| | Resin to Rubber Component *1 | | | | | | |
| | Curing Agent • | | MEHC-7800S | — | — | — | — |
| | Curing Accelerator | | MEHC-7800SS | — | — | — | — |
| | | | 2P4MHZ-PW | — | — | 0.010 | 0.010 |
| | Percentage (wt %) of Curing Agent • | | | — | — | 1.0 | 1.0 |
| | Curing Accelerator to Epoxy Resin | | | | | | |
| Rubber | Rubber | Acrylate- | Art-333 | — | — | — | — |
| Composi- | Compo- | Modified | MEK 75% | | | | |
| tion | nent | Urethane | Solution | | | | |
| | | Rubber | Art-5507 | — | — | — | — |
| | | | MEK 70.6% | | | | |
| | | | Solution | | | | |
| | | Carboxy- | XER-32C (NBR) | — | — | — | — |
| | | Modified | 1072J | 1.633 | — | — | 0.817 |
| | | NBR | DN631 | — | 1.650 | — | — |
| | | Styrene- | SIBSTAR | — | — | — | — |
| | | Isobutylene | | | | | |
| | | Rubber | | | | | |
| | | Modified | BR1220 | — | — | — | — |
| | | Poly- | PB3600 | — | — | — | — |
| | | butadiene | | | | | |
| | | Rubber | | | | | |
| | | Epoxy- | AT501 | — | — | — | — |
| | | Modified | | | | | |
| | | SBR | | | | | |
| | | Acrylic | SG-P3 MEK 15% | — | — | — | — |
| | | Rubber | Solution | | | | |
| | | | SG-280 TEA | — | — | — | — |
| | | | Toluene/ | | | | |
| | | | Ethyl | | | | |
| | | | Acetate 15% | | | | |
| | | | Solution | | | | |
| | | | LA2140e | — | — | — | — |
| | | | LA2250 | — | — | — | — |
| | | | AR31 | — | — | 0.917 | — |
| | Polymer- | Photopoly- | IRGACURE 907 | — | — | — | — |
| | ization | merization | DETX-S | — | — | — | — |
| | Initiator | Initiator | | | | | |
| | | Thermal | AIBN | — | — | — | — |
| | | Polymer- | | | | | |
| | | ization | | | | | |
| | | Initiator | | | | | |

| | | | | |
|---|---|---|---|---|
| Percentage (wt %) of | — | — | — | — |
| Polymerization Initiator | | | | |
| to Rubber Component | | | | |

| | | | | | |
|---|---|---|---|---|---|
| Dispersant (wt %) (Percentage to | BYK-2095 | — | — | — | — |
| Boron Nitride Particles) | | | | | |

| | | | | | | |
|---|---|---|---|---|---|---|
| Evalua- | Thermal Conductivity (W/m · K) | Density | 1.87 | 1.88 | 1.85 | 1.82 |
| tion | | Thickness | 2.01 | 2.03 | 1.87 | 1.62 |
| | | Direction (TD) | | | | |
| | | Plane | 21.39 | 22.22 | 21.19 | 18.70 |
| | | Direction (PD) | | | | |
| | Tensile Test | Tensile Elastic | 42.71 | 37.99 | 61.49 | 45.89 |
| | | Modulus (N/m²) | | | | |

| | | | | | |
|---|---|---|---|---|---|
| Maximum | A*2 | 108.20 | 107.38 | 106.23 | 114.80 |
| Elongation | | | | | |
| (%) | | | | | |
| Elongation | C*3 | 121.94 | 115.55 | 152.63 | 149.32 |
| at Time of | | | | | |
| Fracture | | | | | |
| (%) | | | | | |

| | | | | | |
|---|---|---|---|---|---|
| Flexibility/Bend Test | JIS K5600-5-1 | Excel- | Excel- | Excel- | Excel- |
| | | lent | lent | lent | lent |
| Conformability to Irregularities/ | JIS K7171 | Excel- | Excel- | Excel- | Excel- |
| 3-Point Bending Test | (in 2008) | lent | lent | lent | lent |

| | | | | |
|---|---|---|---|---|
| 90 Degree Peel Adhesive Force (vs Copper Foil) (N/10 mm) | 3.97 | 3.15 | — | 4.04 |

| Examples | | | Ex. 39 | Ex. 40 | Ex. 41 |
|---|---|---|---|---|---|
| Mixing | Boron Nitride Particles (g) (Percentage | PT-110 | 8.95 (70) | 8.95 (70) | 8.95 (70) |
| Formula- | (vol %) to Total Amount of Boron Nitride | | | | |
| tion of | Particles and Polymer Matrix) | | | | |

| | | | | | |
|---|---|---|---|---|---|
| Compo- | Polymer | Content Ratio (vol %) of Polymer Matrix in | 30 | 30 | 30 |
| nents | Matrix | Thermally Conductive Sheet | | | |

| Epoxy | Epoxy | Liquid | EXA-4850-1000 | — | — | — |
|---|---|---|---|---|---|---|
| Resin | Resin | | EXA-4850-150 | — | — | — |
| Composi- | | Semi-Solid | EG-200 | — | — | — |
| tion | | Solid | YSLV-80XY | — | — | — |
| | | | EPPN | — | — | — |
| | | | HP-7200 | — | 1.00 | — |
| | | | 1002 | 1.00 | — | 1.00 |
| | | | 1256 | — | — | — |
| | Volume Blending Ratio of Epoxy | | | 1.00 | 1.00 | 1.00 |
| | Resin to Rubber Component *1 | | | | | |
| | Curing Agent • | | MEHC-7800S | — | — | — |
| | Curing Accelerator | | MEHC-7800SS | — | — | — |
| | | | 2P4MHZ-PW | 0.010 | 0.010 | 0.010 |
| | Percentage (wt %) of Curing Agent • | | | 1.0 | 1.0 | 1.0 |
| | Curing Accelerator to Epoxy Resin | | | | | |
| Rubber | Rubber | Acrylate- | Art-333 | — | — | — |
| Composi- | Compo- | Modified | MEK 75% | | | |
| tion | nent | Urethane | Solution | | | |
| | | Rubber | Art-5507 | — | — | — |
| | | | MEK 70.6% | | | |
| | | | Solution | | | |
| | | Carboxy- | XER-32C (NBR) | — | — | — |
| | | Modified | 1072J | 0.817 | — | — |
| | | NBR | DN631 | — | 0.825 | 0.825 |
| | | Styrene- | SIBSTAR | — | — | — |
| | | Isobutylene | | | | |
| | | Rubber | | | | |
| | | Modified | BR1220 | — | — | — |
| | | Poly- | PB3600 | — | — | — |
| | | butadiene | | | | |
| | | Rubber | | | | |
| | | Epoxy- | AT501 | — | — | — |
| | | Modified | | | | |
| | | SBR | | | | |
| | | Acrylic | SG-P3 MEK 15% | — | — | — |
| | | Rubber | Solution | | | |
| | | | SG-280 TEA | — | — | — |
| | | | Toluene/ | | | |
| | | | Ethyl | | | |
| | | | Acetate 15% | | | |
| | | | Solution | | | |
| | | | LA2140e | — | — | — |
| | | | LA2250 | — | — | — |
| | | | AR31 | — | — | — |
| | Polymer- | Photopoly- | IRGACURE 907 | — | — | — |
| | ization | merization | DETX-S | — | — | — |
| | Initiator | Initiator | | | | |
| | | Thermal | AIBN | — | — | — |
| | | Polymer- | | | | |
| | | ization | | | | |
| | | Initiator | | | | |

| | | | |
|---|---|---|---|
| Percentage (wt %) of | — | — | — |
| Polymerization Initiator | | | |
| to Rubber Component | | | |

| | | | | |
|---|---|---|---|---|
| Dispersant (wt %) (Percentage to | BYK-2095 | — | — | — |
| Boron Nitride Particles) | | | | |

| | | | | | |
|---|---|---|---|---|---|
| Evalua- | Thermal Conductivity (W/m · K) | Density | 1.83 | 1.84 | 1.83 |
| tion | | Thickness | 2.39 | 1.51 | 2.42 |
| | | Direction (TD) | | | |
| | | Plane | 25.32 | 19.50 | 23.94 |
| | | Direction (PD) | | | |
| | Tensile Test | Tensile Elastic | 389.08 | 41.89 | 363.01 |
| | | Modulus (N/m²) | | | |

| | | | | |
|---|---|---|---|---|
| Maximum | A*2 | 103.48 | 108.28 | 102.77 |
| Elongation | | | | |
| (%) | | | | |
| Elongation | C*3 | 110.77 | 158.48 | 110.28 |
| at Time of | | | | |
| Fracture | | | | |
| (%) | | | | |

| | | | | |
|---|---|---|---|---|
| Flexibility/Bend Test | JIS K5600-5-1 | Excel- | Excel- | Excel- |
| | | lent | lent | lent |
| Conformability to Irregularities/ | JIS K7171 | Excel- | Excel- | Excel- |
| 3-Point Bending Test | (in 2008) | lent | lent | lent |

| | | | |
|---|---|---|---|
| 90 Degree Peel Adhesive Force (vs Copper Foil) (N/10 mm) | 3.38 | 5.25 | 4.62 |

*1: Number of parts by volume of epoxy resin/number of parts by volume of rubber component
*2Maximum elongation of thermally conductive sheet (measured value)
*3Elongation at the time of fracture of thermally conductive sheet (measured value)

TABLE 7

| | | | Comparative Examples | | | | |
|---|---|---|---|---|---|---|---|
| | | | Comp. | Comp. | Comp. | Comp. | Comp. |
| | | | Ex. 1 | Ex. 2 | Ex. 3 | Ex. 4 | Ex. 5 |
| Mixing | Boron Nitride Particles (g) (Percentage | PT-110 | 67.08 (70) | 67.08 (70) | 67.08 (70) | 68.43 (70) | 89.44 (70) |
| Formula- | (vol %) to Total Amount of Boron Nitride | | | | | | |
| tion of | Particles and Polymer Matrix) | | | | | | |

| | | | | | | | |
|---|---|---|---|---|---|---|---|
| Compo- | Polymer | Content Ratio (vol %) of Polymer Matrix in | 30 | 30 | 30 | 30 | 30 |
| nents | Matrix | Thermally Conductive Sheet | | | | | |

| Epoxy | Epoxy | Liquid | EXA-4850-1000 | — | — | 15.00 | — | — |
|---|---|---|---|---|---|---|---|---|
| Resin | Resin | | EXA-4850-150 | — | — | — | — | — |
| Composi- | | Semi-Solid | EG-200 | — | — | — | — | — |
| tion | | Solid | YSLV-80XY | — | — | — | 6.00 | 7.63 |
| | | | EPPN | 15.00 | — | — | — | — |
| | | | HP-7200 | — | 15.00 | — | — | — |
| | | | 1002 | — | — | — | 6.00 | — |
| | | | 1256 | — | — | — | — | 7.63 |
| | Volume Blending Ratio of Epoxy | | | — | — | — | — | — |
| | Resin to Rubber Component *1 | | | | | | | |
| | Curing Agent • | | MEHC-7800S | — | — | — | 1.81 | 2.32 |
| | Curing Accelerator | | MEHC-7800SS | — | — | — | 1.49 | 1.90 |
| | | | 2P4MHZ-PW | 0.150 | 0.150 | 0.150 | 0.060 | 0.076 |
| | Percentage (wt %) of Curing Agent • | | | 1.0 | 1.0 | 1.0 | 28.0 | 28.2 |
| | Curing Accelerator to Epoxy Resin | | | | | | | |
| Rubber | Rubber | Acrylate- | Art-333 | — | — | — | — | — |
| Composi- | Compo- | Modified | MEK 75% | | | | | |
| tion | nent | Urethane | Solution | | | | | |
| | | Rubber | Art-5507 | — | — | — | — | — |
| | | | MEK 70.6% | | | | | |
| | | | Solution | | | | | |
| | | Carboxy- | XER-32C (NBR) | — | — | — | — | — |
| | | Modified | 1072J | — | — | — | — | — |
| | | NBR | DN631 | — | — | — | — | — |
| | | Styrene- | SIBSTAR | — | — | — | — | — |
| | | Isobutylene | | | | | | |
| | | Rubber | | | | | | |
| | | Modified | BR1220 | — | — | — | — | — |
| | | Poly- | PB3600 | — | — | — | — | — |
| | | butadiene | | | | | | |
| | | Rubber | | | | | | |
| | | Epoxy- | AT501 | — | — | — | — | — |
| | | Modified | | | | | | |
| | | SBR | | | | | | |
| | | Acrylic | SG-P3 MEK 15% | — | — | — | — | — |
| | | Rubber | Solution | | | | | |
| | | | SG-280 TEA | — | — | — | — | — |
| | | | Toluene/ | | | | | |
| | | | Ethyl | | | | | |
| | | | Acetate 15% | | | | | |
| | | | Solution | | | | | |
| | | | LA2140e | — | — | — | — | — |
| | | | LA2250 | — | — | — | — | — |
| | | | AR31 | — | — | — | — | — |
| | Polymer- | Photopoly- | IRGACURE 907 | — | — | — | — | — |
| | ization | merization | DETX-S | — | — | — | — | — |
| | Initiator | Initiator | | | | | | |
| | | Thermal | AIBN | — | — | — | — | — |
| | | Polymer- | | | | | | |
| | | ization | | | | | | |
| | | Initiator | | | | | | |

| | | | | | |
|---|---|---|---|---|---|
| Percentage (wt %) of | — | — | — | — | — |
| Polymerization Initiator | | | | | |
| to Rubber Component | | | | | |

| | | | | | | |
|---|---|---|---|---|---|---|
| Dispersant (wt %) (Percentage to | BYK-2095 | — | — | — | — | 0.5 |
| Boron Nitride Particles) | | | | | | |

| | | | | | | | |
|---|---|---|---|---|---|---|---|
| Evalua- | Thermal Conductivity (W/m · K) | Density | 1.76 | 1.77 | — | 1.74 | 1.86 |
| tion | | Thickness | 2.56 | 2.35 | — | 1.31 | 2.96 |
| | | Direction (TD) | | | | | |
| | | Plane | 22.00 | 20.90 | — | 18.93 | 26.50 |
| | | Direction (PD) | | | | | |
| | Tensile Test | Tensile Elastic | 4588.50 | 4132.10 | — | 1314.77 | 3385.66 |
| | | Modulus (N/m²) | | | | | |

| | | | | | | |
|---|---|---|---|---|---|---|
| Maximum | A*2 | 100.49 | 100.65 | — | 101.18 | 100.69 |
| Elongation | | | | | | |
| (%) | | | | | | |
| Elongation | C*3 | 100.61 | 100.86 | — | 101.65 | 100.72 |
| at Time of | | | | | | |
| Fracture | | | | | | |
| (%) | | | | | | |

| | | | | | | |
|---|---|---|---|---|---|---|
| Flexibility/Bend Test | JIS K5600-5-1 | Bad | Bad | Bad | Bad | Bad |
| Conformability to Irregularities/ | JIS K7171 | Bad | Bad | Bad | Bad | Bad |
| 3-Point Bending Test | (in 2008) | | | | | |

| | | | | | |
|---|---|---|---|---|---|
| 90 Degree Peel Adhesive Force (vs Copper Foil) (N/10 mm) | — | — | — | — | — |

*1: Number of parts by volume of epoxy resin/number of parts by volume of rubber component
*2Maximum elongation of thermally conductive sheet (measured value)
*3Elongation at the time of fracture of thermally conductive sheet (measured value)

TABLE 8

| Examples | | | Ex. 42 | Ex. 43 | Ex. 44 | Ex. 45 |
|---|---|---|---|---|---|---|
| Mixing | Boron Nitride Particles (g) (Percentage | PT-110 | 11.13 (60) | 12.26 (70) | 13.27 (80) | 8.41 (40) |
| Formula- | (vol %) to Total Amount of Boron Nitride | | | | | |
| tion of | Particles and Polymer Matrix) | | | | | |

| | | | | | | |
|---|---|---|---|---|---|---|
| Compo- | Polymer | Content Ratio (vol %) of Polymer Matrix in | 40 | 30 | 20 | 60 |
| nents | Matrix | Thermally Conductive Sheet | | | | |

| Epoxy | Epoxy | Liquid | EXA-4850-1000 | — | — | — | — |
|---|---|---|---|---|---|---|---|
| Resin | Resin | | EXA-4850-150 | — | — | — | — |
| Composi- | | Semi-Solid | EG-200 | — | — | — | — |
| tion | | Solid | YSLV-80XY | — | — | — | — |
| | | | EPPN | — | — | — | — |
| | | | HP-7200 | 1.935 | 1.371 | 0.865 | — |
| | | | 1002 | — | — | — | 3.293 |
| | | | 1256 | — | — | — | — |
| | Volume Blending Ratio of Epoxy | | | 1.0 | 1.0 | 1.0 | 1.0 |
| | Resin to Rubber Component *1 | | | | | | |
| | Curing Agent • | | MEHC-7800S | — | — | — | — |
| | Curing Accelerator | | MEHC-7800SS | — | — | — | — |
| | (wt %) | | 2P4MHZ-PW | 0.019 | 0.014 | 0.009 | 0.033 |
| | Percentage (wt %) of Curing Agent • | | | 1.0 | 1.0 | 1.0 | 1.0 |
| | Curing Accelerator to Epoxy Resin | | | | | | |
| Rubber | Rubber | Acrylate- | Art-333 | — | — | — | — |
| Composi- | Compo- | Modified | MEK 75% | | | | |
| tion | nent | Urethane | Solution | | | | |
| | | Rubber | Art-5507 | — | — | — | — |
| | | | MEK 70.6% | | | | |
| | | | Solution | | | | |
| | | Carboxy- | XER-32C (NBR) | 1.613 | 1.142 | 0.721 | 2.744 |
| | | Modified | 1072J | — | — | — | — |
| | | NBR | DN631 | — | — | — | — |
| | | Styrene- | SIBSTAR | — | — | — | — |
| | | Isobutylene | | | | | |
| | | Rubber | | | | | |
| | | Modified | BR1220 | — | — | — | — |
| | | Poly- | PB3600 | — | — | — | — |
| | | butadiene | | | | | |
| | | Rubber | | | | | |
| | | Epoxy- | AT501 | — | — | — | — |
| | | Modified | | | | | |
| | | SBR | | | | | |
| | | Acrylic | SG-P3 MEK 15% | — | — | — | — |
| | | Rubber | Solution | | | | |
| | | | SG-280 TEA | — | — | — | — |
| | | | Toluene/ | | | | |
| | | | Ethyl | | | | |
| | | | Acetate 15% | | | | |
| | | | Solution | | | | |
| | | | LA2140e | — | — | — | — |
| | | | LA2250 | — | — | — | — |
| | Polymer- | Photopoly- | IRGACURE 907 | — | — | — | — |
| | ization | merization | DETX-S | — | — | — | — |
| | Initiator | Initiator | | | | | |
| | | Thermal | AIBN | — | — | — | — |
| | | Polymer- | | | | | |
| | | ization | | | | | |
| | | Initiator | | | | | |

| | | | | |
|---|---|---|---|---|
| Percentage (wt %) of | — | — | — | — |
| Polymerization Initiator | | | | |
| to Rubber Component | | | | |

| | | | | | |
|---|---|---|---|---|---|
| Dispersant (wt %) (Percentage to | BYK-2095 | — | — | — | — |
| Boron Nitride Particles) | | | | | |

| | | | | | | |
|---|---|---|---|---|---|---|
| Evalua- | Thermal Conductivity (W/m · K) | Density | 1.80 | 1.87 | 1.92 | 1.60 |
| tion | | Thickness | 1.21 | 1.85 | 2.90 | 0.45 |
| | | Direction (TD) | | | | |
| | | Plane | 16.17 | 22.21 | 31.14 | 6.79 |
| | | Direction (PD) | | | | |
| | Tensile Test | Tensile Elastic | 42.00 | 55.95 | 154.28 | 107.41 |
| | | Modulus (N/m²) | | | | |

| | | | | | |
|---|---|---|---|---|---|
| Maximum | A*2 | 109.98 | 108.74 | 107.12 | 106.21 |
| Elongation | | | | | |
| (%) | | | | | |
| Constant | k | −0.045 | −0.045 | −0.045 | −0.011 |
| Amount of | Y*3 | 13.60 | 8.67 | 5.53 | 4.72 |
| Maximum | | | | | |
| Elongation | | | | | |
| (%) | | | | | |
| Maximum | Z*4 | 113.60 | 108.67 | 105.53 | 104.72 |
| Elongation | | | | | |
| (%) | | | | | |
| Elongation | C*5 | 278.44 | 212.02 | 110.03 | 238.70 |
| at Time of | | | | | |
| Fracture | | | | | |
| (%) | | | | | |
| Constant | l | −0.048 | −0.048 | −0.048 | −0.063 |
| Amount of | V*6 | 86.80 | 53.71 | 33.24 | 46.60 |
| Elongation | | | | | |
| at Time of | | | | | |
| Fracture | | | | | |
| Elongation | W*7 | 186.80 | 153.71 | 133.24 | 146.60 |
| at Time of | | | | | |
| Fracture | | | | | |
| (%) | | | | | |

| | | | | | |
|---|---|---|---|---|---|
| Flexibility/Bend Test | JIS K5600-5-1 | Excel- | Excel- | Excel- | Excel- |
| | | lent | lent | lent | lent |
| Conformability to Irregularities/ | JIS K7171 | Excel- | Excel- | Excel- | Excel- |
| 3-Point Bending Test | (in 2008) | lent | lent | lent | lent |

| | | | | |
|---|---|---|---|---|
| 90 Degree Peel Adhesive Force (vs Copper Foil) (N/10 mm) | — | 4.88 | — | — |

| Examples | | | Ex. 46 | Ex. 47 | Ex. 48 |
|---|---|---|---|---|---|
| Mixing | Boron Nitride Particles (g) (Percentage | PT-110 | 11.13 (60) | 8.94 (70) | 13.27 (80) |
| Formula- | (vol %) to Total Amount of Boron Nitride | | | | |
| tion of | Particles and Polymer Matrix) | | | | |

| | | | | | |
|---|---|---|---|---|---|
| Compo- | Polymer | Content Ratio (vol %) of Polymer Matrix in | 40 | 30 | 20 |
| nents | Matrix | Thermally Conductive Sheet | | | |

| Epoxy | Epoxy | Liquid | EXA-4850-1000 | — | — | — |
|---|---|---|---|---|---|---|
| Resin | Resin | | EXA-4850-150 | — | — | — |
| Composi- | | Semi-Solid | EG-200 | — | — | — |
| tion | | Solid | YSLV-80XY | — | — | — |
| | | | EPPN | — | — | — |
| | | | HP-7200 | — | — | — |
| | | | 1002 | 1.935 | 1.000 | 0.865 |
| | | | 1256 | — | — | — |
| | Volume Blending Ratio of Epoxy | | | 1.0 | 1.0 | 1.0 |
| | Resin to Rubber Component *1 | | | | | |
| | Curing Agent • | | MEHC-7800S | — | — | — |
| | Curing Accelerator | | MEHC-7800SS | — | — | — |
| | (wt %) | | 2P4MHZ-PW | 0.019 | 0.010 | 0.009 |
| | Percentage (wt %) of Curing Agent • | | | 1.0 | 1.0 | 1.0 |
| | Curing Accelerator to Epoxy Resin | | | | | |
| Rubber | Rubber | Acrylate- | Art-333 | — | — | — |
| Composi- | Compo- | Modified | MEK 75% | | | |
| tion | nent | Urethane | Solution | | | |
| | | Rubber | Art-5507 | — | — | — |
| | | | MEK 70.6% | | | |
| | | | Solution | | | |
| | | Carboxy- | XER-32C (NBR) | 1.613 | 0.830 | 0.721 |
| | | Modified | 1072J | — | — | — |
| | | NBR | DN631 | — | — | — |
| | | Styrene- | SIBSTAR | — | — | — |
| | | Isobutylene | | | | |
| | | Rubber | | | | |
| | | Modified | BR1220 | — | — | — |
| | | Poly- | PB3600 | — | — | — |
| | | butadiene | | | | |
| | | Rubber | | | | |
| | | Epoxy- | AT501 | — | — | — |
| | | Modified | | | | |
| | | SBR | | | | |
| | | Acrylic | SG-P3 MEK 15% | — | — | — |
| | | Rubber | Solution | | | |
| | | | SG-280 TEA | — | — | — |
| | | | Toluene/ | | | |
| | | | Ethyl | | | |
| | | | Acetate 15% | | | |
| | | | Solution | | | |
| | | | LA2140e | — | — | — |
| | | | LA2250 | — | — | — |
| | Polymer- | Photopoly- | IRGACURE 907 | — | — | — |
| | ization | merization | DETX-S | — | — | — |
| | Initiator | Initiator | | | | |
| | | Thermal | AIBN | — | — | — |
| | | Polymer- | | | | |
| | | ization | | | | |
| | | Initiator | | | | |

| | | | |
|---|---|---|---|
| Percentage (wt %) of | — | — | — |
| Polymerization Initiator | | | |
| to Rubber Component | | | |

| | | | | |
|---|---|---|---|---|
| Dispersant (wt %) (Percentage to | BYK-2095 | — | — | — |
| Boron Nitride Particles) | | | | |

| | | | | | |
|---|---|---|---|---|---|
| Evalua- | Thermal Conductivity (W/m · K) | Density | 1.75 | 1.87 | 1.93 |
| tion | | Thickness | 1.41 | 2.65 | 3.76 |
| | | Direction (TD) | | | |
| | | Plane | 15.33 | 25.65 | 36.31 |
| | | Direction (PD) | | | |
| | Tensile Test | Tensile Elastic | 262.72 | 399.92 | 484.07 |
| | | Modulus (N/m²) | | | |

| | | | | |
|---|---|---|---|---|
| Maximum | A*2 | 104.63 | 102.81 | 102.47 |
| Elongation | | | | |
| (%) | | | | |
| Constant | k | −0.011 | −0.011 | −0.011 |
| Amount of | Y*3 | 3.79 | 3.39 | 3.04 |
| Maximum | | | | |
| Elongation | | | | |
| (%) | | | | |
| Maximum | Z*4 | 103.79 | 103.39 | 103.04 |
| Elongation | | | | |
| (%) | | | | |
| Elongation | C*5 | 110.91 | 103.47 | 104.42 |
| at Time of | | | | |
| Fracture | | | | |
| (%) | | | | |
| Constant | l | −0.063 | −0.063 | −0.063 |
| Amount of | V*6 | 13.22 | 7.04 | 3.75 |
| Elongation | | | | |
| at Time of | | | | |
| Fracture | | | | |
| Elongation | W*7 | 113.22 | 107.04 | 103.75 |
| at Time of | | | | |
| Fracture | | | | |
| (%) | | | | |

| | | | | |
|---|---|---|---|---|
| Flexibility/Bend Test | JIS K5600-5-1 | Excel- | Excel- | Good |
| | | lent | lent | |
| Conformability to Irregularities/ | JIS K7171 | Excel- | Excel- | Excel- |
| 3-Point Bending Test | (in 2008) | lent | lent | lent |

| | | | |
|---|---|---|---|
| 90 Degree Peel Adhesive Force (vs Copper Foil) (N/10 mm) | — | 3.79 | — |

*1: Number of parts by volume of epoxy resin/number of parts by volume of rubber component
*2Maximum elongation of thermally conductive sheet (measured value)
*3Amount of maximum elongation of thermally conductive sheet
*4Maximum elongation of thermally conductive sheet speculated from formulas (1) and (2) (estimate)
*5Elongation at the time of fracture of thermally conductive sheet (measured value)
*6Amount of elongation at the time of fracture of thermally conductive sheet
*7Elongation at the time of fracture of thermally conductive sheet speculated from formulas (3) and (4) (estimate)

TABLE 9

| Examples | | | Ex. 49 | Ex. 50 | Ex. 51 | Ex. 52 |
|---|---|---|---|---|---|---|
| Mixing | Boron Nitride Particles (g) (Percentage | PT-110 | 8.41 (40) | 9.86 (50) | 5.75 (60) | 8.94 (70) |
| Formula- | (vol %) to Total Amount of Boron Nitride | | | | | |
| tion of | Particles and Polymer Matrix) | | | | | |

| | | | | | | |
|---|---|---|---|---|---|---|
| Compo- | Polymer | Content Ratio (vol %) of Polymer Matrix in | 60 | 50 | 40 | 30 |
| nents | Matrix | Thermally Conductive Sheet | | | | |

| Epoxy | Epoxy | Liquid | EXA-4850-1000 | — | — | — | — |
|---|---|---|---|---|---|---|---|
| Resin | Resin | | EXA-4850-150 | — | — | — | — |
| Composi- | | Semi-Solid | EG-200 | — | — | — | — |
| tion | | Solid | YSLV-80XY | — | — | — | — |
| | | | EPPN | — | — | — | — |
| | | | HP-7200 | 3.293 | 2.571 | 1.00 | 1.00 |
| | | | 1002 | — | — | — | — |
| | | | 1256 | — | — | — | — |
| | Volume Blending Ratio of Epoxy | | | 1.0 | 1.0 | 1.0 | 1.0 |
| | Resin to Rubber Component *1 | | | | | | |
| | Curing Agent • | | MEHC-7800S | — | — | — | — |
| | Curing Accelerator | | MEHC-7800SS | — | — | — | — |
| | (wt %) | | 2P4MHZ-PW | 0.033 | 0.026 | 0.010 | 0.010 |
| | Percentage (wt %) of Curing Agent • | | | 1.0 | 1.0 | 1.0 | 1.0 |
| | Curing Accelerator to Epoxy Resin | | | | | | |
| Rubber | Rubber | Acrylate- | Art-333 | — | — | — | — |
| Composi- | Compo- | Modified | MEK 75% | | | | |
| tion | nent | Urethane | Solution | | | | |
| | | Rubber | Art-5507 | — | — | — | — |
| | | | MEK 70.6% | | | | |
| | | | Solution | | | | |
| | | Carboxy- | XER-32C (NBR) | — | — | — | — |
| | | Modified | 1072J | — | — | — | — |
| | | NBR | DN631 | — | — | — | — |
| | | Styrene- | SIBSTAR | — | — | — | — |
| | | Isobutylene | | | | | |
| | | Rubber | | | | | |
| | | Modified | BR1220 | — | — | — | — |
| | | Poly- | PB3600 | — | — | — | — |
| | | butadiene | | | | | |
| | | Rubber | | | | | |
| | | Epoxy- | AT501 | — | — | — | — |
| | | Modified | | | | | |
| | | SBR | | | | | |
| | | Acrylic | SG-P3 MEK 15% | 18.293 | 14.286 | 5.56 | 5.56 |
| | | Rubber | Solution | | | | |
| | | | SG-280 TEA | — | — | — | — |
| | | | Toluene/ | | | | |
| | | | Ethyl | | | | |
| | | | Acetate 15% | | | | |
| | | | Solution | | | | |
| | | | LA2140e | — | — | — | — |
| | | | LA2250 | — | — | — | — |
| | Polymer- | Photopoly- | IRGACURE 907 | — | — | — | — |
| | ization | merization | DETX-S | — | — | — | — |
| | Initiator | Initiator | | | | | |
| | | Thermal | AIBN | — | — | — | — |
| | | Polymer- | | | | | |
| | | ization | | | | | |
| | | Initiator | | | | | |

| | | | | |
|---|---|---|---|---|
| Percentage (wt %) of | — | — | — | — |
| Polymerization Initiator | | | | |
| to Rubber Component | | | | |

| | | | | | |
|---|---|---|---|---|---|
| Dispersant (wt %) (Percentage to | BYK-2095 | — | — | — | — |
| Boron Nitride Particles) | | | | | |

| | | | | | | |
|---|---|---|---|---|---|---|
| Evalua- | Thermal Conductivity (W/m · K) | Density | 1.65 | 1.77 | 1.79 | 1.87 |
| tion | | Thickness | 0.39 | 0.86 | 1.12 | 2.04 |
| | | Direction (TD) | | | | |
| | | Plane | 6.86 | 11.97 | 16.90 | 23.33 |
| | | Direction (PD) | | | | |
| | Tensile Test | Tensile Elastic | 13.72 | 270.78 | 576.00 | 882.85 |
| | | Modulus (N/m²) | | | | |

| | | | | | |
|---|---|---|---|---|---|
| Maximum | A*2 | 309.45 | 108.19 | 105.72 | 103.85 |
| Elongation | | | | | |
| (%) | | | | | |
| Constant | k | −0.068 | −0.068 | −0.068 | −0.068 |
| Amount of | Y*3 | 31.75 | 16.08 | 8.15 | 4.13 |
| Maximum | | | | | |
| Elongation | | | | | |
| (%) | | | | | |
| Maximum | Z*4 | 131.75 | 116.08 | 108.15 | 104.13 |
| Elongation | | | | | |
| (%) | | | | | |
| Elongation | C*5 | 324.36 | 130.12 | 112.47 | 105.94 |
| at Time of | | | | | |
| Fracture | | | | | |
| (%) | | | | | |
| Constant | l | −0.059 | −0.059 | −0.059 | −0.059 |
| Amount of | V*6 | 45.95 | 25.47 | 14.12 | 7.83 |
| Elongation | | | | | |
| at Time of | | | | | |
| Fracture | | | | | |
| Elongation | W*7 | 145.95 | 125.47 | 114.12 | 107.83 |
| at Time of | | | | | |
| Fracture | | | | | |
| (%) | | | | | |

| | | | | | |
|---|---|---|---|---|---|
| Flexibility/Bend Test | JIS K5600-5-1 | Excel- | Excel- | Excel- | Excel- |
| | | lent | lent | lent | lent |
| Conformability to Irregularities/ | JIS K7171 | Excel- | Excel- | Excel- | Excel- |
| 3-Point Bending Test | (in 2008) | lent | lent | lent | lent |

| | | | | |
|---|---|---|---|---|
| 90 Degree Peel Adhesive Force (vs Copper Foil) (N/10 mm) | — | — | 3.33 | 3.38 |

| Examples | | | Ex. 53 | Ex. 54 | Ex. 55 |
|---|---|---|---|---|---|
| Mixing | Boron Nitride Particles (g) (Percentage | PT-110 | 15.33 (80) | 8.41 (40) | 11.13 (60) |
| Formula- | (vol %) to Total Amount of Boron Nitride | | | | |
| tion of | Particles and Polymer Matrix) | | | | |

| | | | | | |
|---|---|---|---|---|---|
| Compo- | Polymer | Content Ratio (vol %) of Polymer Matrix in | 20 | 60 | 40 |
| nents | Matrix | Thermally Conductive Sheet | | | |

| Epoxy | Epoxy | Liquid | EXA-4850-1000 | — | — | — |
|---|---|---|---|---|---|---|
| Resin | Resin | | EXA-4850-150 | — | — | — |
| Composi- | | Semi-Solid | EG-200 | — | 3.293 | 1.935 |
| tion | | Solid | YSLV-80XY | — | — | — |
| | | | EPPN | — | — | — |
| | | | HP-7200 | 1.00 | — | — |
| | | | 1002 | — | — | — |
| | | | 1256 | — | — | — |
| | Volume Blending Ratio of Epoxy | | | 1.0 | 1.0 | 1.0 |
| | Resin to Rubber Component *1 | | | | | |
| | Curing Agent • | | MEHC-7800S | — | — | — |
| | Curing Accelerator | | MEHC-7800SS | — | — | — |
| | (wt %) | | 2P4MHZ-PW | 0.010 | 0.033 | 0.019 |
| | Percentage (wt %) of Curing Agent • | | | 1.0 | 1.0 | 1.0 |
| | Curing Accelerator to Epoxy Resin | | | | | |
| Rubber | Rubber | Acrylate- | Art-333 | — | — | — |
| Composi- | Compo- | Modified | MEK 75% | | | |
| tion | nent | Urethane | Solution | | | |
| | | Rubber | Art-5507 | — | — | — |
| | | | MEK 70.6% | | | |
| | | | Solution | | | |
| | | Carboxy- | XER-32C (NBR) | — | — | — |
| | | Modified | 1072J | — | — | — |
| | | NBR | DN631 | — | — | — |
| | | Styrene- | SIBSTAR | — | — | — |
| | | Isobutylene | | | | |
| | | Rubber | | | | |
| | | Modified | BR1220 | — | — | — |
| | | Poly- | PB3600 | — | — | — |
| | | butadiene | | | | |
| | | Rubber | | | | |
| | | Epoxy- | AT501 | — | — | — |
| | | Modified | | | | |
| | | SBR | | | | |
| | | Acrylic | SG-P3 MEK 15% | 5.56 | 18.293 | 10.753 |
| | | Rubber | Solution | | | |
| | | | SG-280 TEA | — | — | — |
| | | | Toluene/ | | | |
| | | | Ethyl | | | |
| | | | Acetate 15% | | | |
| | | | Solution | | | |
| | | | LA2140e | — | — | — |
| | | | LA2250 | — | — | — |
| | Polymer- | Photopoly- | IRGACURE 907 | — | — | — |
| | ization | merization | DETX-S | — | — | — |
| | Initiator | Initiator | | | | |
| | | Thermal | AIBN | — | — | — |
| | | Polymer- | | | | |
| | | ization | | | | |
| | | Initiator | | | | |

| | | | |
|---|---|---|---|
| Percentage (wt %) of | — | — | — |
| Polymerization Initiator | | | |
| to Rubber Component | | | |

| | | | | |
|---|---|---|---|---|
| Dispersant (wt %) (Percentage to | BYK-2095 | — | — | — |
| Boron Nitride Particles) | | | | |

| | | | | | |
|---|---|---|---|---|---|
| Evalua- | Thermal Conductivity (W/m · K) | Density | 1.90 | 1.68 | 1.73 |
| tion | | Thickness | 2.51 | 0.45 | 1.38 |
| | | Direction (TD) | | | |
| | | Plane | 35.20 | 8.23 | 16.00 |
| | | Direction (PD) | | | |
| | Tensile Test | Tensile Elastic | 1634.43 | 11.97 | 109.01 |
| | | Modulus (N/m²) | | | |

| | | | | |
|---|---|---|---|---|
| Maximum | A*2 | 101.88 | 169.80 | 109.99 |
| Elongation | | | | |
| (%) | | | | |
| Constant | k | −0.068 | −0.059 | −0.059 |
| Amount of | Y*3 | 2.09 | 36.51 | 11.22 |
| Maximum | | | | |
| Elongation | | | | |
| (%) | | | | |
| Maximum | Z*4 | 102.09 | 136.51 | 111.22 |
| Elongation | | | | |
| (%) | | | | |
| Elongation | C*5 | 102.46 | 181.28 | 118.20 |
| at Time of | | | | |
| Fracture | | | | |
| (%) | | | | |
| Constant | l | −0.059 | −0.051 | −0.051 |
| Amount of | V*6 | 4.34 | 53.71 | 19.37 |
| Elongation | | | | |
| at Time of | | | | |
| Fracture | | | | |
| Elongation | W*7 | 104.34 | 153.71 | 119.37 |
| at Time of | | | | |
| Fracture | | | | |
| (%) | | | | |

| | | | | |
|---|---|---|---|---|
| Flexibility/Bend Test | JIS K5600-5-1 | Excel- | Excel- | Excel- |
| | | lent | lent | lent |
| Conformability to Irregularities/ | JIS K7171 | Excel- | Excel- | Excel- |
| 3-Point Bending Test | (in 2008) | lent | lent | lent |

| | | | |
|---|---|---|---|
| 90 Degree Peel Adhesive Force (vs Copper Foil) (N/10 mm) | 2.23 | — | — |

*1: Number of parts by volume of epoxy resin/number of parts by volume of rubber component
*2Maximum elongation of thermally conductive sheet (measured value)
*3Amount of maximum elongation of thermally conductive sheet
*4Maximum elongation of thermally conductive sheet speculated from formulas (1) and (2) (estimate)
*5Elongation at the time of fracture of thermally conductive sheet (measured value)
*6Amount of elongation at the time of fracture of thermally conductive sheet
*7Elongation at the time of fracture of thermally conductive sheet speculated from formulas (3) and (4) (estimate)

TABLE 10

| | | | Examples • Comparative Examples | | | | | |
|---|---|---|---|---|---|---|---|---|
| | | | | | Comp. | Comp. | Comp. | Comp. |
| | | | Ex. 56 | Ex. 57 | Ex. 6 | Ex. 7 | Ex. 8 | Ex. 9 |
| Mixing | Boron Nitride Particles (g) (Percentage | PT-110 | 8.94 (70) | 13.27 (80) | 0 (0) | 0 (0) | 0 (0) | 0 (0) |
| Formula- | (vol %) to Total Amount of Boron Nitride | | | | | | | |
| tion of | Particles and Polymer Matrix) | | | | | | | |

| | | | | | | | | |
|---|---|---|---|---|---|---|---|---|
| Compo- | Polymer | Content Ratio (vol %) of Polymer Matrix in | 30 | 20 | 100 | 100 | 100 | 100 |
| nents | Matrix | Thermally Conductive Sheet | | | | | | |

| Epoxy | Epoxy | Liquid | EXA-4850-1000 | — | — | — | — | — | — |
|---|---|---|---|---|---|---|---|---|---|
| Resin | Resin | | EXA-4850-150 | — | — | — | — | — | — |
| Composi- | | Semi-Solid | EG-200 | 1.00 | 0.865 | — | — | — | 2.000 |
| tion | | Solid | YSLV-80XY | — | — | — | — | — | — |
| | | | EPPN | — | — | — | — | — | — |
| | | | HP-7200 | — | — | 2.000 | — | 2.000 | — |
| | | | 1002 | — | — | — | 2.000 | — | — |
| | | | 1256 | — | — | — | — | — | — |
| | Volume Blending Ratio of Epoxy | | | 1.0 | 1.0 | 1.0 | 1.0 | 1.0 | 1.0 |
| | Resin to Rubber Component *1 | | | | | | | | |
| | Curing Agent • | | MEHC-7800S | — | — | — | — | — | — |
| | Curing Accelerator | | MEHC-7800SS | — | — | — | — | — | — |
| | | | 2P4MHZ-PW | 0.010 | 0.009 | — | — | — | — |
| | Percentage (wt %) of Curing Agent • | | | 1.0 | 1.0 | — | — | — | — |
| | Curing Accelerator to Epoxy Resin | | | | | | | | |
| Rubber | Rubber | Acrylate- | Art-333 | — | — | — | — | — | — |
| Composi- | Compo- | Modified | MEK 75% | | | | | | |
| tion | nent | Urethane | Solution | | | | | | |
| | | Rubber | Art-5507 | — | — | — | — | — | — |
| | | | MEK 70.6% | | | | | | |
| | | | Solution | | | | | | |
| | | Carboxy- | XER-32C (NBR) | — | — | 1.667 | 1.667 | — | — |
| | | Modified | 1072J | — | — | — | — | — | — |
| | | NBR | DN631 | — | — | — | — | — | — |
| | | Styrene- | SIBSTAR | — | — | — | — | — | — |
| | | Isobutylene | | | | | | | |
| | | Rubber | | | | | | | |
| | | Modified | BR1220 | — | — | — | — | — | — |
| | | Poly- | PB3600 | — | — | — | — | — | — |
| | | butadiene | | | | | | | |
| | | Rubber | | | | | | | |
| | | Epoxy- | AT501 | — | — | — | — | — | — |
| | | Modified | | | | | | | |
| | | SBR | | | | | | | |
| | | Acrylic | SG-P3 | 5.56 | 4.808 | — | — | 11.111 | 11.111 |
| | | Rubber | MEK 15% | | | | | | |
| | | | Solution | | | | | | |
| | | | SG-280 TEA | — | — | — | — | — | — |
| | | | Toluene/ | | | | | | |
| | | | Ethyl | | | | | | |
| | | | Acetate 15% | | | | | | |
| | | | Solution | | | | | | |
| | | | LA2140e | — | — | — | — | — | — |
| | | | LA2250 | — | — | — | — | — | — |
| | | | AR31 | | | | | | |
| | Polymer- | Photopoly- | IRGACURE 907 | — | — | — | — | — | — |
| | ization | merization | DETX-S | — | — | — | — | — | — |
| | Initiator | Initiator | | | | | | | |
| | | Thermal | AIBN | — | — | — | — | — | — |
| | | Polymer- | | | | | | | |
| | | ization | | | | | | | |
| | | Initiator | | | | | | | |

| | | | | | | |
|---|---|---|---|---|---|---|
| Percentage (wt %) of | — | — | — | — | — | — |
| Polymerization Initiator | | | | | | |
| to Rubber Component | | | | | | |

| | | | | | | | |
|---|---|---|---|---|---|---|---|
| Dispersant (wt %) (Percentage | BYK-2095 | — | — | — | — | — | — |
| to Boron Nitride Particles) | | | | | | | |

| | | | | | | | | |
|---|---|---|---|---|---|---|---|---|
| Evalua- | Thermal Conductivity (W/m · K) | Density | 1.88 | 1.95 | 1.16 | 1.10 | 1.20 | 1.15 |
| tion | | Thickness | 2.18 | 3.25 | 0.13 | 0.15 | 0.12 | 0.14 |
| | | Direction (TD) | | | | | | |
| | | Plane | 23.14 | 30.39 | 2.04 | 2.46 | 1.90 | 2.00 |
| | | Direction (PD) | | | | | | |
| | Tensile Test | Tensile Elastic | 404.99 | 528.29 | 0.28 | 41.65 | 0.83 | 0.38 |
| | | Modulus (N/m²) | | | | | | |

| | | | | | | | |
|---|---|---|---|---|---|---|---|
| Maximum | A*2 | 105.74 | 102.92 | 302.43 | 107.33 | 581.96 | 486.63 |
| Elongation | | | | | | | |
| (%) | | | | | | | |
| Constant | k | −0.059 | −0.059 | −0.045 | −0.011 | −0.068 | −0.059 |
| Amount of | Y*3 | 6.22 | 3.45 | 202.43 | 7.33 | 481.96 | 386.63 |
| Maximum | | | | | | | |
| Elongation | | | | | | | |
| (%) | | | | | | | |
| Maximum | Z*4 | 106.22 | 103.45 | 302.43 | 107.33 | 581.96 | 486.63 |
| Elongation | | | | | | | |
| (%) | | | | | | | |
| Elongation | C*5 | 111.13 | 105.80 | 1646.28 | 679.13 | 586.65 | 513.07 |
| at Time of | | | | | | | |
| Fracture | | | | | | | |
| (%) | | | | | | | |
| Constant | l | −0.051 | −0.051 | −0.048 | −0.063 | −0.059 | −0.051 |
| Amount of | V*6 | 11.63 | 6.98 | 1546.28 | 579.13 | 486.65 | 413.07 |
| Elongation | | | | | | | |
| at Time of | | | | | | | |
| Fracture | | | | | | | |
| Elongation | W*7 | 111.63 | 106.98 | 1646.28 | 679.13 | 586.65 | 513.07 |
| at Time of | | | | | | | |
| Fracture | | | | | | | |
| (%) | | | | | | | |

| | | | | | | | |
|---|---|---|---|---|---|---|---|
| Flexibility/Bend Test | JIS K5600-5-1 | Excel- | Excel- | Excel- | Excel- | Excel- | Excel- |
| | | lent | lent | lent | lent | lent | lent |
| Conformability to Irregularities/ | JIS K7171 | Excel- | Excel- | Excel- | Excel- | Excel- | Excel- |
| 3-Point Bending Test | (in 2008) | lent | lent | lent | lent | lent | lent |

| | | | | | | |
|---|---|---|---|---|---|---|
| 90 Degree Peel Adhesive Force (vs Copper Foil) (N/10 mm) | 3.79 | — | — | — | — | — |

*1: Number of parts by volume of epoxy resin/number of parts by volume of rubber component
*2Maximum elongation of thermally conductive sheet (measured value)
*3Amount of maximum elongation of thermally conductive sheet
*4Maximum elongation of thermally conductive sheet speculated from formulas (1) and (2) (estimate)
*5Elongation at the time of fracture of thermally conductive sheet (measured value)
*6Amount of elongation at the time of fracture of thermally conductive sheet
*7Elongation at the time of fracture of thermally conductive sheet speculated from formulas (3) and (4) (estimate)

TABLE 11

| Examples | | | Ex. 58 | Ex. 59 | Ex. 60 | Ex. 61 | Ex. 62 | Ex. 63 |
|---|---|---|---|---|---|---|---|---|
| Mixing | Boron Nitride Particles (g) (Percentage | PT-110 | 30.0 (67) | 30.0 (67) | 30.0 (67) | 30.0 (67) | 10.0 (63) | 10.0 (63) |
| Formula- | (vol %) to Total Amount of Boron Nitride | | | | | | | |
| tion of | Particles and Polymer Matrix) | | | | | | | |
| Compo- | Mg(OH)2 | MGZ-3 | — | — | — | — | 1.92 | 1.92 |

| | | | | | | | | |
|---|---|---|---|---|---|---|---|---|
| nents | Polymer | Content Ratio (vol %) of Polymer Matrix in | 33 | 33 | 33 | 33 | 25 | 25 |
| | Matrix | Thermally Conductive Sheet | | | | | | |

| Epoxy | Epoxy | Liquid | EXA-4850-1000 | — | — | — | 0.58 | — | — |
|---|---|---|---|---|---|---|---|---|---|
| Resin | Resin | | EXA-4850-150 | — | — | — | — | — | — |
| Composi- | | Semi-Solid | EG-200 | — | — | — | — | 0.93 | — |
| tion | | Solid | YSLV-80XY | 0.62 | 0.62 | 0.71 | — | — | — |
| | | | EPPN | — | — | 0.36 | — | — | — |
| | | | HP-7200 | 1.25 | 1.25 | 0.71 | 1.16 | — | 0.93 |
| | | | 1002 | — | — | — | — | — | — |
| | | | 1256 | — | — | — | — | — | — |
| | Volume Blending Ratio of Epoxy | | | 0.45 | 0.45 | 0.43 | 0.42 | 0.91 | 0.91 |
| | Resin to Rubber Component *1 | | | | | | | | |
| | Curing Agent • | | MEHC-7800S | — | — | — | — | — | — |
| | Curing Accelerator | | MEHC-7800SS | 1.37 | 1.37 | 1.47 | 1.52 | — | — |
| | | | 2MAOK-PW | 0.187 | 0.187 | 0.178 | 0.174 | — | — |
| | | | 2P4MHZ-PW | — | — | — | — | 0.093 | 0.093 |
| | Percentage (wt %) of Curing Agent • | | | 83.19 | 83.19 | 140.16 | 97.40 | 10.00 | 10.00 |
| | Curing Accelerator to Epoxy Resin | | | | | | | | |
| Rubber | Rubber | Acrylate- | Art-333 | — | — | — | — | — | — |
| Composi- | Compo- | Modified | Art-5507 | — | — | — | — | — | — |
| tion | nent | Urethane | | | | | | | |
| | | Rubber | | | | | | | |
| | | Carboxy- | XER-32C (NBR) | — | — | — | — | — | 0.85 |
| | | Modified | 1072J | — | — | — | — | — | — |
| | | NBR | DN631 | — | — | — | — | — | — |
| | | Styrene- | SIBSTAR | — | — | — | — | — | — |
| | | Isobutylene | | | | | | | |
| | | Rubber | | | | | | | |
| | | Modified | BR1220 | — | — | — | — | — | — |
| | | Poly- | PB3600 | — | — | — | — | — | — |
| | | butadiene | | | | | | | |
| | | Rubber | | | | | | | |
| | | Epoxy- | AT501 | — | — | — | — | — | — |
| | | Modified | | | | | | | |
| | | SBR | | | | | | | |
| | | Acrylic | SG-P3 | 22.9 | — | — | 22.9 | 5.69 | — |
| | | Rubber | MEK 15% | | | | | | |
| | | | Solution | | | | | | |
| | | | SG-80H | — | 19.0 | 19.0 | — | — | — |
| | | | MEK 18% | | | | | | |
| | | | Solution | | | | | | |
| | | | SG-280TEA | — | — | — | — | — | — |
| | | | LA2140e | — | — | — | — | — | — |
| | | | LA2250 | — | — | — | — | — | — |
| | | | AR31 | — | — | — | — | — | — |
| | Polymer- | Photopoly- | IRGACURE 907 | — | — | — | — | — | — |
| | ization | merization | DETX-S | — | — | — | — | — | — |
| | Initiator | Initiator | | | | | | | |
| | | Thermal | AIBN | — | — | — | — | — | — |
| | | Polymer- | | | | | | | |
| | | ization | | | | | | | |
| | | Initiator | | | | | | | |

| | | | | | | |
|---|---|---|---|---|---|---|
| Percentage (wt %) of | — | — | — | — | — | — |
| Polymerization Initiator | | | | | | |
| to Rubber Component | | | | | | |

| | | | | | | | |
|---|---|---|---|---|---|---|---|
| Dispersant (wt %) (Percentage to | BYK-2095 | — | — | — | — | — | — |
| Boron Nitride Particles) | | | | | | | |

| | | | | | | | | |
|---|---|---|---|---|---|---|---|---|
| Evalua- | Thermal Conductivity (W/m · K) | Density | 1.93 | 1.94 | 1.95 | 1.94 | 1.95 | 1.92 |
| tion | | Thickness | 2.23 | 2.10 | 2.27 | 2.68 | 2.57 | 3.12 |
| | | Direction (TD) | | | | | | |
| | | Plane | 23.7 | 25.7 | 24.6 | 25.6 | 24.9 | 21.0 |
| | | Direction (PD) | | | | | | |
| | Tensile Test | Tensile Elastic | 638.25 | 519.73 | 330.00 | 1029.97 | 808.2 | 244.4 |
| | | Modulus (N/m²) | | | | | | |

| | | | | | | | |
|---|---|---|---|---|---|---|---|
| Maximum | A*2 | 105.62 | 104.92 | 105.79 | 103.89 | 102.9 | 103.8 |
| Elongation | | | | | | | |
| (%) | | | | | | | |
| Elongation | C*3 | 109.26 | 109.68 | 113.96 | 106.23 | 103.3 | 104.6 |
| at Time of | | | | | | | |
| Fracture | | | | | | | |
| (%) | | | | | | | |

| | | | | | | | |
|---|---|---|---|---|---|---|---|
| Flexibility/Bend Test | JIS K5600-5-1 | Excel- | Excel- | Excel- | Excel- | Good | Good |
| | | lent | lent | lent | lent | | |
| Conformability to Irregularities/ | JIS K7171 | Excel- | Excel- | Excel- | Excel- | Excel- | Excel- |
| 3-Point Bending Test | (in 2008) | lent | lent | lent | lent | lent | lent |

| | | | | | | |
|---|---|---|---|---|---|---|
| 90 Degree Peel Adhesive Force (vs Copper Foil) (N/10 mm) | — | — | — | — | — | — |

*1: Number of parts by volume of epoxy resin/number of parts by volume of rubber component
*2Maximum elongation of thermally conductive sheet (measured value)
*3Elongation at the time of fracture of thermally conductive sheet (measured value)

TABLE 12

| | | | Examples • | | |
|---|---|---|---|---|---|
| | | | Comparative Examples | | |
| | | | | | Comp. |
| | | | Ex. 64 | Ex. 65 | Ex. 10 |
| Mixing | Boron Nitride Particles (g) (Percentage | PT-110 | 44.72 (70) | 44.72 (70) | 44.72 (70) |
| Formula- | (vol %) to Total Amount of Boron Nitride | | | | |
| tion of | Particles and Polymer Matrix) | | | | |

| | | | | | |
|---|---|---|---|---|---|
| Compo- | Polymer | Content Ratio (vol %) of Polymer Matrix in | 30 | 30 | 30 |
| nents | Matrix | Thermally Conductive Sheet | | | |

| Epoxy | Epoxy | Liquid | EXA-4850-1000 | — | — | — |
|---|---|---|---|---|---|---|
| Resin | Resin | | EXA-4850-150 | — | — | — |
| Composi- | | Semi-Solid | EG-200 | — | 4.976 | — |
| tion | | Solid | YSLV-80XY | — | — | 3.886 |
| | | | EPPN | — | — | — |
| | | | HP-7200 | — | — | — |
| | | | 1002 | 4.976 | — | — |
| | | | 1256 | — | — | 1.943 |
| | Volume Blending Ratio of Epoxy | | | 1.0 | 1.0 | — |
| | Resin to Rubber Component *1 | | | | | |
| | Curing Agent • | | MEHC-7800S | — | — | 2.03 |
| | Curing Accelerator | | MEHC-7800SS | — | — | 1.35 |
| | | | 2P4MHZ-PW | 0.0497 | 0.0497 | 0.1166 |
| | Percentage (wt %) of Curing Agent • | | | 1.0 | 1.0 | 37.5 |
| | Curing Accelerator to Epoxy Resin | | | | | |
| Rubber | Rubber | Acrylate- | Art-333 | — | — | — |
| Composi- | Compo- | Modified | MEK 75% | | | |
| tion | nent | Urethane | Solution | | | |
| | | Rubber | Art-5507 | — | — | — |
| | | | MEK 70.6% | | | |
| | | | Solution | | | |
| | | Carboxy- | XER-32C (NBR) | 4.976 | — | — |
| | | Modified | 1072J | — | — | — |
| | | NBR | DN631 | — | — | — |
| | | Styrene- | SIBSTAR | — | — | — |
| | | Isobutylene | | | | |
| | | Rubber | | | | |
| | | Modified | BR1220 | — | — | — |
| | | Poly- | PB3600 | — | — | — |
| | | butadiene | | | | |
| | | Rubber | | | | |
| | | Epoxy- | AT501 | — | — | — |
| | | Modified | | | | |
| | | SBR | | | | |
| | | Acrylic | SG-P3 MEK | — | 33.173 | — |
| | | Rubber | 15% Solution | | | |
| | | | SG-280 TEA | — | — | — |
| | | | Toluene/Ethyl | | | |
| | | | Acetate 15% | | | |
| | | | Solution | | | |
| | | | LA2140e | — | — | — |
| | | | LA2250 | — | — | — |
| | | | AR31 | — | — | — |
| | Polymer- | Photopoly- | IRGACURE 907 | — | — | — |
| | ization | merization | DETX-S | — | — | — |
| | Initiator | Initiator | | | | |
| | | Thermal | AIBN | — | — | — |
| | | Polymer- | | | | |
| | | ization | | | | |
| | | Initiator | | | | |

| | | | |
|---|---|---|---|
| Percentage (wt %) of | — | — | — |
| Polymerization Initiator | | | |
| to Rubber Component | | | |

| | | | | |
|---|---|---|---|---|
| Dispersant (wt %) (Percentage to | BYK-2095 | — | — | — |
| Boron Nitride Particles) | | | | |

| | | | | | |
|---|---|---|---|---|---|
| Evalua- | Thermal Conductivity (W/m · K) | Density | 1.87 | 1.78 | 1.76 |
| tion | | Thickness | 2.65 | 1.93 | 2.43 |
| | | Direction (TD) | | | |
| | | Plane | 25.65 | 21.29 | 25.75 |
| | | Direction (PD) | | | |
| | Tensile Test | Tensile Elastic | 203.87 | 255.53 | 1177.11 |
| | | Modulus (N/m²) | | | |

| | | | | |
|---|---|---|---|---|
| Maximum | A*2 | 103.04 | 105.22 | 100.12 |
| Elongation | | | | |
| (%) | | | | |
| Elongation | C*3 | 109.48 | 110.91 | 100.16 |
| at Time of | | | | |
| Fracture | | | | |
| (%) | | | | |

| Flexibility/Bend Test | JIS K5600-5-1 | Excel- | Excel- | Bad |
|---|---|---|---|---|
| | | lent | lent | |
| Conformability to Irregularities/ | JIS K7171 | Excel- | Excel- | Bad |
| 3-Point Bending Test | (in 2008) | lent | lent | |
| 90 Degree Peel Adhesive Force | | — | — | — |
| (vs Copper Foil) (N/10 mm) | | | | |
| Conformability to Unevenness | Conformability | Good | Good | Good |
| | Number of Crack | 0 | 0 | 14 |
| Viscoelasticity | Shear Storage | 33650 | 5829 | 5466 |
| | Elastic Modulus | | | |
| | G′ (Pa) | | | |
| | Shear Loss | 18460 | 1645 | 728 |
| | Elastic Modulus | | | |
| | G″ (Pa) | | | |
| | Complex Shear | 6108000 | 964000 | 877700 |
| | Viscosity η* | | | |
| | (mPa · s) | | | |

*1: Number of parts by volume of epoxy resin/number of parts by volume of rubber component
*2Maximum elongation of thermally conductive sheet (measured value)
*3Elongation at the time of fracture of thermally conductive sheet (measured value)

Next, Examples 1a to 5a, Reference Example 1a, and Comparative Examples 2a to 4a are described as Examples corresponding to the second embodiment.

### Example 1a

Components were blended in conformity with the mixing formulation (a varnish component) in Table 13 to be stirred for 10 minutes with a hybrid mixer, so that a varnish (a rubber-containing composition) in a whitening and dispersed state having a solid content of 25 mass % in Example 1a was prepared.

Next, boron nitride particles were added to the obtained varnish so that the solid content thereof was 70 vol % and the obtained mixture was stirred. Thereafter, MEK was volatilized by vacuum drying, so that a thermally conductive composition powder was obtained.

Next, the obtained thermally conductive composition powder was extended by applying pressure with a twin roll (a heating temperature of 70° C., a revolving rate of 1.0 rpm) using a polyester film (trade name: “SG-2”, manufactured by PANAC Corporation) as a release film, so that a pre-sheet was formed.

The pre-sheet was subjected to vacuum drying at 70° C. for five minutes at 50 Pa or less with a vacuum heating and pressing device and next, was subjected to pressure-pressing at 60 MPa for 10 minutes. Thereafter, depressurization was performed and the resulting sheet was allowed to cool to a room temperature, so that a thermally conductive sheet in Example 1a was obtained. The thermally conductive sheet in Example 1a had a thickness of 256 μm and was in a B-stage state.

### Examples 2a to 5a

Each of the varnishes in Examples 2a to 5a was prepared in the same manner as that in Example 1a, except that the mixing formulation of the varnish was changed to that shown in Table 13. Each of the thermally conductive sheets was obtained using the varnish in the same manner as that in Example 1a, except that the boron nitride particles were blended at the mixing proportion shown in Tables 13 and 14.

### Reference Example 1a and Comparative Examples 2a to 4a

Each of the varnishes in Reference Example 1a and Comparative Examples 2a to 4a was prepared in the same manner as that in Example 1a, except that the mixing formulation of the varnish was changed to that shown in Table 14. Each of the thermally conductive sheets was obtained using the varnish in the same manner as that in Example 1a, except that the boron nitride particles were blended at the mixing proportion shown in Table 14.

(Evaluation)

(1a) Thermal Conductivity Measurement

The thermal conductivity of each of the thermally conductive sheets in Examples 1a to 5a, Reference Example 1a, and Comparative Examples 2a to 4a was measured in the same manner as that in the above-described (1) Thermal Conductivity Measurement.

The results are shown in Tables 13 and 14.

(2a) Elastic Modulus Measurement (Shear Storage Elastic Modulus G′)

MEK was further added to each of the varnishes prepared in Examples 1a to 5a, Reference Example 1a, and Comparative Examples 2a to 4a as required, so that a varnish for elastic modulus measurement having a solid content of 25 mass % was prepared.

Each of the rubber-containing sheets (a sheet for elastic modulus measurement) having a thickness of 250 μm was obtained in the same manner as that in the above-described (7) Elastic Modulus Measurement, except that the varnish for elastic modulus measurement (a solid content of 25 mass %) was used, and the shear storage elastic modulus G′ of the rubber-containing sheet was measured (in the case of the varnishes in Comparative Examples 2a and 3a, non-rubber containing sheets). The results of the shear storage elastic modulus G′ at the attaching temperature (50 to 80° C.) are shown in Tables 13 and 14.

(3a) Epoxy Reaction Rate Measurement in Storage at Room Temperature (Storage Stability)

In each of the thermally conductive sheets fabricated in Examples 1a to 5a, Reference Example 1a, and Comparative Examples 2a to 4a, the thermally conductive sheet that was fabricated on the fabrication day was defined as a sample (the day of fabrication). Also, in each of the thermally conductive sheets fabricated in Examples and Reference Examples, the thermally conductive sheet that was stored at 30° C. for 30 days was defined as a sample (after storage at a room temperature). The reaction heat of each of the sample (the day of fabrication) and the sample (after storage at a room temperature) was analyzed by a DSC measurement.

To be specific, 5 to 15 mg of each of the samples was housed in a vessel made of aluminum of DSC (“Q-2000”, manufactured by TA Instruments Japan Inc.) and was crimped. Next, a DSC curve was obtained by increasing the temperature of the sample from 0 to 250° C. at a rate of 10° C./min under a nitrogen gas atmosphere. Then, the epoxy reaction rate was obtained from a heating value calculated from the DSC curve. That is, in the DSC curve, the area of the exothermic peak of the sample (the day of fabrication) and the area of the exothermic peak of the sample (after storage at a room temperature) were compared and calculated, so that the epoxy reaction rate was calculated.

In each of the samples (after storage at a room temperature) in Examples 1a to 5a, Reference Example 1a, and Comparative Examples 2a to 4a, a case where the epoxy reaction rate was less than 40% was evaluated as “Good” and a case where the epoxy reaction rate was 40% or more was evaluated as “Bad”.

The results are shown in Tables 13 and 14.

(4a) Epoxy Reaction Rate Measurement in Storage at 90° C. (Curability)

In each of the thermally conductive sheets fabricated in Examples 1a to 5a, Reference Example 1a, and Comparative Examples 2a to 4a, the thermally conductive sheet that was stored at 90° C. for one day was defined as a sample (after storage at 90° C.).

The DSC measurement was performed for the reaction rate of the sample (the day of fabrication) and the reaction rate of the sample (after storage at 90° C.) in the same manner as that in the above-described (3a) Epoxy Reaction Rate Measurement in Storage at Room Temperature, so that the epoxy reaction rate was calculated.

The results are shown in Tables 13 and 14.

(5a) Dielectric Breakdown Voltage Measurement

The dielectric breakdown voltage of each of the thermally conductive sheets fabricated in Examples 1a to 5a, Reference Example 1a, and Comparative Examples 2a to 4a was measured in conformity with JISC 2110 by the following method.

Each of the thermally conductive sheets in Examples 1a to 5a, Reference Example 1a, and Comparative Examples 2a to 4a was cut into a piece of 10 cm square to be cured by being stored in a drying oven at 150° C. for two hours, so that a thermally conductive sheet in a C-stage state was obtained. Then, the obtained thermally conductive sheet was defined as a sample. The dielectric breakdown voltage of the sample was measured under the conditions of a normal temperature in the air. To be specific, an electrode in a sphere shape was applied to the upper and lower side of the sample and a load of 500 g was applied thereto. Furthermore, the pressure in the sample was increased at a pressure rising rate of 0.5 kv/sec and a voltage at the time of fracture of the sample was measured as the dielectric breakdown voltage. The measurement result was converted into a thickness of 1 mm and was evaluated as follows.

A case where the dielectric breakdown voltage was 40 kV/mm or more was evaluated as “Good”. A case where the dielectric breakdown voltage was 40 kV/mm or less was evaluated as “Bad”.

The results are shown in Tables 13 and 14.

(6a) Conformability to Unevenness Test

The same mounted substrate 22 (ref: FIG. 7) as that in the above-described (6) was prepared.

The mounted substrate 22 was set in a precision heating and pressurizing device in which the temperature of the surface of the plate was heated at a predetermined attaching temperature (described in Tables 13 and 14) so that the electronic component thereon served as the upper surface. Each of the thermally conductive sheets 1 in Examples 1a to 5a, Reference Example 1a, and Comparative Examples 2a to 4a was set on the mounted substrate 22 (that is, so as to bring the electronic component 22 into contact with the thermally conductive sheet 1) and furthermore, the sponge 25 (trade name: Silicone Rubber Sponge Sheet, manufactured by OHYO) having a thickness of 5 mm was set thereon to be allowed to stand for a while. Thereafter, the thermally conductive sheet 1 was attached to the mounted substrate 22 by applying a pressure thereto at a predetermined pressure (described in Tables 13 and 14) for one minute.

For the mounted substrate 22 to which the thermally conductive sheet 1 was attached, a case where the thermally conductive sheet 1 was in contact with the surface of the substrate 20 and was also in contact with the side surface of the electronic component 21 in the mounted substrate 22 was evaluated as “Excellent”. A case where the thermally conductive sheet 1 was in contact with the surface of the substrate 20 and was not in contact with the side surface of the electronic component 21 in the mounted substrate 22 was evaluated as “Good”. A case where the thermally conductive sheet 1 was in contact with the electronic component 21 and was not in contact with the substrate 20 in the mounted substrate 22 was evaluated as “Bad”.

A presence or absence of a crack generated in the thermally conductive sheet 1 was evaluated. A case of absence of a crack was evaluated as “Good”. A case of presence of cracking was evaluated as “Poor”. A case of presence of fracture in the sheet was evaluated as “Bad”.

The results are shown in Tables 13 and 14.

(7a) Low-Temperature Bonding Properties Test

The mounted substrate with which the thermally conductive sheet was in tight contact obtained in the above-described (6a) Conformability to Unevenness Test was further heated at 90° C. for one hour, so that the thermally conductive sheet was bonded to the mounted substrate.

At the time of peeling the thermally conductive sheet 1 from the mounted substrate, a case where the thermally conductive sheet 1 was not peeled without being scraped off was evaluated as “Excellent”. A case where the thermally conductive sheet 1 was peeled by being broken was evaluated as “Good”. A case where the thermally conductive sheet 1 was peeled with its shape retained was evaluated as “Bad”.

The results are shown in Tables 13 and 14.

TABLE 13

| | | | Ex. 1a | Ex. 2a | Ex. 3a |
|---|---|---|---|---|---|
| Varnish | Epoxy | EXA-4850-1000 | 1 | 1 | |
| Component | Resin | HP-7200 | 1 | 1 | |
| | | EG-200 | | | 1 |
| | | YSLV-80XY | | | |
| | | JER1256 | | | |
| | | EPPN-501HY | | | |
| | Curing | MEH-7800-SS | 3.04 | 3.04 | |
| | Agent | | | | |
| | Curing | 2MAOK-PW | 0.2 | 0.2 | |
| | Accelerator | 2P4MHZ-PW | | | 0.1 |
| | Rubber | SG-P3 | 5.24 | | 1.1 |
| | Component*1 | SG-80H | | 5.24 | |
| | | SG-280TEA | | | |
| | Thixotropic | STN | | | |
| | Agent | | | | |
| | Dispersant | DISPERBYK- | | | |
| | | 2095 | | | |
| Boron Nitride | | PT-110 | 45.9 (69.9) | 45.9 (69.9) | 9.6 (69.9) |
| | | (vol %) | | | |
| | Thermal | Thickness | 2.28 | 1.86 | 2.18 |
| | Conduc- | Direction | | | |
| | tivity | (w/m · K) | | | |
| | | Plane | 28.0 | 24.7 | 23.1 |
| | | Direction | | | |
| | | (w/m · K) | | | |

| Dielectric Breakdown | Good | | | | Good | | | | Good | |
|---|---|---|---|---|---|---|---|---|---|---|
| Voltage (kV/mm) | | | | | | | | | | |
| Attaching Pressure (kN) | 0.3 | 0.3 | 0.5 | 0.5 | 0.15 | 0.3 | 0.5 | 0.5 | 0.15 | 0.15 |
| Attaching Temperature | 80 | 70 | 60 | 50 | 80 | 70 | 60 | 50 | 80 | 70 |
| (° C.) | | | | | | | | | | |
| Storage Elastic Modulus | 35350 | 36790 | 40200 | 29840 | 32000 | 28300 | 36700 | 52100 | 5829 | 6409 |
| at Attaching | | | | | | | | | | |
| Temperature(Pa) | | | | | | | | | | |
| Conformability to | Excel- | Excel- | Excel- | Good | Excel- | Excel- | Excel- | Excel- | Excel- | Excel- |
| Unevenness | lent | lent | lent | | lent | lent | lent | lent | lent | lent |
| Presence or Absence of | Good | Good | Good | Good | Poor | Good | Good | Good | Good | Good |
| Crack | | | | | | | | | | |
| Low-Temperature Bonding | Excel- | Excel- | Excel- | Excel- | Excel- | Excel- | Excel- | Excel- | Good | Good |
| Properties Test | lent | lent | lent | lent | lent | lent | lent | lent | | |

| | | | |
|---|---|---|---|
| Storage Stability (%) | 20 | — | — |
| (30° C., Storage for | | | |
| 30 Days) | | | |
| Curability (%) (90° C., | >95 | >95 | >95 |
| Storage for One Day) | | | |

| | | | Ex. 3a | Ex. 4a | Ex. 5a |
|---|---|---|---|---|---|
| Varnish | Epoxy | EXA-4850-1000 | | 1 | 1 |
| Component | Resin | HP-7200 | | 1 | 1 |
| | | EG-200 | 1 | | |
| | | YSLV-80XY | | | |
| | | JER1256 | | | |
| | | EPPN-501HY | | | |
| | Curing | MEH-7800-SS | | 3.04 | 3.04 |
| | Agent | | | | |
| | Curing | 2MAOK-PW | | 0.2 | 0.2 |
| | Accelerator | 2P4MHZ-PW | 0.1 | | |
| | Rubber | SG-P3 | 1.1 | | 12.1 |
| | Component*1 | SG-80H | | | |
| | | SG-280TEA | | 5.24 | |
| | Thixotropic | STN | | | |
| | Agent | | | | |
| | Dispersant | DISPERBYK- | | | |
| | | 2095 | | | |

| | | | | |
|---|---|---|---|---|
| Boron Nitride | PT-110 | 9.6 (69.9) | 45.9 (69.9) | 75.7 (69.9) |
| | (vol %) | | | |

| | | | | |
|---|---|---|---|---|
| Thermal | Thickness | 2.18 | 1.9 | 2.1 |
| Conduc- | Direction | | | |
| tivity | (w/m · K) | | | |
| | Plane | 23.1 | 22.3 | 22.9 |
| | Direction | | | |
| | (w/m · K) | | | |

| Dielectric Breakdown | Good | | Good | | Good | | |
|---|---|---|---|---|---|---|---|
| Voltage (kV/mm) | | | | | | | |
| Attaching Pressure (kN) | 0.2 | 0.5 | 0.5 | 0.5 | 0.5 | 0.5 | 0.5 |
| Attaching Temperature | 60 | 50 | 60 | 50 | 70 | 60 | 50 |
| (° C.) | | | | | | | |
| Storage Elastic Modulus | 8853 | 17230 | 17190 | 20730 | 38520 | 41480 | 45750 |
| at Attaching | | | | | | | |
| Temperature(Pa) | | | | | | | |
| Conformability to | Excel- | Excel- | Excel- | Excel- | Excel- | Excel- | Excel- |
| Unevenness | lent | lent | lent | lent | lent | lent | lent |
| Presence or Absence of | Good | Good | Good | Good | Good | Good | Good |
| Crack | | | | | | | |
| Low-Temperature Bonding | Good | Good | Excel- | Excel- | Excel- | Excel- | Excel- |
| Properties Test | | | lent | lent | lent | lent | lent |

| | | | |
|---|---|---|---|
| Storage Stability (%) | — | — | — |
| (30° C., Storage for | | | |
| 30 Days) | | | |
| Curability (%) (90° C., | >95 | >95 | >95 |
| Storage for One Day) | | | |

*1Rubber component represents mixing proportion (parts by mass) as solid content.

TABLE 14

| | | | Ref. Ex. 1a | Comp. Ex. 2a |
|---|---|---|---|---|
| Varnish | Epoxy | EXA-4850-1000 | | |
| Component | Resin | HP-7200 | | |
| | | EG-200 | | |
| | | YSLV-80XY | 1 | 1 |
| | | JER1256 | | 0.5 |
| | | EPPN-501HY | 3 | |
| | Curing | MEH-7800-SS | | 0.87 |
| | Agent | | | |
| | Curing | 2MAOK-PW | | |
| | Accelerator | 2P4MHZ-PW | 0.07 | 0.04 |
| | Rubber | SG-P3 | 1.03 | |
| | Component*1 | SG-80H | | |
| | | SG-280TEA | | |
| | Thixo- | STN | | 0.17 |
| | tropic | | | |
| | Agent | | | |
| | Dispersant | DISPERBYK- | | 0.32 |
| | | 2095 | | |
| Boron Nitride | | PT-110 | 23.0 (70.6) | 11.6 (68.0) |
| | | (vol %) | | |
| | Thermal | Thickness | 2.3 | 2.2 |
| | Conduc- | Direction | | |
| | tivity | (w/m · K) | | |
| | | Plane | 24.1 | 23.4 |
| | | Direction | | |
| | | (w/m · K) | | |

| Dielectric Breakdown | Good | | | | Good | | | |
|---|---|---|---|---|---|---|---|---|
| Voltage (kV/mm) | | | | | | | | |
| Attaching Pressure (kN) | 0.15 | 0.15 | 0.15 | 0.2 | 0.15 | 0.15 | 0.15 | 0.15 |
| Attaching Temperature | 80 | 70 | 60 | 50 | 80 | 70 | 60 | 50 |
| (° C.) | | | | | | | | |
| Storage Elastic Modulus | 1260 | 750 | 682 | 2234 | 5466 | 6103 | 9064 | 16010 |
| at Attaching | | | | | | | | |
| Temperature (Pa) | | | | | | | | |
| Conformability to | Excel- | Excel- | Excel- | Excel- | Excel- | Excel- | Excel- | Excel- |
| Unevenness | lent | lent | lent | lent | lent | lent | lent | lent |
| Presence or Absence of | Bad | Bad | Bad | Bad | Bad | Bad | Bad | Bad |
| Crack | | | | | | | | |
| Low-Temperature Bonding | Excel- | Excel- | Excel- | Excel- | Excel- | Excel- | Excel- | Excel- |
| Properties Test | lent | lent | lent | lent | lent | lent | lent | lent |

| | | |
|---|---|---|
| Storage Stability (%) | — | — |
| (30° C., Storage for | | |
| 30 Days) | | |
| Curability (%) (90° C., | >95 | >95 |
| Storage for One Day) | | |

| | | | Comp. Ex. 3a | Comp. Ex. 4 |
|---|---|---|---|---|
| Varnish | Epoxy | EXA-4850-1000 | 1 | |
| Com- | Resin | HP-7200 | | |
| ponent | | EG-200 | | |
| | | YSLV-80XY | | |
| | | JER1256 | 0.5 | |
| | | EPPN-501HY | | |
| | Curing | MEH-7800-SS | 0.41 | |
| | Agent | | | |
| | Curing | 2MAOK-PW | | |
| | Accelerator | 2P4MHZ-PW | 0.01 | |
| | Rubber | SG-P3 | | 1 |
| | Component*1 | SG-80H | | |
| | | SG-280TEA | | |
| | Thixo- | STN | | |
| | tropic | | | |
| | Agent | | | |
| | Dispersant | DISPERBYK- | 0.04 | |
| | | 2095 | | |

| | | | |
|---|---|---|---|
| Boron Nitride | PT-110 | 8.8 (70.4) | 4.3 (69.5) |
| | (vol %) | | |

| | | | |
|---|---|---|---|
| Thermal | Thickness | 2.2 | 2.75 |
| Conduc- | Direction | | |
| tivity | (w/m · K) | | |
| | Plane | 24.8 | 24.7 |
| | Direction | | |
| | (w/m · K) | | |

| Dielectric Breakdown | Good | | | Good | | | |
|---|---|---|---|---|---|---|---|
| Voltage (kV/mm) | | | | | | | |
| Attaching Pressure (kN) | 0.15 | 0.15 | 0.15 | 0.3 | 0.3 | 0.5 | 0.5 |
| Attaching Temperature | 80 | 70 | 60 | 80 | 70 | 60 | 50 |
| (° C.) | | | | | | | |
| Storage Elastic Modulus | 9490 | 19690 | 43680 | 60700 | 62900 | 71900 | 89300 |
| at Attaching | | | | | | | |
| Temperature (Pa) | | | | | | | |
| Conformability to | Excel- | Excel- | Excel- | Excel- | Excel- | Excel- | Bad |
| Unevenness | lent | lent | lent | lent | lent | lent | |
| Presence or Absence of | Bad | Bad | Bad | Good | Good | Bad | Bad |
| Crack | | | | | | | |
| Low-Temperature Bonding | Excel- | Excel- | Excel- | Bad | Bad | Bad | Bad |
| Properties Test | lent | lent | lent | | | | |

| | | |
|---|---|---|
| Storage Stability (%) | — | — |
| (30° C., Storage for | | |
| 30 Days) | | |
| Curability (%) (90° C., | 89 | — |
| Storage for One Day) | | |

*1Rubber component represents mixing proportion (parts by mass) as solid content.

Next, Examples 1b to 8b and Comparative Example 1b are described as Examples and Comparative Example corresponding to the third embodiment.

### Example 1b

### Covering Step

Components were blended and stirred in conformity with the mixing formulation described in Table 15, so that the liquid composition 3a (the varnish) was prepared.

After the charge air temperature of a tumbling fluidized coating device (“MP-01”, manufactured by Powrex Corp.) in FIG. 9 was adjusted to be 25° C., 600 g of the boron nitride particles were put from the input port into the inside of the chamber 42. The air 46 was sent (charged) from below of the chamber 42 upwardly and the stirring blade 33 was revolved, so that the prepared liquid composition 3a (1143 g) was sprayed from the spray port 37, while the boron nitride particles 2 were tumbled and fluidized. The liquid composition 3a (1143 g) was supplied to the inside of the chamber 42 at a liquid rate of 6 to 8 g/min for 163 minutes, so that the liquid composition 3a was attached to the boron nitride particles 2. Furthermore, the air was sent at 25° C. for 10 minutes, so that the liquid composition 3a that was attached to the boron nitride particles 2 was dried. Thereafter, the boron nitride particles 2 were taken out from the outlet port.

In this way, a particle aggregate powder (an average particle size of 294 μm) prepared from a resin-covered boron nitride particles in which the surfaces of the boron nitride particles 2 were covered with a resin component was obtained.

The mass ratio of the boron nitride particles 2 to the resin component was as follows: the boron nitride particles/the resin component=82/18.

Forming Step

Two pieces of rolls were prepared. A gap between the two pieces of the rolls was set to be 450 μm, the temperature of each of the rolls was increased to 70° C., and a gap between guides was adjusted to be 12 cm. Next, a separator (a polyester film, trade name: “PANA-PEEL TP-03”, manufactured by PANAC Co., Ltd., a thickness of 188 μm) having one surface subjected to treatment was set between the rolls. The revolving rate of roll was adjusted to be 1.0 rpm and the particle aggregate powder obtained in the description above was put into a nip portion of the two pieces of the rolls to be extended by applying pressure (a rolling pressure step), so that a pre-sheet (a thickness of 225 μm) was obtained.

Next, the obtained pre-sheet was set in a heating and pressing device.

To be specific, first, a silicone rubber was disposed on a pedestal (heated at 70° C.) of the vacuum heating and pressing device. Next, a release film (a polyester film, trade name: “SG2”, manufactured by PANAC Co., Ltd., 50 μm) was disposed on the silicone rubber and the above-described pre-sheet was disposed on the release film. Next, another release film and another silicone rubber were further disposed sequentially on the pre-sheet.

Next, a pressing plate was moved downwardly and the pre-sheet was hot pressed under a vacuum atmosphere of 10 Pa at 60 MPa at 70° C. for 10 minutes, so that the thermally conductive sheet 1 having a thickness of 207 μm was obtained. The obtained thermally conductive sheet 1 was in a B-stage state.

### Examples 2B to 5b

The thermally conductive sheet 1 was obtained in the same manner as that in Example 1b, except that the liquid composition was prepared at the mixing ratio described in Table 15.

### Example 6b

A particle aggregate powder was obtained in the same manner as that in Example 1b.

Two pieces of rolls were prepared. A gap between the two pieces of the rolls was set to be 450 μm, the temperature of each of the rolls was increased to 70° C., and a gap between guides was adjusted to be 12 cm. Next, a separator (a polyester film, trade name: “PANA-PEEL TP-03”, manufactured by PANAC Co., Ltd., a thickness of 188 μm) having one surface subjected to treatment was set between the rolls. The revolving rate of roll was adjusted to be 1.0 rpm and the particle aggregate powder obtained in the description above was put into a nip portion of the two pieces of the rolls to be subjected to a rolling pressure step, so that a pre-sheet A was formed.

Next, two pieces of the pre-sheets A were laminated and a rolling pressure step was performed by again putting the pre-sheets A into a gap of the two pieces of the rolls (a heating temperature of 70° C., a revolving rate of 1.0 rpm). By performing the rolling pressure steps with respect to the pre-sheet A by four times in total, a pre-sheet B was formed.

Next, the pre-sheet B was cut into a piece of 10 cm square and was set in a vacuum heating and pressing device under the same conditions as those in Example 1b to be hot pressed, so that the thermally conductive sheet 1 was obtained. The obtained thermally conductive sheet 1 was in a B-stage state.

### Example 7b

A particle aggregate powder was obtained in the same manner as that in Example 5b. The thermally conductive sheet 1 was obtained in the same manner as that in Example 6b, except that the obtained particle aggregate powder was used. The obtained thermally conductive sheet 1 was in a B-stage state.

### Example 8b

Components were blended and stirred in conformity with the mixing formulation described in Table 15 to be subjected to vacuum drying, so that a particle aggregate powder was obtained.

The thermally conductive sheet 1 was obtained in the same manner as that in Example 1b, except that the obtained particle aggregate powder was used. The obtained thermally conductive sheet 1 was in a B-stage state.

### Comparative Example 1b

The thermally conductive sheet 1 was obtained in the same manner as that in Example 8b, except that the mixing formulation described in Table 15 was used. The obtained thermally conductive sheet 1 was in a B-stage state.

[Table 15]

TABLE 15

| | Blending | | | | | | | | | | |
|---|---|---|---|---|---|---|---|---|---|---|---|
| | | Liquid Composition | | | | | | | | | |
| | Boron | Epoxy Resin(g) | | | | | Rubber (g) | Curing | | | |
| | Nitride | EXA- | | | | | SG-P3 | Agent (g) | | Curing | |
| | Particles (g) | 4850- | | YSLV- | | | (15% MEK | MEH- | MEH- | Accelerator(g) | |
| | PT110 | 1000 | HP7200 | 80XY | JER1256 | EG200 | Solution) | 7800-SS | 7800-S | 2MAOK-PW | 2P4MHZ-PW |
| Ex. 1b | 600 | 13.09 | 13.09 | | | | 457 | 39.78 | | 2.617 | |
| Ex. 2b | 600 | 13.09 | 13.09 | | | | 457 | 39.78 | | 2.617 | |
| Ex. 3b | 600 | 13.09 | 13.09 | | | | 457 | 39.78 | | 2.617 | |
| Ex. 4b | 600 | 13.09 | 13.09 | | | | 457 | 39.78 | | 2.617 | |
| Ex. 5b | 600 | | | | | 44.24 | 457 | 19.90 | | 4.424 | |
| Ex. 6b | 600 | 13.09 | 13.09 | | | | 457 | 39.78 | | 2.617 | |
| Ex. 7b | 600 | | | | | 44.24 | 457 | 19.90 | | 4.424 | |
| Ex. 8b | 409 | | | | | 45.69 | 254 | | | | 0.457 |
| Comp. | 409 | | | 17.98 | 35.97 | | | 12.52 | 18.77 | | 1.619 |
| Ex. 1b | | | | | | | | | | | |

| | Blending | | | | | | |
|---|---|---|---|---|---|---|---|
| | Liquid Composition | | | | | | |
| | | | | Total | Solid | | |
| | | | | Amount | Content | | Rolling |
| | Dispersant (g) | | | Liquid | Concen- | | Pressure |
| | DISPERBYK- | Solvent (g) | | Composi- | tration | Producing | Step |
| | 2095 | Acetone | MEK | tion (g) | (%) | Method | (times) |
| Ex. 1b | | 503 | 114 | 1143 | 12 | Tumbling | 1 |
| | | | | | | Fluidized | |
| Ex. 2b | | 389 | | 914 | 15 | Tumbling | 1 |
| | | | | | | Fluidized | |
| Ex. 3b | | 236 | | 762 | 18 | Tumbling | 1 |
| | | | | | | Fluidized | |
| Ex. 4b | | 160 | | 686 | 20 | Tumbling | 1 |
| | | | | | | Fluidized | |
| Ex. 5b | | 503 | 114 | 1143 | 12 | Tumbling | 1 |
| | | | | | | Fluidized | |
| Ex. 6b | | 503 | 114 | 1143 | 12 | Tumbling | 5 |
| | | | | | | Fluidized | |
| Ex. 7b | | 503 | 114 | 1143 | 12 | Tumbling | 5 |
| | | | | | | Fluidized | |
| Ex. 8b | | | | | | Vacuum | 1 |
| | | | | | | Drying | |
| Comp. | 6.129 | | | | | Vacuum | 1 |
| Ex. 1b | | | | | | Drying | |

(Evaluation)

(1b) Thermal Conductivity in Plane Direction

The thermal conductivity of each of the thermally conductive sheets in Examples 1b to 8b and Comparative Example 1b was measured in the same manner as that in the above-described (1) Thermal Conductivity Measurement.

The results are shown in Table 16.

(2b) Tack Force Measurement Test

The tack force of each of the thermally conductive sheets 1 was measured.

Each of the thermally conductive sheets 1 obtained in Examples 1b to 8b and Comparative Example 1b was cut into a circular shape having a diameter of 25 mm to obtain a cut piece. The cut piece was attached to the tip (a diameter of 20 mm) of a short needle of a texture analyzer (a compression-tensile test, trade name: Texture Analyzer (TA. XTPL/5), manufactured by EKO Instruments). The atmosphere temperature was set to be an arbitrary temperature with a thermostatic chamber attached to the texture analyzer. On the other hand, a glass epoxy substrate (manufactured by TopLine) was fixed to a falling position of the short needle.

Next, the short needle was allowed to fall slowly and the thermally conductive sheet 1 was brought into contact with the glass epoxy substrate at a load of 4 kg for 10 seconds. Thereafter, the short needle was pulled up at 10 mm/s, so that the thermally conductive sheet 1 was peeled from the glass epoxy substrate. The maximum load required at this time was measured.

The results are shown in Table 16.

(3b) TOF-SIMS Analysis

The analysis based on TOF-SIMS of each of the particle aggregate powders obtained in Examples 2b to 4b and Example 8b was performed and the ratio (C₇H₇⁺/B⁺) of a resin contributing ion (C₇H₇⁺) to a boron nitride contributing ion (r) was measured.

The measurement was performed under the conditions of primary ion: Bi₃²⁺, pressurized voltage: 25 kV, and measurement area: 200 μm square using TOF-SIMS (manufactured by ION-TOF GmbH) as a device.

The results are shown in Table 16.

(4b) Conformability to Unevenness Test

Each of the thermally conductive sheets 1 obtained in Examples 1b to 8b and Comparative Example 1b was subjected to a conformability to unevenness test at 60 to 90° C.

To be specific, the mounted substrate 22 (ref: FIG. 7) in which the thermally conductive sheet 1 conformed to the unevenness of the electronic components 21 was taken out from the lower metal mold 23 in the same manner as that in the above-described (6) Conformability to Unevenness Test, except that the temperature at the inside of the drying oven (ref: FIG. 8) was set to be 60 to 90° C. and the heating temperature of the thermally conductive sheet 1 was changed to 60 to 90° C.

For the mounted substrate 22, under the temperature conditions performed in the above-described test, a case where the thermally conductive sheet 1 was in contact with the surface of the substrate between the component “a” and the component “b” (a distance of 1.75 mm) in the mounted substrate 22 and where a crack or damage was not confirmed in the appearance of the thermally conductive sheet 1 was evaluated as “Good”. A case where the thermally conductive sheet 1 was not in contact with the surface of the substrate between the component “a” and the component “b” in the mounted substrate 22 or where a crack or damage was confirmed in the appearance of the thermally conductive sheet 1, even when the thermally conductive sheet 1 was in contact with the surface of the substrate between the component “a” and the component “b” in the mounted substrate 22, was evaluated as “Bad”.

The results are shown in Table 16.

(5b) Initial Bonding Properties Test

A test of allowing the mounted substrate 22 in which the thermally conductive sheet 1 conformed to the surface with unevenness obtained in the above-described Conformability to Unevenness Test to fall from a height of 30 cm was repeated by 10 times and the results were evaluated as follows.

Evaluation: “Good” The thermally conductive sheet was not peeled from the mounted substrate.

Evaluation: “Poor” The thermally conductive sheet was not peeled from the mounted substrate in a falling test performed by four to 10 times.

Evaluation: “Bad” The thermally conductive sheet was peeled from the mounted substrate in a falling test performed by one to three times.

(6b) Heat Bonding Properties Test

The mounted substrate 22 in which the thermally conductive sheet 1 conformed to the surface with unevenness obtained in the above-described Conformability to Unevenness Test was further heated at 150° C. for two hours, so that the thermally conductive sheet 1 was bonded to the mounted substrate 22 by heating.

Next, a test of allowing the mounted substrate 22 that was bonded by heating to fall from a height of 30 cm was performed by 10 times. A case where the thermally conductive sheet 1 was not peeled from the mounted substrate 22 was evaluated as “Good”. A case where the thermally conductive sheet 1 was peeled from the mounted substrate 22 was evaluated as “Bad”.

The results are shown in Table 16.

(7b) 90 Degree Peeling Test

The surface of each of the thermally conductive sheets in Examples 1b to 8b and Comparative Example 1b was overlapped with a rough surface (in conformity with JIS B0601 (in 1994)) of a copper foil (GTS-MP, manufactured by FURUKAWA ELECTRIC CO., LTD.) having a surface roughness Rz of 12 μm and a thickness of 70 μm so as to be in contact therewith, so that a copper foil laminated sheet sandwiched by the copper foil was fabricated. The fabricated copper foil laminated sheet was set in a vacuum heating and pressing device.

Next, each of the thermally conductive sheets in Examples 1b to 7b was pressed at 90° C. at 30 MPa for five minutes, after the vacuum drawing, to be extended by applying pressure and brought into tight contact with the copper foil. After the tight contact by applying pressure, the copper foil laminated sheet was retained at 90° C. for 24 hours or at 150° C. for one hour, so that the reaction was accelerated, so that the thermally conductive sheet 1 was brought from a B-stage state into a C-stage state and in this way, the thermally conductive sheet 1 was bonded to the copper foil.

On the other hand, each of the thermally conductive sheets in Example 8b and Comparative Example 1b was pressed at 30 MPa for 9 minutes, while the temperature was increased to be 150° C., and the thermally conductive sheet was extended by applying pressure and brought into tight contact with the copper foil to be furthermore, retained at 30 MPa for 10 minutes, so that reaction was accelerated, so that the thermally conductive sheet was brought from a B-stage state into a C-stage state. Thereafter, the thermally conductive sheet was taken out from the vacuum heating and pressing device and was put into a drying oven at 150° C. to be allowed to stand still for one hour. In this way, the thermally conductive sheet was bonded to the copper foil.

Next, the copper foil laminated sheet obtained in the description above was cut into a strip having a size of 1 cm×4 cm and the obtained strip was set in a tensile testing device (manufactured by Shimadzu Corporation, trade name: AGS-J). Subsequently, the 90 degree peel adhesive force at the time when the strip was peeled at an angle of 90 degrees with respect to the copper foil at a rate of 10 mm/min in the longitudinal direction of the strip was measured.

The results are shown in Table 16.

TABLE 16

| | Thermal Conductivity | | | | | | | | |
|---|---|---|---|---|---|---|---|---|---|
| | (W/m · K) | | Film | | Tack Force to Substrate | | | | |
| | Plane | Thickness | Thickness | Density | (g/φ2 cm) | | | | |
| | Direction | Direction | (g/cm1) | (g/cm2) | 25° C. | 40° C. | 50° C. | 60° C. | 70° C. |
| Ex. 1b | 19.8 | 1.88 | 207 | 1.90 | 4.08 | 17.8 | 177 | 544 | 1514 |
| Ex. 2b | 21.0 | 1.56 | 280 | 1.94 | 3.60 | 5.81 | 63.8 | 442 | 1150 |
| Ex. 3b | 23.8 | 1.47 | 255 | 1.94 | 2.82 | 4.07 | 22.3 | 188 | 807 |
| Ex. 4b | 20.5 | 1.64 | 257 | 1.94 | 2.62 | 4.55 | 11.0 | 164 | 836 |
| Ex. 5b | 21.1 | 1.69 | 217 | 1.94 | 3.29 | 5.91 | 137 | 722 | 1525 |
| Ex. 6b | 27.8 | 1.13 | 185 | 1.88 | 4.50 | 33.9 | 59.3 | 440 | 875 |
| Ex. 7b | 26.6 | 1.58 | 259 | 1.95 | 7.60 | 37.5 | 244 | 838 | 1327 |
| Ex. 8b | 23.1 | 2.18 | 229 | 1.88 | 17.5 | 27.0 | 500 | 624 | 540 |
| Comp. | 24.8 | 2.75 | 246 | 1.80 | 3.22 | 2.98 | 3.39 | 3.78 | 9.06 |
| Ex. 1b | | | | | | | | | |

| | | | | Conform- | | | |
|---|---|---|---|---|---|---|---|
| | Tack Force to Substrate | | TOF-SIMS | ability | Initial | Heat | |
| | (g/φ2 cm) | | (Strength | to Uneven- | Bonding | Bonding | 90 Degree |
| | 80° C. | 90° C. | Ratio) | ness | Properties | Properties | Peel Test |
| Ex. 1b | 2345 | 2339 | — | Good | Good | Good | 3.3 |
| Ex. 2b | 1324 | 2006 | 8.20 | Good | Good | Good | 3.1 |
| Ex. 3b | 1174 | 1468 | 5.60 | Good | Good | Good | 3.0 |
| Ex. 4b | 1332 | 1275 | 2.05 | Good | Good | Good | 3.2 |
| Ex. 5b | 1661 | 2067 | — | Good | Good | Good | 2.3 |
| Ex. 6b | 1787 | 1730 | — | Good | Good | Good | 1.1 |
| Ex. 7b | 2034 | 1612 | — | Good | Good | Good | 2.7 |
| Ex. 8b | 568 | 278 | 0.42 | Good | Poor | Good | 3.8 |
| Comp. | 25.2 | 306 | — | Bad | Bad | Bad | 2.6 |
| Ex. 1b | | | | | | | |

Next, Examples 1c to 8c and Comparative Example 1c are described as Examples and Comparative Example corresponding to the fourth embodiment.

### Example 1c

Components were blended and stirred in conformity with the mixing formulation described in Table 17 to be subsequently subjected to vacuum drying, so that a thermally conductive composition was obtained.

Two pieces of rolls were prepared. A gap between the two pieces of the rolls was set to be 450 μm, the temperature of each of the rolls was increased to 70° C., and a gap between guides was adjusted to be 12 cm. Next, a separator (a polyester film, trade name: “PANA-PEEL TP-03”, a thickness of 188 μm, manufactured by PANAC Co., Ltd.) having one surface subjected to treatment was set between the rolls. The revolving rate of roll was adjusted to be 1.0 rpm and the thermally conductive composition obtained in the description above was put into a nip portion of the two pieces of the rolls to be extended by applying pressure (a rolling pressure step), so that a pre-sheet (a thickness of 225 μm) was obtained.

Next, the obtained pre-sheet was set in a heating and pressing device.

To be specific, first, a silicone rubber was disposed on a pedestal (heated at 70° C.) of the vacuum heating and pressing device. Next, a release film (a polyester film, trade name: “SG2”, manufactured by PANAC Co., Ltd., 50 μm) was disposed on the silicone rubber and the above-described pre-sheet was disposed on the release film. Next, another release film and another silicone rubber were further disposed sequentially on the pre-sheet.

Next, the pedestal was moved upwardly and the pre-sheet was hot pressed under a vacuum atmosphere of 10 Pa at 60 MPa at 70° C. for 15 minutes, so that the thermally conductive sheet 1 was obtained.

The obtained thermally conductive sheet 1 was in a B-stage state.

### Examples 2c to 8c

Each of the thermally conductive sheets obtained in the above-described Examples 1b to 7b was prepared as each of the thermally conductive sheets in Examples 2c to 8c.

### Comparative Example 1c

The thermally conductive sheet 1 in Comparative Example 1c was obtained in the same manner as that in Example 2c, except that the liquid composition was prepared at the mixing proportion described in Table 17. The obtained thermally conductive sheet 1 was in a B-stage state.

TABLE 17

| | Blending | | | | | | | | | | |
|---|---|---|---|---|---|---|---|---|---|---|---|
| | | Liquid Composition | | | | | | | | | |
| | Boron | Epoxy Resin(g) | | | | | Rubber (g) | Curing | | | |
| | Nitride | EXA- | | | | | SG-P3 | Agent (g) | | Curing | |
| | Particles (g) | 4850- | | YSLV- | | | (15% MEK | MEH- | MEH- | Accelerator(g) | |
| | PT110 | 1000 | HP7200 | 80XY | JER1256 | EG200 | Solution) | 7800-SS | 7800-S | 2MAOK-PW | 2P4MHZ-PW |
| Ex. 1c | 3000 | 65.43 | 65.43 | | | | 2286 | 199 | | 13.09 | |
| Ex. 2c | 600 | 13.09 | 13.09 | | | | 457 | 39.78 | | 2.617 | |
| Ex. 3c | 600 | 13.09 | 13.09 | | | | 457 | 39.78 | | 2.617 | |
| Ex. 4c | 600 | 13.09 | 13.09 | | | | 457 | 39.78 | | 2.617 | |
| Ex. 5c | 600 | 13.09 | 13.09 | | | | 457 | 39.78 | | 2.617 | |
| Ex. 6c | 600 | | | | | 44.24 | 457 | 19.90 | | 4.424 | |
| Ex. 7c | 600 | 13.09 | 13.09 | | | | 457 | 39.78 | | 2.617 | |
| Ex. 8c | 600 | | | | | 44.24 | 457 | 19.90 | | 4.424 | |
| Comp. | 650 | | | 29.98 | 59.95 | | | 20.86 | 31.30 | | 2.698 |
| Ex. 1c | | | | | | | | | | | |

| | Blending | | | | | | |
|---|---|---|---|---|---|---|---|
| | Liquid Composition | | | | | | |
| | | | | Total | Solid | | |
| | | | | Amount | Content | | Rolling |
| | Dispersant (g) | | | Liquid | Concen- | | Pressure |
| | DISPERBYK- | Solvent (g) | | Compo- | tration | Producing | Step |
| | 2095 | Acetone | MEK | sition (g) | (%) | Method | (times) |
| Ex. 1c | | — | — | — | — | Vacuum | 1 |
| | | | | | | Drying | |
| Ex. 2c | | 503 | 114 | 1143 | 12 | Tumbling | 1 |
| | | | | | | Fluidized | |
| Ex. 3c | | 389 | | 914 | 15 | Tumbling | 1 |
| | | | | | | Fluidized | |
| Ex. 4c | | 236 | | 762 | 18 | Tumbling | 1 |
| | | | | | | Fluidized | |
| Ex. 5c | | 160 | | 686 | 20 | Tumbling | 1 |
| | | | | | | Fluidized | |
| Ex. 6c | | 503 | 114 | 1143 | 12 | Tumbling | 1 |
| | | | | | | Fluidized | |
| Ex. 7c | | 503 | 114 | 1143 | 12 | Tumbling | 5 |
| | | | | | | Fluidized | |
| Ex. 8c | | 503 | 114 | 1143 | 12 | Tumbling | 5 |
| | | | | | | Fluidized | |
| Comp. | 3.250 | 191 | 332 | 721 | 21 | Tumbling | 1 |
| Ex. 1c | | | | | | Fluidized | |

(Evaluation)

(1c) Thermal Conductivity Measurement

The thermal conductivity of each of the thermally conductive sheets in Examples 1c to 8c and Comparative Example 1c was measured in the same manner as that in the above-described (1) Thermal Conductivity Measurement.

The results are shown in Table 18.

TABLE 18

| | Thermal Conductivity | | | | Conformability to | | Dielectric | |
|---|---|---|---|---|---|---|---|---|
| | (W/m · K) | | Film | | Unevenness/Crack | | Breakdown | Low |
| | Plane | Thickness | Thickness | Density | Resistance | | Voltage | Temperature |
| | Direction | Direction | (g/cm1) | (g/cm2) | 60° C. | 70° C. | (kV/mm) | Curing Test |
| Ex. 1c | 28.0 | 2.28 | 258 | 1.92 | Good | Good | Excellent | Good |
| Ex. 2c | 19.8 | 1.88 | 207 | 1.90 | Good | Good | Excellent | Good |
| Ex. 3c | 21.0 | 1.56 | 280 | 1.94 | Good | Good | Excellent | Good |
| Ex. 4c | 23.8 | 1.47 | 255 | 1.94 | Good | Good | Excellent | Good |
| Ex. 5c | 20.5 | 1.64 | 257 | 1.94 | Good | Good | Excellent | Good |
| Ex. 6c | 21.1 | 1.69 | 217 | 1.94 | Good | Good | Excellent | Good |
| Ex. 7c | 27.8 | 1.13 | 185 | 1.88 | Good | Good | Excellent | Good |
| Ex. 8c | 26.6 | 1.58 | 259 | 1.95 | Good | Bad | Excellent | Good |
| Comp. | 23.4 | 2.15 | 300 | 1.82 | Bad | Bad | Good | Good |
| Ex. 1c | | | | | | | | |

(2c) Breaking Strain in Plane Direction PD

The breaking strain of each of the thermally conductive sheets in Examples 1c to 8c and Comparative Example 1c at each of the temperatures was measured by the following method.

To be specific, the temperature of the inside of a thermostatic chamber of a universal tensile and compression testing device (TG-10 kN, manufactured by Minebea Co., Ltd., Load Cell TT3D-1 kN) was set to be a predetermined temperature (described in Table 19) to be allowed to stand for 30 minutes, so that the temperature of the inside of the thermostatic chamber was stabilized at the above-described predetermined temperature. Next, the fabricated thermally conductive sheet was cut into a strip having a size of 1×4 cm and the obtained strip was set in a tensile testing device with paper put in the chuck portion. Next, after the sample was set, it was allowed to stand for five minutes until the stabilization at the above-described predetermined temperature.

Subsequently, the breaking strain at the time of pulling the strip at a rate of 5 mm/min in the longitudinal direction of the strip was measured.

The results are shown in Table 19.

TABLE 19

| | Breaking Strain (%) in Plane Direction | | | | | | |
|---|---|---|---|---|---|---|---|
| | 25° | 40° | 50° | 60° | 70° | 80° | 90° |
| | C. | C. | C. | C. | C. | C. | C. |
| Ex. 1c | 102.8 | 125.2 | 139.7 | 188.8 | 174.1 | 130.8 | 109.8 |
| Ex. 2c | 112.0 | 144.5 | 214.3 | 468.9 | 181.0 | 122.5 | 108.9 |
| Ex. 3c | 105.9 | 142.2 | 173.9 | 561.4 | 143.7 | 117.3 | 107.3 |
| Ex. 4c | 105.3 | 126.9 | 137.0 | 440.0 | 146.0 | 126.2 | 108.4 |
| Ex. 5c | 104.4 | 128.2 | 130.6 | 369.0 | 145.2 | 116.3 | 110.9 |
| Ex. 6c | 106.7 | 132.3 | 170.0 | 138.9 | 126.0 | 109.2 | 106.3 |
| Ex. 7c | 106.1 | 132.8 | 127.0 | 239.0 | 144.4 | 115.8 | 108.7 |
| Ex. 8c | 106.8 | 121.1 | 134.2 | 125.0 | 114.4 | 107.7 | 107.1 |
| Comp. | 100.6 | 102.7 | 108.6 | 113.5 | 112.8 | 107.2 | 106.4 |
| Ex. 1c | | | | | | | |

(3c) Elastic Modulus in Plane Direction PD

The elastic modulus of each of the thermally conductive sheets in Examples 1c to 8c and Comparative Example 1c at each of the temperatures was measured in the same manner as that in the above-described (2c) Breaking Strain.

The results are shown in Table 20.

TABLE 20

| | Elastic Modulus (N/mm2) in Plane Direction | | | | | | |
|---|---|---|---|---|---|---|---|
| | 25° | 40° | 50° | 60° | 70° | 80° | 90° |
| | C. | C. | C. | C. | C. | C. | C. |
| Ex. 1c | 1830 | 186 | 123 | 77.1 | 46.7 | 34.7 | 22.4 |
| Ex. 2c | 833 | 131 | 69.1 | 50.3 | 35.9 | 26.9 | 21.9 |
| Ex. 3c | 1680 | 262 | 119 | 59.1 | 38.2 | 28.2 | 20.6 |
| Ex. 4c | 1734 | 322 | 137 | 80.7 | 53.8 | 36.9 | 30.0 |
| Ex. 5c | 1810 | 285 | 116 | 71.5 | 44.7 | 29.4 | 26.1 |
| Ex. 6c | 1335 | 213 | 92.0 | 55.2 | 38.2 | 23.3 | 18.7 |
| Ex. 7c | 1763 | 214 | 126 | 87.3 | 56.8 | 36.9 | 22.6 |
| Ex. 8c | 1802 | 194 | 96.2 | 48.4 | 43.1 | 21.3 | 13.3 |
| Comp. | 5518 | 1407 | 444 | 137 | 61.1 | 24.3 | 12.8 |
| Ex. 1c | | | | | | | |

(4c) Conformability to Unevenness/Crack Resistance

Each of the thermally conductive sheets 1 in Examples 1c to 8c and Comparative Example 1c was subjected to a conformability to unevenness test at the temperature described in Table 18.

That is, the mounted substrate 22 (ref: FIG. 7) in which the thermally conductive sheet 1 conformed to the unevenness of the electronic components 21 was taken out from the lower metal mold 23 in the same manner as that in the above-described (6) Conformability to Unevenness Test, except that the temperature of the inside of the drying oven (ref: FIG. 8) was set to be 60° C. or 70° C. and the heating temperature of the thermally conductive sheet 1 was changed to 60° C. or 70° C.

For the mounted substrate 22, a case where the thermally conductive sheet 1 was in contact with the surface of the substrate between the component “a” and the component “b” (a distance of 1.75 mm) in the mounted substrate 22 and where a crack or damage was not confirmed in the appearance of the thermally conductive sheet 1 was evaluated as “Good”. A case where the thermally conductive sheet 1 was not in contact with the surface of the substrate between the component “a” and the component “b” in the mounted substrate 22 or where a crack or damage was confirmed in the appearance of the thermally conductive sheet 1, even when the thermally conductive sheet 1 was in contact with the surface of the substrate between the component “a” and the component “b” in the mounted substrate 22, was evaluated as “Bad”.

The results are shown in Table 18.

(5c) Needle Stick Test

The needle stick test was performed by the following method.

Each of the thermally conductive sheets in Examples 1c to 8c and Comparative Example 1c was cut into a square having a size of 3 cm×3 cm to obtain a cut piece. The cut piece was attached to a pedestal for a needle stick test of a texture analyzer (a compression-tensile test, trade name: Texture Analyzer (TA. XTPL/5), manufactured by EKO Instruments). The atmosphere temperature was set to be an arbitrary temperature with a thermostatic chamber attached to the texture analyzer.

Next, a short needle in a cylindrical shape (a diameter of 5 mm) was allowed to fall at a rate of 10 mm/min. The elongation (mm) in the thickness direction TD of the sheet at the time of fracture of piercing the thermally conductive sheet to be broken was measured and calculated as the elongation (mm/the thickness of the sheet of 200 μm) in the thickness direction TD per the thickness of the sheet of 200 μm. The elastic modulus (MPa) in the thickness direction TD at the time of fracture of piercing the thermally conductive sheet to be broken was also measured.

The results are shown in Tables 21 and 22.

TABLE 21

| | Elongation in Thickness Direction | | | | | | |
|---|---|---|---|---|---|---|---|
| | (mm/thickness of sheet of 200 μm) | | | | | | |
| | 25° | 40° | 50° | 60° | 70° | 80° | 90° |
| | C. | C. | C. | C. | C. | C. | C. |
| Ex. 1c | 1.00 | 1.56 | 1.77 | 1.89 | 2.02 | 2.10 | 1.92 |
| Ex. 2c | 0.92 | 1.46 | 1.74 | 1.98 | 2.30 | 2.67 | 1.76 |
| Ex. 3c | 0.57 | 0.99 | 1.45 | 1.86 | 2.16 | 2.58 | 1.57 |
| Ex. 4c | 0.63 | 1.04 | 1.47 | 1.78 | 2.05 | 2.84 | 1.93 |
| Ex. 5c | 0.60 | 1.06 | 1.41 | 1.63 | 2.21 | 2.06 | 1.85 |
| Ex. 6c | 0.78 | 1.29 | 1.63 | 1.86 | 1.92 | 1.65 | 1.40 |
| Ex. 7c | 0.62 | 1.14 | 1.35 | 1.61 | 1.71 | 1.94 | 1.74 |
| Ex. 8c | 0.85 | 1.52 | 1.89 | 2.09 | 2.01 | 1.66 | 1.43 |
| Comp. | 0.23 | 0.62 | 1.00 | 1.36 | 1.34 | 1.45 | 1.32 |
| Ex. 1c | | | | | | | |

TABLE 22

| | Elastic Modulus in Thickness Direction (MPa) | | | | | | |
|---|---|---|---|---|---|---|---|
| | 25° | 40° | 50° | 60° | 70° | 80° | 90° |
| | C. | C. | C. | C. | C. | C. | C. |
| Ex. 1c | 11.97 | 6.50 | 5.24 | 0.90 | 0.57 | 0.44 | 0.34 |
| Ex. 2c | 16.64 | 7.44 | 5.44 | 0.84 | 0.63 | 0.43 | 0.35 |
| Ex. 3c | 8.97 | 4.70 | 2.53 | 1.42 | 1.02 | 0.74 | 0.58 |
| Ex. 4c | 7.62 | 4.41 | 2.35 | 1.43 | 0.99 | 0.74 | 0.59 |
| Ex. 5c | 7.60 | 4.30 | 2.56 | 1.46 | 1.02 | 0.77 | 0.57 |
| Ex. 6c | 16.77 | 10.39 | 8.19 | 1.25 | 0.69 | 0.50 | 0.35 |
| Ex. 7c | 7.31 | 4.00 | 2.53 | 1.43 | 1.09 | 0.86 | 0.67 |
| Ex. 8c | 15.82 | 8.71 | 6.24 | 0.91 | 0.58 | 0.42 | 0.35 |
| Comp. | 7.68 | 3.05 | 2.05 | 1.15 | 0.73 | 0.39 | 0.35 |
| Ex. 1c | | | | | | | |

(6c) Dielectric Breakdown Voltage Measurement

The dielectric breakdown voltage of each of the thermally conductive sheets in Examples 1c to 8c and Comparative Example 1c was measured in the same manner as that in the above-described (5a) Dielectric Breakdown Voltage Measurement and was evaluated as follows.

Bad: less than 10 kV/mm

Poor: 10 kV/mm or more and less than 40 kV/mm

Good: 40 kV/mm or more and less than 50 kV/mm

Excellent: 50 kV/mm or more

The results are shown in Table 18.

(7c) Low Temperature Curing Test

In each of the thermally conductive sheets in Examples 1c to 8c and Comparative Example 1c, the thermally conductive sheet at the time of fabrication thereof was defined as a sample (before curing). Also, in each of the thermally conductive sheets fabricated in Examples 1c to 8c and Comparative Example 1c, the thermally conductive sheet that was stored under a temperature of 90° C. for 24 hours was defined as a sample (after curing). The reaction heat of each of the sample (before curing) and the sample (after curing) was analyzed by a DSC measurement.

To be specific, 10 to 20 mg of each of the samples was housed in a vessel made of aluminum of DSC (“Q-2000”, manufactured by TA Instruments Japan Inc.) and was crimped. Next, a DSC curve was obtained by increasing the temperature of the sample from 0 to 250° C. at a rate of 5° C./min under a nitrogen gas atmosphere. Then, the epoxy reaction rate was obtained from a heating value calculated from the DSC curve. That is, in the DSC curve, the area of the exothermic peak at 80 to 200° C. of the sample (before curing) and the area of the exothermic peak of the sample (after curing) were compared and calculated, so that the epoxy reaction rate was calculated.

A case where the reaction rate of the sample (after curing) was 90% or more was evaluated as “Good” and a case where the reaction rate of the sample (after curing) was less than 90% was evaluated as “Bad”.

The results are shown in Table 18.

Next, Examples 1d to 7d and Comparative Examples 1d to 3d are described as Examples and Comparative Examples corresponding to the fifth embodiment.

(Fabrication of Thermally Conductive Layer)

Components were blended and stirred in conformity with the mixing formulation shown in Table 23 to be subsequently subjected to vacuum drying, so that a mixture of a thermally conductive composition was prepared.

Next, the obtained mixture was fractured for 10 seconds with a pulverizer, so that a fined mixture powder was obtained.

Next, the obtained mixture powder was set in a twin roll.

To be specific, first, the rolls of the twin roll were heated at 70° C. Next, separators (polyester film, trade name: “PANA-PEEL TP-03”, manufactured by PANAC Co., Ltd.) were sandwiched between the rolls so that the release treated surfaces thereof faced inwardly and the mixture powder of the thermally conductive composition obtained in the description above was set between the separators. A pre-sheet was obtained by allowing the resulting mixture powder to be treated at a rate of 0.3 m/min.

Next, the obtained pre-sheet was cut into a piece of 10 cm square to be set in a vacuum heating and pressing device.

To be specific, first, a silicone rubber having a thickness of 1 mm was disposed on a hot plate of the vacuum heating and pressing device. Furthermore, a release film having the surface subjected to a silicone treatment was disposed and the pre-sheet that was fabricated in the description above was disposed on the release film. Next, a spacer made of brass and having a thickness of 200 μm was disposed on the release film in a frame shape so as to surround the pre-sheet. Next, the release film having the surface subjected to the silicone treatment was disposed on the spacer and the pre-sheet and furthermore, a silicone rubber having a thickness of 1 mm was disposed thereon. In this way, the pre-sheet was sandwiched between the two pieces of the release films in the thickness direction to be set in the vacuum heating and pressing device.

Next, hot pressing was performed under a vacuum atmosphere of 10 Pa at 60 MPa at 70° C. for 10 minutes, so that a thermally conductive layer having both surfaces thereof sandwiched between the release films and having a thickness of 176 μm was obtained.

The obtained thermally conductive layer was in a B-stage state and had rubber elasticity.

Also, the thermally conductive layer in a B-stage state was put in a drying oven at 150° C. to be heated for 60 minutes as required, so that the thermally conductive layer was thermally cured. In this way, a thermally conductive layer in a C-stage state was obtained.

(Fabrication of Adhesive Layer)

A mixture in the mixing formulation shown in Table 23 was added to a mixture solvent of acetone and MEK, so that a liquid mixture having a solid content of 15 mass % was prepared.

Next, the obtained liquid mixture was applied onto a release film with an applicator so that the film thickness (before drying) was 50 to 100 μm. Thereafter, the applied film was dried at 50° C. for 10 minutes with a drying oven to be further dried at 70° C. for 10 minutes, so that a solvent was removed and an adhesive layer (a film thickness of 9 μm) laminated on the release film was obtained.

The obtained adhesive layer was in a B-stage state and had tackiness at a normal temperature.

### Example 1d

The adhesive layer obtained in the description above was cut into a piece of 12 cm square. Next, the release film on one surface of the thermally conductive layer was peeled. The surface (the peeled surface) of the thermally conductive layer and the surface (the surface that was the opposite side to the surface on which the release film was laminated) of the adhesive layer were disposed on a hot plate heated at 70° C. to be allowed to stand still for 10 seconds and then, were attached to each other with a hand roller to be pressed, so that a thermally conductive sheet in Example 1d having both surfaces thereof sandwiched between the release films was obtained.

### Examples 2D to 7d

Each of the thermally conductive sheets in Examples 2d to 7d was obtained in the same manner, except that the mixing formulation of the thermally conductive layer and the adhesive layer was changed to the mixing formulation described in Table 23.

### Comparative Example 1d

A thermally conductive layer was obtained in the same manner, except that the mixing formulation of the thermally conductive layer was changed to the mixing formulation described in Table 23. The obtained thermally conductive layer was defined as a thermally conductive sheet in Comparative Example 1d.

### Comparative Example 2d

A thermally conductive layer was obtained in the same manner, except that the mixing formulation of the thermally conductive layer was changed to the mixing formulation described in Table 23. The obtained thermally conductive layer was defined as a thermally conductive sheet in Comparative Example 2d.

### Comparative Example 3d

A thermally conductive sheet was obtained in the same manner, except that the mixing formulation of the thermally conductive layer and the adhesive layer was changed to the mixing formulation described in Table 23. The obtained thermally conductive sheet was defined as a thermally conductive sheet in Comparative Example 3d.

(Evaluation)

(1d) Thermal Conductivity Measurement

The thermal conductivity of each of the thermally conductive layers (in a B-stage state) fabricated in Examples 1d to 7d and Comparative Examples 1d to 3d was measured in the same manner as that in the above-described (1) Thermal Conductivity Measurement.

The results are shown in Table 23.

(2d) Tack Force Measurement Test

The tack force of each of the thermally conductive sheets 1 was measured.

Each of the thermally conductive sheets 1 obtained in Examples 1d to 7d and Comparative Examples 1d to 3d was cut into a circular shape having a diameter of 10 mm. The cut thermally conductive sheet 1 was fixed to the tip (a diameter of 10 mm) of a short needle of a texture analyzer (a compression-tensile test, trade name: Texture Analyzer (TA. XTPL/5), manufactured by EKO Instruments) so that the thermally conductive layer 1a faced upwardly and the adhesive layer 5 faced downwardly. On the other hand, a glass epoxy substrate (manufactured by TopLine) was fixed to a falling position (a pedestal of the texture analyzer) of the short needle. In the fixing, a double-coated adhesive tape (manufactured by NITTO DENKO CORPORATION, “No. 500”) was used.

The atmosphere temperature was set to be an arbitrary temperature (25° C., 70° C.) with a thermostatic chamber attached to the texture analyzer. Next, the short needle was allowed to fall slowly and the adhesive layer 5 of the thermally conductive sheet 1 was brought into contact with the glass epoxy substrate at a load of 1 kg for 10 seconds. Thereafter, the short needle was pulled up at 10 mm/s, so that the thermally conductive sheet 1 was peeled from the glass epoxy substrate. The maximum load required at this time was measured.

The results are shown in Table 23.

(3d) Conformability to Unevenness/Crack Resistance Test

Each of the thermally conductive sheets 1 obtained in Examples 1d to 7d and Comparative Examples 1d to 3d was subjected to a conformability to unevenness test at 60° C. and 70° C.

To be specific, the mounted substrate 22 (ref: FIG. 7) in which the thermally conductive sheet 1 conformed to the unevenness of the electronic components 21 was taken out from the lower metal mold 23 in the same manner as that in the above-described (6) Conformability to Unevenness Test, except that the temperature of the inside of the drying oven (ref: FIG. 8) was set to be 60° C. and 70° C. and the heating temperature of the thermally conductive sheet 1 was changed to 60° C. and 70° C. The thermally conductive sheet 1 was disposed in the drying oven so that the adhesive layer 5 thereof was in contact with the electronic components 21.

For the mounted substrate 22, under any temperature conditions performed in the above-described test, a case where the thermally conductive sheet 1 was in contact with the surface of the substrate between the component “a” and the component “b” (a distance of 1.75 mm) in the mounted substrate 22 and where a crack or damage was not confirmed in the appearance of the thermally conductive sheet 1 was evaluated as “Good”. A case where the thermally conductive sheet 1 was not in contact with the surface of the substrate between the component “a” and the component “b” in the mounted substrate 22 or where a crack or damage was confirmed in the appearance of the thermally conductive sheet 1, even when the thermally conductive sheet 1 was in contact with the surface of the substrate between the component “a” and the component “b” in the mounted substrate 22, was evaluated as “Bad”.

The results are shown in Table 23.

(4d) Temporary Bonding Properties Test

The mounted substrate 22 with which each of the thermally conductive sheets 1 in Examples 1d to 7d and Comparative Examples 1d to 3d was in tight contact obtained in the conformability to unevenness test was brought back to a room temperature. A cut of 2 mm square in a parallel cross shape was made in the thermally conductive sheet 1 that was in tight contact the ceiling portion of the electronic component 21 (a) and the glass epoxy substrate 20 in the mounted substrate 22 in FIG. 7 and then, the mounted substrate 22 was allowed to fall from a height of 30 cm.

A case where “Good” was confirmed in the conformability to unevenness/crack resistance test and where a sheet or a sheet portion in which a cut in a parallel cross shape was made was not peeled was evaluated as “Good”. A case where only a sheet in which a cut in a parallel cross shape was made in the ceiling portion of the electronic component 21 (a) was peeled was evaluated as “Poor”. A case where a sheet or a sheet portion in which a cut in a parallel cross shape was made was peeled was evaluated as “Bad”. A case where “Bad” was confirmed in the conformability to unevenness/crack resistance test and where a sheet or a sheet portion in which a cut in a parallel cross shape was made was not peeled was evaluated as “Bad and Poor”.

The results are shown in Table 23.

(5d) Bonding Properties Test

The mounted substrate 22 with which each of the thermally conductive sheets 1 in Examples 1d to 7d and Comparative Examples 1d to 3d was in tight contact obtained in the conformability to unevenness test was further heated at 90° C. for one day, so that the thermally conductive sheet was bonded to the mounted substrate.

A case where “Good” was confirmed in the conformability to unevenness/crack resistance test and where a sheet or a sheet portion in which a cut in a parallel cross shape was made was not peeled was evaluated as “Good”. A case where only a sheet in which a cut in a parallel cross shape was made in the ceiling portion of the electronic component 21 (a) was peeled was evaluated as “Poor”. A case where a sheet or a sheet portion in which a cut in a parallel cross shape was made was peeled was evaluated as “Bad”. A case where “Bad” was confirmed in the conformability to unevenness/crack resistance test and where a sheet or a sheet portion in which a cut in a parallel cross shape was made was not peeled was evaluated as “Bad and Poor”.

The results are shown in Table 23.

(6d) Slide Test/Falling Test

By bringing the surface of the adhesive layer 5 of each of the thermally conductive sheets 1 in Examples 1d to 7d and Comparative Examples 1d to 3d into contact with a glass epoxy substrate at a normal temperature or 70° C., a temporary fixing was attempted.

To be specific, 2 cm square of the thermally conductive sheet 1 was disposed on the glass epoxy substrate (manufactured by TopLine) to be extended by applying pressure at a normal temperature with a load of 1 kg, so that the temporary fixing was performed. A case where the thermally conductive sheet 1 was not slid from the glass epoxy substrate, when the glass epoxy substrate that was temporarily fixed at a normal temperature was turned upside down, was evaluated as “Good”.

For the thermally conductive sheet 1 that was slid from the glass epoxy substrate in the temporary fixing at a normal temperature described above, after the temporary fixing was again performed by changing the temperature from the normal temperature to 70° C., the glass epoxy substrate was allowed to fall from a height of 1 m by three times. At this time, a case where the thermally conductive sheet 1 was not peeled from the glass epoxy substrate was evaluated as “Poor”. A case where the thermally conductive sheet 1 was peeled from the glass epoxy substrate was evaluated as “Bad”.

The results are shown in Table 23.

(7d) Dielectric Breakdown Voltage Measurement

The dielectric breakdown voltage of each of the thermally conductive sheets in Examples 1d to 7d and Comparative Examples 1d to 3d was measured in the same manner as that in the above-described (5a) Dielectric Breakdown Voltage Measurement and was evaluated as follows.

Bad: less than 30 kV/mm

Good: 30 kV/mm or more and less than 50 kV/mm

Excellent: 50 kV/mm or more

The results are shown in Table 23.

TABLE 23

| | | | Ex. 1d | Ex. 2d | Ex. 3d | Ex. 4d | Ex. 5d | Ex. 6d |
|---|---|---|---|---|---|---|---|---|
| Thermally | Boron Nitride | BN (PT110) | 1000 | 1000 | 1000 | 1000 | 1000 | 600 |
| Conductive | Particles | | | | | | | |
| Layer | Rubber | SG-P3 | 762 | 762 | 762 | 762 | 762 | 457 |
| | | (MEK 15% | | | | | | |
| | | Solution) | | | | | | |
| | | XER-32C | — | — | — | — | — | — |
| | Epoxy Resin | EXA-4850-1000 | 21.8 | 21.8 | 21.8 | 21.8 | 21.8 | — |
| | | YSLV-80XY | — | — | — | — | — | — |
| | | EG-200 | — | — | — | — | — | 44.2 |
| | | JER1002 | — | — | — | — | — | — |
| | | JER1256 | — | — | — | — | — | — |
| | | HP7200 | 21.8 | 21.8 | 21.8 | 21.8 | 21.8 | — |
| | Curing Agent | MEH-7800-SS | 66.3 | 66.3 | 66.3 | 66.3 | 66.3 | 19.9 |
| | | MEH-7800-S | — | — | — | — | — | — |
| | Dispersant | DIK2095 | — | — | — | — | — | — |
| | Curing | 2MAOK-PW | 4.36 | 4.36 | 4.36 | 4.36 | 4.36 | 4.424 |
| | Accelerator | 2P4MHZ-PW | — | — | — | — | — | — |
| Adhesive | Rubber | XER32C | — | 3.429 | — | — | — | — |
| Layer | | SG-P3 | 22.859 | — | — | — | — | — |
| | | (MEK 15% | | | | | | |
| | | Solution) | | | | | | |
| | | SG-280TEA | — | — | 22.859 | 22.859 | 22.859 | 22.859 |
| | | (15% | | | | | | |
| | | Solution) | | | | | | |
| | Epoxy Resin | EG-200 | — | — | — | — | 2.212 | — |
| | | YSLV-80XY | 0.918 | 0.918 | 0.918 | — | — | — |
| | | HP7200 | 0.918 | 0.918 | 0.918 | 1.948 | — | 1.948 |
| | Curing Agent | MEH-7800-SS | 1.409 | 1.409 | 1.409 | 1.286 | 0.995 | 1.286 |
| | Curing | 2MAOK-PW | 0.184 | 0.184 | 0.184 | 0.195 | 0.221 | 0.195 |
| | Accelerator | | | | | | | |
| | Thickness | | 9.0 | 6.2 | 4.0 | 6.4 | 3.8 | 4.8 |
| | (μm) | | | | | | | |
| Properties | Thermal | Thickness | 1.4 | 1.6 | 1.7 | 1.4 | 1.7 | 1.8 |
| | Conductivity | Direction | | | | | | |
| | (W/m/K) | Plane | 25.4 | 26.6 | 27.0 | 25.8 | 26.1 | 18.3 |
| | | Direction | | | | | | |
| | Tack Force | 25° C. | 2.72 | 912 | 2932 | 3698 | 1269 | 1867 |
| | (g/diameter | 70° C. | 2494 | 1593 | 1714 | 1529 | 1609 | 2021 |
| | of 10 mm) | | | | | | | |

| | | | | | | |
|---|---|---|---|---|---|---|
| Conformability to | Good | Good | Good | Good | Good | Good |
| Unevenness/Crack | | | | | | |
| Resistance Test | | | | | | |
| Temporary Bonding | Poor | Good | Good | Good | Good | Good |
| Properties Test | | | | | | |
| Bonding Properties Test | Good | Good | Good | Good | Good | Good |
| Slide Test/Falling Test | Poor | Good | Good | Good | Good | Good |
| Dielectric Breakdown | Excel- | Excel- | Excel- | Excel- | Excel- | Excel- |
| Voltage | lent | lent | lent | lent | lent | lent |

| | | | | Comp. | Comp. | Comp. |
|---|---|---|---|---|---|---|
| | | | Ex. 7d | Ex. 1d | Ex. 2d | Ex. 3d |
| Thermally | Boron Nitride | BN (PT110) | 409 | 409 | 403 | 403 |
| Conductive | Particles | | | | | |
| Layer | Rubber | SG-P3 | 254 | — | — | — |
| | | (MEK 15% | | | | |
| | | Solution) | | | | |
| | | XER-32C | — | — | — | — |
| | Epoxy Resin | EXA-4850-1000 | — | — | — | — |
| | | YSLV-80XY | — | 18.0 | — | — |
| | | EG-200 | 45.7 | — | 90.0 | 90.0 |
| | | JER1002 | — | — | — | — |
| | | JER1256 | — | 36.0 | — | — |
| | | HP7200 | — | — | — | — |
| | Curing Agent | MEH-7800-SS | — | 12.5 | — | — |
| | | MEH-7800-S | — | 18.8 | — | — |
| | Dispersant | DIK2095 | — | 6.129 | — | — |
| | Curing | 2MAOK-PW | — | — | — | — |
| | Accelerator | 2P4MHZ-PW | 0.457 | 1.619 | 0.900 | 0.900 |
| Adhesive | Rubber | XER32C | — | — | — | — |
| Layer | | SG-P3 | — | — | — | — |
| | | (MEK 15% | | | | |
| | | Solution) | | | | |
| | | SG-280TEA | 22.859 | — | — | 22.859 |
| | | (15% | | | | |
| | | Solution) | | | | |
| | Epoxy Resin | EG-200 | — | — | — | — |
| | | YSLV-80XY | — | — | — | — |
| | | HP7200 | 1.948 | — | — | 1.948 |
| | Curing Agent | MEH-7800-SS | 1.286 | — | — | 1.286 |
| | Curing | 2MAOK-PW | 0.195 | — | — | 0.195 |
| | Accelerator | | | | | |
| | Thickness | | 8.4 | — | — | 6.2 |
| | (μm) | | | | | |
| Properties | Thermal | Thickness | 1.9 | 2.8 | 2.1 | 1.7 |
| | Conductivity | Direction | | | | |
| | (W/m/K) | Plane | 22.7 | 24.8 | 23.9 | 21.5 |
| | | Direction | | | | |
| | Tack Force | 25° C. | 5022 | 1.90 | 2.14 | 2754 |
| | (g/diameter | 70° C. | 2203 | 96.4 | 642 | 2706 |
| | of 10 mm) | | | | | |

| | | | | |
|---|---|---|---|---|
| Conformability to | Good | Bad | Bad | Bad |
| Unevenness/Crack | | | | |
| Resistance Test | | | | |
| Temporary Bonding | Good | Bad | Bad | Bad and |
| Properties Test | | | | Poor |
| Bonding Properties Test | Good | Bad | Bad | Bad and |
| | | | | Poor |
| Slide Test/Falling Test | Good | Bad | Bad | Good |
| Dielectric Breakdown | Good | Good | Good | Good |
| Voltage | | | | |

Next, Examples 1e to 7e, Reference Example 1e, and Comparative Example 2e are described as Examples, Reference Example, and Comparative Example corresponding to the sixth embodiment.

### Example 1e

In order to have the mixing amount shown in Table 24, first, an epoxy resin and an MEK solution with a concentration of 15 mass % of acrylic rubber were weighed. MEK was added thereto and was dissolved with an ultrasonic cleaning device. Thereafter, a curing agent, a curing accelerator, and boron nitride particles were sequentially mixed thereto and the MEK was volatilized by reduced pressure drying to be fractured with a pulverizer, so that a thermally conductive composition powder was obtained.

Next, the obtained thermally conductive composition powder was extended by applying pressure with a twin roll (a heating temperature of 70° C., a revolving rate of 1.0 rpm) using a polyester film (trade name: “SG-2”, manufactured by PANAC Co., Ltd.) as a release film, so that a pre-sheet was formed.

The pre-sheet was subjected to vacuum drying at 70° C. for five minutes with a vacuum heating and pressing device and next, after pressure-pressing was performed at 60 MPa for 10 minutes, depressurization was performed and the resulting pre-sheet was allowed to cool till the room temperature. In this way, a thermally conductive layer was obtained. The thermally conductive layer had a thickness of 200 μm.

The obtained thermally conductive layer was in a B-stage state and had rubber elasticity.

Next, as a pressure-sensitive adhesive layer, a pressure-sensitive adhesive sheet (an ultrathin double-coated adhesive tape No. 5600, manufactured by NITTO DENKO CORPORATION, a layer thickness excluding the release film of 5 μm, thermal conductivity of 0.10 W/m·k) in which an acrylic pressure-sensitive adhesive layer (a thickness of 2 μm, an alkyl(meth)acrylate), a substrate film (a thickness of 1 μm, a polyester film), and an acrylic pressure-sensitive adhesive layer (a thickness of 2 μm, an alkyl(meth)acrylate) were sequentially laminated on a release film (a thickness of 75 μm, a polyester film) was prepared. By attaching the thermally conductive layer obtained in the description above onto the acrylic pressure-sensitive adhesive sheet using a roller, a thermally conductive sheet in Example 1e was obtained.

### Example 2e

A thermally conductive sheet in Example 2e was fabricated in the same manner as that in Example 1e, except that a pressure-sensitive adhesive sheet (an ultrathin double-coated adhesive tape No. 5601, manufactured by NITTO DENKO CORPORATION, a layer thickness excluding the release film of 10 μm, thermal conductivity of 0.10 W/m·k) in which an acrylic pressure-sensitive adhesive layer (a thickness of 4.5 μm, an alkyl(meth)acrylate), a substrate film (a thickness of 1 μm, a polyester film), and an acrylic pressure-sensitive adhesive layer (a thickness of 4.5 μm, an alkyl(meth)acrylate) were sequentially laminated on a release film (a thickness of 75 μm, a polyester film) was prepared instead of the pressure-sensitive adhesive sheet (an ultrathin double-coated adhesive tape No. 5600, manufactured by NITTO DENKO CORPORATION, a layer thickness excluding the release film of 5 μm).

### Example 3e

A thermally conductive sheet in Example 3e was fabricated in the same manner as that in Example 1e, except that a pressure-sensitive adhesive sheet (an ultrathin double-coated adhesive tape No. 5603, manufactured by NITTO DENKO CORPORATION, a layer thickness excluding the release film of 30 μm, thermal conductivity of 0.10 W/m·k) in which an acrylic pressure-sensitive adhesive layer (a thickness of 14.5 μm, an alkyl(meth)acrylate), a substrate film (a thickness of 1 μm, a polyester film), and an acrylic pressure-sensitive adhesive layer (a thickness of 14.5 μm, an alkyl(meth)acrylate) were sequentially laminated on a release film (a thickness of 75 μm, a polyester film) was prepared instead of the pressure-sensitive adhesive sheet (an ultrathin double-coated adhesive tape No. 5600, manufactured by NITTO DENKO CORPORATION, a layer thickness excluding the release film of 5 μm).

### Example 4e

A thermally conductive sheet in Example 4e was fabricated in the same manner as that in Example 1e, except that the mixing formulation of the thermally conductive composition was changed to the mixing formulation shown in Table 24.

### Example 5e

A thermally conductive sheet in Example 5e was fabricated in the same manner as that in Example 4e, except that a pressure-sensitive adhesive sheet (an ultrathin double-coated adhesive tape No. 5601, manufactured by NITTO DENKO CORPORATION, a layer thickness excluding the release film of 10 μm) was prepared instead of the pressure-sensitive adhesive sheet (an ultrathin double-coated adhesive tape No. 5600, manufactured by NITTO DENKO CORPORATION, a layer thickness excluding the release film of 5 μm).

### Example 6e

A thermally conductive sheet in Example 6e was fabricated in the same manner as that in Example 4e, except that a pressure-sensitive adhesive sheet (an ultrathin double-coated adhesive tape No. 5603, manufactured by NITTO DENKO CORPORATION, a layer thickness excluding the release film of 30 μm) was prepared instead of the pressure-sensitive adhesive sheet (an ultrathin double-coated adhesive tape No. 5600, manufactured by NITTO DENKO CORPORATION, a layer thickness excluding the release film of 5 μm).

### Example 7e

A thermally conductive sheet in Example 7e was fabricated in the same manner as that in Example 1e, except that an acrylic pressure-sensitive adhesive layer (a thickness of 5 μm, an alkyl(meth)acrylate) was prepared instead of the pressure-sensitive adhesive sheet (an ultrathin double-coated adhesive tape No. 5600, manufactured by NITTO DENKO CORPORATION, a layer thickness excluding the release film of 5 μm).

### Reference Example 1e

A thermally conductive sheet in Reference Example 1e was fabricated in the same manner as that in Example 1e, except that the pressure-sensitive adhesive sheet was not attached. That is, the thermally conductive layer only fabricated in Example 1e was defined as the thermally conductive sheet in Reference Example 1e.

### Comparative Example 2e

A thermally conductive sheet in Comparative Example 2e was fabricated in the same manner as that in Example 1e, except that the mixing formulation of the thermally conductive composition was changed to the mixing formulation shown in Table 24.

(Evaluation)

(1e) Thermal Conductivity Measurement

The thermal conductivity of each of the thermally conductive layers in Examples 1e to 7e, Reference Example 1e, and Comparative Example 2e was measured in the same manner as that in the above-described (1) Thermal Conductivity Measurement.

The results are shown in Table 24.

(2e) Conformability to Unevenness Test (at 80° C.)

Each of the thermally conductive sheets 1 obtained in Examples 1e to 7e, Reference Example 1e, and Comparative Example 2e was subjected to a conformability to unevenness test at 80° C.

To be specific, the mounted substrate 22 (ref: FIG. 7) in which the thermally conductive sheet 1 was attached to the unevenness of the electronic components 21 was taken out from the lower metal mold 23 in the same manner as that in the above-described (6) Conformability to Unevenness Test, except that the temperature of the inside of the drying oven (ref: FIG. 8) was set to be 80° C., the heating temperature of the thermally conductive sheet 1 was changed to 80° C., and the standing duration of the thermally conductive sheet 1 at the inside of the drying oven was changed to 60 minutes. The thermally conductive sheet 1 was set in the drying oven so that the pressure-sensitive adhesive layer 6 thereof was in contact with the electronic components 21.

For the mounted substrate 22, a case where the thermally conductive sheet 1 was in contact with the surface of the substrate between the component “a” and the component “b” (a distance of 1.75 mm) in the mounted substrate 22 and where the occurrence of a crack was not confirmed in the thermally conductive sheet 1 was evaluated as “Pass”. On the other hand, a case where a gap was generated between the thermally conductive sheet 1 and the surface of the mounted substrate 22 (between the component “a” and the component “b”) or where the occurrence of a crack was confirmed in the thermally conductive sheet 1 in a portion other than one portion in contact with the corner of the component “a”, even when the thermally conductive sheet 1 was in contact with the surface of the mounted substrate 22 (between the component “a” and the component “b”), was evaluated as “Failure”.

Three pieces of each of the thermally conductive sheets 1 in Examples 1e to 7e, Reference Example 1e, and Comparative Example 2e were prepared and the conformability to unevenness test were performed by three times. As a result, a case of having three times of “Pass” was evaluated as “Good”. A case of having twice of “Pass” was evaluated as “Poor”. A case of having three times of “Failure” was evaluated as “Bad”.

The results are shown in Table 24.

(3e) Peel Strength Test (at 80° C.)

The peel strength of the mounted substrate to which the thermally conductive sheet was attached obtained in the above-described (2e) Conformability to Unevenness Test (at 80° C.) was measured using a micro part cutting device (SAICAS, manufactured by DAYPLA WINTES CO., LTD.). First, the mounted substrate to which the thermally conductive sheet was attached was set in SAICAS; a cutting edge of a diamond blade having a width of 1 mm was pressed onto a portion of the thermally conductive sheet that was not in tight contact with the electronic component (that is, a portion that was directly in tight contact with the substrate); a cutting was made obliquely into the inside of the sheet at a predetermined rate of horizontal/vertical component (horizontal=10 μm·s⁻¹, vertical=1 μm·s⁻¹) (an obliquely cutting step); and then, a cutting was made horizontally from the vicinity of the interface between the pressure-sensitive adhesive sheet and the substrate (a horizontally cutting step). An applied force to the blade in the horizontal/vertical direction was detected with a load cell and simultaneously, a difference of elevation between a sample surface and a position of the blade in the vertical direction was detected with a displacement sensor to be measured as a depth of cutting.

According to the measurement, a case where peeling between the thermally conductive sheet and the substrate was confirmed in the horizontally cutting step was evaluated as “Good”. A case where peeling between the thermally conductive sheet and the substrate was confirmed in the obliquely cutting step was evaluated as “Poor”. A case where peeling between the thermally conductive sheet and the substrate was confirmed immediately after pressing the cutting edge onto the thermally conductive sheet was evaluated as “Bad”.

The results are shown in Table 24.

(4e) Dielectric Breakdown Voltage Measurement

The dielectric breakdown voltage of each of the thermally conductive sheets fabricated in Examples 1e to 7e, Reference Example 1e, and Comparative Example 2e was measured in the same manner as that in the above-described (5a) Dielectric Breakdown Voltage Measurement and was evaluated as follows.

Bad: less than 10 kV/mm

Poor: 10 kV/mm or more and less than 40 kV/mm

Good: 40 kV/mm or more

The results are shown in Table 24.

TABLE 24

| | | | Ex. 1e | Ex. 2e | Ex. 3e | Ex. 4e | Ex. 5e |
|---|---|---|---|---|---|---|---|
| Thermally | Boron Nitride | BN (PT110) | 6.71 (70) | 6.71 (70) | 6.71 (70) | 6.71 (70) | 6.71 (70) |
| Conductive | Particles | | | | | | |
| Layer | (vol % in | | | | | | |
| | solid content) | | | | | | |
| | Solid Epoxy | YSLV-80XY | 0.422 | 0.422 | 0.422 | — | — |
| | Resin | | | | | | |
| | Solid Epoxy | EPPN-501HY | 0.211 | 0.211 | 0.211 | — | — |
| | Resin | | | | | | |
| | Liquid Epoxy | EXA-4850-1000 | — | — | — | 0.145 | 0.145 |
| | Resin | | | | | | |
| | Solid Epoxy | HP-7200 | — | — | — | 0.145 | 0.145 |
| | Resin | | | | | | |
| | Solid Epoxy | JER 1256 | — | — | — | — | — |
| | Resin | | | | | | |
| | Rubber | SG-P3 | 1.500 | 1.500 | 1.500 | 5.001 | 5.001 |
| | | (MEK 15% | | | | | |
| | | Solution) | | | | | |
| | Curing Agent | MEH-7800-SS | 0.579 | 0.579 | 0.579 | 0.432 | 0.432 |
| | Curing Agent | MEH-7800-S | — | — | — | — | — |
| | Curing | 2P4MHZ-PW | 0.063 | 0.063 | 0.063 | — | — |
| | Accelerator | | | | | | |
| | Curing | 2MAOK-PW | — | — | — | 0.029 | 0.029 |
| | Accelerator | | | | | | |
| Pressure- | Acrylic | Total Film | 5 | 10 | 30 | 5 | 10 |
| Sensitive | Pressure- | Thickness | | | | | |
| Adhesive | Sensitive | (μm) | | | | | |
| Layer | Adhesive | | | | | | |
| | Layer/ | | | | | | |
| | Substrate/ | | | | | | |
| | Acrylic | | | | | | |
| | Pressure- | | | | | | |
| | Sensitive | | | | | | |
| | Adhesive | | | | | | |
| | Layer | | | | | | |
| Properties • | Thermal | Thickness | 2.4 | 1.9 | 1.2 | 1.5 | 1.3 |
| Evaluation | Conduc- | Direction | | | | | |
| | tivity | Plane | 30.9 | 28.6 | 24.4 | 26.8 | 25.1 |
| | (W/m · K) | Direction | | | | | |

| | | | | | |
|---|---|---|---|---|---|
| Conformability to | Good | Good | Good | Good | Good |
| Unevenness Test | | | | | |
| (at 80° C.) | | | | | |
| Peel Strength Test | Good | Poor | Poor | Good | Poor |
| (at 80° C.) | | | | | |
| Dielectric Breakdown | Good | Good | Good | Good | Good |
| Voltage Measurement | | | | | |

| | | | | | Ref. | Comp. |
|---|---|---|---|---|---|---|
| | | | Ex. 6e | Ex. 7e | Ex. 1e | Ex. 2e |
| Thermally | Boron Nitride | BN (PT110) | 6.71 (70) | 6.71 (70) | 6.71 (70) | 6.71 (70) |
| Conductive | Particles | | | | | |
| Layer | (vol % in | | | | | |
| | solid content) | | | | | |
| | Solid Epoxy | YSLV-80XY | — | 0.422 | — | 1.000 |
| | Resin | | | | | |
| | Solid Epoxy | EPPN-501HY | — | 0.211 | — | — |
| | Resin | | | | | |
| | Liquid Epoxy | EXA-4850-1000 | 0.145 | — | 0.145 | — |
| | Resin | | | | | |
| | Solid Epoxy | HP-7200 | 0.145 | — | 0.145 | — |
| | Resin | | | | | |
| | Solid Epoxy | JER 1256 | — | — | — | 1.000 |
| | Resin | | | | | |
| | Rubber | SG-P3 | 5.001 | 1.500 | 5.001 | — |
| | | (MEK 15% | | | | |
| | | Solution) | | | | |
| | Curing Agent | MEH-7800-SS | 0.432 | 0.579 | 0.432 | 0.220 |
| | Curing Agent | MEH-7800-S | — | — | — | 0.330 |
| | Curing | 2P4MHZ-PW | — | 0.063 | — | 0.010 |
| | Accelerator | | | | | |
| | Curing | 2MAOK-PW | 0.029 | — | 0.029 | — |
| | Accelerator | | | | | |
| Pressure- | Acrylic | Total Film | 30 | 5⁽*¹⁾ | 0 | 5 |
| Sensitive | Pressure- | Thickness | | | | |
| Adhesive | Sensitive | (μm) | | | | |
| Layer | Adhesive | | | | | |
| | Layer/ | | | | | |
| | Substrate/ | | | | | |
| | Acrylic | | | | | |
| | Pressure- | | | | | |
| | Sensitive | | | | | |
| | Adhesive | | | | | |
| | Layer | | | | | |
| Properties • | Thermal | Thickness | 0.8 | 0.8 | 1.7 | 1.6 |
| Evaluation | Conduc- | Direction | | | | |
| | tivity | Plane | 21.6 | 18.9 | 27.1 | 18.7 |
| | (W/m · K) | Direction | | | | |

| | | | | |
|---|---|---|---|---|
| Conformability to | Good | Poor | Good | Bad |
| Unevenness Test | | | | |
| (at 80° C.) | | | | |
| Peel Strength Test | Poor | Good | Bad | Bad |
| (at 80° C.) | | | | |
| Dielectric Breakdown | Good | Good | Good | Good |
| Voltage Measurement | | | | |

⁽*¹⁾Film thickness of single layer of acrylic pressure-sensitive adhesive layer is shown.

In Tables 1 to 12 and 15 to 24, values for the components are in grams unless otherwise specified. In Tables 13 and 14, values for the components are parts by mass.

Abbreviations in Tables are described in detail in the following.
PT-110: trade name, boron nitride particles in a plate shape, an average particle size (a laser diffraction scattering method) of 45 μm, manufactured by Momentive Performance Materials Japan Inc.
MGZ-3: trade name, magnesium hydroxide, an average particle size of 0.1 μm, manufactured by SAKAI CHEMICAL INDUSTRY CO., LTD.
EXA-4850-1000: trade name: “EPICLON EXA-4850-1000”, a bisphenol A epoxy resin, an epoxy equivalent of 310 to 370 g/eq., liquid at a normal temperature, a viscosity (at 25° C.) of 100,000 mPa·s, manufactured by DIC Corporation
EXA-4850-150: trade name, a bisphenol A epoxy resin, an epoxy equivalent of 410 to 470 g/eq., liquid at a normal temperature, a viscosity (at 25° C.) of 15,000 mPa·s, manufactured by DIC Corporation
EG-200: trade name: “OGSOL EG-200”, a fluorene epoxy resin, an epoxy equivalent of 292 g/eq., semi-solid at a normal temperature, manufactured by Osaka Gas Chemicals Co., Ltd.
YSLV-80XY: trade name, a bisphenol F epoxy resin, an epoxy equivalent of 180 to 210 g/eq., solid at a normal temperature, a melting point of 75 to 85° C., manufactured by Nippon Steel Chemical Co., Ltd.
EPPN: trade name: “EPPN-501HY”, a triphenylmethane epoxy resin, an epoxy equivalent of 163 to 175 g/eq., solid at a normal temperature, a softening point of 57 to 63° C., manufactured by Nippon Kayaku Co., Ltd.
HP-7200: trade name: “EPICLON HP-7200”, a dicyclopentadiene epoxy resin, an epoxy equivalent of 254 to 264 g/eq., solid at a normal temperature, a softening point of 56 to 66° C., manufactured by DIC Corporation
1002: trade name: “JER1002”, a bisphenol A epoxy resin, an epoxy equivalent of 600 to 700 g/eq., solid at a normal temperature, a softening point of 78° C., manufactured by Mitsubishi Chemical Corporation
1256: trade name: “JER1256”, a bisphenol A epoxy resin, an epoxy equivalent of 7500 to 8500 g/eq., solid at a normal temperature, a softening point of 85° C., manufactured by Mitsubishi Chemical Corporation
MEH-7800-S: trade name, a phenol-aralkyl resin, a curing agent, a hydroxyl group equivalent of 173 to 177 g/eq., manufactured by MEIWA PLASTIC INDUSTRIES, LTD.
MEH-7800-SS: trade name, a phenol-aralkyl resin, a curing agent, a hydroxyl group equivalent of 173 to 177 g/eq., manufactured by MEIWA PLASTIC INDUSTRIES, LTD.
2P4MHZ-PW: trade name: “Curezol 2P4MHZ-PW”, a 2-phenyl-4-methyl-5-hydroxymethyl imidazole, an imidazole compound, a curing accelerator, manufactured by Shikoku Chemicals Corporation
2MAOK-PW: trade name, a 2,4-diamino-6-[2′-methylimidazolyl-(1′)]-ethyl-s-triazine isocyanuric acid adduct, a curing accelerator, manufactured by Shikoku Chemicals Corporation, a decomposition point (a melting point) of 260° C.
Sylgard 184: trade name, a silicone resin, manufactured by Dow Corning Toray Co., Ltd.
Art-333 MEK 75% solution: trade name: “Art-Resin UN-333”, an acrylate-modified urethane rubber, solvent: methyl ethyl ketone, a content ratio of rubber composition of 75 mass %, an average number of vinyl group: 2, a vinyl group equivalent of 2500 g/eq., a weight average molecular weight of 5,000, manufactured by Negami Chemical Industrial Co., Ltd.
Art-5507 MEK 70.6% solution: trade name: “Art-Resin UN-5507”, an acrylate-modified urethane rubber, solvent: methyl ethyl ketone, a content ratio of rubber composition of 70.6 mass %, an average number of vinyl group: 2, a vinyl group equivalent of 1100 g/eq., a weight average molecular weight of 17,000, manufactured by Negami Chemical Industrial Co., Ltd.
XER-32C: trade name, a carboxy-modified NBR, manufactured by JSR Corporation
1072J: trade name: “Nipol 1072J”, a carboxy-modified NBR, manufactured by ZEON CORPORATION
DN631: trade name: “Nipol DN631”, a carboxy-modified NBR, manufactured by ZEON CORPORATION
SIBSTAR: trade name: “SIBSTAR 072T”, a styrene-isobutylene-styrene block copolymer (SIBS), manufactured by Kaneka Corporation
BR-1220: trade name: “Nipol BR-1220”, a modified-polybutadiene rubber, manufactured by ZEON CORPORATION
PB3600: trade name: “EPOLEAD PB3600”, an epoxy-modified polybutadiene, a number average molecular weight of 5900, manufactured by Daicel Corporation
AT501: trade name: “EPOFRIEND AT501”, an epoxy-modified SBR, a styrene content of 40 mass %, manufactured by Daicel Corporation
SG-P3 MEK 15% solution: trade name: “Teisan Resin SG-P3”, an epoxy-modified ethyl acrylate-butyl acrylate-acrylonitrile copolymer, solvent: methyl ethyl ketone, a content ratio of rubber composition of 15 mass %, a weight average molecular weight of 850,000, an epoxy equivalent of 210 eq./g, a theoretical glass transition temperature of 12° C., manufactured by Nagase ChemteX Corporation
SG-280TEA toluene/ethyl acetate 15% solution: trade name: “Teisan Resin SG-280TEA”, solvent: toluene/ethyl acetate, a content ratio of rubber composition of 15 mass %, a carboxy-modified butyl acrylate-acrylonitrile copolymer, a weight average molecular weight of 900,000, an acid value of 30 mgKOH/g, a theoretical glass transition temperature of −29° C., manufactured by Nagase ChemteX Corporation
SG-80H MEK 18% solution: trade name: “Teisan Resin SG-80H”, an epoxy-modified ethyl acrylate-butyl acrylate-acrylonitrile copolymer, solvent: methyl ethyl ketone, a content ratio of rubber composition of 18 mass %, a weight average molecular weight of 350,000, an epoxy equivalent of 0.07 eq./kg, a theoretical glass transition temperature of 11° C., manufactured by Nagase ChemteX Corporation
LA2140e: trade name: “KURARITY LA2140e”, a methyl methacrylate-n-butyl acrylate-methyl methacrylate block copolymer, manufactured by KURARAY CO., LTD.
LA2250: trade name: “KURARITY LA2250”, a methyl methacrylate-n-butyl acrylate-methyl methacrylate block copolymer, manufactured by KURARAY CO., LTD.
AR31: trade name: “Nipol AR31”, an acrylic rubber, a glass transition temperature of −15° C., a decomposition temperature of 300° C., a Mooney viscosity of 40 ML1+4 (at 100° C.), a specific gravity of 1.10, manufactured by ZEON CORPORATION
IRGACURE907: trade name, 2-methyl-1-[4-(methylthio)phenyl]-2-morpholinopropane-1-one, an α-aminoketone compound, a photopolymerization initiator, manufactured by NAGASE & CO., LTD.
DETX-S: trade name: “KAYACURE DETX-S”, 2,4-dimethylthioxanthone, a thioxanthone compound, a photopolymerization initiator, manufactured by NAGASE & CO., LTD.
AIBN: 2,2′-azobisisobutyronitrile, an azo compound, a thermal polymerization initiator
STN: trade name: “LUCENTITE STN”, synthetic smectite, manufactured by CO-OP CHEMICAL CO., LTD.
BYK-2095: trade name: “DISPER BYK-2095”, a mixture of polyaminoamide salt and polyester, a dispersant, manufactured by BYK Japan KK

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The thermally conductive sheet of the present invention can be used for various industrial products and an example thereof includes a heat dissipating sheet to be attached to or to be covered with, for example, an electronic component and a mounted substrate in which the electronic component is mounted on a substrate.

1. A thermally conductive sheet formed from a thermally conductive composition containing boron nitride particles in a plate shape and a rubber component, wherein
the content ratio of the boron nitride particles in the thermally conductive sheet is 35 vol % or more and
the thermal conductivity in a direction perpendicular to a thickness direction of the thermally conductive sheet is 4 W/m·K or more.

2. The thermally conductive sheet according to claim 1, wherein
the thermally conductive sheet has the maximum elongation in the direction perpendicular to the thickness direction in a tensile test of 101.7% or more.

3. The thermally conductive sheet according to claim 1, wherein
a rubber-containing sheet has a shear storage elastic modulus of 5.6×10³ to 2×10⁵ Pa at least any temperature in a temperature range of 20 to 150° C. when the temperature of the rubber-containing sheet is increased under the following conditions:
a temperature rising rate of 2° C./min, and
a frequency of 1 Hz,
the rubber-containing sheet being formed from a rubber-containing composition obtained by excluding the boron nitride particles from the thermally conductive composition.

4. The thermally conductive sheet according to claim 1, wherein
the thermally conductive sheet has a 90 degree peel adhesive force of 2 N/10 mm or more when the thermally conductive sheet is peeled at 90 degrees and a rate of 10 mm/min from a copper foil after bonding the thermally conductive sheet to the copper foil.

5. The thermally conductive sheet according to claim 1, wherein
the thermally conductive composition further contains an epoxy resin composition.
